(19) United States
(12) Patent Application Publication
(10) Pub. No.: US 2024/0409720 A1
(43) Pub. Date: Dec. 12, 2024

(54) CARBON PARTICLE COMPOSITIONS AND METHODS OF GENERATING THE SAME

(71) Applicant: Monolith Materials, Inc., Lincoln, NE (US)

(72) Inventors: Ned J. Hardman, Houston, TX (US); Christopher G. Robertson, Akron, OH (US); Lucas A. Wilke, Lincoln, NE (US); Daniel A. Karsten, Lincoln, NE (US)

(21) Appl. No.: 18/736,457

(22) Filed: Jun. 6, 2024

Related U.S. Application Data
(63) Continuation of application No. PCT/US2024/032863, filed on Jun. 6, 2024.
(60) Provisional application No. 63/471,461, filed on Jun. 6, 2023.

(51) Int. Cl. C08K 9/06; C08K 3/06; C08K 5/47

(52) U.S. Cl. CPC C08K 9/06; C08K 3/06; C08K 5/47; C08K 2201/001

(57) ABSTRACT

The present disclosure provides compositions comprising carbon particles, such as carbon black. Compositions may comprise rubber, for example rubber usable for tires, and carbon black as a filler compound. Carbon black filler compounds may comprise carbon black particles generated by thermal plasma methane pyrolysis and one or more binders configured to pelletize the carbon black particles.

### CROSS-REFERENCE

This application a continuation of International Application No. PCT/US2024/032863, filed Jun. 6, 2024, and is related to and claims the benefit of priority under 35 U.S.C. § 119(e) from U.S. Provisional Patent Application No. 63/471,461, filed Jun. 6, 2023, the disclosure of which is expressly incorporated herein by reference in its entirety.

### BACKGROUND

There is a significant industrial need for more environmentally friendly fillers for rubber compositions used in tires. Toward meeting the global societal drive for more sustainable products, major tire manufacturers have announced specific targets for lower carbon emissions and higher sustainable materials usage associated with their tire products by a certain year. For example, some of the top global tire manufacturers have set goals to produce tires from 100% sustainable materials and to reach net-zero carbon emissions (carbon neutrality) by the year 2050. Particulate fillers used in tire rubber compositions account for about 25% of the weight of a tire, and such fillers are predominantly various grades of furnace carbon black. Every ton of carbon black produced using a furnace process (“furnace carbon black” or “furnace black” herein) generates substantial harmful emissions, including multiple tons of carbon dioxide (CO₂) and tens of kilograms of nitrogen oxides (NOx) and sulfur oxides (SOx). An alternative process, pyrolysis of end-of-life tires, yields a carbon filler material substantially inferior to virgin furnace carbon black when compounded into rubber compounds for vehicle tires. Bio-based materials, including their pyrolysis products, have been investigated as fillers toward potential use in tires, but these materials also impart inferior properties to rubber formulations compared to furnace carbon black, and they are not produced at sufficient scale for supplying the tire industry.

There is also a need to increase thermal conductivity of rubber compositions used in tires to promote faster curing (vulcanization) of the tire components, which improves productivity and reduces energy consumption in manufacturing. Higher thermal conductivity of tire compounds is especially desired in the manufacturing of large tires for heavy trucks, construction and mining equipment, tractors, and the like. Increased thermal conductivity also enhances tire durability by improving heat transfer, which helps to counter viscoelastic heat generation during tire use. Tire rubber compounds are hysteretic viscoelastic materials that dissipate mechanical deformation, which produces heat (viscoelastic heat generation). Any heat that is not transferred out of the material by heat transfer causes the temperature to rise, hence the tire industry's strong impetus for improving heat transfer of tire compositions by increasing the thermal conductivity. At constant hysteresis (dissipation) and constant related heat generation, a higher thermal conductivity will reduce the temperature of a dynamically deforming tire component. The rates of fatigue cracking, wear, and degradation of tire compositions will decrease as temperature is decreased. Improved tire durability from lower operating temperature yields safer tires and longer tire lifetime, the latter having positive environmental effects.

There are currently no low-emission solutions for substantially increasing the thermal conductivity of tire compositions without detrimentally affecting other tire performance characteristics. A few specialty fillers with high thermal conductivity exist, such as boron nitride, but these are non-reinforcing fillers with micrometer-sized particles that have negative impacts on mechanical stiffness (reinforcement), durability, and other properties when used to replace traditional fillers such as furnace carbon black and precipitated silica.

The embodiments described herein meet the challenges described above. As such, the present disclosure provides a solution that mitigates climate change through capture, storage and/or sequestration of greenhouse gases (e.g., CO₂ and methane) by using a combustion-free (low emission) thermal plasma process to generate carbon black fillers and/or by converting methane into carbon black fillers for use in tire rubber compositions and rubber articles, thereby reducing greenhouse gas emissions, reducing and/or preventing additional greenhouse gas emissions, and/or mitigating climate change in the production of goods.

### SUMMARY

The present disclosure provides compositions comprising carbon particles, for example carbon black particles, and methods of making the same. Carbon particles may be generated via a thermal plasma process (e.g., pyrolysis of methane). Carbon particles may be contacted with a binder to pelletize the carbon particles. The pelletized carbon particles may be compounded in rubber, for example, a rubber formulation for use in a tire.

In an aspect, the present disclosure provides a rubber article comprising at least 2% by weight of a plasma carbon black filler compounded therein. The rubber article may be a tire component such as an inner liner, a sidewall, a sub-tread, a bead skim, a wire skim, a tread, or a body ply skim.

In some embodiments, the rubber article may also include at least 10% by weight of natural rubber, butadiene rubber, halobutyl, butyl rubber, isoprene rubber, chloroprene rubber, EPDM, and/or synthetic elastomer.

In some embodiments, the rubber article may also include precipitated silica, recovered carbon, furnace carbon black, graphene, lignin, carbon nanotubes, and/or clay. In some embodiments, the ratio of plasma carbon black filler to the precipitated silica, recovered carbon, furnace carbon black, graphene, lignin, carbon nanotubes, or clay may be in a range of 1:10 to 10:1. In some embodiments, the precipitated silica, recovered carbon, or furnace carbon black may be present in a range of 15 phr to 60 phr.

In some embodiments, the rubber article may have an enhanced (increased) thermal conductivity compared to another rubber article of the same type that includes furnace carbon black filler and no plasma carbon black filler. In various embodiments, the enhanced thermal conductivity may be at least 0.33 W/mK or exceed a thermal conductivity of the other (non-plasma carbon black containing) rubber article by at least 5% or by at least 20%.

In some embodiments, the rubber article may include at least 0.2% by weight of MBT (mercaptobenzothiazol) or MBTS (2,2′ dibenzothiazyl disulfide). In some embodiments, the rubber article may include sulfur in a range of about 0.05 to 5% by weight.

In some embodiments, the rubber article may have an enhanced diffusion compared to a second rubber article of the same type that comprises furnace carbon black filler and no plasma carbon black filler.

In some embodiments, the rubber article may have a reduced viscoelastic loss tangent (tan δ) compared to a second rubber article of the same type that includes furnace carbon black in a weight percentage within 20% of the plasma carbon black filler in the rubber article and no plasma carbon black filler. In some embodiments, the reduced viscoelastic loss tangent (tan δ) may be at least 2% lower than a viscoelastic loss tangent of the second rubber article.

In another aspect, the present disclosure provides a carbon particle made via a thermal plasma process that may have a centrifugal particle sedimometry (CPS) measured equivalent sphere diameter of less than 1 micrometer, a lattice constant (Lc) greater than 3 nanometers (nm), and a deviation of less than 20% between a measured aggregate diameter and a calculated aggregate diameter, where the measured aggregate diameter is a Z-average value measured by dynamic light scattering (DLS) and the calculated aggregate diameter (Da) is determined by the equation [Da=(2540+(71*OAN))/STSA].

In some embodiments, the carbon particle may include a silane added to the carbon particle after the carbon particle is pelletized and dried. In some embodiments, a silicon content of the carbon particle may be greater than 0.05% but less than 1%.

In another aspect, the present disclosure provides a rubber article comprising an elastomer composition, where the elastomer composition includes a plasma carbon black filler having (i) a statistical thickness surface area (STSA) and an oil absorption number (OAN) within 15% of a comparative STSA and OAN of a comparative furnace carbon black filler and (ii) a thermal conductivity at least 10% greater than a comparative thermal conductivity of a comparative elastomer composition comprising the comparative furnace carbon black filler.

In another aspect, the present disclosure provides a rubber article comprising an elastomer composition, where the elastomer composition includes a plasma carbon black filler having (i) a tensile stress at 100% strain (M100), calculated average aggregate diameter (Da), or Shore A hardness within 15% of a comparative M100, Da, or Shore A hardness of a comparative elastomer composition that comprises a furnace carbon black filler and (ii) a thermal conductivity at least 10% greater than a comparative thermal conductivity of the comparative elastomer composition.

In another aspect, the present disclosure provides a tire comprising two sidewalls, two bead skims, and a tread, each sidewall configured to connect one of the two bead skims to the tread, and at least one of the two sidewalls, two bead regions, and tread comprising thermal plasma carbon black.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative, and not restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. Abetter understanding of the features and advantages of the present disclosure will be obtained by reference to the following detailed description that sets forth illustrative embodiments, in which the principles of the present disclosure are utilized, and the accompanying drawings (also “Figure” and “FIG.” herein), of which:

FIG. 1 shows a schematic representation of a method of generating a carbon particle composition according to one or more embodiments of the present disclosure;

FIG. 2 shows a schematic representation of an example apparatus that can be used to provide a carbon particle according to one or more embodiments of the present disclosure;

FIG. 3 shows a schematic representation of an example apparatus that can be used to provide a carbon particle according to one or more embodiments of the present disclosure;

FIG. 4 shows a schematic representation of an example apparatus that can be used to provide a carbon particle according to one or more embodiments of the present disclosure;

FIG. 5 shows a schematic representation of an example system that can be used to provide a carbon particle according to one or more embodiments of the present disclosure;

FIG. 6 shows a schematic representation of an example system that can be used to provide a plasma carbon black according to one or more embodiments of the present disclosure;

FIG. 7 shows a schematic representation of an example process that can be used to provide a plasma carbon black according to one or more embodiments of the present disclosure;

FIG. 8 shows a schematic representation of an example cross section of a vehicle tire according to one or more embodiments of the present disclosure;

FIG. 9 shows an example graph of thermal conductivity as a function of oil absorption number (OAN) for a Sidewall Formulation with various examples of furnace carbon black and plasma carbon black compounded therein, according to one or more embodiments of the present disclosure;

FIG. 10 shows an example graph of thermal conductivity as a function of nitrogen surface area (N2SA) for a Sidewall Formulation (with various examples of furnace carbon black and plasma carbon black compounded therein, according to one or more embodiments of the present disclosure;

FIG. 11 shows an example graph of thermal conductivity as a function of OAN and compressed oil absorption number (COAN) for an Inner Liner Formulation with various examples of furnace carbon black and plasma carbon black compounded therein, according to one or more embodiments of the present disclosure;

FIG. 12 shows an example graph of thermal conductivity as a function of Shore A hardness for a Body Ply Skim Formulation with varied carbon black loading (43, 50, and 57 phr) for various examples of furnace carbon black and plasma carbon black compounded therein, according to one or more embodiments of the present disclosure;

FIG. 13 shows an example graph of thermal conductivity (k) as a function of 100% modulus (M100) for a Body Ply Skim Formulation with varied carbon black loading (43, 50, and 57 phr) for various examples of furnace carbon black and plasma carbon black compounded therein, according to one or more embodiments of the present disclosure;

FIG. 14 shows an example graph of thermal conductivity (k) as a function of 300% modulus (M300) for a Body Ply Skim Formulation with varied carbon black loading (43, 50, and 57 phr) for various examples of furnace carbon black and plasma carbon black compounded therein, according to one or more embodiments of the present disclosure;

FIG. 15 shows an example graph of stress versus strain for a Body Ply Skim Formulation with various examples of furnace carbon black and plasma carbon black (baseline and modifications 1-4) compounded therein, according to one or more embodiments of the present disclosure;

FIG. 16 shows an example graph of thermal conductivity as a function of OAN and COAN for a Tread Formulation with various examples of furnace carbon black and plasma carbon black compounded therein, according to one or more embodiments of the present disclosure; and

FIG. 17 shows an example graph of thermal conductivity as a function of Z-average aggregate diameter for a Tread Formulation with various examples of furnace carbon black and plasma carbon black compounded therein, according to one or more embodiments of the present disclosure.

### DETAILED DESCRIPTION

While various embodiments of the present disclosure are shown and described herein, those skilled in the art will understand that such embodiments are provided by way of example only. Numerous variations, changes, and substitutions may occur to those skilled in the art without departing from the present disclosure. It should be understood that various alternatives to the embodiments described herein may be employed.

Whenever the term “at least,” “greater than,” or “greater than or equal to” precedes the first numerical value in a series of two or more numerical values, the term “at least,” “greater than,” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain embodiments herein contemplate numerical ranges. When ranges are present, the ranges include the range endpoints. Additionally, every sub range and value within the range is present as if explicitly written out. The term “about” or “approximately” may mean within an acceptable error range for the particular value, which will depend in part on how the value is measured or determined, e.g., the limitations of the measurement system. For example, “about” may mean within one or more than one standard deviation, per the practice in the art. Alternatively, “about” may mean a range of up to 20%, up to 10%, up to 5%, or up to 1% variation with respect to a given value. Where particular values are set forth herein, unless otherwise stated, it may be assumed that the term “about” means within an acceptable error range for the particular value.

Carbon black manufacture utilizing a thermal plasma process to crack a hydrocarbon feedstock (e.g., methane pyrolysis) may have cost and pollution-reducing advantages over the furnace process. The plasma based carbon black generating process may be low-emission, emitting near-zero local carbon dioxide (CO₂) and near-zero amounts of sulfur dioxides (SOx) and nitrogen oxides (NOx) for every ton of carbon black produced—compared to multiple tons of CO₂ and tens of kilograms of NOx and SOx for the furnace process. Plasma pyrolysis of methane may be as described in U.S. Pat. No. 10,808,097, incorporated by reference herein.

The hydrocarbon feedstock may include any chemical within the formula CₙHₓ or CₙHₓO_{y}, where: n is an integer; x is (i) between 1 and 2n+2 or (ii) less than 1 for fuels such as coal, coal tar, pyrolysis fuel oils, and the like; and y is between 0 and n. The hydrocarbon feedstock may include, for example, simple hydrocarbons (e.g., methane, ethane, propane, butane, etc.), aromatic feedstocks (e.g., benzene, toluene, xylene, methyl naphthalene, pyrolysis fuel oil, coal tar, coal, heavy oil, oil, bio oil, biodiesel, other biologically derived hydrocarbons, and the like), unsaturated hydrocarbons (e.g., ethylene, acetylene, butadiene, styrene, and the like), oxygenated hydrocarbons (e.g., ethanol, methanol, propanol, phenol, ketones, ethers, esters, and the like), or any combination thereof. The hydrocarbon feedstock may comprise or be natural gas. Sustainable hydrocarbon feedstocks also can be used, for example, feedstocks sourced from bio-matter or comprising at least 10% biological matter that contain a substantial amount of carbon-14 (C14) compared to fossil fuels (e.g., C14:C12 ratios of at least 1.35*10⁻¹⁴). Examples of sustainable feedstocks include renewable natural gas generated from landfills, raw sewage, manure, livestock, or other sources, and feedstocks generated from the pyrolysis of end of life tires in the form of a gaseous hydrocarbon mixture, a liquid hydrocarbon mixture, and/or a carbonaceous solid. Other sustainable hydrocarbon feedstocks that do not contain C14 include processed end of life plastics that can be used to generate aliphatic and aromatic hydrocarbons suitable for use in gas or liquid form. These non-limiting examples of acceptable feedstocks need only have a hydrocarbon component (i.e., need not be 100% or even majority hydrocarbon) and may be further combined and/or mixed with other components, including, for example, to ensure an amount of sustainable hydrocarbon feedstock is used in the thermal plasma process.

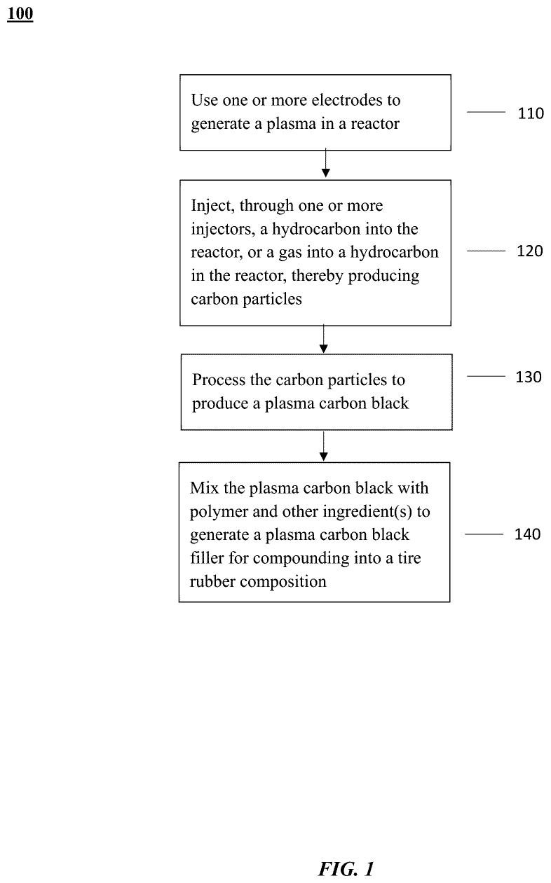

FIG. 1 shows an example method of generating a carbon particle composition 100 according to one or more embodiments of the present disclosure. Method 100 may comprise using one or more electrodes to generate a plasma in a reactor (operation 110), and injecting, through one or more injectors, a hydrocarbon into the reactor, or a gas into a hydrocarbon in the reactor, thereby producing carbon particles (operation 120). The term “carbon particle” may refer to a particle comprising carbon. Method 100 may comprise processing the carbon particles to produce a plasma carbon black (operation 130). The term “plasma carbon black” (also referred to as “plasma black,” “thermal plasma black,” or “thermal plasma carbon black” herein) refers to a carbon black produced from operations 100-130, which collectively may be referred to as a “thermal plasma process.”

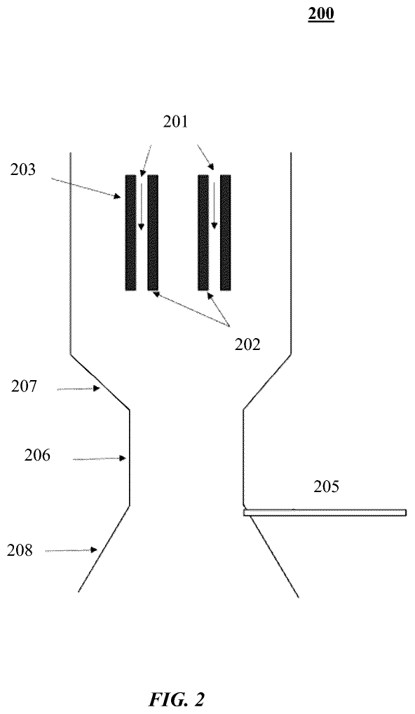

Operations 110, 120, and 130 of FIG. 1 are further described with reference to schematics of example apparatuses and/or systems that can be used to provide a carbon black particle, as shown in FIGS. 2, 3, 4, and 7. FIG. 2 shows a schematic representation of an example apparatus 200. A thermal transfer gas (e.g., plasma gas) 201 that may include one or more of, for example, nitrogen, argon, helium, hydrogen, carbon monoxide, hydrocarbon (e.g., methane, ethane, unsaturated), air, oxygen, etc. may be injected into an annulus created by electrodes that are positioned in an upper chamber in a concentric fashion. Plasma forming electrodes may comprise an inner electrode 202 and an outer electrode 203. The thermal transfer gas also may be injected inside the inner electrode 202 and outside the outer electrode 203. A sufficiently large voltage may be applied between the two electrodes. The electrodes may comprise or be made of copper, tungsten, graphite, molybdenum, silver, etc. The thus-formed plasma may enter into a reaction zone where it may react/interact with a hydrocarbon feedstock that is fed at hydrocarbon injector(s) 205 to generate a carbon particle. The walls of the vessel (e.g., comprising or constructed of refractory, graphite, cooled, etc.) may withstand the plasma forming temperatures. The hydrocarbon injector(s) 205 may be located anywhere on a plane at or near a throat 206 below a converging region 207 or further downstream of the throat 206 in a diverging region 208 of the reactor. Hydrocarbon injector tips may be arranged, for example, concentrically around the injection plane. There may be at least 6 injectors and at least 18 tips of this sort, or a slot, or a continuous slot, as non-limiting examples.

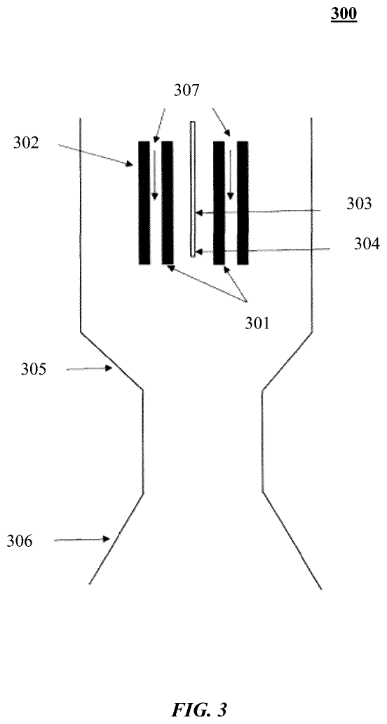

FIG. 3 shows a schematic representation of another example of an apparatus 300 comprising inner and outer electrodes, 301 and 302, respectively, comprising concentric rings of electrically conductive material (e.g., graphite). Thermal transfer gas (e.g., plasma gas) 307 may flow through the annulus between the two electrodes where an arc may then excite the gas into the plasma state. The arc may be controlled through the use of a magnetic field which moves the arc in a circular fashion rapidly around the electrode tips. In this example, the hydrocarbon may be injected at a hydrocarbon injector 303 (e.g., at a hydrocarbon injector tip 304) through the center of the concentric electrodes via the hydrocarbon injector 303. In some examples, the hydrocarbon injector 303 may be, for example, water-cooled. The hydrocarbon injector tip may be placed to a point above the bottom plane of the electrodes, or it can be below the plane, or in the same plane (e.g., at the same height as the plane). In some implementations, the apparatus may comprise converging region(s) 305 leading to a narrowing of the reactor and then diverging region(s) 306 downstream of the converging region(s).

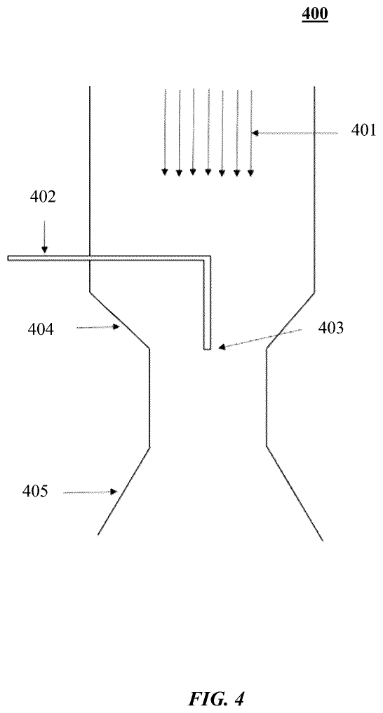

FIG. 4 shows a schematic representation of another example of an apparatus 400. In this example, hot thermal transfer gas 401 may be generated in an upper portion of the reactor through the use of three or more AC electrodes, through the use of concentric DC electrodes (e.g., as shown in FIGS. 2 and 3), or through the use of a resistive or inductive heater. The hot thermal transfer gas may comprise, for example, at least about 50% hydrogen by volume that may be at least about 1,800° C. A hydrocarbon injector 402 may be cooled (e.g., water-cooled). The hydrocarbon injector 402 may enter from the side of the reactor (e.g., as shown, or at a suitable location as described elsewhere herein), and may then turn into an axial position with respect to the thermal transfer gas (hot gas) flow. A hydrocarbon injector tip 403 may comprise or be one opening or a plurality of openings (e.g., that may inject hydrocarbons in clockwise or counter-clockwise flow patterns (e.g., to optimize mixing)). The reactor may comprise converging region(s) 404. The converging region(s) 404 may lead to a narrowing of the reactor and/or to diverging region(s) 405 downstream of the converging region(s). See, for example, commonly assigned Int. Pat. Pub. Nos. WO 2017/044594 (“CIRCULAR FEW LAYER GRAPHENE”) and WO 2017/048621 (“CARBON BLACK FROM NATURAL GAS”), each incorporated by reference herein.

While the example reactor apparatuses shown in FIGS. 2, 3, and 4 have a vertical orientation with downward flow, an upward flow or a horizontal reactor orientation may be used.

A silicon additive may be supplied in the hot zone of a thermal plasma reactor during particle formation. For example, a silicon additive may be present in the effluent stream of hydrocarbon, hydrogen, and silicon additive at less than 1% (e.g., less than 0.5%) in terms of moles of silicon per moles of carbon atoms. The silicon atoms can be supplied through solid addition, gaseous injection, or liquid injection. Use of silicon provides for a lower reaction temperature, which may result in greater energy efficiency and lower power consumption. The silicon can be present in the final pelletized carbon black product as elemental silicon, silicon carbide, or silicon oxide, or a mixture of these (e.g., a silicon oxycarbide). Addition of the silicon species may result in an increase in ash content in a carbon particle from 0.01% to 0.05% to over 0.2% but less than 1.5%.

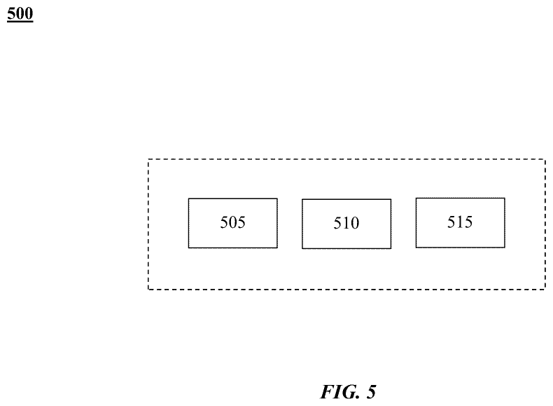

FIG. 5 schematically shows an example system 500 that can be used to provide a carbon particle according to one or more embodiments of the present disclosure. The apparatus may be configured to enable, for example, thermal generation (e.g., heating) 505, injection 510, and reaction 515. For example, the apparatus may comprise one or more constant diameter regions/sections, one or more converging regions/sections, one or more diverging regions/sections, one or more inserts or other additional components, or any combination thereof. Such regions/sections, and/or inserts or other additional components, may be combined in various ways to implement the thermal generation (e.g., heating) 505, injection 510, and reaction 515. Such implementations may include, but are not limited to, configurations as described in relation to the schematic representations in FIGS. 2, 3, and 4. For example, a region/section where thermal generation 505 is implemented may or may not be separated by a throat from a reaction region/section where reaction 515 is implemented, injection 510 may or may not be downstream from the thermal generation 505, etc.

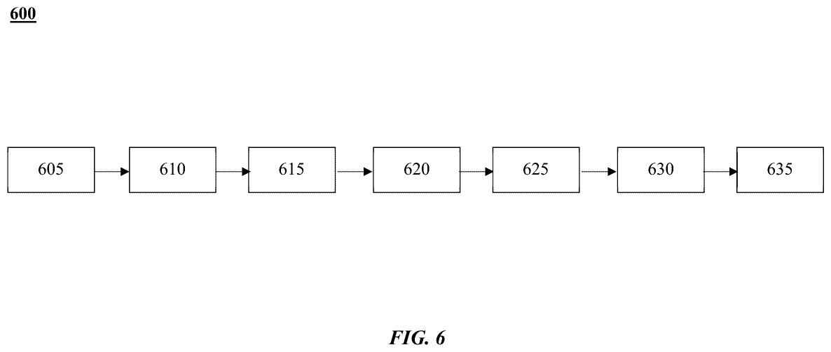

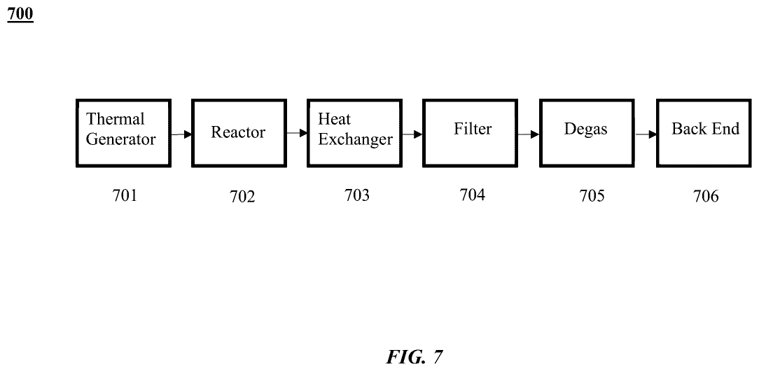

Returning to FIG. 1, a method or system of the present disclosure may include processing the carbon particles to produce a plasma carbon black (operation 130), which processing may comprise or use one or more of a heat exchanger (e.g., connected to the reactor), a main filter (e.g., connected to the heat exchanger), a degas (e.g., product inerting) apparatus (e.g., chamber) (e.g., connected to the filter), and a back end. Operation 130 of FIG. 1 is further described with reference to FIGS. 6 and 7, which show schematic representations of an example system and process, respectively, that can be used to provide a plasma carbon black according to embodiments of the present disclosure.

FIG. 6 shows an example of a system 600 configured to implement a process of the present disclosure. The system may comprise a thermal activation chamber (e.g., a plasma chamber) 605, a throat and/or other region 610, and a reactor 615 (generally relevant to operations 110 and 120 of FIG. 1), as well as a heat exchanger 620, a filter 625, a degas (e.g., degas chamber) 630, a back end 635, or combinations thereof (generally relevant to operation 130 of FIG. 1).

FIG. 7 shows an example of a flow chart of a process 700. The process may begin by way of heat generation in a thermal generator 701. The process may include one or more of the steps of heating the gas (e.g., thermal transfer gas), adding the hydrocarbon to the hot gas, and passing the stream through a reactor 702 (as described, for example, in relation to FIGS. 2-5) to generate carbon particles. The process also may include using one or more of a heat exchanger 703, filter 704, degas (e.g., degas chamber) 705, and back end 706. The hot gas may be a stream of hot gas at an average temperature of at least about 1,800° C. In some implementations, the process(es) described herein may be substantially free of atmospheric oxygen. The process may include heating a gas (e.g., comprising 50% or greater by volume hydrogen) and then adding this hot gas to a hydrocarbon at 701. Heat may (e.g., also) be provided through latent radiant heat from the wall of the reactor. This may occur through heating the walls via externally provided energy or through heating the walls from the hot gas. The heat may be transferred from the hot gas to the hydrocarbon feedstock; this heat transfer may occur immediately upon addition of the hydrocarbon feedstock to the hot gas in the reactor or the reaction zone 702. The hydrocarbon may begin to crack and decompose before being fully converted into carbon particles. The reaction products may be cooled after manufacture.

A system of the present disclosure may be configured to implement an enclosed process, for example, using an enclosed particle generating reactor. The system (the process) may include one or more of a thermal generator (e.g., a plasma generator), a thermal activation chamber (e.g., a plasma chamber), a reactor or reaction chamber, above a throat and/or other region (e.g., as described in relation to FIGS. 2-5), a main filter, and/or a degas chamber (e.g., as described in relation to FIGS. 6-7). These components may be substantially free of oxygen and other atmospheric gases. The process (or portions thereof) may allow only a given atmosphere. For example, oxygen may be excluded or dosed at a controlled amount of, for example, less than about 5% by volume in the enclosed process.

With reference to the example thermal plasma system and process schematics of FIGS. 6-7, the carbon particles (e.g., plasma carbon black particles) may be produced in an admixture of an effluent stream of hot gas containing combustible gas which exits the reactor (e.g., 615 or 702) into contact with a heat exchanger (e.g., 620 or 703). The effluent stream of hot gas containing combustible gas may be (e.g., subsequently) passed through a filter (e.g., 625 or 704), capturing substantially all of the carbon particles (e.g., carbon black particles) on the filter. The gas may (e.g., subsequently) pass through a degas apparatus (e.g., 630 or 705) where the amount of combustible gas is reduced to less than about 10% by volume. The combustible gas may comprise or be hydrogen. The carbon particles (e.g., plasma carbon black particles) may (e.g., subsequently) enter a back end (e.g., 635 or 706) and mixed with water with a binder and then formed into pellets, followed by removal of the majority of the water in a dryer.

A quench (not shown) may be used to cool the reaction products. For example, a quench comprising a majority of hydrogen gas may be used. The quench may be injected in the reactor portion of the process.

A heat exchanger may be used (e.g., 620 or 703) to cool the process gases. In the heat exchanger, the process gases may be exposed to a large amount of surface area and thus allowed to cool, while the product stream may be simultaneously transported through. Due to the elevated temperatures in the plasma processes of the present disclosure, heat exchange may be more efficient than, for example, in the furnace process. The heat exchanger may be configured, for example, as described in Int. Pat. Pub. Nos. WO 2016/126599 (“CARBON BLACK GENERATING SYSTEM”) and WO 2017/034980 (“HIGH TEMPERATURE HEAT INTEGRATION METHOD OF MAKING CARBON BLACK”), incorporated by reference herein. For a given configuration, energy removed may depend, for example, on operating conditions and/or plasma carbon black grade. The carbon particles may be produced in an admixture of/with an effluent stream of hot gas which exits the reactor into contact with a heat exchanger. The heat exchanger may reduce the thermal energy of the effluent stream of gases and carbon particles by greater than about 5000 kilojoules/kilogram (kJ/kg) of carbon particles.

The effluent stream of gases and carbon particles may be (e.g., subsequently) passed through a filter (e.g., 625 or 704) which allows more than 50% of the gas to pass through, capturing substantially all of the carbon particles on the filter. At least about 98% by weight of the carbon particles may be captured on the filter.

The carbon particles may be degassed (e.g., 630 or 705). Hydrogen and/or other combustible gases may be separated from the pores and/or interstitial spaces of a carbon particle production stream (e.g., formed in a plasma torch reactor system, or other system for making carbon particles that results in the gases made in forming the carbon particles containing more than about 40% combustible gases). A one-step process may contain the reactants and products up until a degas step has been completed to remove the combustible gas(es) (e.g., hydrogen) produced from the cracking of the hydrocarbon feedstock (e.g., methane). Hydrogen, a highly combustible gas, may be separated from the as-produced carbon particles in order to manipulate the carbon particles. Such combustible gases may be removed (e.g., to a safe level where an explosion cannot take place or to create an inert environment) by, for example, varying the pressure (pressure swing method) or temperature (temperature swing method), or discharging the carbon particles produced into an upward flowing stream of inert gas (counter-current method) (e.g., replacing the combustible gas with an inert gas, thereby rendering the carbon particles safe to process in downstream equipment). The inert gas may be, for example, nitrogen, a noble gas (helium, neon, argon, krypton, xenon etc.), steam, or carbon dioxide, or any combination thereof. The combustible gas(es) (e.g., hydrogen) also may be removed from the carbon particles via diffusion (e.g., placement in filters over time), flowing gas through a mass of carbon particles or through fluidized (e.g., a fluidized bed of) carbon particles, or dilution with an inert gas (e.g., argon). In some examples, removing the combustible gas(es) may refer to reducing the combustible gas(es) to an acceptable volume percentage. For example, degas may be considered to be complete if the hydrogen level has been reduced to less than 20 percent by volume (or other amount). The degas (e.g., 630 or 705) may be, for example, as described in commonly assigned Int. Pat. Pub. No. WO 2016/126599 (“CARBON BLACK GENERATING SYSTEM”), incorporated by reference herein.

The back end (e.g., 635 or 706) of the reactor may include, for example, one or more of a pelletizer (e.g., connected to the degas apparatus), a binder mixing (e.g., binder and water) tank (e.g., connected to the pelletizer), a dryer (e.g., connected to the pelletizer), and/or a bagger. As non-limiting examples of other components, a conveying process, process filter, cyclone, classifier, hammer mill and/or other size reduction equipment (e.g., to reduce the proportion of grit in the product) may be added. Components may be added or removed. See also, for example, U.S. Pat. No. 3,981,659 (“APPARATUS FOR DRYING CARBON BLACK PELLETS”), U.S. Pat. No. 3,309,780 (“PROCESS AND APPARATUS FOR DRYING WET PARTICULATE SOLIDS”) and U.S. Pat. No. 3,307,923 (“PROCESS AND APPARATUS FOR MAKING CARBON BLACK”), each of which is incorporated herein by reference.

Examples of a pelletizer may be found in U.S. Pat. Pub. No. 2012/0292794 (“PROCESS FOR THE PREPARATION OF CARBON BLACK PELLETS”), which is incorporated herein by reference. For the pelletizer, water, binder and carbon particles (e.g., carbon black) may be added together in a pin type pelletizer, processed through the pelletizer, and then dried. The binder:carbon particle ratio may be less than about 0.1:1, and the water:carbon particle ratio may be within a range from about 0.1:1 to about 3:1. Carbon particles having lower dibutyl phthalate (DBP) absorption may use less water to make acceptable quality pellets and so may need less heat. The pelletizing medium (e.g., water) may be heated (e.g., so that the carbon goes into the dryer at a higher temperature). Alternatively, the process may use a dry pelletization process in which a rotating drum densifies the product. The pelletizer may use an oil pelletization process, an example of which may be found in U.S. Pat. No. 8,323,793 (“PELLETIZATION OF PYROLYZED RUBBER PRODUCTS”), which is incorporated herein by reference. A binder oil (e.g., at least one of a highly aromatic oil, a naphthenic oil, and a paraffinic oil) and carbon particles may be added together in the pelletizer. The binder oil may be added into a mixer (e.g., up to about 15 percent by weight) with the carbon particles to form pelletized carbon particles (e.g., a pelletized carbon black). Alternatively, distilled water and ash free binder (e.g., sugar, polyethylene glycol, and/or polyoxyethylene (e.g., polymers of ethylene oxide such as, for example, Tween® 80 and/or Tween® 20 materials)) may be used.

The dryer may be an indirect (e.g., indirect fired or otherwise heated, e.g., by heat exchange with one or more fluids of the system in lieu of combustion) rotary dryer. The dryer may use one or more of air, process gas and purge gas to heat the (e.g., pelletized) carbon particles. In some examples, only purge gas may be used. In some examples, air, with or without purge gas, may be used. In some examples, process gas, with or without purge gas, may be used. In some examples, air and process gas, with or without purge gas, may be used. The dryer may be configured for co-current or counter-current operation (e.g., with a purge gas). The dryer also may be a vibratory fluidized bed comprising a vibrating tray conveyor where hot gases flow through perforations or holes in a tray to contact the carbon pellets to be dried. Vibration of the tray in combination with fluidization of the carbon pellets enables conveyance of the pellets forward as they are dried, as well as creation of different zones in which temperature of the hot gas can be varied to effect a tailored drying protocol. The hot gas can be electrically heated via resistive or plasma based processes, thereby eliminating any need for combustion and consequently any potential CO₂ emissions from the drying process.

The reactor (e.g., 615 or 702) may be operated at atmospheric pressure (about 0 bar) or at a pressure above atmospheric pressure (greater than about 0 bar), for example, at a pressure in a range of about 0 bar to about 100 bar or more, e.g., about 0 to 10 bar, about 0 to 20 bar, about 1 to 10 bar, about 10 to 50 bar, etc., more examples of which can be found in Int. Pat. Pub. No. WO 2016/028658 (“SYSTEMS AND METHODS FOR ELECTRIC PROCESSING”), incorporated herein by reference. For example, the reactor may be operated at a pressure within a range of about 1.1 bar to about 4 bar. The carbon particles formed in a reactor operated at a higher pressure may have a smaller surface area than carbon particles formed in a reactor operated at a lower pressure.

Returning to FIG. 1, in some cases the process 100 may produce hydrogen. For example, in the production of carbon black particles using a thermal plasma process, hydrogen gas can be produced as well. The hydrogen can be discarded or can be collected as an additional product of the process. The hydrogen and the carbon particles can be produced in a once-through, single stage process. For example, the hydrogen and the carbon particles can be produced at a same time (e.g., the process operations that generate the carbon particles can also generate the hydrogen). In this example, the hydrogen and the plasma carbon black can be produced in a single operation of the reactor (e.g., in a same hydrocarbon decomposition operation). The single stage process may provide increased reaction efficiency (e.g., the efficiency of heat transfer from the plasma to the feedstock), enable cost savings due to the types of materials of construction and maintenance possible, and/or have a dense (e.g., optically dense) field of carbon particles at in or in close vicinity of the plasma arc (e.g., provide increased heat transfer into the carbon particles and decreased heat transfer to the walls of the reactor). In some cases, the hydrogen and the carbon particles can be produced in a multi-stage (e.g., two stage, three stage, etc.) process. For example, a two stage process can comprise a first injection of the hydrocarbon and a second injection of the hydrocarbon. Multiple stages can reduce fouling in the reactor or on the electrodes by lowering the amount of hydrocarbon in a given area of the reactor, enable additional process operations to occur between the stages (e.g., a water injection can be performed to remove fouling from the reactor without having to shut down the reactor or disable the plasma), and/or provide increased mixing of the feedstocks into the plasma gas due to the increased velocity and momentum of the plasma gas.

The surface area of the carbon particles may be increased using one or more additives. The one or more additives may be added to the hydrocarbon before, during, or after the hydrocarbon is injected into the reactor. The one or more additives may be injected into the reactor prior to the plasma. Examples of additives include, but are not limited to, hydrocarbons (e.g., hydrocarbon gases), silicon-containing compounds (e.g., siloxanes, silanes, etc.), aromatic additives (e.g., benzene, xylenes, polycyclic aromatic hydrocarbons, etc.), or the like, or any combination thereof.

The systems and methods described herein may be integrated with, coupled to, or otherwise usable with one or more computer systems. The one or more computer systems may be configured to implement or may be otherwise operable to implement the methods described elsewhere herein or monitor the status of the systems described elsewhere herein. For example, one or more computer systems may be used to monitor product or equipment temperature at various points in the process, control or monitor process conditions, such as non-hydrogenous gas, hydrocarbon feedstock, or separated gas flow rates, control or monitor inlet or effluent gas concentrations, control or monitor pretreatment or post-reactor conditions, or any combination thereof. The one or more computer systems may be configured to monitor or may monitor root mean square current and voltages for plasma phase (e.g., each of the three phases for a three phase system), gas flow rates at input and output, input and output water temperatures in systems comprising water cooling loops, water flow rates per loop for systems comprising water cooling loops, or any combination thereof. The one or more computer systems may further monitor internal reactor wall temperatures at different locations within the reactor using, for example, optical pyrometers and Type C thermocouples (e.g., tungsten/rhenium based thermocouples). The average reactor temperatures may be usable as or as an estimate for mean reaction temperature.

With reference to FIG. 1, after the plasma carbon black is produced (through operations 110, 120, and 130 discussed above), the plasma carbon black may be mixed with polymer and other ingredient(s) to generate a plasma carbon black filler for compounding into a tire rubber composition (operation 140), for example, for a component of a tire, as described in the paragraphs and examples below.

The systems and methods (e.g., thermal plasma process) described herein may be used to produce improved carbon particles (e.g., carbon black) for a variety of purposes, including without limitation for use in pigments and/or in elastomer composites for tires and/or tire components (e.g., as a filler in polymers). Carbon particles may have a set or a combination of properties. As described, for example, in commonly assigned Int. Pat. Pub. No. WO 2018/195460 (“PARTICLE SYSTEMS AND METHODS”), incorporated by reference herein, carbon particle(s) may have a given shape, size(s) or size distribution, density, crystallinity, surface functionality (e.g., (surface) hydrophilic content), surface acid group content, moisture content, elemental analyses (e.g., oxygen content, hydrogen content, sulfur content, nitrogen content, carbon content, etc.), water spreading pressure, surface area (e.g., nitrogen surface area (N2SA), statistical thickness surface area (STSA), STSA/N2SA ratio), structure (e.g., expressed in terms of dibutyl phthalate (DBP) absorption, where larger DBP values may correspond to higher degree of structure), and other properties. In addition, as described further below, measured properties may include transmittance of toluene extract (TOTE), centrifugal particle sedimometry (CPS) number mean, and dynamic light scattering (DLS) Z-average aggregate diameter. Some modifications and/or adjustments to the systems and methods described herein may be necessary to realize some of the particle properties and/or combinations of properties.

The carbon black may have a given surface area. Surface area may refer to, for example, nitrogen surface area (N2SA) and/or statistical thickness surface area (STSA), as described further below. In some examples, the surface area, excluding internal pores, may be from about 10 m²/g (square meters per gram) to about 300 m²/g. In some examples, the surface area, excluding internal pores, may be from about 15 m²/g to about 300 m²/g. In some examples, the surface area, excluding internal pores, may be from about 15 m²/g to about 150 m²/g. The surface area (e.g., N2SA and/or STSA) may be, for example, greater than or equal to about 5, 10, 20, 30, 50, 80, 100, 120, 150, 180, 200, 250, 300, or 400 m²/g. Alternatively, or in addition, the surface area (e.g., N2SA and/or STSA) may be, for example, less than or equal to about 400, 300, 250, 200, 180, 150, 120, 100, 80, 50, 30, 20, 10, or 5 m²/g. The surface area (e.g., N2SA and/or STSA) may be within a range defined by any two of the preceding values. For example, the N2SA or STSA may be in a range of about 15 m²/g to about 200 m²/g. The STSA and N2SA may differ.

The carbon black may have a given structure. The structure may be expressed in terms of oil absorption number (OAN), as described further below. The structure (e.g., OAN) may be, for example, greater than or equal to about 32, 40, 50, 80, 100, 120, 150, 180, 200, or 250 mL/100 g (milliliters per 100 grams, or 10⁵ m³/kg). Alternatively, or in addition, the structure (e.g., OAN) may be, for example, less than or equal to about 250, 200, 180, 150, 120, 100, 80, 50, or 40 mL/100 g. The structure (e.g., OAN) may be within a range defined by any two of the preceding values. For example, the OAN may be in a range of about 32 mL/100 g to about 250 mL/100 g, or about 50 mL/100 g to about 180 mL/100 g.

Carbon particles (e.g., carbon black) may be classified into grades. For example, ASTM D1765, which is incorporated herein by reference, provides a standard classification system for carbon blacks used in rubber products (see, e.g., N550, N660, N326, and others, where the prefix “N” indicates normal curing rate for furnace blacks). ASTM grade classification is based on certain measured parameters (e.g., surface area(s) N2SA and/or STSA, oil absorption number (OAN), oil absorption number of compressed sample (“compressed OAN” or COAN), etc.) as will be described further below. The thermal plasma process derived carbon black particles (e.g., carbon black) of the present disclosure may be of any grade or no grade at all.

Generally, given the same N2SA and OAN, the COAN may be higher and the STSA may be higher for plasma carbon black compared to furnace carbon black. The lattice constant (Lc) or crystallinity as measured by powder x-ray diffraction (XRD) may be larger for plasma carbon black compared to furnace carbon black.

Colloidal properties of plasma carbon black samples (“M” samples) compared to furnace carbon black (“N” samples) for various grades are given in Tables 1 and 2 below.

TABLE 1

| | STSA | | | Grit, | TOTE | | | |
|---|---|---|---|---|---|---|---|---|
| | ASTM | OAN | COAN | 325 | ASTM | pH | CPS # | DLS |
| | D6556 | (mL/ | (mL/ | mesh | D1618-99 | ASTM | mean | Z-avg |
| Sample | (m2/g) | 100 g) | 100 g) | (ppm) | (%) | D1512 | (nm) | (nm) |
| GB7220 (M772) | 32.1 | 68.9 | 66.4 | 8 | 100 | 9.1 | 124 | 228 |
| N772 | 25.4 | 67.2 | 60.6 | 8 | 99.1 | 4.3 | 95 | 222 |
| GB7260 (M660) | 32.3 | 96.1 | 85.4 | 24 | 99.3 | 6.9 | 153 | 284 |
| N660 | 36.1 | 91.4 | 73.9 | 28 | 95.6 | 3.9 | 131 | 206 |
| CORE6580 (M550) | 42.0 | 124 | 103.4 | 164 | 99.6 | 8.8 | 216 | 274 |
| GB6180 (M550) | 43.0 | 123 | 104.2 | 122 | 99.3 | 8.2 | 208 | 274 |
| N550 | 38.2 | 124 | 74.7 | 52 | 97.6 | 5.5 | 161 | 232 |

TABLE 2

| | | | | | XRD | XRD |
|---|---|---|---|---|---|---|
| | O | N | H | S | d002 | Lc |
| Sample | (%) | (%) | (%) | (%) | (nm) | (nm) |
| GB7220 (M772) | 0.24 | 0.04 | 0.04 | 0.02 | 0.346 | 4.55 |
| N772 | 0.30 | 0.07 | 0.21 | 2.12 | 0.354 | 1.47 |
| GB7260 (M660) | 0.40 | 0.05 | 0.07 | 0.02 | 0.345 | 4.66 |
| N660 | 0.64 | 0.11 | 0.33 | 2.10 | 0.353 | 1.65 |
| CORE 6580 (M550) | 0.08 | 0.02 | 0.04 | 0.01 | 0.347 | 3.67 |
| GB6180 (M550) | 0.33 | 0.01 | 0.06 | 0.24 | 0.347 | 3.67 |
| N550 | 0.48 | 0.12 | 0.27 | 1.47 | 0.354 | 1.46 |

For use in tires and other critical applications, the colloidal properties of a carbon black grade must be well defined and capable of reproducible manufacture. Table 1 lists surface area and structure data, which may be considered predictive of how carbon black particles will perform in rubber compounds. In particular, Table 1 lists values for STSA (statistical thickness surface area) measured via ASTM D6556 (e.g., ASTM D6556-10); OAN and COAN (oil absorption number and compressed OAN) measured via ASTM D2414 (e.g., ASTM D2414-09) and ASTM D3493, respectively; grit 325 mesh measured via ASTM D1514 water wash grit test through a 325 wire mesh screen; TOTE measured via ASTM D1618-99; and pH measured via ASTM D1512. Table 1 also lists DLS and CPS data, where DLS Z-average gives the mean hydrodynamic particle size (e.g., diameter), calculated using the Einstein-Stokes equation with a correlation factor calculated using a detector that measures the particles' collective rapidity of movement, and CPS uses Mie scattering to count the aggregate particles as they are centrifuged through a gradient viscosity solution to determine the mass or corresponding volume of an equivalent sphere.

The data of Table 1 indicate that, regardless of whether STSA is decreased (M660) or increased (M772, M550) or OAN is increased (M660, M772) or held steady (M550), plasma carbon black has larger particle size results relative to furnace carbon black, as measured by DLS and CPS. For example, both the hydrodynamic radius (DLS) and the equivalent sphere (CPS) are larger for plasma grade M660 than for the furnace grade N660 counterpart, increasing by 38% and 17% percent, respectively. For the three plasma grades tested, DLS increases ranged from 3% to 38% and CPS increases ranged from 17% to 32% over the corresponding furnace grades. An increase in DLS Z-average value or an increase in CPS value between a plasma carbon black of the present disclosure and a corresponding furnace black grade may be, for example, 1%, 5%, 10%, 15%, 20%, 25%, 30%, 35%, 40%, therebetween or more. This slight colloidal difference in particle size is intentional; an important aspect for the manufacturer of a new carbon black is not necessarily to match across colloidal properties but rather to match (or exceed) the in-rubber performance properties of the corresponding furnace carbon black. Even so, it is desirable to repeatedly manufacture the same STSA and OAN that matches the DLS and CPS for use of the carbon black in tires, as set forth in the systems and methods of the present disclosure.

Table 2 lists results of measured elemental analyses (in weight percent) of the oxygen (O), nitrogen (N), hydrogen (H), and sulfur (S) in each sample, as well as X-ray crystal diffractometry (XRD) results:analysis of the 002 peak of graphite using the Scherrer equation to obtain Lc (lattice constant or “crystallinity” herein) and d002 (the lattice spacing of the 002 peak of graphite) values. Larger Lc values may correspond to higher crystallinity. Smaller d002 values may correspond to higher crystallinity or a more graphite-like lattice structure, while larger d002 values (e.g., greater than about 0.35 or 0.36 nm) may be indicative of turbostratic carbon (e.g., which is common for carbon black samples produced via the furnace process). Here, measured crystallinity (Lc) values for the plasma carbon black samples over the corresponding furnace carbon black samples range from 2.5× to 3.1× greater. An increase in crystallinity between a plasma carbon black of the present disclosure and a corresponding furnace black grade may be, for example, 0, 0.5×, 1×, 1.5×, 2×, 2.5×, 3×, 3.5×, or more.

Table 3 compares DLS Z-average values (Table 1) and calculated Z-average values according to the equation Dₐ=(2540+(71*OAN))/STSA, where Da (aggregate diameter) is the calculated Z-average value.

TABLE 3

| | DLS | Calc. | |
|---|---|---|---|
| Sample | Z-Avg | Z-Avg (Da) | Deviation |
| GB7220 (M772) | 228 | 231.5 | 1.7% |
| N772 | 222 | 288.3 | 29.8% |
| GB7260 (M660) | 284 | 289.9 | 2.0% |
| N660 | 206 | 250.4 | 21.7% |
| CORE 6580 (M550) | 274 | 270.1 | 1.2% |
| GB6180 (M550) | 274 | 262.2 | 4.4% |
| N550 | 232 | 297.0 | 28.3% |

The plasma carbon blacks of the present disclosure show low deviation (ranging from 1.2 to 4.4 percent) relative to the corresponding furnace black grades, which differ from the calculated Z-average values by at least 21% (up to 29.8%). The deviation between the measured and calculated Z average can be 0%, 1%, 2%, 3%, 4%, 5%, up to 15% or more. Significantly lower deviation between measured and calculated Z-average values for plasma carbon blacks of the present disclosure compared to corresponding furnace carbon black grades indicates that the plasma carbon blacks, while sharing certain colloidal and rubber performance properties with furnace blacks, are comprised of carbon black particles that are distinctive.

Plasma carbon black fillers of the present disclosure may have particular utility in various tire rubber compositions, as described further below. In an example, a plasma carbon black may be mixed with polymer (e.g., an elastomer polymer and/or a rubber) and other ingredient(s) to generate a plasma carbon black filler for compounding into a tire rubber composition. In an example, a plasma carbon black filler may be compounded in a tire rubber composition. Accordingly, a tire rubber composition may include a plasma carbon black filler, which may comprise carbon black particles generated by a thermal plasma process and a binder used to pelletize the carbon black particles.

In some embodiments, an elastomer of a tire rubber composition may be or include natural rubber, or synthetic elastomer or synthetic polymer (e.g., polybutadiene (butadiene rubber), polyisobutylene (butyl rubber), polyisoprene, nitrile rubber, halobutyl, ethylene propylene rubber, ethylene propylene diene rubber, silicone rubber, fluoroelastomer, or the like).

In some embodiments, a tire rubber composition may include a plasma carbon black filler compounded therein, the plasma carbon black filler comprising carbon black particles generated by a thermal plasma process, silica nanoparticles as a minor filler component, incorporated to form a mixture of carbon black particles and silica particles, and a binder used to pelletize the mixture of carbon black particles and silica particles. The carbon black particles and/or the silica particles can be in the form of one or more molecules, nanoparticles (e.g., particles with a size less than or equal to about 2 micrometer volume equivalent sphere), particles (e.g., particles with a size up to about 10 micrometers, 50 micrometers, 100 micrometers, 150 micrometers, or more), or the like, or any combination thereof.

In some embodiments, a tire rubber composition may include plasma carbon black filler compounded therein, the plasma carbon black filler comprising plasma carbon black particles generated by a thermal plasma process, furnace carbon black particles as a minor filler component, incorporated to form a mixture of plasma carbon black particles and furnace carbon black particles, and a binder used to pelletize the mixture of plasma carbon black particles and furnace carbon black particles.

Plasma carbon black filler may be classified according to the following scheme: Class A (e.g., no minor filler component), Class B (e.g., silica particles incorporated as a minor or major filler component), and Class C (e.g., furnace carbon black particles incorporated as a minor or major filler component). Class A may be further classified as types A1 (e.g., no binder), A2 (e.g., standard binder), and A3 (e.g., special binder). Class B may be further classified as types B1 (e.g., no binder), B2 (e.g., standard binder), and B3 (e.g., special binder). Class C may be further classified as types C1 (e.g., no binder), C2 (e.g., standard binder), and C3 (e.g., special binder).

For example, for carbon black filler with no binder (e.g., A1, B1, and C1 types), water alone may be used in the pelletization process conducted in pin agglomerator equipment. For example, for carbon black filler with standard binder (e.g., A2, B2, and C2 types), standard binder materials may be used in the pelletization process conducted in pin agglomerator equipment. Standard binder materials for carbon black pelletization may include various sugars, molasses, lignosulfonates, poly(ethylene glycol) (PEG), Tween® 80 (polysorbate 80), and/or the like. The binder may be one of these individually or a mixture of various combinations of these standard binder materials. The loading levels of the standard binders relative to the carbon black may be in a range of about 0.1% to 4% or about 0.2% to 0.6%, for example.

Special binders may be used in certain examples of plasma carbon black filler (e.g., A3, B3, and C3 types) disclosed herein, with the special binder applied in the pelletization process conducted in pin agglomerator equipment.

A fourth class of plasma carbon black filler may be Class D, which may be further classified as types D1 (e.g., no binder), D2 (e.g., standard binder), and D3 (e.g., special binder), for any combination of thermal plasma carbon black in combination with recovered carbon. Recovered carbon refers to the carbon that is recovered from the pyrolysis of used tires and may be, for example, approximately 85% carbon and 15% ash. The ash may be comprised of silica, zinc oxide, zinc sulfide, various metals and oxides thereof, as well as other impurities that were present in the tire. While this is a difficult starting material to make quality tire product, a tire can be made a circular product (even more beneficial from an environmental carbon footprint perspective) by using mixtures of thermal plasma carbon black with recovered carbon from end of life tires. Before combining with plasma carbon black, the recovered carbon may be treated, for example, by extracting the ash with acids or bases or other means (sublimation) or by breaking up the large particles using any number of comminution techniques, such as but not limited to ball milling, jet milling and/or the like.

Any of these feeds of filler materials (e.g., Classes A-D above), as well as other fillers (e.g., rubber-grade clays used in certain tire components), can be co-pelletized with the thermal plasma carbon black particles.

Plasma carbon black filler can be loaded into a tire rubber composition or formulation (e.g., for a rubber article) of the present disclosure with one or more other filler(s), for example, furnace carbon black, precipitated silica, recovered carbon, or other filler material. The total filler material in a tire rubber composition for a rubber article may be, for example, 0.1, 1, 5, 10, 20, 30, 40, 50, 60, 70, 80, 90 weight percent or more. The total filler material in a tire rubber composition for a rubber article may be, for example, 90, 8, 70, 60, 50, 40, 30, 20, 10, 5, 1, 0.1 weight percent or less. The filler materials may be present or loaded in the tire rubber composition or formulation within a range defined by any two of the preceding values. For example, the total filler material may be present in a range of about 30 to about 70 percent by weight. The weight percentage may be a total weight percentage (e.g., weight percentage of a total composition comprising the plasma carbon black and other filler(s)). The various filler(s) (e.g., precipitated silica, furnace carbon black, recovered caron, and/or the like) can either be co-pelletized with the carbon particles generated in a thermal plasma process or added as separate ingredients and mixed in the rubber formulation.

Tire rubber compositions (e.g., for rubber articles) may combine plasma carbon black filler with another filler—e.g., silica (Class B), furnace carbon black (Class C), and/or recovered carbon (Class D)—in various ratios of plasma carbon black filler to the other filler material(s). For example, a ratio of plasma carbon black filler to any one or more of silica (e.g., precipitated silica), furnace carbon black, or recovered carbon may be 1:1, 1:2, 1:3, 1:4, 1:5, 1:6, 1:7, 1:8, 1:9, 1:10, 1:20, 1:50, 1:100 or less, 2:1, 3:1, 4:1, 5:1, 6:1, 7:1, 8:1, 9:1, 10:1, 20:1, 50:1, 100:1 or more, or any ratio therebetween.

For types A3, B3, C3, and D3 the special binder admixture may comprise any number of binder additives. For example, an additive mixture may comprise one or more carboxylate salts. A carboxylate salt may be or comprise any hydrocarbon that possesses a carboxylate or carboxylic acid moiety. A salt of a carboxylic acid, for example, may be any one of a class of organic compounds in which a carbon atom is bonded (i) to an oxygen atom by a double bond and (ii) to a hydroxyl group where the hydrogen atom is replaced by a metal, a metalloid, or the like, and (iii) where the fourth bond of the carbon atom may be to another carbon atom or to a hydrogen atom. The carboxylate salt may comprise an anion (e.g., the carboxylate containing portion of the salt) and a cation (e.g., the one or more counterions of the anion). Examples of carboxylate salt anions include, but are not limited to, citrate, acetate, propionate, oxalate, phthalate, oleate, maleate, malate, sulfanilate, trithiocyanurate, stearate, acrylate, methacrylate, dibutyl phthalate, fumarate, lactate, ethylene diamine tetraacetate, benzoate, aminobenzoate, periodate, polymers comprising carboxylates (e.g., polyacrylate, polybutadiene/maleate copolymer, etc.), or the like. Examples of carboxylate salt cations include, but are not limited to, hydrogen, alkali metals (e.g., lithium, sodium, potassium, rubidium, etc.), alkali earth metals (magnesium, calcium, barium, etc.), tin, zirconium, vanadium, chromium, manganese, iron, cobalt, nickel, zinc, organic cations (e.g., cations comprising carbon), other polyatomic cationic species (e.g., ammonium, tetramethylammonium, trimethylammonium, triethylammonium, tetrabutylammonium, guanidinium, other ammonia species, hydronium, etc.), polycations, or the like.

An additive mixture may comprise one or more carboxylic acids. A carboxylic acid may be any one of a class or organic compounds in which a carbon atom is bonded (i) to an oxygen atom by a double bond and (ii) to a hydroxyl group by a single bond, and (iii) where the fourth bond of the carbon atom may be to another carbon atom or to a hydrogen atom (e.g., as in the case of formic acid). The carboxylate acid may be or comprise, for example, citric acid, acetic acid, propionic acid, oxalic acid, phthalic acid, oleic acid, maleic acid, malic acid, sulfanilic acid, trithiocyanuric acid, stearic acid, acrylic acid, methacrylic acid, dibutyl phthalic acid, fumaric acid, lactic acid, glycolic acid, tannic acid, lignocellulosic acid, ethylene diamine tetraacetic acid, benzoic acid, aminobenzoic acid, periodic acid, or the like. The carboxylic acid may be or comprise, for example, the conjugate acid of the corresponding carboxylate salts listed above wherein the anion is the carboxylate salt and the cation is the positively charged hydrogen ion (H+) moiety. The special additive mixture may also comprise an amino functionality such as pyridine, carbamate, or any vitamin or protein.

An additive mixture may comprise one or more additives, each additive one or more of a hydrate, hydrated salt, carboxylate salt, carboxylate, carboxylic acid. An additive mixture may comprise one or more of a filler (e.g., silica, other carbon particles, etc.), an oil (e.g., an organic oil, a silicon oil, etc.), a metal oxide, (e.g., zinc oxide, titanium oxide, etc.), a peroxide or a reaction product therefrom (e.g., hydrogen peroxide), a sulfur containing compound (e.g., sulfur, a benzenesulfenamide, thiocarbamate, dithiocarbamate, etc.), a vulcanization accelerator (e.g., a thiuram, urea, thiourea, an organic acid (e.g., stearic acid, etc.), etc.), or the like, or any combination thereof. Other examples of the components of an additive mixture may be found in “The Science and Technology of Rubber” (Mark, Erman, and Roland, Fourth Edition, Academic Press), the disclosure of which is incorporated herein by reference.

In operation 130 of FIG. 1, an additive mixture may be added to the plasma carbon particles or plasma carbon black via, for example, addition of a binder comprising the additive mixture. For example, the additive mixture may be suspended or dissolved in water and/or be in the form of an aqueous solution, and the water, additive mixture, and/or aqueous solution can be added to (e.g., contacted with) the plasma-generated carbon. The additive mixture can be added to the carbon particle at a feed bin of a pelletizer, subsequent to a drying of the carbon particle (e.g., using a rotary kiln, a vibratory fluidized bed (VFB) dryer, a fluidized bed dryer, a tray dryer, or the like, or any combination thereof), as a neat spray, as a diluted spray (e.g., diluted with a solvent), or the like, or any combination thereof.

In some cases, operation 130 may comprise adding a pelletizer solution to the plasma carbon particles. The pelletizer solution may be configured to bind a carbon particle to one or more other carbon particles, thereby (e.g., after pelletization) forming a carbon pellet (e.g., plasma carbon black) comprising the carbon particle. The additive mixture may comprise the pelletizer solution. For example, the pelletizer solution may be at least a portion of the additive mixture. In some cases, the pelletizer solution may be added to the carbon particle after the additive mixture. The pelletizer solution may comprise, by way of non-limiting example, water, water soluble binders such as lignosulfonate, sugar, molasses, polysorbate polymers (e.g., Tween® 80, Tween® 20, etc.), polyethylene glycol, or the like, or any combination thereof. Where the additive is used primarily to bind the material together for the purpose of pellet mechanical integrity, these may be examples of producing type A2, B2, or C2 plasma carbon black.

In some cases, the additive mixture may comprise one or more sulfur containing compounds. Examples of sulfur containing compounds include, but are not limited to, organometallic sulfur compounds (e.g., a compound comprising sulfur or a sulfur containing species bound to one or more metal ions), metallic sulfur (e.g., a compound comprising a metal ion bound to a sulfur or sulfur containing ion), polysulfides, sulfides, free sulfur, or the like, or any combination thereof. The sulfur containing compounds may be present at a ratio of at least about 0.01, 0.05, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 11, 12, 13, 14, 15, 16, 17, 18, 19, 20, or more percent by weight of the total weight of the carbon pellet sample after drying. The sulfur containing compounds may be present at a ratio of at most about 20, 19, 18, 17, 16, 15, 14, 13, 12, 11, 10, 9, 8, 7, 6, 5, 4.5, 4, 3.5, 3, 2.5, 2, 1.5, 1, 0.9, 0.8, 0.7, 0.6, 0.5, 0.4, 0.3, 0.2, 0.1, 0.05, 0.01, or less percent by weight of the total weight of the carbon pellet sample after drying. The sulfur containing compounds may be present in a ratio within a range defined by any two of the preceding values. For example, the sulfur containing compounds may be present at a ratio in a range of about 0.05 to about 0.8 percent by weight. The weight percentage may be a total weight percentage (e.g., weight percentage of a total composition comprising the carbon particles). The weight percentage may be with respect to the carbon particles (e.g., the weight percentage of the one or more hydrates, hydrated salts, carboxylate salts, carboxylates, or carboxylic acids and the carbon particles). For example, an additive mixture may comprise 0.2% sulfur by weight, 0.3% sodium acetate trihydrate by weight, with the remaining weight (e.g., carbon black) at 99.5%, or if there is 0.3% binder, with the remaining weight (e.g., carbon black) at 99.2%. The amount of sulfur containing compound may be similar or substantially similar to the amount of hydrate, hydrated salt, carboxylate salt, carboxylate, or carboxylic acid contained within the additive mixture. The sulfur containing compound can be in the form of one or more molecules, nanoparticles (e.g., particles with a size less than or equal to about 2 micrometer volume equivalent sphere), particles (e.g., particles with a size up to about 10 micrometers, 50 micrometers, 100 micrometers, 150 micrometers, or more), or the like, or any combination thereof.

The special binder materials utilized in plasma carbon black filler types A3, B3, and C3 can include any member of the group of sulfur-containing organosilanes. A sulfur-containing organosilane may contain a polysulfide component, or structure, such as, for example, a bis(3-alkoxysilylalkyl)polysulfide where the alkyl radicals for the alkoxy group are selected from methyl and ethyl radicals, the alkyl radical for the silane portion are selected from ethyl, propyl, and butyl radicals, and the polysulfidic bridge contains: (a) from 2 to 6, and an average of from 2.1 to 2.8, sulfur atoms; or (b) from 2 to 8, and an average of from 3.5 to 4.5, sulfur atoms. A representative example of such a coupling agent is bis-(3-triethoxysilylpropyl)-polysulfide having: (a) from 2 to 6, and an average of from 2.1 to 2.8, sulfur atoms in its polysulfidic bridge; or (b) from 2 to 8, and an average of from 3.5 to 4.5, sulfur atoms in its polysulfidic bridge. Example coupling agents include bis(3-triethoxysilylpropyl)-tetrasulfide (TESPT), also called Si69 manufactured by Evonik, and bis(3-triethoxysilylpropyl)-disulfide (TESPD). Additional sulfur-containing organosilane coupling agents may include 3-octanoylthio-1-propyltriethoxy silane and mercapto-functional organosilanes including so-called blocked mercaptan varieties like the Si363 silane produced by Evonik or Momentive's NXT silanes. Specific examples of plasma carbon black fillers disclosed herein may utilize Si69 as a component of a special binder.

Some embodiments of the present disclosure may include tire rubber compositions wherein precipitated silica may be additionally compounded therein. Passenger tire treads may include substantial loading of precipitated silica, and the use of silica may expand into other tire components such as sidewall. Sulfur-containing organosilanes like Si69 may function as silica-polymer coupling agents in tire rubber formulations containing precipitated silica to create silica-polymer linkages after mixing and curing (vulcanization) of the rubber, which can reduce tire rolling resistance and/or give other tire performance improvements. Plasma carbon black filler examples of the present disclosure, with Si69 incorporated as part of the special binder, provide a unique means of delivering Si69 to the rubber formulation and may function synergistically with the silica and silane coupling agent added to the rubber formulation. Si69 may also introduce carbon black-polymer coupling in rubber compounds.

In some examples wherein the carbon black filler is type B3, the silica particles incorporated as a minor filler component may serve as a carrier for a special binder component. In some examples wherein the carbon black filler is type C3, the furnace carbon black particles incorporated as a minor filler component may serve as a carrier for a special binder component.

Various embodiments of the tire rubber composition with plasma carbon black filler compounded therein may include distinct rubber components that are used in the construction of a tire, including but not limited to tread cap, tread base (also called sub-tread or under-tread), sidewall, inner liner, body ply skim (or coat), belt skim (or coat), bead filler, or any combination thereof.

In some embodiments, the plasma carbon black filler may improve thermal conductivity compared to a reference furnace carbon black filler when compounded into certain tire rubber compositions. The increase in thermal conductivity of a tire rubber composition with a plasma carbon black filler of the present disclosure, relative to a tire rubber composition without a plasma carbon black filler of the present disclosure (e.g., with furnace carbon black only), may be, for example, greater than or equal to about 0.1%, 0.2%, 0.5%, 1%, 2%, 3%, 4%, 5%, 6%, 7%, 8%, 9%, 10%, 12%, 15%, 18%, 20%, 22%, 25%, 28%, 30%, 32%, 35%, 38%, 40%, 42%, 45%, 48%, 50%, 55%, 60%, or more. Alternatively, or in addition, the increase in thermal conductivity of the tire rubber composition may be, for example, less than or equal to about 80%, 75%, 70%, 65%, 60%, 55%, 50%, 45%, 40%, 35%, 30%, 25%, 20%, 15%, 10%, 5%, 1%, or less. The thermal conductivity improvement from a plasma carbon black filler of the present disclosure may be in a range as defined by any two of the preceding percentage values. For example, the thermal conductivity increase may be in a range between about 2% and 10%, 5% and 50%, 15% and 30%, 20% and 40%, or any other range. Such improvements in thermal conductivity may be useful in promoting faster curing (vulcanization) of tire components and in improving heat transfer for countering viscoelastic heat generation during tire use, as mentioned in the Background section above.

In some embodiments, the plasma carbon black filler may improve filler dispersion compared to a reference furnace carbon black filler when compounded into certain tire rubber compositions. Improved filler dispersion may improve fatigue lifetime (mechanical durability) of tire rubber compositions and yield more abrasion resistance when the composition is used as a tread cap component, for example.

In some embodiments, the plasma carbon black filler may reduce viscoelastic loss tangent, called tan delta (tan δ), compared to a reference furnace carbon black filler when compounded into certain tire rubber compositions. The decrease in viscoelastic loss tangent (tan δ) of a tire rubber composition with a plasma carbon black filler of the present disclosure, relative to a tire rubber composition without a plasma carbon black filler of the present disclosure (e.g., with furnace carbon black only), may be, for example, greater than or equal to about 0.1%, 0.2%, 0.5%, 1%, 2%, 3%, 4%, 5%, 6%, 7%, 8%, 9%, 10%, 12%, 15%1, 18%, 20%, 22%, 25%, 28%, 30%, 32%, 35%, 38%, 40%, 42%, 45%, 48%, 50%, 55%, 60%, or more. Alternatively, or in addition, the decrease in viscoelastic loss tangent (tan δ) of the tire rubber composition may be, for example, less than or equal to about 80%, 75%, 70%, 65%, 60%, 55%, 50%, 45%, 40%, 35%, 30%, 25%, 20%1, 15%, 0%, 5%, 1%, or less. The tan δ improvement from a plasma carbon black filler of the present disclosure may be in a range as defined by any two of the preceding percentage values. For example, the tan δ reduction may be in a range between about 2% and 10%, 5% and 50%, 15% and 30%, 20% and 40%, or any other range. Reduced tan δ of a tire rubber composition may be predictive of lower rolling resistance and lower heat build-up when the tire rubber composition is employed as a component of a tire.

For Examples 1-9 that follow, standard techniques and/or equipment may be used to characterize the properties of the carbon black fillers, which may include:

N2SA (m²/g) and STSA (m²/g) via ASTM D6556—Test methods used to measure the total and external surface area of carbon blacks based on multipoint nitrogen adsorption. The N2SA measurement is based on the Brunauer-Emmett-Teller (BET) theory and includes the total surface area, inclusive of micropores i.e. pore diameters less than 2 nm (20 Å). The external surface area, based on the statistical thickness method (STSA), may be defined as the specific surface area that is accessible to rubber.

Structure (OAN) (mL/100 g) via ASTM D2414—Test method used to calculate the structure of carbon black as quantified using the oil absorption number (OAN). The OAN is a measure of the number of primary particles that are fused together and more specifically the amount of intra-aggregate void volume of the nanostructured aggregates. The OAN is measured through the dripping of oil at a constant rate into a cylinder containing carbon black. The cylinder contains the carbon black and two rotors that are moving at constant speed. The torque required to turn the rotors reaches a maximum where the entirety of the void volume between the aggregates has been filled. The curve is fitted to a quadratic and a pre-determined method of calculating the OAN value is used to give the official OAN or structure value.

COAN (mL/100 g) via ASTM D3493—Compressed OAN or COAN uses the same absorption method, however, the carbon black pellets are submitted to extreme pressure in a piston (e.g., compressed or crushed) four times prior to the measurement to mimic the crushing or shearing in the rubber processing equipment.

To make a plasma carbon black of a specific grade, furnace black colloidal properties (e.g., STSA or N2SA and OAN or COAN) and/or furnace black in-rubber performance properties can be matched (as discussed above), or a plasma black of different colloidal and/or in-rubber performance properties can be made and then mixed with a precipitated silica or another carbon black (furnace carbon black or plasma carbon black) to make a filler of the appropriate properties. For example, an N660 and an N234 (furnace or plasma) can be mixed to form an N326 or an N330 plasma carbon black. Additionally, the mixture can be mixed with an activating agent such as, for example, an organozinc, a sulfenamide, or a polysulfide organosilane or siloxane or similar type of agent.

Various mixing techniques may be employed for compounding the plasma carbon black fillers of the present disclosure into rubber formulations, with details provided in sections below for the different tire rubber compositions used in Examples 1-9. Such mixing techniques may involve using one or more of: Farrel Tecnolab BR1600 Banbury mixer with internal volume of 1.57 L and tangential rotors, Reliable Rubber and Plastics Machinery Company lab scale two roll mill, Zwick/Roell 5 kN loadframe long stroke tensiometer, Zwick/Roell digital durometer, Alpha Premier RPA, Alpha Premier Mooney Viscometer, Alpha View disperGRADER, Alpha Pioneer Density tester, C-Therm Trident Thermal Conductivity Instrument, reasonable alternative(s), and/or any combination thereof.

Rubber formulations into which plasma carbon black fillers of the present disclosure may be compounded may include mixtures comprising thermoplastic(s) and/or thermoset(s) (e.g., thermosetting plastics or thermosetting polymers) with elastomers.

The rubber mixing (compounding) of tire rubber compositions may be conducted in internal mixers (Banbury-type and the like). Mixing may proceed in batch mixing stages, also called steps or passes, which may be non-productive. The final mixing stage, also called the productive mixing stage, is where the majority of the cure/vulcanization chemicals may be added. Other non-productive mixing stages may precede the final mixing stage, and these non-productive stages or passes are where the particulate fillers such as carbon black or precipitated silica may be dispersed and compounded into the rubber. Tire rubber formulations containing predominantly carbon black filler may be mixed in two or more stages or passes, wherein at least one non-productive mixing stage is followed by at least one productive mixing stage. At least one additional non-productive mixing stage may be included for compounds containing predominantly precipitated silica as filler, for a total of at least three mixing stages or passes. Various other mixing schemes may be used, such as, for example, additional non-productive mixing passes, tandem mixing, ingredient masterbatch approaches, or any combination thereof.

The Examples 1-9 that follow detail lab scale mixes to illustrate and demonstrate the mixing of plasma carbon black fillers of the present disclosure with rubber and other rubber mixing ingredients. Such lab scale mixing provides a reasonable proxy for mixing at industrial scale; while equipment size may differ, both operations may include multiple mixing passes, first mixes performed at higher temperatures (non-productive mixes), and subsequent mixes performed at lower temperatures (productive mixes) as the more reactive components are added. In some cases, industrial rubber mixing can be conducted in one mixing stage (one pass) by controlling the time and temperature to remain below the onset of curing and adding curatives late in the mixing cycle. All or some of the mixing may be conducted using two-roll mills. Various methods and orders for introducing ingredients to the mixer may be used. Various mixer types may be used, including tangential and intermeshing, with various options for rotor designs. Rubber compounds also may be mixed using specialized continuous mixing approaches, for example, by using specialized two-screw extruders.

After a mixing stage, a rubber compound may receive additional processing and/or shaping using a two-roll mill, sheeter, calender, or the like. For example, after a mixing stage, rubber compounds may be formed into a sheet using a two-roll mill or sheeter and then may proceed to a batch off-line, where the sheet may be dipped in a water solution to apply an anti-tack coating such as zinc stearate, calcium stearate, magnesium stearate, or related materials and combinations thereof, followed by a cooling and drying stage and then back-and-forth (wig-wag) stacking of the rubber sheet onto a pallet.

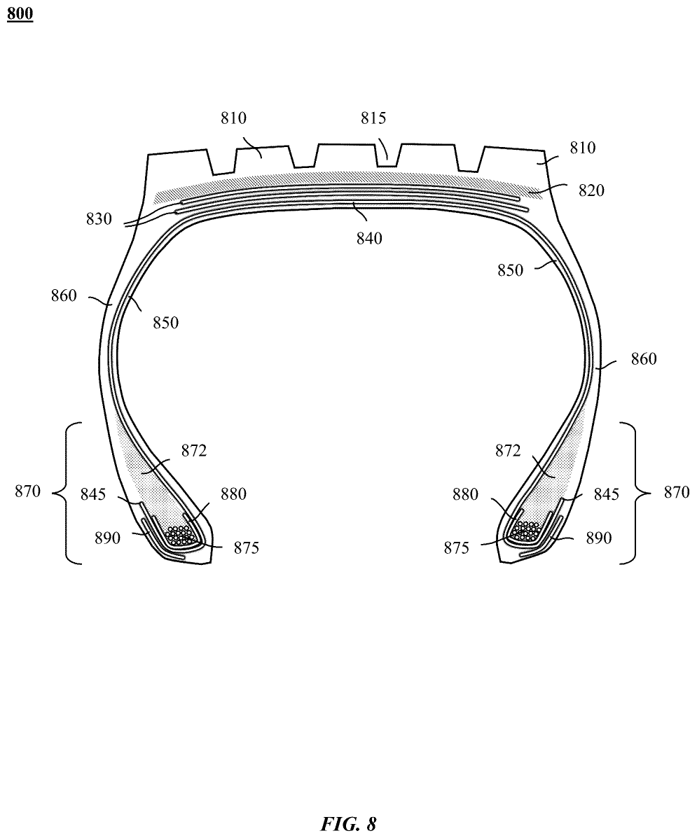

In embodiments, the present disclosure includes the use of plasma carbon black fillers in tire rubber compositions for rubber articles that can be employed as components of a vehicle tire. FIG. 8 shows a schematic example cross section of a tire 800 for a vehicle (not shown). This example tire construction is intended to be representative and not limiting. The tire 800 has a rubber tread 810 with a molded tread pattern including circumferential grooves 815, a rubber sub-tread (tread base) 820, two or more belts 830 each with a plurality of reinforcing metal cords (wires) coated with a rubber wire skim or coat (not shown), one or more body ply (e.g., carcass ply) 840 with a plurality of reinforcing cords coated with a rubber body ply skim or coat (not shown), a rubber inner liner 850, two rubber sidewalls 860, and two bead regions 870 each comprising rubber bead filler apex 872 and bead bundle 875 with a plurality of metal cords coated with rubber bead filler (not shown). In some embodiments, the reinforcing metal cords in bead bundles 875 are made of steel that may be coated with brass or other coating. In some embodiments, the reinforcing metal cords in belts 830 are made of steel that may be coated with brass or other coating. Body ply 840 may include a pair of axially opposite end portions 845. Each axial end portion 845 of body ply 840 may be turned up and around the respective bead region to a position sufficient to anchor each axial end portion 845. In some embodiments, such as for some tires for passenger vehicles, the reinforcing cords in body ply 840 may be made of textile cord material such as, for example, polyester, rayon, nylon, aramid, or similar suitable organic polymeric compounds that may be coated with an adhesive or bonding coating. In some embodiments, such as for some heavy truck and bus tires, the reinforcing cords in body ply 840 may be made of steel that may be coated with brass or other coating. Axial end portions 845 of body ply 840 may engage axial outer surfaces of two flippers 880 and axial inner surfaces of two chippers 890, with compositions that may be similar to body ply 840. The example of FIG. 8 is provided for illustrative purposes only; tire components may vary, including additional, different, or fewer components, and it is envisaged that the tire rubber compositions and methods of the present disclosure will be equally applicable to rubber articles, tire components, and tire configurations not pictured.

The tire is a complex structure, and seemingly minor details can strongly affect key performance characteristics like road noise, air retention, fuel economy (MPG or MPGe), wear, fatigue, crack growth, premature oxidation or aging, and tread life. Factors that may affect critical quality parameters may include, for example, tread geometry, bead placement and geometry, how the body ply and inner liner seal or do not seal into one another, how the bead interacts with the rim of the tire, thickness(es) and composition(s) of the polymer(s) coating the bead or body ply, and a host of other factors. How a tire is assembled and constructed, including materials selection and manufacture, can strongly affect performance and lifespan.

The Examples 1-9 that follow show the utility of plasma carbon black in tire rubber compositions for various rubber articles used in the construction of a tire, including tread, sub-tread, sidewall, inner liner, belt skim, body ply skim, and bead filler mentioned above.

The tire rubber compositions used in Examples 1-9 are intended to be representative and not limiting. Adjustments may be made to types and amounts of ingredients in tire rubber formulations to meet specific performance and/or processability requirements. Some ingredients also may be shifted between or among the various mixing stages or may have their total amount divided for separate addition in two or more different mixing stages. Adjustments to the mixing steps and mixing conditions in each step are also routine when necessary for improving mixing quality and/or productivity. Additionally, alternate suppliers of raw materials may offer substantially similar, but not necessarily identical, grades for use in tire rubber compositions. The weight loadings of ingredients in the rubber formulations/compositions may be expressed in terms of parts-per-hundred-rubber (phr).

Compression molding and curing of rubber compounds in a heated press may be conducted to create cured/vulcanized rubber specimens for property testing. Uncured rubber compounds may also be tested for various properties.

For shaping into a tire component, a tire rubber composition may be shaped using extrusion, calendering, and/or other rubber processing approach(es). Various tire components may be combined to form an uncured (green) tire, which can be subsequently molded and cured into a vehicle tire. An uncured tire rubber composition may be stored, separately or in combination with other tire rubber compositions before the building, molding, and curing of the composite tire. For example, after each of the tread (tread cap) and sub-tread (tread base) rubber compounds are mixed, they can be extruded together (coextruded) to form a combined tread cap and base, which can be stored in a continuous manner on a reel or cut into tire tread lengths and stored in booking trays before being combined with other tire components in the tire building process. Rubber compounds used to coat reinforcing cords in belts, plies, and beads can be calendered or otherwise applied onto the cords, and such sheets or strips of rubber coated cords can be stored on reels in the uncured state before tire building. Cords can have tension applied and be cured under tension. Rubber compounds can also be stored on pallets in the uncured state after mixing but before shaping operations such as extrusion and calendering. Tire building may be conducted by combining the tire components to form an uncured (green) tire using tire building machinery produced by VMI Group and others. Methods for molding and curing green tires to form final cured (vulcanized) tires may include the use of clam shell molds or segmented tire molds (e.g., with a curing bladder inside the tire filled with high pressure steam and with heated mold surfaces on the outside of the tire).

For Examples 1-9 that follow, standard techniques and/or equipment may be used to characterize the properties of the tire rubber compositions, which may include:

A testing apparatus for characterizing properties including but not limited to 100% modulus (M100), 300% modulus (M300), tensile strength at break, and elongation at room temperature may comprise a lower fixture configured to a crosshead and held in a fixed position, and an upper fixture configured with a load cell and connected to a mobile crosshead that moves at a constant strain. The test may follow ASTM D412 with the capability of using rings or dumbbells.

A testing apparatus for characterizing Shore A hardness of a rubber specimen may include a base housing with integrated electronics and display, and a height-adjustable support table for specimens. This apparatus may meet the requirements of ASTM D2240.

A testing apparatus for measuring filler dispersion in a compound may utilize an advanced reflected light microscope to take live images of multiple (e.g., 5) different locations of a rubber sample. An image may be processed through an image algorithm to suppress noise and irregularities on the surface and then filtered and thresholded to produce a black and white image. For example, the Alpha Technologies disperGRADER follows ASTM D7723 and uses these functions to measure dispersion (%) and Z-value (%).

A testing apparatus for measuring the density of a cured rubber compound may be a semi-automated Densimeter that utilizes the hydrostatic method by comparing the weights of a sample in air and in an immersion liquid. The process may follow ASTM D297 and measures density in g/cm³. The sample weight in air, weight in water, and weight difference may be recorded and reported.

A testing apparatus for measuring Mooney viscosity may include two heated platens and a cylindrical metal rotor. Mooney viscosity is defined as the shearing torque resisting rotation of a cylindrical metal rotor embedded in rubber with a cylindrical cavity. The test measures ML 1+4 (MU) and may be set to meet the setpoints specified by ASTM D1646.

A testing apparatus for calculating cure time of a rubber specimen may be configured as a rotorless cure meter formed by two die cavities. For example, the Rubber Process Analyzer (RPA), a rotorless cure meter, may eliminate the unheated rotor of an oscillating disk cure meter and better distribute temperature in the test specimen. The RPA measures torque, temperature, frequency, strain, pressure, and angle. The process may be set up to meet setpoints specified by ASTM D5289 with ts2, t60, and t95 in minutes being reported. Strain sweeps, holding frequency and temperature constant, may be set up using the RPA to look at dynamic properties before and after cure. Dynamic properties for a cured compound may be seen at a specific temperature, frequency, and strain. For example, some tables below list properties including storage modulus (G′) and tan delta (tan δ) at a specified temperature, frequency, and strain.

A testing apparatus for measuring thermal conductivity of a cured rubber compound may include a Modified Transient Plane Source (MTPS) method that employs a single-sided sensor to directly measure thermal conductivity and effusivity of the rubber. This process may be set to follow ASTM D7984 and measures thermal conductivity in W/mK (Watts per meter-Kelvin) and effusivity in Ws^{1/2}/m²K ([Watts-square root seconds] per [square meter-Kelvin]).

A testing apparatus for measuring electrical volume resistivity of a cured rubber compound may be set up with a four-point probe to measure sheet resistivity of semiconductors and a Keithley SourceMeter to provide measurement capabilities on a wide range of materials. This process may be set to follow the ASTM F84 in-line four-point probe configuration and measures electrical volume resistivity in Ohm-cm. Electrical conductivity (in Siemens/cm) can be calculated as the reciprocal of the measured electrical volume resistivity in Ohm-cm.

A testing apparatus used for measuring DeMattia crack growth rate may include a test frame for mounting an adjustable stationary head with grips for holding one end of the test specimen(s) in a fixed position and a reciprocating head for holding the other end of the test specimen(s). Each test specimen may be a molded strip with a centerline groove that may be pierced before testing at a point equidistant from the sides. With the specimen(s) securely clamped in place, the reciprocating head will cycle at a frequency of 5 Hz at a test temperature of 23° C. After testing has started, the machine is stopped at periodic intervals to measure the crack length which allows for calculation of crack growth rate in mm/min. This process may be set to meet setpoints specified by ASTM D813.

A testing apparatus for evaluating the resistance to abrasion of rubber materials through the measure of the volumetric loss of a specimen exposed to an abrasive medium may be configured with the abrasive/frictional surface attached to a rotary drum. The test specimen rotates while it moves laterally across the rotating drum to assure uniform contact between test specimen and abrasive medium. This process may be set to follow the specifications and requirements set forth in DIN 53516.

A testing apparatus for evaluating the resilience of rubber may be set up as a Schob Type pendulum with a spherically terminated mass at the end of the pendulum. The percentage resilience (rebound) is calculated from the ratio between the returned and applied energy from a spherically terminated mass that impacts the rubber specimen at a specified test condition. The Schob Type pendulum is designed to provide an indication of hysteretic energy loss. The rubber specimens may be tested at temperatures of −20° C. to 100° C. with a constant strain energy and strain rate applied. This process may be set to follow the specifications and requirements set forth in ASTM D7121.

### EXAMPLES

Example rubber formulations demonstrate the utility of plasma carbon black filler in various rubber articles used as components of tires, including tread, sub-tread, sidewall, inner liner, body ply skim, belt skim, and bead filler. The rubber chemicals/ingredients in these example tire rubber compositions are summarized in Table 4. Various functionally comparable substitutions and alternate sources for these ingredients may be used, as will be elaborated later, to achieve a desired balance of rubber properties and associated tire performance properties. The raw materials, and sample ingredients, mixing and preparation methodologies used, and all other example data herein are intended to be representative and not limiting.

TABLE 4

| Raw Material/ | | |
|---|---|---|
| Ingredient | Class | Description |
| NR (SMR-L) | Polymer | SMR (Standard Malaysian Rubber) is |
| | | a natural rubber grade with maximum |
| | | dirt content of 0.02 wt. % and |
| | | maximum ash content of 0.5 wt. % |
| BR (Diene | Polymer | Amorphous, neodymium, high cis |
| 140ND) | | polybutadiene |
| Plasticizer | Oil | Hydro-treated naphthenic rubber |
| ln | | process oil of low viscosity |
| Zinc Oxide | Activator | French Process Zinc Oxide made |
| RGT-M | | from zinc metal coated with |
| | | propionic acid - ZnO (dry basis) |
| | | 99.8% |
| Antioxidant | Antioxidant | Polymerized 2,2,4-trimethyl-1,2- |
| DQ (TMQ) | | dihydroquinoline providing heat |
| | | and oxidative aging properties |
| Stearic | Activator | Mixture of fatty acids composed |
| Acid RG | | primarily of octadecanoic (stearic), |
| | | and hexadecenoic (palmitic 50%) |
| | | acids to a controlled titer and |
| | | acid value |
| C595 Resin | Resin | Light colored C5 resin which |
| | | provides tackifying action to |
| | | synthetic and natural rubber |
| | | applications |
| Antiozonant | Antiozonant | N-(1,3-dimethyl butyl) N′-phenyl- |
| PD-2 (6PPD) | | p-phenylene diamine is a staining/ |
| | | discoloring antiozonant and |
| | | antioxidant in rubber goods |
| TBBS | Accelerator | N-tert-butyl-2 benzothiazole- |
| | | sulfenamide is a delayed action |
| | | accelerator for natural and |
| | | synthetic rubbers |
| Rubbermakers | Curative | Standard sulfur grade vulcanizing |
| Sulfur | | agent for rubber compounds with |
| | | a purity of 99.5% sulfur |
| Exxon | Polymer | Brominated copolymer of isobutylene |
| Bromobutyl | | and isoprene |
| 2222 | | |
| Proaid | Resin | Mixture of dark aromatic hydrocarbon |
| AC-740 | | resins designed to act as a |
| | | processing aid for homogenizing |
| | | polymer blends |
| Phenolic | Resin | Thermoplastic resin made from |
| Resin | | octyphenol formaldehyde used to |
| Tackifier | | increase tack in natural rubber |
| (SP 1068) | | and synthetic elastomers |
| MBTS | Accelerator | 2,2′ Dibenzothiazyl Disulfide, a |
| | | disulfide of mercaptobenzothiazol |
| | | (MBT), is a non-staining, primary |
| | | thiazole accelerator for natural |
| | | and synthetic rubbers |
| SIR20 Prime | Polymer | SIR (Standard Indonesian Rubber) |
| Rubber | | is a natural rubber grade with a |
| | | maximum dirt content of 0.2 wt. % |
| | | and maximum ash content of 1 wt. % |
| Exxon | Polymer | Chlorinated copolymer of isobutylene |
| Chlorobutyl | | and isoprene |
| 1066 | | |
| Polyfil DL | Filler | Large particle size delaminated |
| | | clay, used to reduce gas/vapor |
| | | permeability, processed to have a |
| | | high aspect ratio and reduced clay |
| | | stacks to thin kaolin platelets |
| Magnesium | Retarder | Powdered magnesium oxide used in |
| Oxide | | halogenated compounds as a vulcanizer/ |
| (Elastomag 170) | | activator/acid acceptor |
| ESBR 1502 | Polymer | Taipol SBR 1502 is an emulsion |
| | | styrene-butadiene rubber, produced |
| | | by cold polymerization and |
| | | stabilized by a non-staining |
| | | antioxidant, having a composition |
| | | of 23.5% styrene by weight, with |
| | | 15% of the butadiene polymerized |
| | | in the 1,2 (vinyl) configuration |
| Crystex | Curative | Polymeric sulfur and insoluble in |
| CurePro | | elastomers - Non-blooming |
| | | vulcanizing agent for unsaturated |
| | | elastomers - 10.5% oiled |
| DPTT | Accelerator | Dipentamethylene Thiuram (Tetra/ |
| | | Hexa Sulfide*) Polysulfide Mixture |
| | | is a sulfur bearing accelerator |
| | | at 25% available sulfur |
| CureRite 18 | Accelerator | Thiocarbamyl Sulfenamide primary |
| | | accelerator for natural and |
| | | synthetic rubbers |
| Akrosorb | Coupling | bis-(3-(triethoxysilyl)-propyl) |
| 29460 | Agent | tetrasulfide is a 72% active dry |
| | | powdered dispersion coupling |
| | | agent absorbed on synthetic |
| | | calcium silicate |
| Si69 | Coupling | bis-(3-(triethoxysilyl)-propyl) |
| | Agent | tetrasulfide (TESPT) is a multi- |
| | | functional silane coupling agent |
| Akrowax | Wax | 100% high molecular weight (MW) |
| Micro 23 | | microcrystalline wax composed of |
| | | a complex mixture of long chain |
| | | straight paraffins, branched |
| | | paraffins, and mono and |
| | | polycyclic aliphatic materials |
| Akrosorb | Oil | 72% dry powdered dispersion of |
| 9740 | | aromatic oil (Sundex 790) on |
| | | synthetic calcium silicate, used |
| | | as a plasticizer and process aid |
| | | for polychloroprene, styrene- |
| | | butadiene rubber (SBR), |
| | | polybutadiene (PBD), and chlorosul- |
| | | fonated polyethylene rubber (CSM) |
| | | elastomers |
| Accelerator | Accelerator | N-cyclohexyl-2-benzothioazole |
| CBTS | | sulfenamide is a delayed action |
| | | sulfenamide accelerator for use in |
| | | natural and synthetic rubbers |
| Retarder CTP | Retarder | N-(cyclohexylthio) Phthalimide is |
| | | a potent retarder for sulfur-cured |
| | | elastomers and is most effective |
| | | with sulfenamide and thiazoles |
| Perkalink 900 | Anti- | Anti-reversion agent which provides |
| | Reversion | long term heat stability in sulfur |
| | | vulcanized compounds by substituting |
| | | stable, flexible carbon-carbon bond |
| | | crosslink for the sulfur crosslink |
| Buna VSL | Polymer | Solution SBR with 26 wt. % styrene, |
| 4526-2 HM | | 44.5 wt. % vinyl, and 27.3 wt. % oil |
| Mansil 190G | Filler | Precipitated silica with medium |
| | | high surface area (190-210 m2/g) |
| TDAE Oil | Oil | Treated distillate aromatic extracts |
| | | (TDAE) is a rubber processing oil |
| | | with high aromatic content, used |
| | | as a rubber softening additive |
| TBZTD | Accelerator | Tetrabenzylthiuram disulfide may |
| | | replace thiurams such as TMTD when |
| | | the presence of harmful nitrosamines |
| | | is of concern and is a fast curing |
| | | primary or secondary accelerator and |
| | | sulfur donor in NR, SBR and nitrile |
| | | butadiene rubber (NBR) applications |
| DPG | Accelerator | Diphenyl Guanidine is an accelerator/ |
| | | activator for natural rubber, SBR, |
| | | and NBR, and activates accelerators |
| | | such as MBT, MBTS and sulfenamides |
| Akroform | Adhesion | 80% active polymeric dispersion of |
| Resorcinol | Promoter | Resorcinol used in combination with |
| | | methylene donors to promote adhesion |
| | | of rubber to fiber, steel cord, and |
| | | fabric; methylene acceptor |
| Cobalt | Bonding | Cobalt rubber adhesion promoter for |
| naphthenate | Agent | Radial tires |
| CoMEND A | Bonding | Cobalt rubber adhesion promoter for |
| | Agent | Radial tires - Cobalt 22-23% - |
| | | Boron 1.7-2.1% |
| HMMM | Bonding | Hardener for novolac and resorcinol |
| | Agent | resins; improves adhesion of rubber |
| | | to fiber, steel cord and fabric; |
| | | methylene donor |

### Example 1: Tire Sidewall

The forthcoming examples demonstrate the utility of plasma carbon black when employed in tire rubber compositions for use as a sidewall component of a tire. The specific rubber formulations shown are intended to be representative and not limiting. The polyisoprene (e.g., natural rubber) (NR) to butadiene (e.g., butadiene rubber) (BR) (NR/BR) polymer ratio can vary in sidewall formulations from about 35/65 to about 65/35, and other elastomeric polymers may be included, including epoxidized NR, various types of ethylene propylene diene monomer (EPDM), and lithium (anionic) BR. With growing concern about the environment and the desire to use more sustainable elastomers, increasing emphasis may be put on using larger proportions of natural rubber (NR) whenever possible, including up to 100%. Various furnace carbon black grades may be used, such as, for example, N550, N660, N650, and others. Fillers used can also include carbon fillers from pyrolysis of recycled rubber materials, recycled rubber products like end-of-life tires, biomass waste, and other sources. Various types of precipitated silica can be used as fillers, with or without known varieties of sulfur-containing organosilanes and/or other coupling agents. Furnace carbon black, clays, graphenes, precipitated silica, other inorganic particulate fillers, recovered carbon filler from pyrolysis of end-of-life tires, and the like may be used in various combinations with the presently disclosed plasma carbon black fillers at various loading levels. Other adjustments to the formulation can be made for assorted performance and processability reasons. In particular, there are various options for amounts and types of cure/vulcanization ingredients and for antidegradants such as antioxidants, antiozonants, waxes, and the like. Variations in types and amounts of processing aids such as oils, tackifying resins, and the like may be used. The embodiments set forth herein, related to use of plasma carbon black filler in tire rubber compositions used for sidewall components, encompass reasonable sidewall formulation variations.

The examples below of tire sidewall compositions containing plasma carbon black filler show comparable performance in standard rubber testing (within about 10%, plus or minus) to reference carbon black from the furnace process. The production of furnace carbon black generates multiple tons of CO₂ for every ton of carbon black produced, whereas the production of plasma carbon black generates <20% of that CO₂, so these examples show that plasma carbon black fillers in tire sidewall components can have a significant positive impact on sustainability of tires without substantially compromising rubber properties. Advantages may be noted in terms of improved filler dispersion and reduced hysteresis (tan δ) for some examples of plasma carbon black fillers relative to the respective furnace carbon black reference.

It was surprisingly discovered for tire sidewall composition examples that plasma carbon black gives substantially higher thermal conductivity relative to comparative furnace carbon black when compounded into the rubber formulations, with the projected benefits to tire manufacturing and tire performance discussed earlier.

Ingredients of an example sidewall compound are listed below.

TABLE 5
Compound Formulation (Sidewall BRNRW01)

| | | |
|---|---|---|
| Ingredient | PHR | Wt. % |

Pass 1 mixing stage, Master Batch (MB)

| | | |
|---|---|---|
| Natural rubber (NR) (SMR-L); polymer | 40 | 21.39 |
| Butadiene rubber (BR) (Diene 140ND); polymer | 60 | 32.09 |
| Carbon Black; filler | 55 | 29.41 |
| Naphthenic oil (Plasticizer ln); process oil, | 10.5 | 5.61 |
| processing aid | | |
| Zinc Oxide; activator | 2.5 | 1.34 |
| TMQ (Antioxidant DQ); antioxidant | 6.5 | 3.48 |
| Stearic Acid; activator, processing aid | 1.5 | 0.80 |
| C5 resin (C595); tackifying resin, processing aid | 7 | 3.74 |
| Total | 183 | — |

Pass 2 mixing stage

| | | |
|---|---|---|
| Master Batch (MB) from Pass 1 | 183 | — |
| 6PPD (Antiozonant PD-2); antiozonant/antioxidant | 1 | 0.53 |
| TBBS; accelerator | 1 | 0.53 |
| Sulfur; crosslinker/curative | 2 | 1.07 |
| Total | 187 | 100.00 |

Summary of Mixing Steps. First Pass: add polymers (natural rubber (NR) and butadiene rubber (BR)); mix 30 seconds; add carbon black; mix 60 seconds; add naphthenic oil, phenolic resin, and stearic acid; mix 30 seconds; include two ram clean-out steps at 30 seconds each; mix until drop temperature of 125° C. is reached. Second Pass: add first pass mix plus zinc oxide, sulfur, and MBTS; mix until drop temperature of 105° C. is reached.

TABLE 6
Material Composition and Mixing - First Pass

| Component | Weigh-Up 1^{st} Pass (g) |
|---|---|
| SMR-L | 300 |
| Diene 140ND | 450 |
| Plasticizer ln | 78.8 |
| Zinc Oxide | 18.8 |
| Antioxidant DQ | 48.8 |
| Stearic Acid | 11.3 |
| C595 Resin | 52.5 |
| Carbon Black | 412.5 |
| Calculated Total | 1372.5 |

Detailed Mixing Steps. Banbury First Pass: starting temperature of 45° C. and starting RPM (rotations per minute) of 30. Add polymers (e.g., SMR-L and Diene 140ND); mix for 30 seconds. While mixing proceeds, manually prepare thickened oil by pouring about 25% of the carbon black (CB) into the oil. Add dry CB (remaining about 75%) by pouring down the mixer throat; mix for 60 seconds. Add naphthenic oil (oil thickened with about 25% of the CB). Add zinc oxide, antioxidant DQ, stearic acid, and resin C595; mix for 30 seconds. Clean ram; mix for 25 seconds. Clean ram; mix until a drop temperature of 125° C. at 90 RPM is reached. Milling First Pass: set water temperature on the mill to 80° F.; mill gap gauge (a.k.a. mill roll gauge) is 1.2 mm to start.

TABLE 7
Material Composition and Mixing - Second Pass

| Component | Weigh-Up 2^{nd} Pass (g) |
|---|---|
| First pass non-productive mix | 1281 |
| Antiozonant PD-2 | 7 |
| TBBS | 7 |
| Sulfur | 14 |
| Calculated Total | 1309 |

Banbury Second Pass: starting temperature of 45° C. and starting RPM of 30. Add ingredients: add non-productive mix (first pass compound); add antiozonant PD-2, TBBS, sulfur. Lower ram; mix at 90 RPM until a drop temperature of 105° C. is reached. Milling Second Pass: set water temperature on mill to 80° F. Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 8 such pig rolls, alternating starting edges. Increase mill gap gauge to 1.2 mm for final sheeting out.

Rubber Properties. The BRNRW01 sidewall formulation was used to compare rubber properties for A1, A2, and A3 types of plasma carbon black filler (tire rubber composition examples F2 to F5) in comparison to N550 furnace carbon black (example F1), with results shown in Table 8. The colloidal properties of the plasma carbon black samples are in a similar range as the N550 reference furnace carbon black. The examples containing plasma carbon black filler show comparable rubber performance (within about 10%, plus or minus) to the reference furnace black, with some advantages noted in terms of improved filler dispersion for the examples with plasma carbon black fillers relative to the N550 reference. Viscoelastic properties and thermal conductivity were not assessed for these particular examples.

TABLE 8
Rubber Properties

| Formulation: | Example | | | | |
|---|---|---|---|---|---|
| BRNRW01 Sidewall | F1 | F2 | F3 | F4 | F5 |

Formulation note/addition:

| | | | | | |
|---|---|---|---|---|---|
| CB grade ID/code: | N550 | P007A | P007B | P007C | T22 |
| N2SA (m²/g): | 40.5 | 43.2 | — | 40.0 | 40.7 |
| STSA (m²/g): | 40.0 | 48.3 | — | 44.6 | 45.6 |
| OAN (mL/100 g): | 126.7 | 124.5 | 123.8 | 121.0 | 123.0 |
| COAN (mL/100 g): | 85.5 | 103.4 | 104.2 | 102.9 | 103.5 |
| Plasma CB type: | — | A1 | A2 | A3 | A3 |

Additional type info:

| | | | | | |
|---|---|---|---|---|---|
| ts2 (min) [cure rheology at 170° C.]: | 1.70 | 1.85 | 2.15 | 2.12 | 2.01 |
| t60 (min) [cure rheology at 170° C.]: | 2.29 | 2.55 | 2.81 | 2.85 | 2.99 |
| t95 (min) [cure rheology at 170° C.]: | 3.56 | 4.12 | 4.26 | 4.39 | 4.73 |
| ML₁₊₄ @ 100° C. (MU): | 52.9 | 52.8 | 53.6 | 53.1 | 58.2 |
| Rubber cure time (min) at 170° C.: | t95 + 7 | t95 + 7 | t95 + 7 | t95 + 7 | t95 + 7 |
| M100 - 100% modulus @ 23° C. (MPa): | 1.47 | 1.43 | 1.41 | 1.65 | 1.71 |
| M300 - 300% modulus @ 23° C. (MPa): | 6.63 | 5.73 | 5.70 | 6.59 | 6.89 |
| M300/M100 @ 23° C.: | 4.52 | 4.01 | 4.03 | 3.99 | 4.03 |
| Tensile at Break @ 23° C. (MPa): | 15.5 | 12.8 | 14.4 | 13.9 | 14.3 |
| Elongation at Break @ 23° C. (%): | 625 | 598 | 649 | 587 | 586 |
| Shore A hardness: | 48.2 | 52.6 | 51.2 | 55.4 | 50.3 |
| Dispersion (%) [disperGRADER]: | 85.8 | 99.1 | 98.5 | 99.4 | 99.3 |
| Z Value (%) [disperGRADER]: | 80.7 | 91.8 | 95.3 | 95.5 | 96.0 |
| Density (g/cm³): | 1.12 | 1.10 | 1.10 | 1.10 | 1.12 |

The BRNRW01 sidewall formulation was used to compare rubber properties for A1, A2, and A3 types of plasma carbon black filler (tire rubber composition examples G2 to G5) in comparison to N762 furnace carbon black (example G1), with results shown in Table 9. The colloidal properties of the plasma carbon black samples are in a similar range as the N762 reference furnace carbon black. The examples containing plasma carbon black filler show comparable rubber performance (within about 10%, plus or minus) to the reference furnace black, with some advantages noted in terms of improved filler dispersion for the examples with plasma carbon black fillers relative to the N762 reference. Viscoelastic properties and thermal conductivity were not assessed for these particular examples.

TABLE 9
Rubber Properties

| Formulation: | Example | | | | |
|---|---|---|---|---|---|
| BRNRW01 Sidewall | G1 | G2 | G3 | G4 | G5 |

Formulation note/addition:

| | | | | | |
|---|---|---|---|---|---|
| CB grade ID/code: | N762 | 557A | 557E | 557F | 557G |
| N2SA (m²/g): | 28.9 | 28.1 | 26.2 | 25.5 | 25.4 |
| STSA (m²/g): | 27.6 | 31.4 | 29.4 | 28.9 | 28.6 |
| OAN (mL/100 g): | 65.8 | 73.6 | 72.3 | 71.3 | 71.1 |
| COAN (mL/100 g): | 59.2 | 70.9 | 69.4 | — | 71.1 |
| Plasma CB type: | — | A1 | A2 | A3 | A3 |

Additional type info:

| | | | | | |
|---|---|---|---|---|---|
| ts2 (min) [cure rheology at 160° C.]: | 3.80 | 2.85 | 3.58 | 5.01 | 3.74 |
| t60 (min) [cure rheology at 160° C.]: | 4.63 | 3.61 | 4.40 | 6.05 | 4.72 |
| t95 (min) [cure rheology at 160° C.]: | 7.00 | 5.35 | 6.48 | 8.76 | 7.05 |
| ML₁₊₄ @ 100° C. (MU): | 40.5 | 38.4 | 41.4 | 39.8 | 39.3 |
| Rubber cure time (min) at 160° C.: | t95 + 2 | t95 + 2 | t95 + 2 | t95 + 2 | t95 + 2 |
| M100 - 100% modulus @ 23° C. (MPa): | 1.28 | 1.54 | 1.28 | 1.34 | 1.35 |
| M300 - 300% modulus @ 23° C. (MPa): | 5.12 | 5.39 | 4.35 | 4.49 | 4.44 |
| M300/M100 @ 23° C.: | 4.01 | 3.50 | 3.40 | 3.36 | 3.30 |
| Tensile at Break @ 23° C. (MPa): | 14.3 | 8.00 | 13.7 | 12.3 | 13.2 |
| Elongation at Break @ 23° C. (%): | 630 | 464 | 682 | 640 | 665 |
| Shore A hardness: | 46.1 | 50.0 | 48.7 | 49.3 | 49.8 |
| Dispersion (%) [disperGRADER]: | 69.8 | 97.5 | 96.1 | 96.5 | 95.8 |
| Z Value (%) [disperGRADER]: | 72.6 | 94.5 | 87.0 | 89.0 | 85.0 |
| Density (g/cm³): | 1.10 | 1.10 | 1.11 | 1.10 | 1.10 |

The BRNRW01 sidewall formulation was used to compare rubber properties for A1, A2, and A3 types of plasma carbon black filler (tire rubber composition examples H2 to H5) in comparison to N660 furnace carbon black (example H1), with results shown in Table 10. The colloidal properties of the plasma carbon black samples are in a similar range as the N660 reference furnace carbon black. The examples containing plasma carbon black filler show comparable rubber performance (within about 10%, plus or minus) to the reference furnace black. Viscoelastic properties and thermal conductivity were not assessed for these particular examples.

TABLE 10
Rubber Properties

| Formulation: | Example | | | | |
|---|---|---|---|---|---|
| BRNRW01 Sidewall | H1 | H2 | H3 | H4 | H5 |

Formulation note/addition:

| | | | | | |
|---|---|---|---|---|---|
| CB grade ID/code: | N660 | 370A | 370D | 370J | 370K |
| N2SA (m²/g): | 35.9 | 37.8 | 36.8 | 35.9 | — |
| STSA (m²/g): | 35.2 | 43.3 | 42.2 | 40.6 | — |
| OAN (mL/100 g): | 90.3 | 95.5 | 98.4 | 99.3 | 98.6 |
| COAN (mL/100 g): | 71.2 | 87.9 | — | — | 92.1 |
| Plasma CB type: | — | A1 | A2 | A3 | A3 |

Additional type info:

| | | | | | |
|---|---|---|---|---|---|
| ts2 (min) [cure rheology at 160° C.]: | 3.29 | 4.08 | 4.80 | 4.69 | 4.41 |
| t60 (min) [cure rheology at 160° C.]: | 4.20 | 5.00 | 5.56 | 5.78 | 5.47 |
| t95 (min) [cure rheology at 160° C.]: | 6.55 | 7.35 | 8.25 | 8.47 | 8.10 |
| ML₁₊₄ @ 100° C. (MU): | 46.6 | 43.9 | 46.1 | 42.8 | 44.6 |
| Rubber cure time (min) at 160° C.: | t95 + 2 | t95 + 2 | t95 + 2 | t95 + 2 | t95 + 2 |
| M100 - 100% modulus @ 23° C. (MPa): | 1.43 | 1.41 | 1.44 | 1.54 | 1.54 |
| M300 - 300% modulus @ 23° C. (MPa): | 6.23 | 4.70 | 4.70 | 4.96 | 4.89 |
| M300/M100 @ 23° C.: | 4.36 | 3.33 | 3.26 | 3.22 | 3.18 |
| Tensile at Break @ 23° C. (MPa): | 13.7 | 13.6 | 12.6 | 12.7 | 12.7 |
| Elongation at Break @ 23° C. (%): | 572 | 676 | 653 | 635 | 637 |
| Shore A hardness: | 52.1 | 50.6 | 52.8 | 54.8 | 55.6 |
| Dispersion (%) [disperGRADER]: | 90.0 | 99.4 | 99.5 | 99.7 | 99.5 |
| Z Value (%) [disperGRADER]: | 89.7 | 94 | 94.6 | 95.6 | 96.8 |
| Density (g/cm³): | 1.11 | 1.11 | 1.11 | 1.11 | 1.11 |

The BRNRW01 sidewall formulation was used to compare rubber properties for A1, A2, and A3 types of plasma carbon black filler (tire rubber composition examples I2 to I5) in comparison to N660 furnace carbon black (example I1), with results shown in Table 11. The colloidal properties of the plasma carbon black samples are in a similar range as the N660 reference furnace carbon black. The examples containing plasma carbon black filler show comparable rubber performance (within about 10%, plus or minus) to the reference furnace black, with advantages noted in terms of improved filler dispersion and reduced viscoelastic loss tangent (tan δ) for the examples with plasma carbon black fillers relative to the N660 reference. The loss tangent (tan δ) was reduced in the range of 17% to 26% for the sidewall rubber formulation examples containing plasma carbon black compared to the example with furnace carbon black N660. Reduced tan δ of a tire rubber composition can be predictive of lower rolling resistance and lower viscoelastic heat build-up when the tire rubber composition is employed as or in a component of a tire. Improved filler dispersion can improve fatigue lifetime (mechanical durability) and abrasion resistance of tire rubber compositions.

A significant and surprising advantage of plasma carbon black filler over furnace carbon black in the tire sidewall formulation is increased (enhanced) thermal conductivity (k), which in examples I2-I5 was 41% to 45% higher for plasma carbon black compared to the N660 furnace carbon black of example I1. Such improvements in thermal conductivity can promote faster curing (vulcanization) of tire components and improve heat transfer for countering viscoelastic heat generation during tire use, as mentioned in the Background section above.

TABLE 11
Rubber Properties

| Formulation: | Example | | | | |
|---|---|---|---|---|---|
| BRNRW01 Sidewall | I1 | I2 | I3 | I4 | I5 |

Formulation note/addition:

| | | | | | |
|---|---|---|---|---|---|
| CB grade ID/code: | N660 | P040A | P040B | P040G | P040I |
| N2SA (m²/g): | 35.9 | 30.0 | 28.9 | 28.4 | 27.7 |
| STSA (m²/g): | 35.2 | 32.6 | 31.7 | 31.1 | 29.9 |
| OAN (mL/100 g): | 90.3 | 94.8 | 93.2 | 93.4 | 94.3 |
| COAN (mL/100 g): | 71.2 | 86.0 | — | 87.3 | 86.9 |
| Plasma CB type: | — | A1 | A2 | A3 | A3 |

Additional type info:

| | | | | | |
|---|---|---|---|---|---|
| ts2 (min) [cure rheology at 170° C.]: | 1.71 | 1.88 | 2.05 | 2.18 | 1.47 |
| t60 (min) [cure rheology at 170° C.]: | 2.29 | 2.50 | 2.64 | 2.88 | 2.11 |
| t95 (min) [cure rheology at 170° C.]: | 3.60 | 3.87 | 3.96 | 4.36 | 3.36 |
| ML₁₊₄ @ 100° C. (MU): | 48.9 | 46.9 | 47.4 | 45.2 | 45.9 |
| Rubber cure time (min) at 170° C.: | t95 + 7 | t95 + 7 | t95 + 7 | t95 + 7 | t95 + 7 |
| M100 - 100% modulus @ 23° C. (MPa): | 1.40 | 1.31 | 1.40 | 1.47 | 1.54 |
| M300 - 300% modulus @ 23° C. (MPa): | 5.95 | 5.13 | 5.36 | 5.57 | 5.77 |
| M300/M100 @ 23° C.: | 4.26 | 3.93 | 3.84 | 3.78 | 3.75 |
| Tensile at Break @ 23° C. (MPa): | 15.2 | 12.3 | 15.5 | 14.0 | 12.1 |
| Elongation at Break @ 23° C. (%): | 635 | 602 | 685 | 636 | 572 |
| Shore A hardness: | 51.5 | 50.9 | 50.9 | 53.3 | 54.6 |
| Dispersion (%) [disperGRADER]: | 75.8 | 97.2 | 96.5 | 98.6 | 98.4 |
| Z Value (%) [disperGRADER]: | 76.7 | 85.1 | 93.1 | 88.9 | 88.2 |
| Density (g/cm³): | 1.10 | 1.10 | 1.11 | 1.11 | 1.11 |
| ΔG′ (MPa) [RPA; 40° C.; 5 Hz; 0.1%-20%]: | 0.40 | 0.32 | 0.31 | 0.37 | 0.41 |
| tan δ [RPA; 40° C.; 5 Hz, 5%]: | 0.121 | 0.095 | 0.100 | 0.092 | 0.089 |
| G′ (MPa) [RPA; 40° C.; 5 Hz; 5%]: | 0.95 | 0.97 | 0.92 | 1.00 | 1.09 |
| Thermal Conductivity (W/mK): | 0.302 | 0.425 | 0.435 | 0.430 | 0.439 |

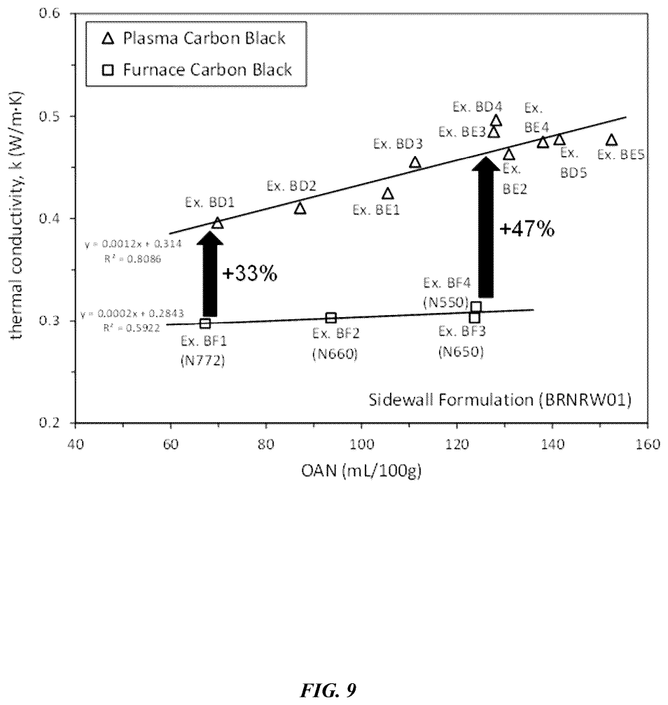

The BRNRW01 sidewall formulation was used to evaluate rubber properties for A2 types of plasma carbon black filler where the filler colloidal properties were varied across the range of nitrogen surface area (N2SA) from 30.3 to 40.2 m²/g and across the range of OAN structure from 69.8 to 152.4 mL/100 g, with results shown in Tables 12 and 13 (examples BD1 to BD5 and BEl to BE5, respectively). Table 14 provides rubber properties for furnace carbon black reference materials (examples BF1 to BF4). These examples enabled evaluation of the dependence of thermal conductivity (k) on filler structure (oil absorption number (OAN)), as shown in FIG. 9. Significantly, the plasma carbon black examples have k values that are 33% to 47% higher than corresponding furnace carbon black k values at the same OAN, and the plasma carbon black examples show stronger dependence of k on OAN compared to k for furnace carbon black, which is nearly independent of OAN. For example, the slope of the line (from linear regression) fit to the plasma carbon black data in FIG. 9 is six (6) times greater than the slope of the line fit to the furnace carbon black data.

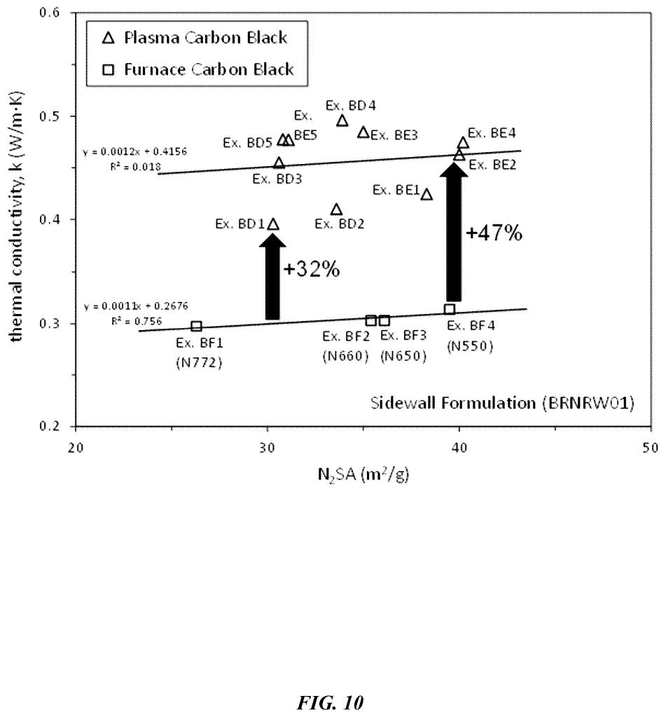

FIG. 10 shows the same k data plotted versus nitrogen surface area (N2SA) of the carbon blacks. There is no clear dependence of thermal conductivity (k) on filler surface area across the series of examples, but the results emphasize that the substantial increase in k for plasma carbon black relative to furnace carbon black is also observed when the fillers are compared at constant surface area. The same data provided in Tables 12-14 also shows that the substantial thermal conductivity advantage is maintained if plasma and furnace carbon blacks are compared on a constant mechanical reinforcement basis, for example using Shore A hardness, tensile stress at 100% strain (M100), or tensile stress at 300% strain (M300).

TABLE 12
Rubber Properties

| Formulation: | Example | | | | |
|---|---|---|---|---|---|
| BRNRW01 (variable OAN) | BD1 | BD2 | BD3 | BD4 | BD5 |

Formulation note/addition:

| | | | | | |
|---|---|---|---|---|---|
| CB grade ID/code: | P070B | A93F | P005A | ID670 | ID700 |
| N2SA (m²/g): | 30.3 | 33.6 | 30.6 | 33.9 | 30.8 |
| STSA (m²/g): | 33.7 | 36.9 | 32.7 | 39.4 | 34.9 |
| OAN (mL/100 g): | 69.8 | 87.1 | 111.2 | 128.2 | 141.5 |
| COAN (mL/100 g): | 69.8 | 81.4 | 95.6 | 110.6 | 118.4 |
| Plasma CB type: | A2 | A2 | A2 | A2 | A2 |

Additional type info:

| | | | | | |
|---|---|---|---|---|---|
| ts2 (min) [cure rheology at 160° C.]: | 4.19 | 2.49 | 3.53 | 2.65 | 2.50 |
| t60 (min) [cure rheology at 160° C.]: | 5.11 | 3.44 | 4.58 | 3.55 | 3.46 |
| t95 (min) [cure rheology at 160° C.]: | 7.94 | 5.89 | 7.30 | 5.59 | 5.88 |
| ML₁₊₄ @ 100° C. (MU): | 40.4 | 42.6 | 48.3 | 52.3 | 54.9 |
| Rubber cure time (min) at 160° C.: | 10 | 8 | 9 | 8 | 8 |
| M100 - 100% modulus @ 23° C. (MPa): | 1.24 | 1.52 | 1.61 | 1.70 | 2.03 |
| M300 - 300% modulus @ 23° C. (MPa): | 4.47 | 5.66 | 5.93 | 5.59 | 7.41 |
| M300/M100 @ 23° C.: | 3.62 | 3.73 | 3.68 | 3.29 | 3.64 |
| Tensile at Break @ 23° C. (MPa): | 15.0 | 11.7 | 13.4 | 13.5 | 13.5 |
| Elongation at Break @ 23° C. (%): | 690.1 | 550.9 | 621.0 | 636.4 | 558.2 |
| Shore A hardness: | 49.4 | 52.8 | 53.3 | 55.6 | 57.7 |
| Dispersion (%) [disperGRADER]: | 96.5 | 97.8 | 94.2 | 97.7 | 99.4 |
| Z Value (%) [disperGRADER]: | 90.8 | 94.2 | 84.6 | 91.3 | 94.8 |
| Density (g/cm³): | 1.124 | 1.115 | 1.120 | 1.114 | 1.115 |
| ΔG′ (MPa) [RPA; 60° C.; 10 Hz; 1%-20%]: | 0.25 | 0.35 | 0.35 | 0.66 | 0.57 |
| tan δ [RPA; 60° C.; 10 Hz, 10%]: | 0.102 | 0.112 | 0.116 | 0.141 | 0.129 |
| G′ (MPa) [RPA; 60° C.; 10 Hz; 5%]: | 1.14 | 1.32 | 1.38 | 1.58 | 1.65 |
| DeMattia Crack Growth Rate (mm/min) | 0.196 | 0.226 | 0.181 | — | — |
| Electrical Volume Resistivity (Ohm-cm) | 1.21E+11 | 8.61E+08 | 2.68E+08 | 4.79E+02 | 9.82E+02 |
| Thermal Conductivity (W/mK) | 0.396 | 0.410 | 0.455 | 0.496 | 0.478 |

TABLE 13
Rubber Properties

| Formulation: | Example | | | | |
|---|---|---|---|---|---|
| BRNRW01 (variable OAN) | BE1 | BE2 | BE3 | BE4 | BE5 |

Formulation note/addition:

| | | | | | |
|---|---|---|---|---|---|
| CB grade ID/code: | A94B | A94E | ID667 | ID1030 | ID698 |
| N2SA (m²/g): | 38.3 | 40.0 | 35.0 | 40.2 | 31.1 |
| STSA (m²/g): | 42.1 | 45.3 | 38.9 | 45.5 | 35.4 |
| OAN (mL/100 g): | 105.5 | 130.9 | 127.7 | 138.0 | 152.4 |
| COAN (mL/100 g): | 96.9 | 106.5 | 111.2 | 111.7 | 112.6 |
| Plasma CB type: | A2 | A2 | A2 | A2 | A2 |

Additional type info:

| | | | | | |
|---|---|---|---|---|---|
| ts2 (min) [cure rheology at 160° C.]: | 1.99 | 3.99 | 3.86 | 4.28 | 2.67 |
| t60 (min) [cure rheology at 160° C.]: | 2.98 | 5.10 | 4.93 | 5.45 | 3.65 |
| t95 (min) [cure rheology at 160° C.]: | 5.02 | 8.00 | 7.65 | 8.41 | 5.77 |
| ML₁₊₄ @ 100° C. (MU): | 47.1 | 50.7 | 52.3 | 56.1 | 55.2 |
| Rubber cure time (min) at 160° C.: | 7 | 10 | 10 | 10 | 8 |
| M100 - 100% modulus @ 23° C. (MPa): | 1.68 | 1.50 | 1.77 | 1.72 | 2.04 |
| M300 - 300% modulus @ 23° C. (MPa): | 6.70 | 5.97 | 6.52 | 7.07 | 7.43 |
| M300/M100 @ 23° C.: | 3.98 | 3.97 | 3.69 | 4.10 | 3.64 |
| Tensile at Break @ 23° C. (MPa): | 15.0 | 15.1 | 13.3 | 14.9 | 14.0 |
| Elongation at Break @ 23° C. (%): | 607.6 | 665.3 | 589.8 | 614.3 | 570.9 |
| Shore A hardness: | 55.1 | 54.1 | 55.7 | 55.5 | 57.2 |
| Dispersion (%) [disperGRADER]: | 99.2 | 99.0 | 98.1 | 99.6 | 99.4 |
| Z Value (%) [disperGRADER]: | 99.2 | 94.7 | 86.9 | 98.1 | 93.9 |
| Density (g/cm³): | 1.096 | 1.107 | 1.105 | 1.105 | 1.105 |
| ΔG′ (MPa) [RPA; 60° C.; 10 Hz; 1%-20%]: | 0.51 | 0.63 | 0.58 | 0.68 | 0.61 |
| tan δ [RPA; 60° C.; 10 Hz, 5%]: | 0.121 | 0.140 | 0.128 | 0.138 | 0.137 |
| G′ (MPa) [RPA; 60° C.; 10 Hz; 5%]: | 1.59 | 1.61 | 1.68 | 1.76 | 1.73 |
| Electrical Volume Resistivity (Ohm-cm) | 8.27E+05 | 4.85E+03 | 1.94E+03 | 2.71E+03 | 1.70E+03 |
| Thermal Conductivity (W/mK) | 0.425 | 0.463 | 0.485 | 0.475 | 0.477 |

TABLE 14
Rubber Properties

| Formulation: | Example | | | |
|---|---|---|---|---|
| BRNRW01 (variable OAN, Furnace) | BF1 | BF2 | BF3 | BF4 |

Formulation note/addition:

| | | | | |
|---|---|---|---|---|
| CB grade ID/code: | N772 | N660 | N650 | N550 |
| N2SA (m²/g): | 26.3 | 35.4 | 36.1 | 39.5 |
| STSA (m²/g): | 25.4 | 33.9 | 34.6 | 38.2 |
| OAN (mL/100 g): | 67.2 | 93.6 | 123.7 | 124 |
| COAN (mL/100 g): | 60.6 | 73.0 | 96.9 | 74.7 |
| ts2 (min) [cure rheology at 160° C.]: | 3.73 | 3.21 | 3.20 | 3.09 |
| t60 (min) [cure rheology at 160° C.]: | 4.71 | 4.19 | 4.19 | 4.09 |
| t95 (min) [cure rheology at 160° C.]: | 7.62 | 6.94 | 6.85 | 6.73 |
| ML₁₊₄ @ 100° C. (MU): | 39.5 | 45.9 | 50.81 | 50.69 |
| Rubber cure time (min) at 160° C.: | 10 | 9 | 9 | 9 |
| M100 - 100% modulus @ 23° C. (MPa): | 1.23 | 1.49 | 1.66 | 1.74 |
| M300 - 300% modulus @ 23° C. (MPa): | 4.97 | 6.46 | 7.70 | 7.79 |
| M300/M100 @ 23° C.: | 4.04 | 4.35 | 4.63 | 4.48 |
| Tensile at Break @ 23° C. (MPa): | 15.0 | 16.4 | 16.6 | 15.9 |
| Elongation at Break @ 23° C. (%): | 672.1 | 639.5 | 594.0 | 579.8 |
| Shore A hardness: | 48.4 | 51.6 | 54.1 | 54.7 |
| Dispersion (%) [disperGRADER]: | 83.0 | 81.6 | 83.1 | 90.4 |
| Z Value (%) [disperGRADER]: | 81.3 | 81.1 | 80.7 | 87.2 |
| Density (g/cm³): | 1.115 | 1.113 | 1.111 | 1.113 |
| ΔG′ (MPa) [RPA; 60° C.; 10 Hz; 1%-20%]: | 0.188 | 0.366 | 0.466 | 0.549 |
| tan δ [RPA; 60° C.; 10 Hz, 10%]: | 0.104 | 0.129 | 0.135 | 0.141 |
| G′ (MPa) [RPA; 60° C.; 10 Hz; 5%]: | 1.02 | 1.27 | 1.43 | 1.57 |
| DeMattia Crack Growth Rate (mm/min) | 0.157 | 0.177 | 0.183 | 0.232 |
| Electrical Volume Resistivity (Ohm-cm) | 6.84E+10 | 3.80E+10 | 1.14E+09 | 4.28E+07 |
| Thermal Conductivity (W/mK) | 0.297 | 0.303 | 0.303 | 0.314 |

### Example 2: Tire Sidewall Including Silica

Carbon black remains the predominant filler in tire sidewalls. However, precipitated silica is increasingly being utilized as a filler in tire sidewalls, for example, in combination with furnace carbon black grades such as N550, N660, N650, and the like, with sulfur-containing organosilane such as Si69 added as a silica-polymer coupling agent. Such formulations can give reduced rolling resistance, less heat build-up, enhanced durability, and/or other tire performance advantages compared to compositions with carbon black filler alone. Some embodiments of the present disclosure may include the incorporation of plasma carbon black filler in sidewall formulations that additionally contain precipitated silica. Useful plasma carbon blacks can include types A3, B3, and/or C3, with a variety of possible special binder additives including TESPT (Si69) silane coupling agent and/or other sulfur-containing organosilane. Silica-containing sidewall formulations that are representative but not limiting are presented in Table 15 below. The formulations are shown as a three-stage mixing scheme, but a two-stage mixing scheme may also be used, in particular for compounds with a lower loading of silica (e.g., 15 phr), or other mixing schemes may be used when appropriate.

Embodiments wherein plasma carbon black is incorporated in silica-containing sidewall filler formulations may include cases where precipitated silica is the major filler ingredient and cases where carbon black is the major filler ingredient. It can be envisaged that silica can be present from 0.5 to 99.5% and also that carbon black can be present from 0.5 to 99.5%. The carbon black that is present may be a mixture of plasma carbon black and furnace carbon black, and recovered carbon black may be included at up to 30-40%. Any combination of these fillers can be used, as well as exotic additive fillers such as nanotubes and graphene. This is non-limiting in that small amounts of these filler ingredients can cause large differences in performance. Additionally, small amounts of plasma carbon black can drastically improve the environmental impact of the resultant product. The product will have a smaller CO₂ footprint with more plasma carbon black added to the elastomer/carbon black composite.

Ingredients of example sidewall compounds including silica are listed below.

TABLE 15
Compound Formulations (Sidewall with Silica)

| Formulation: | Rubber Composition (phr) | | | | | | | |
|---|---|---|---|---|---|---|---|---|
| Sidewall with silica | 1 | 2 | 3 | 4 | 5 | 6 | 7 | 8 |
| 1^{st} Pass (first non- | | | | | | | | |
| productive stage): | | | | | | | | |
| Natural Rubber | 40 | 40 | 40 | 40 | 40 | 40 | 40 | 40 |
| Butadiene Rubber | 60 | 60 | 60 | 60 | 60 | 60 | 60 | 60 |
| Precipitated Silica | 15 | 15 | 15 | 15 | 35 | 35 | 35 | 35 |
| (e.g. Mansil 190G) | | | | | | | | |
| Si69 silane | 1.2 | 1.2 | 1.2 | 1.2 | 2.8 | 2.8 | 2.8 | 2.8 |
| coupling agent | | | | | | | | |
| N550 furnace CB | 40 | | | | 20 | | | |
| (comparative ref.) | | | | | | | | |
| Plasma CB [type B3; | | 40 | | | | 20 | | |
| Si69 in binder] | | | | | | | | |
| Plasma CB [type C3; | | | 40 | | | | 20 | |
| Si69 in binder] | | | | | | | | |
| Plasma CB [other | | | | 40 | | | | 20 |
| example(s)] | | | | | | | | |
| Naphthenic oil | 10.5 | 10.5 | 10.5 | 10.5 | 10.5 | 10.5 | 10.5 | 10.5 |
| Wax | 2 | 2 | 2 | 2 | 2 | 2 | 2 | 2 |
| Tackifying resin | 7 | 7 | 7 | 7 | 7 | 7 | 7 | 7 |
| 2^{nd} Pass (second non- | | | | | | | | |
| productive stage): | | | | | | | | |
| 6PPD | 2.5 | 2.5 | 2.5 | 2.5 | 2.5 | 2.5 | 2.5 | 2.5 |
| TMQ | 2 | 2 | 2 | 2 | 2 | 2 | 2 | 2 |
| Zinc oxide | 2.5 | 2.5 | 2.5 | 2.5 | 2.5 | 2.5 | 2.5 | 2.5 |
| Stearic acid | 1.5 | 1.5 | 1.5 | 1.5 | 1.5 | 1.5 | 1.5 | 1.5 |
| 3^{rd} Pass (productive stage): | | | | | | | | |
| TBBS accelerator | 1 | 1 | 1 | 1 | 1 | 1 | 1 | 1 |
| DPG accelerator | 0.6 | 0.6 | 0.6 | 0.6 | 1.2 | 1.2 | 1.2 | 1.2 |
| Sulfur | 1.8 | 1.8 | 1.8 | 1.8 | 1.8 | 1.8 | 1.8 | 1.8 |

### Example 3: Tire Inner Liner

The forthcoming examples demonstrate the utility of plasma carbon black when employed in tire rubber compositions for use as an inner liner component of a tire. The specific rubber formulations shown are intended to be representative and not limiting. The bromobutyl rubber (BIIR) to polyisoprene (e.g., natural rubber) (NR) (BIIR/NR) polymer ratio can vary in inner liner formulations from 100/0 to about 70/30, and other elastomeric polymers may be used as minor polymer components, including various types of isoprene rubber (IR), butadiene rubber (BR), styrene-butadiene rubber (SBR), ethylene-propylene-diene monomer (EPDM), and/or the like. Various furnace carbon black grades may be used, such as N762, N772, N774, N660, N650, and others. Various types of platy fillers like delaminated and exfoliated clays, graphenes, and other options can be included for improving gas barrier characteristics. Fillers may also include carbon fillers from pyrolysis of recycled rubber materials, recycled rubber products like end-of-life tires, biomass waste, and other sources. Precipitated silica can be used as filler, with or without varieties of sulfur-containing organosilanes and/or other coupling agents. Furnace carbon black, clays, graphenes, precipitated silica, other inorganic particulate fillers, recovered carbon filler from pyrolysis of end-of-life tires, and the like may be used in various combination with the disclosed plasma carbon black filler at various loading levels. Other adjustments to the formulation can be made for assorted performance and processability reasons. In particular, there are various options for amounts and types of cure/vulcanization ingredients. Variations in types and amounts of processing aids such as oils, tackifying resins, homogenizing agents/resins (e.g., Promix 400 from Flow Polymers), and the like may be used. The embodiments set forth herein, related to use of plasma carbon black filler in tire rubber compositions used for inner liner components, encompass reasonable inner liner formulation variations.

The following list summarizes adjustments to the BIIR Inner Liner and BIIR/NR Inner Liner formulations and/or mixing scheme that have been conducted through the course of research toward developing the tire rubber compositions of the present disclosure. Inner liner formulation adjustments explored include, for example: adding benzoic acid at 0.25 phr; adding n-cyclohexylthio-phthalimide (CTP) at 0.25 phr; adding Retrocure G at 0.25 phr; adding MgO at 0.25 phr; decreasing sulfur loading from 0.5 phr to 0.38 phr; moving the phenolic resin to the productive mixing stage (second pass); decreasing the non-productive total mixing time; increasing the non-productive drop temperature from 125° C. to 140° C. and 150° C.; adding Polyfil DL delaminated clay at 60 phr; replacing Exxon Bromobutyl 2222 with Exxpro 3563; and adding 0.75 phr of amylphenol disulfide oligomer (Vultac 3) to the productive mixing stage.

The examples below of tire inner liner compositions containing plasma carbon black filler show comparable performance (within about 10%, plus or minus) in standard rubber testing to reference carbon black from the furnace process. The production of furnace carbon black generates multiple tons of CO₂ for every ton of carbon black produced, whereas the production of plasma carbon black generates <20% of that CO₂, so these examples show that plasma carbon black fillers in tire inner liner components can have a significant positive impact on sustainability of tires without substantially compromising rubber properties.

It was surprisingly discovered for tire inner liner composition examples that plasma carbon black gives substantially higher (enhanced) thermal conductivity relative to comparative furnace carbon black when compounded into the rubber formulations, with the projected benefits to tire manufacturing and tire performance discussed earlier.

Ingredients of an example B3IJ01 inner liner compound are listed below.

TABLE 16
Compound Formulation (Inner Liner BII01)

| | | | |
|---|---|---|---|
| Ingredient | Detail | PHR | Wt. % |

Pass 1, Master Batch (MB)

| | | | |
|---|---|---|---|
| BIIR | Exxon Bromobutyl 2222; polymer | 100 | 54.70 |
| Naphthenic Oil | Plasticizer ln; process oil, | 8 | 4.38 |
| | processing aid | | |
| Blk | Carbon Black; filler | 60 | 32.82 |
| Hydrocarbon | Proaid AC-740; tackifying resin; | 7 | 3.83 |
| Resin | processing aid | | |
| Phenolic Resin | SP 1068 (P-90) Resin; curative, | 4 | 2.19 |
| | tackifying resin | | |
| Stearic Acid | Stearic Acid-Rubbergrade; | 1 | 0.55 |
| | activator, processing aid | | |
| Total | Total | 180 | — |

Pass 2

| | | | |
|---|---|---|---|
| MB | Master Batch | 180 | — |
| Zinc | Zinc Oxide RGT-M; activator, curative | 1 | 0.55 |
| Sulfur | Rubbermakers sulfur; curative | 0.5 | 0.27 |
| Accel | MBTS; accelerator | 1.3 | 0.71 |
| Total | Total | 182.8 | 100.00 |

Summary ofMixin Steps. First Pass: add polymer and hydrocarbon resin blend (Exxon Bromobutyl 2222 and Proaid AC-740); mix 30 seconds. Add carbon black; mix 60 seconds. Add naphthenic oil, phenolic resin, and stearic acid; mix 30 seconds. Include two ram clean-out steps at 30 seconds each; mix until drop temperature of 125° C. is reached. Second Pass: add first pass mix plus zinc oxide, sulfur, and MBTS; mix until drop temperature of 105° C. is reached.

TABLE 17
Material Composition and Mixing - First Pass

| Component | Weigh-Up 1^{st} Pass (g) |
|---|---|
| Exxon Bromobutyl 2222 | 709.4 |
| Naphthenic Oil (Plasticizer ln) | 56.8 |
| Stearic Acid | 7.1 |
| Phenolic Resin Tackifier (SP 1068) | 28.4 |
| Proaid AC-740 | 49.7 |
| Carbon Black | 485.9 |
| Calculated Total | 1337.3 |

Detailed Mixing Steps. Banbury First Pass: starting temperature 45° C. and starting RPM of 30. Add Proaid AC-740 and Exxon Bromobutyl 2222; mix 30 seconds. While mixing proceeds, manually prepare thickened oil by pouring about 25% of the carbon black (CB) into the oil. Add dry CB (remaining about 75%) by pouring down the mixer throat; mix 60 seconds. Add naphthenic oil (oil thickened with about 25% of the CB). Add phenolic resin (SP1068) and stearic acid; mix 30 seconds. Clean ram; mix 25 seconds. Clean ram; mix until a drop temperature of 125° C. at 90 RPM is reached. Milling First Pass: make sure chiller unit is on and flowing 45° F. water through the rolls; mill gap gauge (a.k.a. mill roll gauge) is 1.2 mm to start.

TABLE 18
Material Composition and Mixing - Second Pass

| Component | Weigh-Up 2^{nd} Pass (g) |
|---|---|
| First pass non-productive mix | 1319.5 |
| Sulfur | 3.5 |
| MBTS | 9.1 |
| Zinc Oxide | 7.0 |
| Calculated Total | 1339.1 |

Banbury Second Pass: starting temperature of 45° C. and starting RPM of 30. Add ingredients: non-productive mix (first pass compound); sulfur, MBTS, zinc oxide. Lower ram; mix at 90 RPM until a drop temperature of 105° C. is reached. Milling Second Pass: chill the mill rolls via chiller set to 45° F. Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges. Increase mill gap gauge to 1.2 mm for final sheeting out.

Rubber Properties. The BII01 inner liner formulation was used to compare rubber properties for A1, A2, and A3 types of plasma carbon black filler (tire rubber composition examples J2 to J5) in comparison to N772 furnace carbon black (example J1), with results shown in Table 19. The colloidal properties of the plasma carbon black samples are in a similar range as the N772 reference furnace carbon black. The examples containing plasma carbon black filler show comparable rubber performance (within about 10%, plus or minus) to the reference furnace black. Viscoelastic properties and thermal conductivity were not assessed for these particular examples.

TABLE 19
Rubber Properties

| Formulation: | Example | | | | |
|---|---|---|---|---|---|
| BII01 inner liner | J1 | J2 | J3 | J4 | J5 |

Formulation note/addition:

| | | | | | |
|---|---|---|---|---|---|
| CB grade ID/code: | N772 | 547A | 095A | 095C | 095F |
| N2SA (m²/g): | 26.75 | 27.75 | 31.97 | 31.82 | — |
| STSA (m²/g): | 25.81 | 29.94 | 35.11 | 34.99 | — |
| OAN (mL/100 g): | 67.2 | 72.8 | 69.6 | 70.6 | 72.0 |
| COAN (mL/100 g): | 58.1 | 71.5 | 69.3 | 69.2 | — |
| Plasma CB type: | | A1 | A2 | A3 | A3 |

Additional type info:

| | | | | | |
|---|---|---|---|---|---|
| ts2 (min) [cure rheology at 160° C.]: | 5.32 | 5.68 | 5.08 | 4.35 | 3.12 |
| t60 (min) [cure rheology at 160° C.]: | 4.85 | 5.98 | — | — | — |
| t95 (min) [cure rheology at 160° C.]: | 15.38 | 11.60 | 18.09 | 13.55 | 15.25 |
| ML₁₊₄ @ 100° C. (MU): | 46.7 | 46.2 | — | — | — |
| Rubber cure time (min) at 160° C.: | 17 | 14 | 20 | 16 | 17 |
| M100 - 100% modulus @ 23° C. (MPa): | 0.7 | 0.7 | 0.7 | 0.7 | 0.8 |
| M300 - 300% modulus @ 23° C. (MPa): | 1.9 | 1.9 | 1.8 | 2.3 | 2.4 |
| M300/M100 @ 23° C.: | 2.89 | 2.77 | 2.68 | 3.10 | 3.16 |
| Tensile at Break @ 23° C. (MPa): | 8.4 | 8.2 | 8.6 | 9.3 | 9.9 |
| Elongation at Break @ 23° C. (%): | 942 | 880 | 976 | 902 | 950 |
| Shore A hardness: | 38.6 | 38.1 | 37.2 | 36.5 | 37.3 |
| Dispersion (%) [disperGRADER]: | 98.3 | 97.5 | 98.9 | 98.9 | 98.6 |
| Z Value (%) [disperGRADER]: | 96.6 | 95.9 | 93.6 | 95.0 | 98.4 |
| Density (g/cm³): | 1.13 | 1.15 | 1.13 | 1.13 | 1.14 |

The BII01 inner liner formulation was used to compare rubber properties for A1, A2, and A3 types of plasma carbon black filler (tire rubber composition examples K2 to K5) in comparison to N772 furnace carbon black (example K1), with results shown in Table 20. The colloidal properties of the plasma carbon black samples are in a similar range as the N772 reference furnace carbon black. The examples containing plasma carbon black filler show comparable rubber performance (within about 10%, plus or minus) to the reference furnace black. Viscoelastic properties and thermal conductivity were not assessed for these particular examples.

TABLE 20
Rubber Properties

| Formulation: | Example | | | | |
|---|---|---|---|---|---|
| BII01 inner liner | K1 | K2 | K3 | K4 | K5 |

Formulation note/addition:

| | | | | | |
|---|---|---|---|---|---|
| CB grade ID/code: | N772 | 470A | 470B | 470H | 470I |
| N2SA (m²/g): | 26.75 | 34.00 | 32.19 | — | 31.07 |
| STSA (m²/g): | 25.81 | 36.01 | 34.81 | — | 34.01 |
| OAN (mL/100 g): | 67.2 | 67.5 | 67.0 | 65.7 | 67.1 |
| COAN (mL/100 g): | 58.1 | 67.5 | — | — | 67.1 |
| Plasma CB type: | | A1 | A2 | A3 | A3 |

Additional type info:

| | | | | | |
|---|---|---|---|---|---|
| ts2 (min) [cure rheology at 160° C.]: | 5.32 | 5.17 | 5.69 | 4.76 | 5.18 |
| t60 (min) [cure rheology at 160° C.]: | 4.85 | — | — | — | — |
| t95 (min) [cure rheology at 160° C.]: | 15.38 | 12.82 | 11.79 | 14.02 | 11.57 |
| ML₁₊₄ @ 100° C. (MU): | 46.65 | 48.1 | 47.7 | 49.2 | 49.2 |
| Rubber cure time (min) at 160° C.: | 17 | 15 | 14 | 16 | 14 |
| M100 - 100% modulus @ 23° C. (MPa): | 0.7 | 0.7 | 0.6 | 0.7 | 0.7 |
| M300 - 300% modulus @ 23° C. (MPa): | 1.9 | 1.9 | 1.7 | 1.9 | 2.1 |
| M300/M100 @ 23° C.: | 2.89 | 2.89 | 2.73 | 2.93 | 3.04 |
| Tensile at Break @ 23° C. (MPa): | 8.4 | 9.2 | 9.2 | 9.1 | 9.7 |
| Elongation at Break @ 23° C. (%): | 942 | 948 | 965 | 928 | 917 |
| Shore A hardness: | 38.6 | 40.2 | 38.0 | 39.4 | 39.4 |
| Dispersion (%) [disperGRADER]: | 98.3 | 98.3 | 97.9 | 97.2 | 98.1 |
| Z Value (%) [disperGRADER]: | 96.6 | 96.2 | 95.2 | 95.7 | 96.5 |
| Density (g/cm³): | 1.133 | 1.134 | 1.135 | 1.136 | 1.136 |

The BII01 inner liner formulation was used to compare rubber properties for A1, A2, and A3 types of plasma carbon black filler (tire rubber composition examples L2 to L5) in comparison to N660 furnace carbon black (example Li), with results shown in Table 21. The colloidal properties of the plasma carbon black samples are in a similar range as the N660 reference furnace carbon black. The examples containing plasma carbon black filler show comparable rubber performance (within about 10%, plus or minus) to the reference furnace black. Viscoelastic properties and thermal conductivity were not assessed for these particular examples.

TABLE 21
Rubber Properties

| Formulation: | Example | | | | |
|---|---|---|---|---|---|
| BII01 inner liner | L1 | L2 | L3 | L4 | L5 |

Formulation note/addition:

| | | | | | |
|---|---|---|---|---|---|
| CB grade ID/code: | N660 | 365A | 365B | 365E | 365G |
| N2SA (m²/g): | 35.89 | 42.54 | 37.87 | 40.02 | 38.65 |
| STSA (m²/g): | 35.15 | 46.13 | 41.64 | 45.00 | 42.86 |
| OAN (mL/100 g): | 90.3 | 102.7 | 100.7 | 101.0 | 100.9 |
| COAN (mL/100 g): | 71.2 | 92.9 | 92.4 | 93.5 | 93.4 |
| Plasma CB type: | | A1 | A2 | A3 | A3 |

Additional type info:

| | | | | | |
|---|---|---|---|---|---|
| ts2 (min) [cure rheology at 160° C.]: | 4.10 | 3.86 | 4.44 | 3.72 | 3.51 |
| t60 (min) [cure rheology at 160° C.]: | 4.47 | — | — | — | — |
| t95 (min) [cure rheology at 160° C.]: | 14.59 | 14.96 | 12.8 | 15.05 | 15.53 |
| ML₁₊₄ @ 100° C. (MU): | 54.2 | 62.7 | 61.7 | 63.9 | 63.9 |
| Rubber cure time (min) at 160° C.: | 17 | 17 | 15 | 17 | 18 |
| M100 - 100% modulus @ 23° C. (MPa): | 0.6 | 1.0 | 1.0 | 1.0 | 1.0 |
| M300 - 300% modulus @ 23° C. (MPa): | 2.8 | 3.1 | 3.0 | 2.9 | 2.9 |
| M300/M100 @ 23° C.: | 3.32 | 3.07 | 3.02 | 3.01 | 3.08 |
| Tensile at Break @ 23° C. (MPa): | 9.0 | 7.9 | 8.1 | 8.2 | 8.5 |
| Elongation at Break @ 23° C. (%): | 863 | 762 | 802 | 805 | 827 |
| Shore A hardness: | 42.7 | 51.8 | 52.1 | 51.1 | 49.5 |
| Dispersion (%) [disperGRADER]: | 97.3 | 98.6 | 98.8 | 98.8 | 99.2 |
| Z Value (%) [disperGRADER]: | 93.9 | 96.9 | 98.1 | 98.1 | 94.1 |
| Density (g/cm³): | 1.13 | 1.13 | 1.13 | 1.13 | 1.13 |
| DeMattia Crack Growth Rate (mm/min) | 0.022 | 0.012 | 0.015 | — | — |

The BII01 inner liner formulation was used to compare rubber properties for A1, A2, and A3 types of plasma carbon black filler (tire rubber composition examples M2 to M5) in comparison to N660 furnace carbon black (example M1), with results shown in Table 22. The colloidal properties of the plasma carbon black samples are in a similar range as the N660 reference furnace carbon black. The examples containing plasma carbon black filler show comparable rubber performance (within about 10%, plus or minus) to the reference furnace black. Viscoelastic properties were not assessed for these particular examples.

A significant and surprising advantage of plasma carbon black over furnace carbon black in the tire inner liner formulation BII01 was noted for the property of thermal conductivity (k), which was 48% to 54% higher (enhanced) for plasma carbon black compared to the N660 furnace carbon black.

TABLE 22
Rubber Properties

| Formulation: | Example | | | | |
|---|---|---|---|---|---|
| BII01 inner liner | M1 | M2 | M3 | M4 | M5 |

Formulation note/addition:

| | | | | | |
|---|---|---|---|---|---|
| CB grade ID/code: | N660 | 629A | 629B | 629D | 629F |
| N2SA (m²/g): | 35.89 | 30.02 | 28.32 | 26.95 | 26.42 |
| STSA (m²/g): | 35.15 | 32.56 | 31.21 | 29.64 | 28.76 |
| OAN (mL/100 g): | 90.3 | 100.6 | 98.2 | 96.3 | 96.1 |
| COAN (mL/100 g): | 71.2 | — | 88.8 | 88.5 | 87.2 |
| Plasma CB type: | | A1 | A2 | A3 | A3 |

Additional type info:

| | | | | | |
|---|---|---|---|---|---|
| ts2 (min) [cure rheology at 160° C.]: | 4.11 | 5.41 | 5.30 | 4.38 | 5.34 |
| t60 (min) [cure rheology at 160° C.]: | 4.47 | 5.55 | 5.36 | 5.13 | 6.31 |
| t95 (min) [cure rheology at 160° C.]: | 14.59 | 21.39 | 17.94 | 12.3 | 15.62 |
| ML₁₊₄ @ 100° C. (MU): | 54.2 | 58.3 | 57.7 | 56.7 | 58.6 |
| Rubber cure time (min) at 160° C.: | 17 | 23 | 20 | 14 | 18 |
| M100 - 100% modulus @ 23° C. (MPa): | 0.6 | 0.9 | 0.8 | 0.9 | 0.9 |
| M300 - 300% modulus @ 23° C. (MPa): | 2.8 | 2.7 | 2.4 | 2.7 | 2.8 |
| M300/M100 @ 23° C.: | 3.33 | 2.96 | 2.89 | 2.90 | 3.01 |
| Tensile at Break @ 23° C. (MPa): | 9.0 | 7.4 | 7.2 | 7.8 | 7.9 |
| Elongation at Break @ 23° C. (%): | 863 | 835 | 860 | 856 | 835 |
| Shore A hardness: | 42.7 | 42.9 | 41.2 | 42.6 | 42.5 |
| Dispersion (%) [disperGRADER]: | 97.3 | 95.7 | 94.4 | 92.4 | 97.1 |
| Z Value (%) [disperGRADER]: | 93.9 | 94.8 | 95.2 | 81.6 | 96.5 |
| Density (g/cm³): | 1.13 | 1.13 | 1.12 | 1.13 | 1.13 |
| Thermal Conductivity (W/mK): | 0.272 | 0.409 | 0.402 | 0.408 | 0.418 |

BIIR Inner Liner with Clay. Delaminated clay was compounded into the inner liner composition using the same formulation and mixing conditions as BIIR Inner Liner above, with the exception that 40 phr of Polyfil DL delaminated clay was added in the first pass with the dry carbon black. The BII01 inner liner formulation with clay added was used to compare rubber properties for A1, A2, and A3 types of plasma carbon black filler (tire rubber composition examples N2 to N5) in comparison to N762 furnace carbon black (example N1), with results shown in Table 23. The colloidal properties of the plasma carbon black samples are in a similar range as the N762 reference furnace carbon black. The examples containing plasma carbon black filler show comparable rubber performance (within about 10%, plus or minus) to the reference furnace black. Viscoelastic properties and thermal conductivity were not assessed for these particular examples.

TABLE 23
Rubber Properties

| Formulation: | Example | | | | |
|---|---|---|---|---|---|
| BII01 with Clay | N1 | N2 | N3 | N4 | N5 |

Formulation note/addition:

| | | | | | |
|---|---|---|---|---|---|
| CB grade ID/code: | N762 | 575A | 575B | 575G | 575H |
| N2SA (m²/g): | 31.9 | 31.5 | 28.9 | 28.5 | 28.0 |
| STSA (m²/g): | 30.7 | 34.5 | 32.3 | 31.2 | 30.4 |
| OAN (mL/100 g): | 66.3 | 67.9 | 67.1 | 68.4 | 68.6 |
| COAN (mL/100 g): | 60.5 | 67.3 | — | 67.3 | — |
| Plasma CB type: | | A1 | A2 | A3 | A3 |

Additional type info:

| | | | | | |
|---|---|---|---|---|---|
| ts2 (min) [cure rheology at 160° C.]: | 5.42 | 5.41 | 5.55 | 6.91 | 8.31 |
| t60 (min) [cure rheology at 160° C.]: | 5.4 | 5.71 | 5.78 | 7.71 | 8.83 |
| t95 (min) [cure rheology at 160° C.]: | 19.06 | 18.12 | 17.14 | 18.37 | 17.79 |
| ML₁₊₄ @ 100° C. (MU): | 48.7 | 49.6 | 50.9 | 51.8 | 52.8 |
| Rubber cure time (min) at 160° C.: | 21 | 20 | 19 | 20 | 20 |
| M100 - 100% modulus @ 23° C. (MPa): | 1.0 | 1.0 | 1.0 | 1.1 | 1.1 |
| M300 - 300% modulus @ 23° C. (MPa): | 2.5 | 2.4 | 2.3 | 2.6 | 2.7 |
| M300/M100 @ 23° C.: | 2.473 | 2.368 | 2.389 | 2.398 | 2.442 |
| Tensile at Break @ 23° C. (MPa): | 7.9 | 6.9 | 6.5 | 6.8 | 6.8 |
| Elongation at Break @ 23° C. (%): | 876.7 | 852.1 | 826.8 | 804.3 | 782.2 |
| Shore A hardness: | 46.8 | 45.9 | 46.2 | 46.2 | 45.9 |
| Dispersion (%) [disperGRADER]: | 96.0 | 97.8 | 97.0 | 97.4 | 97.2 |
| Z Value (%) [disperGRADER]: | 70.2 | 75.2 | 74.8 | 72.9 | 73.3 |
| Density (g/cm³): | 1.267 | 1.264 | 1.265 | 1.267 | 1.265 |

Ingredients of an example BINRI01 inner liner compound are listed below.

TABLE 24
Compound Formulation (Inner Liner BINRI01)

| | | | |
|---|---|---|---|
| Ingredient | Detail | PHR | Wt. % |

Pass 1, Master Batch (MB)

| | | | |
|---|---|---|---|
| BIIR | Exxon Bromobutyl 2222; polymer | 80 | 43.76 |
| NR | Natural Rubber SIR 20; polymer | 20 | 10.94 |
| Naphthenic Oil | Plasticizer ln; process oil, | 8 | 4.38 |
| | processing aid | | |
| Blk | Carbon Black; filler | 60 | 32.82 |
| Hydrocarbon | Proaid AC-740; tackifying resin, | 7 | 3.83 |
| Resin | processing aid | | |
| Phenolic Resin | SP 1068 (P-90) Resin; curative, | 4 | 2.19 |
| | tackifying resin | | |
| Stearic Acid | Stearic Acid-Rubbergrade; activator, | 1 | 0.55 |
| | processing aid | | |
| Total | Total | 180 | — |

Pass 2

| | | | |
|---|---|---|---|
| MB | Master Batch | 180 | — |
| Zinc | Zinc Oxide RGT-M; activator, curative | 1 | 0.55 |
| Sulfur | Rubbermakers sulfur; curative | 0.5 | 0.27 |
| Accel | MBTS; accelerator | 1.3 | 0.71 |
| Total | Total | 182.8 | 100.00 |

Summary of Mixing Steps. First Pass: add polymers (Exxon Bromobutyl 2222 and SIR 20) and hydrocarbon resin (Proaid AC-740); mix 30 seconds. Add carbon black; mix 60 seconds. Add naphthenic oil, phenolic resin, and stearic acid; mix 30 seconds. Include two ram clean-out steps at 30 seconds each; mix until drop temperature of 125° C. is reached. Second Pass: add first pass mix plus zinc oxide, sulfur, and MBTS; mix until drop temperature of 105° C. is reached.

TABLE 25
Material Composition and Mixing - First Pass

| Component | Weigh-Up 1^{st} Pass (g) |
|---|---|
| Exxon Bromobutyl 2222 | 600.0 |
| SIR20 Prime Rubber | 150.0 |
| Naphthenic Oil (Plasticizer ln) | 60.0 |
| Stearic Acid | 7.5 |
| Phenolic Resin Tackifier (SP 1068) | 30.0 |
| Proaid AC-740 | 52.5 |
| Carbon Black | 450.0 |
| Calculated Total | 1350.0 |

Detailed Mixing Steps. Banbury First Pass: starting temperature 45° C. and starting RPM of 30. Add Proaid AC-740 and polymers (Exxon Bromobutyl 2222 and SIR 20); mix 30 seconds. While mixing proceeds, manually prepare thickened oil by pouring about 25% of the carbon black (CB) into the oil. Add dry CB (remaining about 75%) by pouring down the mixer throat; mix 60 seconds. Add naphthenic oil (oil thickened with about 25% of the CB). Add phenolic resin (SP1068) and stearic acid; mix 30 seconds. Clean ram; mix 25 seconds. Clean ram; mix at 90 RPM until a drop temperature of 125° C. is reached. Milling First Pass: make sure chiller unit is on and flowing 45° F. water through the rolls; mill gap gauge (a.k.a. mill roll gauge) is 1.2 mm to start.

TABLE 26
Material Composition and Mixing - Second Pass

| Component | Weigh-Up 2^{nd} Pass (g) |
|---|---|
| First pass non-productive mix | 1303.7 |
| Sulfur | 3.6 |
| MBTS | 9.4 |
| Zinc Oxide | 7.2 |
| Calculated Total | 1323.9 |

Banbury Second Pass: temperature 45° C. and starting RPM of 30. Add ingredients: add non-productive mix (first pass compound); sulfur, MBTS, zinc oxide. Lower ram; mix at 90 RPM until a drop temperature of 105° C. is reached. Milling Second Pass: chill the mill rolls via chiller set to 45° F. Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges; increase mill gap gauge to 1.2 mm for final sheeting out.

Rubber Properties. The BINRI01 inner liner formulation was used to compare rubber properties for A1, A2, and A3 types of plasma carbon black filler (tire rubber composition examples 02 to 05) in comparison to N660 furnace carbon black (example 01), with results shown in Table 27. The colloidal properties of the plasma carbon black samples are in a similar range as the N660 reference furnace carbon black. The examples containing plasma carbon black filler show comparable rubber performance (within about 10%, plus or minus) to the reference furnace black. Viscoelastic properties and thermal conductivity were not assessed for these particular examples.

TABLE 27
Rubber Properties

| Formulation: | Example | | | | |
|---|---|---|---|---|---|
| BINRI01 inner liner | O1 | O2 | O3 | O4 | O5 |

Formulation note/addition:

| | | | | | |
|---|---|---|---|---|---|
| CB grade ID/code: | N660 | 688A | 688B | 688C | 367E |
| N2SA (m²/g): | 35.89 | 41.88 | 39.80 | 39.76 | 40.02 |
| STSA (m²/g): | 35.15 | 46.13 | 44.11 | 44.64 | 45.00 |
| OAN (mL/100 g): | 90.3 | 104.8 | 104.0 | 103.4 | 101.0 |
| COAN (mL/100 g): | 71.2 | 94.8 | 94.6 | 95.5 | 93.5 |
| Plasma CB type: | | A1 | A2 | A3 | A3 |

Additional type info:

| | | | | | |
|---|---|---|---|---|---|
| ts2 (min) [cure rheology at 160° C.]: | 4.76 | 4.57 | 5.3 | 4.52 | 4.14 |
| t60 (min) [cure rheology at 160° C.]: | 5.28 | 5.73 | 6.4 | 6.47 | — |
| t95 (min) [cure rheology at 160° C.]: | 11.29 | 11.89 | 12.46 | 12.63 | 10.22 |
| ML₁₊₄ @ 100° C. (MU): | 48.80 | 55.12 | 55.46 | 56.89 | 57.55 |
| Rubber cure time (min) at 160° C.: | 13 | 14 | 14 | 15 | 12 |
| M100 - 100% modulus @ 23° C. (MPa): | 0.83 | 1.0 | 1.0 | 1.1 | 1.07 |
| M300 - 300% modulus @ 23° C. (MPa): | 2.7 | 3.0 | 2.8 | 3.4 | 3.29 |
| M300/M100 @ 23° C.: | 3.241 | 2.904 | 2.934 | 3.108 | 3.07 |
| Tensile at Break @ 23° C.: | 9.2 | 7.8 | 8.1 | 8.5 | 8.8 |
| Elongation at Break @ 23° C.: | 855.5 | 749.3 | 763.0 | 712.9 | 740.8 |
| Shore A hardness: | 48.8 | 49.4 | 49.4 | 49.5 | 51.2 |
| Dispersion (%) [disperGRADER]: | 95.5 | 99.6 | 98.8 | 99.0 | 99.2 |
| Z Value (%) [disperGRADER]: | 90.3 | 94.4 | 93.2 | 94.3 | 95.3 |
| Density (g/cm³): | 1.137 | 1.122 | 1.136 | 1.139 | 1.134 |

The BINRI01 inner liner formulation was used to compare rubber properties for A1, A2, and A3 types of plasma carbon black filler (tire rubber composition examples P2 to P5) in comparison to N772 furnace carbon black (example P1), with results shown in Table 28. The colloidal properties of the plasma carbon black samples are in a similar range as the N772 reference furnace carbon black. The examples containing plasma carbon black filler show comparable rubber performance (within about 10%, plus or minus) to the reference furnace black. Viscoelastic properties and thermal conductivity were not assessed for these particular examples.

TABLE 28
Rubber Properties

| Formulation: | Example | | | | |
|---|---|---|---|---|---|
| BINRI01 inner liner | P1 | P2 | P3 | P4 | P5 |

Formulation note/addition:

| | | | | | |
|---|---|---|---|---|---|
| CB grade ID/code: | N772 | 404A | 404B | 404C | 404D |
| N2SA (m²/g): | 26.75 | 32.56 | 30.88 | 30.86 | 28.84 |
| STSA (m²/g): | 25.81 | 35.59 | 34.40 | 34.02 | 32.00 |
| OAN (mL/100 g): | 67.2 | 69.3 | 68.6 | 68.1 | 66.5 |
| COAN (mL/100 g): | 58.1 | 67.2 | — | — | 65.8 |
| Plasma CB type: | | A1 | A2 | A3 | A3 |

Additional type info:

| | | | | | |
|---|---|---|---|---|---|
| ts2 (min) [cure rheology at 160° C.]: | 5.09 | 5.52 | 5.60 | 4.75 | 4.77 |
| t60 (min) [cure rheology at 160° C.]: | 5.41 | — | — | — | — |
| t95 (min) [cure rheology at 160° C.]: | 11.33 | 11.55 | 11.73 | 11.12 | 10.86 |
| ML₁₊₄ @ 100° C. (MU): | 40.94 | 42.41 | 42.88 | 44.37 | 44.49 |
| Rubber cure time (min) at 160° C.: | 13 | 14 | 14 | 13 | 13 |
| M100 - 100% modulus @ 23° C. (MPa): | 0.7 | 0.76 | 0.77 | 0.76 | 0.80 |
| M300 - 300% modulus @ 23° C. (MPa): | 2.0 | 2.17 | 2.12 | 2.22 | 2.32 |
| M300/M100 @ 23° C.: | 2.883 | 2.842 | 2.757 | 2.898 | 2.887 |
| Tensile at Break @ 23° C.: | 8.6 | 8.9 | 8.9 | 9.4 | 9.4 |
| Elongation at Break @ 23° C.: | 904.7 | 833.6 | 844.2 | 853.1 | 827.7 |
| Shore A hardness: | 40.3 | 43.3 | 40.5 | 42.0 | 42.1 |
| Dispersion (%) [disperGRADER]: | 95.3 | 99.0 | 99.4 | 99.2 | 97.5 |
| Z Value (%) [disperGRADER]: | 90.9 | 98.5 | 99.2 | 99.1 | 97.4 |
| Density (g/cm³): | 1.135 | 1.133 | 1.132 | 1.135 | 1.135 |

The BINRI01 inner liner formulation was used to compare rubber properties for A1, A2, and A3 types of plasma carbon black filler (tire rubber composition examples Q2 to Q5) in comparison to N772 furnace carbon black (example Q1), with results shown in Table 29. The colloidal properties of the plasma carbon black samples are in a similar range as the N772 reference furnace carbon black. The examples containing plasma carbon black filler show comparable rubber performance (within about 10%, plus or minus) to the reference furnace black. Thermal conductivity was not measured for these particular examples.

TABLE 29
Rubber Properties

| Formulation: | Example | | | | |
|---|---|---|---|---|---|
| BINRI01 inner liner | Q1 | Q2 | Q3 | Q4 | Q5 |

Formulation note/addition:

| | | | | | |
|---|---|---|---|---|---|
| CB grade ID/code: | N772 | 876A | 876B | 534G | 534F |
| N2SA (m²/g): | 26.75 | 27.86 | 26.29 | 26.51 | — |
| STSA (m²/g): | 25.81 | 30.26 | 28.72 | 29.34 | — |
| OAN (mL/100 g): | 67.2 | 73.2 | 71.2 | 71 | 71.5 |
| COAN (mL/100 g): | 58.1 | 71 | — | 70.6 | — |
| Plasma CB type: | | A1 | A2 | A3 | A3 |

Additional type info:

| | | | | | |
|---|---|---|---|---|---|
| ts2 (min) [cure rheology at 160° C.]: | 5.09 | 5.23 | 5.7 | 6.73 | 5.13 |
| t60 (min) [cure rheology at 160° C.]: | 5.41 | 5.71 | 5.85 | 7.21 | 6.22 |
| t95 (min) [cure rheology at 160° C.]: | 11.33 | 11.05 | 11.94 | 12.27 | 11.6 |
| ML₁₊₄ @ 100° C. (MU): | 40.94 | 42.62 | 42.47 | 45.30 | 46.42 |
| Rubber cure time (min) at 160° C.: | 13 | 13 | 14 | 14 | 14 |
| M100 - 100% modulus @ 23° C. (MPa): | 0.7 | 0.7 | 0.7 | 0.7 | 0.8 |
| M300 - 300% modulus @ 23° C. (MPa): | 2.0 | 2.1 | 1.9 | 2.3 | 2.8 |
| M300/M100 @ 23° C.: | 2.883 | 2.886 | 2.803 | 3.060 | 3.278 |
| Tensile at Break @ 23° C.: | 8.6 | 7.9 | 7.8 | 9.5 | 9.9 |
| Elongation at Break @ 23° C.: | 904.7 | 843.9 | 867.7 | 816.0 | 768.6 |
| Shore A hardness: | 40.3 | 42.3 | 40.7 | 38.9 | 39.9 |
| Dispersion (%) [disperGRADER]: | 95.3 | 97.4 | 96.2 | 98.5 | 96.7 |
| Z Value (%) [disperGRADER]: | 90.9 | 92.2 | 90.3 | 98.6 | 92.6 |
| Density (g/cm³): | 1.135 | 1.142 | 1.142 | 1.117 | 1.123 |

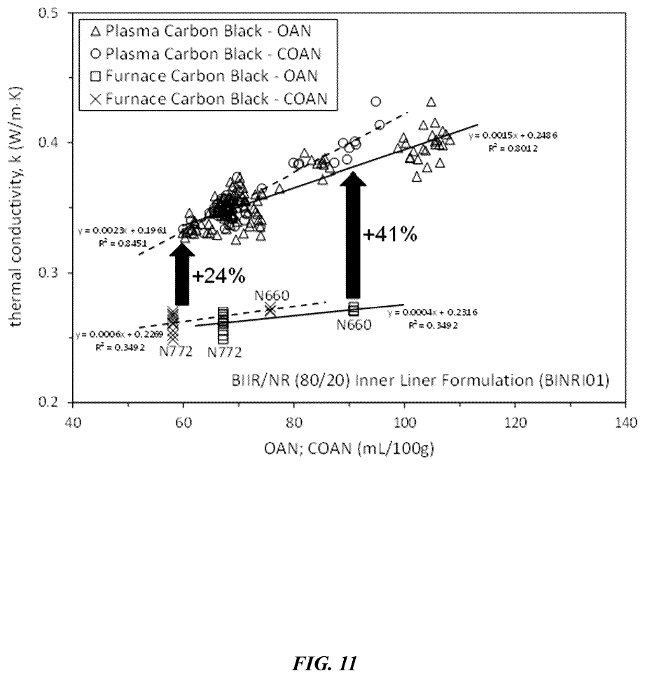

The BINRI01 inner liner formulation was used to evaluate rubber properties for A1, A2, and A3 types of plasma carbon black filler where the filler colloidal properties were varied across the range of nitrogen surface area (N2SA) from 23.8 to 41.9 m²/g and across the range of OAN structure from 59.9 to 108.2 mL/100 g. The number of examples considered was 124, which includes examples that are nominally similar to examples 02 to 05, P2 to P5, and Q2 to Q5 in Tables 27-29 above. These examples enabled evaluation of the dependence of thermal conductivity (k) on filler structure (oil absorption number (OAN)), as shown on FIG. 11 in comparison to comparable furnace carbon black grades N772 and N660. Significantly, the plasma carbon black examples have k values that are 24% to 41% higher than corresponding furnace carbon black k values at the same OAN, and the plasma carbon black examples show a stronger dependence of k on OAN compared to k for furnace carbon black, which is nearly independent of OAN. For example, the slope of the line (from linear regression) fit to the plasma carbon black data in FIG. 11 is nearly four (4) times greater than the slope of the line fit to the furnace carbon black data. Similar results are noted when k is plotted versus the compressed oil absorption number (COAN), as illustrated in the same figure.

BIIR/NR Inner Liner with Clay. Delaminated clay was compounded into an inner liner composition using the same formulation and mixing conditions as BIIR/NR Inner Liner above, with the exception that 40 phr of Polyfil DL delaminated clay was added in the first pass with the dry carbon black to give a clay loading of 17.95 wt. % in the compound. Thermal conductivity was not measured for these particular examples.

TABLE 30
Rubber Properties

| Formulation: | Example | | | | |
|---|---|---|---|---|---|
| BINRI01 with Clay | R1 | R2 | R3 | R4 | R5 |

Formulation note/addition:

| | | | | | |
|---|---|---|---|---|---|
| CB grade ID/code: | N762 | 576A | 576B | 576D | 576I |
| N2SA (m²/g): | 31.9 | 31.5 | 28.9 | 28.1 | 27.6 |
| STSA (m²/g): | 30.7 | 34.5 | 32.3 | 31.3 | 30.1 |
| OAN (mL/100 g): | 66.3 | 67.9 | 67.1 | 67.5 | 68.2 |
| COAN (mL/100 g): | 60.5 | 67.3 | — | 67.5 | 67.3 |
| Plasma CB type: | | A1 | A2 | A3 | A3 |

Additional type info:

| | | | | | |
|---|---|---|---|---|---|
| ts2 (min) [cure rheology at 160° C.]: | 5.86 | 6.02 | 6.35 | 7.20 | 9.75 |
| t60 (min) [cure rheology at 160° C.]: | 6.63 | 6.80 | 7.09 | 8.39 | 11.79 |
| t95 (min) [cure rheology at 160° C.]: | 13.62 | 12.58 | 12.31 | 13.83 | 17.42 |
| ML₁₊₄ @ 100° C. (MU): | 43.3 | 47.2 | 45.9 | 48.9 | 49.6 |
| Rubber cure time (min) at 160° C.: | 16 | 15 | 14 | 16 | 19 |
| M100 - 100% modulus @ 23° C. (MPa): | 1.3 | 1.2 | 1.2 | 1.4 | 1.4 |
| M300 - 300% modulus @ 23° C. (MPa): | 3.4 | 3.2 | 3.1 | 3.6 | 3.8 |
| M300/M100 @ 23° C.: | 2.590 | 2.547 | 2.582 | 3.622 | 2.771 |
| Tensile at Break @ 23° C. (MPa): | 8.1 | 7.2 | 7.6 | 7.8 | 8.4 |
| Elongation at Break @ 23° C. (%): | 717.8 | 687.4 | 727.9 | 686.3 | 695.6 |
| Shore A hardness: | 49.4 | 48.9 | 48.0 | 50.2 | 49.0 |
| Dispersion (%) [disperGRADER]: | 88.7 | 96.6 | 96.5 | 96.9 | 96.4 |
| Z Value (%) [disperGRADER]: | 64.5 | 76.8 | 73.3 | 74.5 | 71.2 |
| Density (g/cm³): | 1.267 | 1.267 | 1.268 | 1.270 | 1.268 |

Ingredients of an example CIJ01 inner liner compound are listed below.

TABLE 31
Compound Formulation (Inner Liner CII01)
Pass 1, Master Batch (MB)

| Ingredient | Detail | PHR | Wt. % |
|---|---|---|---|
| CIIR | Exxon Chlorobutyl 1066; polymer | 100 | 53.72 |
| Blk | Carbon Black; filler | 60 | 32.23 |
| Oil | Plasticizer ln; process oil, processing aid | 8 | 4.30 |
| Hydrocarbon | Proaid AC-740; tackifying resin, processing aid | 7 | 3.76 |
| Resin | | | |
| Phenolic Resin | SP 1068 (P-90) Resin; curative; tackifying resin | 4 | 2.15 |
| ZnO | Zinc Oxide; activator, curative | 3 | 1.61 |
| Stearic Acid | Stearic Acid-Rubbergrade; activator, processing aid | 2 | 1.07 |
| MgO | Magnesium Oxide; activator, acid acceptor, anti- | 0.15 | 0.08 |
| | scorch aid | | |
| Total | Total | 184.15 | — |

Pass 2

| Ingredient | | PHR | Wt. % |
|---|---|---|---|
| MB | Master Batch | 184.15 | — |
| Sulfur | Rubbermakers sulfur; curative | 0.5 | 0.27 |
| Accel | MBTS; accelerator | 1.5 | 0.81 |
| Total | Total | 186.15 | 100.00 |

Summary of Mixing Steps. First Pass: add polymer (Exxon Chlorobutyl 1066), magnesium oxide, and hydrocarbon resin (Proaid AC-740); mix 30 seconds. Add carbon black; mix 60 seconds. Add naphthenic oil, phenolic resin, stearic acid, and zinc oxide; mix 30 seconds. Include two ram clean-out steps at 30 seconds each; mix until drop temperature of 125° C. is reached. Second Pass: add first pass mix plus sulfur and MBTS; mix until drop temperature of 105° C. is reached.

TABLE 32
Material Composition and Mixing - First Pass

| Component | Weigh-Up 1^{st} Pass (g) |
|---|---|
| Exxon Chlorobutyl 1066 | 730.0 |
| Naphthenic Oil (Plasticizer ln) | 58.4 |
| Stearic Acid | 14.6 |
| Phenolic Resin Tackifier (SP 1068) | 29.2 |
| Proaid AC-740 | 51.1 |
| Magnesium Oxide (Elastomag 170) | 1.1 |
| Zinc Oxide | 21.9 |
| Carbon Black | 438.0 |
| Calculated Total | 1344.3 |

Detailed Mixing Steps. Banbury First Pass: starting temperature 45° C. and starting RPM of 30. Add Proaid AC-740, magnesium oxide, and Exxon Bromobutyl 2222; mix 30 seconds. While mixing proceeds, manually prepare thickened oil by pouring about 25% of the carbon black (CB) into the oil. Add dry CB (remaining about 75%) by pouring down the mixer throat; mix 60 seconds. Add naphthenic oil (oil thickened with about 25% of the CB). Add phenolic Resin (SP1068), zinc oxide, and stearic acid; mix 30 seconds. Clean ram; mix 25 seconds. Clean ram; mix at 90 RPM until drop temperature of 125° C. is reached. Milling First Pass: make sure chiller unit is on and flowing 45° F. water through the rolls; mill gap gauge (a.k.a. mill roll gauge) is 1.2 mm to start.

TABLE 33
Material Composition and Mixing - Second Pass

| Component | Weigh-Up 2^{nd} Pass (g) |
|---|---|
| First pass non-productive mix | 1304.0 |
| Sulfur | 3.6 |
| MBTS | 10.8 |
| Calculated Total | 1318.4 |

Banbury Second Pass: starting temperature 45° C. and starting RPM of 30. Add ingredients: non-productive mix (first pass compound); sulfur, MBTS. Lower ram; mix at 90 RPM until drop temperature of 105° C. is reached. Milling Second Pass: chill the mill rolls via chiller set to 45° F. Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges. Increase mill gap gauge to 1.2 mm for final sheeting out.

Rubber Properties. The CII01 inner liner formulation was used to compare rubber properties for A1, A2, and A3 types of plasma carbon black filler (tire rubber composition examples S2 to S5) in comparison to N772 furnace carbon black (example S1), with results shown in Table 34. The colloidal properties of the plasma carbon black samples are in a similar range as the N772 reference furnace carbon black. The examples containing plasma carbon black show comparable rubber performance (within about 10%, plus or minus) to the reference furnace carbon black. Viscoelastic properties and thermal conductivity were not assessed for these

TABLE 34
Rubber Properties

| Formulation: | Example | | | | |
|---|---|---|---|---|---|
| CII01 inner liner | S1 | S2 | S3 | S4 | S5 |

Formulation note/addition:

| | | | | | |
|---|---|---|---|---|---|
| CB grade ID/code: | N772 | 405A | 405B | 405C | 405I |
| N2SA (m²/g): | 26.75 | 32.56 | 30.88 | 30.86 | 30.48 |
| STSA (m²/g): | 25.81 | 35.59 | 34.40 | 34.02 | 32.77 |
| OAN (mL/100 g): | 67.2 | 69.3 | 68.6 | 68.1 | — |
| COAN (mL/100 g): | 58.1 | 67.2 | — | — | — |
| Plasma CB type: | | A1 | A2 | A3 | A3 |

Additional type info:

| | | | | | |
|---|---|---|---|---|---|
| ts2 (min) [cure rheology at 160° C.]: | 3.60 | 3.84 | 2.44 | 2.58 | 3.08 |
| t60 (min) [cure rheology at 160° C.]: | — | — | — | — | — |
| t95 (min) [cure rheology at 160° C.]: | 18.94 | 9.57 | 19.59 | 17.92 | 16.25 |
| ML₁₊₄ @ 100° C. (MU): | 50.4 | 59.0 | 55.1 | 59.2 | 60.4 |
| Rubber cure time (min) at 160° C.: | 20 | 20 | 20 | 20 | 20 |
| M100 - 100% modulus @ 23° C. (MPa): | 0.7 | 0.9 | 0.9 | 0.9 | 0.9 |
| M300 - 300% modulus @ 23° C. (MPa): | 2.3 | 3.1 | 2.8 | 3.1 | 3.2 |
| M300/M100 @ 23° C.: | 3.09 | 3.56 | 3.22 | 3.51 | 3.59 |
| Tensile at Break @ 23° C. (MPa): | 8.8 | 9.2 | 9.1 | 9.7 | 9.9 |
| Elongation at Break @ 23° C. (%): | 956 | 810 | 837 | 826 | 826 |
| Shore A hardness: | 41.9 | 42.4 | 44.6 | 41.9 | 43.8 |
| Dispersion (%) [disperGRADER]: | 98.5 | 98.0 | 98.7 | 98.5 | 98.4 |
| Z Value (%) [disperGRADER]: | 95.8 | 98.0 | 97.2 | 97.8 | 97.6 |
| Density (g/cm³): | 1.13 | 1.13 | 1.13 | 1.13 | 1.13 |

The CII01 inner liner formulation was used to compare rubber properties for A1, A2, and A3 types of plasma carbon black filler (tire rubber composition examples T2 to T5) in comparison to N660 furnace carbon black (example T1), with results shown in Table 35. The colloidal properties of the plasma carbon black samples are in a similar range as the N660 reference furnace carbon black. The examples containing plasma carbon black show comparable rubber performance (within about 10%, plus or minus) to the reference furnace carbon black. Viscoelastic properties and thermal conductivity were not assessed for these particular examples.

TABLE 35
Rubber Properties

| Formulation: | Example | | | | |
|---|---|---|---|---|---|
| CII01 inner liner | T1 | T2 | T3 | T4 | T5 |

Formulation note/addition:

| | | | | | |
|---|---|---|---|---|---|
| CB grade ID/code: | N660 | 372A | 372B | 372I | 372K |
| N2SA (m²/g): | 35.89 | 37.83 | 36.83 | 35.37 | — |
| STSA (m²/g): | 35.15 | 43.34 | 42.17 | 40.03 | — |
| OAN (mL/100 g): | 90.3 | 95.5 | 98.4 | 97.8 | 98.6 |
| COAN (mL/100 g): | 71.2 | 87.9 | — | 89.8 | 92.1 |
| Plasma CB type: | | A1 | A2 | A3 | A3 |

Additional type info:

| | | | | | |
|---|---|---|---|---|---|
| ts2 (min) [cure rheology at 160° C.]: | 3.83 | 1.8 | 1.8 | 1.8 | 2.1 |
| t60 (min) [cure rheology at 160° C.]: | 4.34 | — | — | — | — |
| t95 (min) [cure rheology at 160° C.]: | 18.72 | 18.15 | 18.59 | 19.52 | 18.74 |
| ML₁₊₄ @ 100° C. (MU): | 58.1 | 62.8 | 63.2 | 64.1 | 63.8 |
| Rubber cure time (min) at 160° C.: | 20 | 20 | 20 | 20 | 20 |
| M100 - 100% modulus @ 23° C. (MPa): | 0.9 | 1.2 | 1.2 | 1.2 | 1.2 |
| M300 - 300% modulus @ 23° C. (MPa): | 3.0 | 3.5 | 3.5 | 3.5 | 3.6 |
| M300/M100 @ 23° C.: | 3.28 | 2.95 | 2.96 | 2.93 | 2.91 |
| Tensile at Break @ 23° C. (MPa): | 8.7 | 8.5 | 8.2 | 8.9 | 8.6 |
| Elongation at Break @ 23° C. (%): | 905 | 775 | 752 | 786 | 766 |
| Shore A hardness: | 45.0 | 53.3 | 53.0 | 51.5 | 53.0 |
| Dispersion (%) [disperGRADER]: | 97.3 | 99.6 | 98.8 | 98.7 | 99.4 |
| Z Value (%) [disperGRADER]: | 90.3 | 99.6 | 97.1 | 93.3 | 95.0 |
| Density (g/cm³): | 1.14 | 1.14 | 1.14 | 1.14 | 1.14 |

### Example 4: Body Ply Skim

The forthcoming examples demonstrate the utility of plasma carbon black when employed in tire rubber compositions for use as a body ply skim (a.k.a. body ply coat) component of a tire. The specific rubber formulations shown are intended to be representative and not limiting. The NR/SBR polymer ratio can vary in body ply skim formulations from 100/0 to about 60/40, and emulsion SBR (ESBR) and/or various types of solution SBR (SSBR) can be used. Other elastomeric polymers can be used as minor polymer components, including various types of IR, BR, and epoxidized NR. Various furnace carbon black grades may be used, such as N550, N660, N650, N330, and others. Fillers used can also include carbon fillers from pyrolysis of recycled rubber materials, recycled rubber products like end-of-life tires, biomass waste, and other sources. Precipitated silica can be used as filler, with or without varieties of sulfur-containing organosilanes and/or other coupling agents. Furnace carbon black, clays, graphenes, precipitated silica, other inorganic particulate fillers, recovered carbon filler from pyrolysis of end-of-life tires, and the like may be used in various combination with the presently disclosed plasma carbon black at various loading levels. Other adjustments to the formulation can be made for assorted performance and processability reasons. In particular, there are various options for amounts and types of cure/vulcanization ingredients and for antidegradants such as antioxidants, antiozonants, and the like. Variations in types and amounts of processing aids such as oils, tackifying resins, and the like also may be used. The embodiments set forth herein, related to use of plasma carbon black in tire rubber compositions used for body ply skim components, encompass reasonable body ply and body ply skim formulation variations.

The following list summarizes adjustments to the NR/SBR body ply skim formulation and/or mixing scheme that have been conducted through the course of research toward developing the tire rubber compositions of the present disclosure. Body ply skim formulation adjustments explored include, for example: adding Cure-Rite 18 at 0.25 and 0.5 phr; adding DPTT at 0.25 and 0.5 phr; adding 0.2 phr of Cure-Rite 18 and 0.2 phr of DPTT while increasing Crystex CurePro from 2.2 phr to 2.5 phr; decreasing MBTS and TBBS by 0.25 phr then adding 0.5 phr of Cure-Rite 18; decreasing MBTS and TBBS by 0.25 phr then adding 0.5 phr of DPTT; moving antioxidant DQ and antiozonant PD-2 to the productive mixing stage for non-productive drop temperatures of 150° C. and 165° C.; adding 0.5 phr of benzofuroxan to the non-productive mixing stage at a drop temperature of 150° C.; adding 0.5 phr of benzofuroxan to the non-productive mixing stage at a drop temperature of 150° C. while moving antioxidant DQ and antiozonant PD-2 from the non-productive to the productive mixing stage; adding 1 and 0.5 phr of benzofuroxan to the non-productive mixing stage at a drop temperature of 165° C.; adding 0.5 phr of benzofuroxan to the non-productive mixing stage at a drop temperature of 165° C. while moving antioxidant DQ and antiozonant PD-2 from the non-productive to the productive mixing stage; increasing the drop temperature from 150° C. to 165° C.; increasing the amount of NR present in the mix to 85 and 100 phr from 70 phr while decreasing the SBR to 15 and 0 phr from 30 phr respectively; removing SP1068 from the mix with a drop temperature of 150° C.; removing SP1068 from the mix with a drop temperature of 165° C.; adding 0.1 phr, 0.25 phr, and 0.5 phr of CTP to the productive mixing stage; adding 0.2 phr of DPG to the productive mixing stage; adding 0.5 phr of pk-900 to the productive mixing stage; replacing the 2.2 phr of Crystex CurePro with 2 phr of Rubbermakers sulfur; adding Akrosorb 29460 at loading levels of 1, 2, and 3 phr to the non-productive mixing stage; adding phr of carbon black to stiffen; increasing sulfur in the low temperature addition step; adding sulfenamide or other curative.

The examples below of tire body ply skim compositions containing plasma carbon black show comparable performance (within about 10%, plus or minus) in standard rubber testing compared to reference carbon black from the furnace process. The production of furnace carbon black generates multiple tons of CO₂ for every ton of carbon black produced, whereas the production of plasma carbon black generates <20% of that CO₂, so these examples show that plasma carbon black fillers in tire body ply skim components can have a significant positive impact on sustainability of tires without substantially compromising rubber properties. For some examples of plasma carbon black, significant reductions in hysteresis (tan delta or tan δ) are noted relative to the respective furnace carbon black reference.

It was surprisingly discovered for the tire body ply skim composition examples that plasma carbon black gives substantially higher (enhanced) thermal conductivity relative to comparative furnace carbon black when compounded into the rubber formulations, with the projected benefits to tire manufacturing and tire performance discussed earlier.

Ingredients of an example NRESP01 body ply skim compound are listed below.

TABLE 36
Compound Formulation (Body Ply Skim NRESP01)

| | | |
|---|---|---|
| Ingredient | PHR | Wt. % |

Pass 1, Master Batch (MB)

| | | |
|---|---|---|
| Natural rubber (NR) (grade SMR L); polymer | 70 | 39.73 |
| Styrene-butadiene rubber (SBR) | 30 | 17.03 |
| (grade 1502); polymer | | |
| Carbon Black; filler | 50 | 28.38 |
| ZnO; activator | 5 | 2.84 |
| Stearic Acid; activator, processing aid | 2 | 1.14 |
| Naphthenic Oil (plasticizer Ln); | 10 | 5.68 |
| process oil, processing aid | | |
| SP 1068 (phenol formaldehyde resin); | 4 | 2.27 |
| tackifying resin, processing aid | | |
| TMQ; antioxidant | 0.5 | 0.28 |
| 6PPD; antiozonant and antioxidant | 1 | 0.57 |
| Total | 172.5 | — |

Pass 2

| | | |
|---|---|---|
| Master Batch | 172.5 | — |
| MBTS; accelerator | 0.5 | 0.28 |
| TBBS; accelerator | 1 | 0.57 |
| Crystex CurePro (insoluble sulfur, | 2.2 | 1.25 |
| 10% oil); curative | | |
| Total | 176.2 | 100.00 |

Summary of Mixing Steps. First Pass: add polymers (natural rubber (NR) and SBR); mix 60 seconds. Add half carbon black; mix 60 seconds. Add half carbon black/plasticizer mix, phenolic resin, antioxidant, antiozonant; mix 60 seconds. Add stearic acid and zinc oxide; mix 60 seconds. Include cleanout step; mix until drop temperature of 150° C. is reached. Second Pass: add half of the first pass, MBTS, TBBS, Crystex CurePro, and then second half of the first pass; mix until drop temperature of 105° C. is reached.

TABLE 37
Material Composition and Mixing - First Pass

| Component | Weigh-Up 1^{st} Pass (g) |
|---|---|
| SMR-L | 560 |
| ESBR 1502 | 240 |
| Zinc Oxide | 40 |
| Stearic Acid | 16 |
| Plasticizer Ln (Naphthenic Oil) | 80 |
| SP-1068 | 32 |
| Antioxidant DQ | 4 |
| Antiozonant PD-2 | 8 |
| Carbon Black | 400 |
| Calculated Total | 1380 |

Detailed Mixing Steps. Banbury First Pass: starting temperature 70° C. and starting RPM of 40. Add polymers (SMR-L and ESBR 1502); mix 60 seconds. While mixing proceeds, manually prepare thickened oil by pouring about 25% of the carbon black (CB) into the oil. Add dry CB (remaining about 75%) by pouring down the mixer throat; mix 60 seconds. Add naphthenic oil (oil thickened with about 25% of the CB), phenolic resin, antioxidant DQ, and PD-2; mix 60 seconds. Add stearic acid and zinc oxide; mix 60 seconds. Clean ram; mix until drop temperature of 150° C. at 110 RPM is reached. Milling First Pass: set water temperature on mill to 140° F.; mill gap gauge (a.k.a. mill roll gauge) is 1.2 mm to start.

TABLE 38
Material Composition and Mixing - Second Pass

| Component | Weigh-Up 2^{nd} Pass (g) |
|---|---|
| First pass non-productive mix | 1311 |
| Accelerator MBTS | 3.8 |
| TBBS | 0.8 |
| Crystex CurePro | 11.6 |
| Calculated Total | 1327.2 |

Banbury Second Pass: starting temperature 70° C. and starting RPM of 40. Add ingredients: add half of the non-productive mix (first pass compound), then MBTS, TBBS, and Crystex CurePro, then second half of the non-productive mix. Lower ram; mix at 60 RPM until drop temperature of 105° C. is reached. Milling Second Pass: water temperature on mill at 140° F. Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges. Increase mill gap gauge to 1.2 mm for final sheeting out.

Rubber Properties. The NRESP01 body ply skim formulation was used to compare rubber properties for A1, A2, and A3 types of plasma carbon black (tire rubber composition examples U2 to U5) in comparison to N550 furnace carbon black (example U1), with results shown in Table 39. The colloidal properties of the plasma carbon black samples are in a similar range as the N550 reference furnace carbon black. The examples containing plasma carbon black show comparable rubber performance (within about 10%, plus or minus) to the reference furnace carbon black. Viscoelastic properties and thermal conductivity were not assessed for these particular examples. For sample U5, which is a type A3 sample, the binder is sodium acetate, lignosulfonate, and sulfur. All ingredients are at 0.2% to 0.3%. The carbon black was dried carefully to preserve the hydrated state of the sodium acetate hydrate salt.

TABLE 39
Rubber Properties

| Formulation: | | | | | |
|---|---|---|---|---|---|
| NRESP01 Body | Example | | | | |
| Ply Skim | U1 | U2 | U3 | U4 | U5 |

Formulation note/addition:

| | | | | | |
|---|---|---|---|---|---|
| CB grade ID/code: | N550 | 616A | P051B | P024D | T22 |
| N2SA (m²/g): | 40.5 | — | 42.6 | 39.2 | 40.7 |
| STSA (m²/g): | 40.0 | — | 48.0 | 44.1 | 45.6 |
| OAN (mL/100 g): | 126.7 | — | 106.2 | 127.8 | 123.0 |
| COAN (mL/100 g): | 85.5 | — | 89.7 | — | 103.5 |
| Plasma CB type: | — | A1 | A2 | A3 | A3 |

Additional type info:

| | | | | | |
|---|---|---|---|---|---|
| ts2 (min) [cure | 1.14 | 1.46 | 1.60 | 1.26 | 1.25 |
| rheology at 170° C.]: | | | | | |
| t60 (min) [cure | 1.89 | 2.27 | 2.31 | 2.00 | 2.09 |
| rheology at 170° C.]: | | | | | |
| t95 (min) [cure | 3.48 | 4.02 | 4.22 | 3.43 | 3.68 |
| rheology at 170° C.]: | | | | | |
| ML₁₊₄ @ 100° | 47.2 | 49.2 | 49.1 | 53.0 | 54.7 |
| C. (MU): | | | | | |
| Rubber cure time | t95 + 7 | t95 + 7 | t95 + 7 | t95 + 7 | t95 + 7 |
| (min) at 170° C.: | | | | | |
| M100 - 100% modulus | 2.15 | 1.88 | 1.74 | 2.00 | 2.32 |
| @ 23° C. (MPa): | | | | | |
| M300 - 300% modulus | 10.2 | 8.30 | 7.14 | 7.87 | 9.95 |
| @ 23° C. (MPa): | | | | | |
| M300/M100 @ | 4.76 | 4.41 | 4.1 | 3.95 | 4.28 |
| 23° C.: | | | | | |
| Tensile at Break | 18.0 | 16.8 | 16.9 | 16.5 | 17.0 |
| @ 23° C. (MPa): | | | | | |
| Elongation at | 506 | 538 | 575 | 550 | 492 |
| Break @ 23° C. (%): | | | | | |
| Shore A hardness: | 56.2 | 49.3 | 54.6 | 56.0 | 53.4 |
| Dispersion (%) | 98.5 | 98.7 | 99.7 | 99.0 | 98.4 |
| [disperGRADER]: | | | | | |
| Z Value (%) | 94.3 | 95.1 | 97.1 | 94.8 | 96.2 |
| [disperGRADER]: | | | | | |
| Density (g/cm³): | 1.12 | 1.13 | 1.12 | 1.13 | 1.13 |

The NRESP01 body ply skim formulation was used to compare rubber properties for A1, A2, and A3 types of plasma carbon black (tire rubber composition examples V2 to V5) in comparison to N660 furnace carbon black (example V1), with results shown in Table 40. The colloidal properties of the plasma carbon black samples are in a similar range as the N660 reference furnace carbon black. The examples containing plasma carbon black show comparable rubber performance (within about 10%, plus or minus) to the reference furnace carbon black. Viscoelastic properties and thermal conductivity were not assessed for these particular examples.

TABLE 40
Rubber Properties

| Formulation: | | | | | |
|---|---|---|---|---|---|
| NRESP01 Body | Example | | | | |
| Ply Skim | V1 | V2 | V3 | V4 | V5 |

Formulation note/addition:

| | | | | | |
|---|---|---|---|---|---|
| CB grade ID/code: | N660 | P008A | P008B | NHB117A | 364F |
| N2SA (m²/g): | 35.9 | 41.9 | 39.8 | 39.1 | 38.7 |
| STSA (m²/g): | 35.2 | 46.1 | 44.1 | 43.1 | 42.9 |
| OAN (mL/100 g): | 90.3 | 104.8 | 104.0 | — | 100.9 |
| COAN (mL/100 g): | 71.2 | 94.8 | 94.6 | — | 93.4 |
| Plasma CB type: | — | A1 | A2 | A3 | A3 |

Additional type info:

| | | | | | |
|---|---|---|---|---|---|
| ts2 (min) [cure | 1.22 | 1.42 | 1.56 | 1.09 | 1.29 |
| rheology at 170° C.]: | | | | | |
| t60 (min) [cure | 1.84 | 2.19 | 2.30 | 1.86 | 1.97 |
| rheology at 170° C.]: | | | | | |
| t95 (min) [cure | 3.39 | 4.00 | 3.99 | 3.47 | 3.49 |
| rheology at 170° C.]: | | | | | |
| ML₁₊₄ @ 100° C. | 37.5 | 45.0 | 39.3 | 51.1 | 37.3 |
| (MU): | | | | | |
| Rubber cure time | t95 + 7 | t95 + 7 | t95 + 7 | t95 + 7 | t95 + 7 |
| (min) at 170° C.: | | | | | |
| M100 - 100% modulus | 1.65 | 1.46 | 1.66 | 2.05 | 1.66 |
| @ 23° C. (MPa): | | | | | |
| M300 - 300% modulus | 8.80 | 6.17 | 7.60 | 8.45 | 7.57 |
| @ 23° C. (MPa): | | | | | |
| M300/M100 @ | 5.35 | 4.22 | 4.58 | 4.13 | 4.57 |
| 23° C.: | | | | | |
| Tensile at Break | 18.1 | 16.4 | 15.9 | 16.9 | 17.1 |
| @ 23° C. (MPa): | | | | | |
| Elongation at | 533 | 619 | 537 | 533 | 559 |
| Break @ 23° C. (%): | | | | | |
| Shore A hardness: | 51.1 | 49.8 | 53.2 | 57.7 | 52.5 |
| Dispersion (%) | 96.0 | 97.0 | 99.0 | 99.6 | 99.0 |
| [disperGRADER]: | | | | | |
| Z Value (%) | 91.6 | 91.0 | 95.1 | 98.2 | 94.9 |
| [disperGRADER]: | | | | | |
| Density (g/cm³): | 1.13 | 1.13 | 1.14 | 1.13 | 1.14 |

The NRESP01 body ply skim formulation was used to compare rubber properties for A1, A2, and A3 types of plasma carbon black filler (tire rubber composition examples W2 to W5) in comparison to N660 furnace carbon black (example W1), with results shown in Table 41. The colloidal properties of the plasma carbon black samples are in a similar range as the N660 reference furnace carbon black. The examples containing plasma carbon black filler show comparable rubber performance (within about 10%, plus or minus) to the reference furnace carbon black. Viscoelastic properties and thermal conductivity were not assessed for these

TABLE 41
Rubber Properties

| Formulation: | | | | | |
|---|---|---|---|---|---|
| NRESP01 Body | Example | | | | |
| Ply Skim | W1 | W2 | W3 | W4 | W5 |

Formulation note/addition:

| | | | | | |
|---|---|---|---|---|---|
| CB grade ID/code: | N660 | P046A | P046B | P043G | P053D |
| N2SA (m²/g): | 35.9 | 27.3 | 25.9 | — | 26.22 |
| STSA (m²/g): | 35.2 | 29.5 | 28.1 | — | 27.62 |
| OAN (mL/100 g): | 90.3 | 94.4 | 94.7 | 93.7 | 93.4 |
| COAN (mL/100 g): | 71.2 | 87.6 | 84.6 | 85.7 | 85.4 |
| Plasma CB type: | — | A1 | A2 | A3 | A3 |

Additional type info:

| | | | | | |
|---|---|---|---|---|---|
| ts2 (min) [cure | 1.22 | 1.55 | 1.66 | 1.14 | 1.36 |
| rheology at 170° C.]: | | | | | |
| t60 (min) [cure | 1.84 | 2.35 | 2.44 | 1.82 | 2.11 |
| rheology at 170° C.]: | | | | | |
| t95 (min) [cure | 3.39 | 4.28 | 4.23 | 3.24 | 3.76 |
| rheology at 170° C.]: | | | | | |
| ML₁₊₄ @ 100° | 37.5 | 43.4 | 44.5 | 45.7 | 42.6 |
| C. (MU): | | | | | |
| Rubber cure time | t95 + 7 | t95 + 7 | t95 + 7 | t95 + 7 | t95 + 7 |
| (min) at 170° C.: | | | | | |
| M100 - 100% modulus | 1.65 | 1.62 | 1.77 | 1.80 | 1.78 |
| @ 23° C. (MPa): | | | | | |
| M300 - 300% modulus | 8.80 | 7.00 | 7.54 | 7.54 | 7.56 |
| @ 23° C. (MPa): | | | | | |
| M300/M100 @ 23° C.: | 5.35 | 4.31 | 4.27 | 4.19 | 4.24 |
| Tensile at Break | 18.1 | 14.9 | 18.5 | 16.7 | 16.7 |
| @ 23° C. (MPa): | | | | | |
| Elongation at | 533 | 541 | 586 | 558 | 561 |
| Break @ 23° C. (%): | | | | | |
| Shore A hardness: | 51.1 | 48.1 | 48.1 | 53.3 | 51.6 |
| Dispersion (%) | 96.0 | 98.4 | 98.2 | 98.5 | 98.4 |
| [disperGRADER]: | | | | | |
| Z Value (%) | 91.6 | 88.7 | 88.6 | 89.9 | 86.9 |
| [disperGRADER]: | | | | | |
| Density (g/cm³): | 1.13 | 1.13 | 1.12 | 1.12 | 1.12 |

The NRESP01 body ply skim formulation was used to compare rubber properties for A2, A3, B2, and B3 types of plasma carbon black filler (tire rubber composition examples AU2 to AU5) in comparison to N660 furnace carbon black (example AU1), with results shown in Table 42. The B2 and B3 type plasma carbon black fillers contain silica in the binder, and the special additive in the B3 type plasma CB is Si69 (TESPT) silane. The colloidal properties of the plasma carbon black samples are in a similar range as the N660 reference furnace carbon black. The examples containing plasma carbon black filler show comparable rubber performance (within about 10%, plus or minus) to the reference furnace carbon black, with advantages noted in terms of reduced viscoelastic loss tangent (tan δ) for the examples with plasma carbon black fillers relative to the N660 reference. Reduced tan δ of a tire rubber composition can be predictive of lower rolling resistance and lower viscoelastic heat build-up when the tire rubber composition is employed as a component of a tire. Thermal conductivity was not assessed for these particular examples.

TABLE 42
Rubber Properties

| Formulation: | | | | | |
|---|---|---|---|---|---|
| NRESP01 Body | Example | | | | |
| Ply Skim | AU1 | AU2 | AU3 | AU4 | AU5 |

Formulation note/addition:

| | | | | | |
|---|---|---|---|---|---|
| CB grade ID/code: | N660 | P066B | P066C | P066D | P066E |
| N2SA (m²/g): | 35.4 | 29.4 | 29.3 | 29.2 | 27.7 |
| STSA (m²/g): | 33.9 | 32.5 | 31.9 | 31.7 | 30.4 |
| OAN (mL/100 g): | 93.6 | 107.6 | 106.4 | 106.6 | 107.9 |
| COAN (mL/100 g): | 73.0 | 92.5 | | 91.8 | |
| Plasma CB type: | | A2 | B2 | B3 | A3 |
| Additional type info: | | | | Si69 | |
| ts2 (min) [cure | 1.16 | 1.20 | 1.21 | 1.18 | 1.16 |
| rheology at 170° C.]: | | | | | |
| t60 (min) [cure | 1.81 | 1.86 | 1.90 | 1.84 | 1.89 |
| rheology at 170° C.]: | | | | | |
| t95 (min) [cure | 3.33 | 3.21 | 3.33 | 3.19 | 3.34 |
| rheology at 170° C.]: | | | | | |
| ML₁₊₄ @ 100° | 43.1 | 46.9 | 47.7 | 48.1 | 47.8 |
| C. (MU): | | | | | |
| Rubber cure time | 11 | 11 | 11 | 11 | 11 |
| (min) at 170° C.: | | | | | |
| M100 - 100% modulus | 1.76 | 1.80 | 1.81 | 1.74 | 1.84 |
| @ 23° C. (MPa): | | | | | |
| M300 - 300% modulus | 8.64 | 7.82 | 7.97 | 7.65 | 7.80 |
| @ 23° C. (MPa): | | | | | |
| M300/M100 @ | 4.91 | 4.34 | 4.40 | 4.40 | 4.24 |
| 23° C.: | | | | | |
| Tensile at Break | 18.3 | 16.3 | 16.4 | 15.2 | 17.0 |
| @ 23° C. (MPa): | | | | | |
| Elongation at | 548.4 | 547.8 | 543.2 | 524.4 | 562.6 |
| Break @ 23° C. (%): | | | | | |
| Shore A hardness: | 52.9 | 52.7 | 52.5 | 52.0 | 53.2 |
| Dispersion (%) | 92.7 | 97.5 | 97.7 | 97.4 | 97.3 |
| [disperGRADER]: | | | | | |
| Z Value (%) | 86.8 | 84.0 | 84.9 | 83.9 | 86.3 |
| [disperGRADER]: | | | | | |
| Density (g/cm³): | 1.127 | 1.132 | 1.134 | 1.133 | 1.133 |
| ΔG′ (MPa) [RPA; 60° | 0.225 | 0.186 | 0.188 | 0.183 | 0.231 |
| C.; 10 Hz; 1%-20%]: | | | | | |
| tan δ [RPA; 60° | 0.122 | 0.093 | 0.095 | 0.094 | 0.094 |
| C.; 10 Hz, 5%]: | | | | | |
| G′ (MPa) [RPA; | 0.802 | 0.871 | 0.876 | 0.865 | 1.043 |
| 60° C.; 10 Hz; 5%]: | | | | | |

The NRESP01 body ply skim formulation, with three different carbon black loadings of 43, 50, and 57 parts per hundred rubber (phr), was used to compare rubber properties for A2 and A3 types of plasma carbon black filler (tire rubber composition examples BA2, BA3, BB2, BB3, BC2, and BC3) in comparison to N660 furnace carbon black (examples BA1, BA2, and BA3), with results shown in Tables 43-45. The colloidal properties of the plasma carbon black samples are in a similar range as the N660 reference furnace carbon black. The examples containing plasma carbon black show comparable rubber performance (within about 10%, plus or minus) to the reference furnace carbon black, with advantages noted in terms of reduced viscoelastic loss tangent (tan δ) for the examples with plasma carbon black relative to the N660 reference.

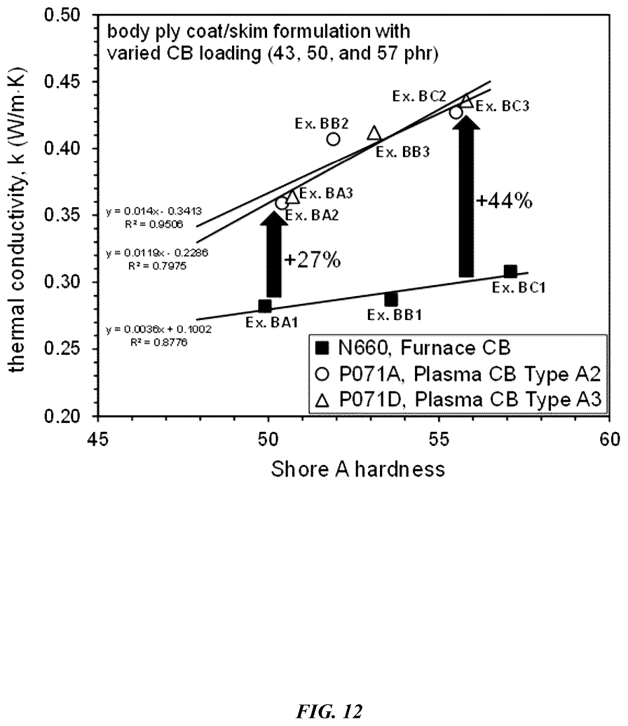

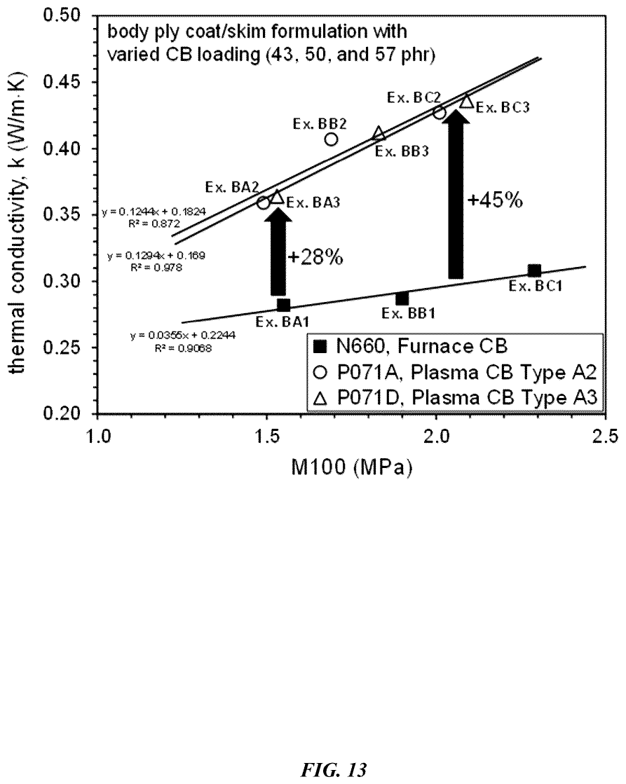

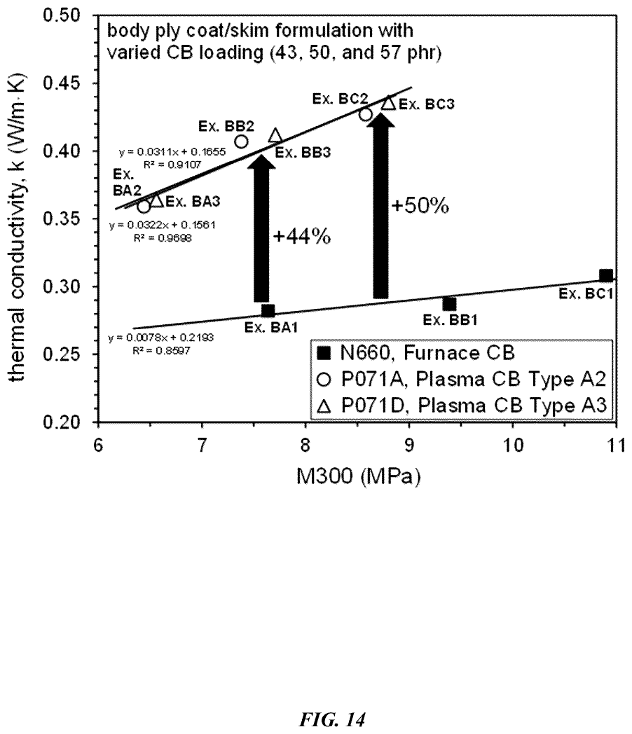

A significant and surprising advantage of plasma carbon black filler over furnace carbon black in the tire body ply skim formulation is enhanced thermal conductivity (k), which was 27% to 44% higher for plasma carbon black then for the N660 furnace carbon black. The data provided in Tables 43-45 and displayed in FIGS. 12-14 also show that plasma black's substantial thermal conductivity advantage holds when examined on a constant mechanical reinforcement basis, for example using Shore A hardness, tensile stress at 100% strain (M100), or tensile stress at 300% strain (M300). The highest loading considered of 57 phr for furnace carbon black (example BC1) yielded a thermal conductivity of 0.308 W/mK, which is still inferior to all thermal conductivity values for plasma carbon black formulations, even at the lowest loading considered of 43 phr. In other words, for the body ply skim formulations in Tables 43-45 below, the 43 phr plasma carbon black filled rubber article is more thermally conductive than the 57 phr furnace carbon black filled rubber article. The values of 0.364 W/mK (plasma carbon black) vs. 0.308 W/mK (reference furnace carbon black) equate to an increase in (enhanced) thermal conductivity of 18% by filling with plasma carbon black at 43 phr load instead of furnace carbon black at higher 57 phr load. Generally, plasma carbon black filled rubber articles may have thermal conductivity greater than about 0.33 W/mK for articles loaded at 25% to 40% by weight of plasma carbon black. Corresponding furnace carbon black filled rubber articles may not be more thermally conductive than about 0.314 W/mK for semi-reinforcing (SRF grade) furnace black and up to about 0.329 W/mK for N234 (tread grade) furnace black.

TABLE 43
Rubber Properties

| Formulation: | | | |
|---|---|---|---|
| NRESP01 Body Ply Skim | Example | | |
| (43 phr of CB) | BA1 | BA2 | BA3 |

Formulation note/addition:

| | | | |
|---|---|---|---|
| CB grade ID/code: | N660 | P071A | P071D |
| N2SA (m²/g): | 35.4 | 28.7 | 27.4 |
| STSA (m²/g): | 33.9 | 31.2 | 29.8 |
| OAN (mL/100 g): | 93.6 | 97.6 | 95.9 |
| COAN (mL/100 g): | 73.0 | 85.9 | |
| Plasma CB type: | | A2 | A3 |

Additional type info:

| | | | |
|---|---|---|---|
| ts2 (min) [cure | 1.19 | 1.29 | 1.23 |
| rheology at 170° C.]: | | | |
| t60 (min) [cure | 1.90 | 1.98 | 1.91 |
| rheology at 170° C.]: | | | |
| t95 (min) [cure | 3.60 | 3.70 | 3.41 |
| rheology at 170° C.]: | | | |
| ML₁₊₄ @ 100° | 39.2 | 39.2 | 39.6 |
| C. (MU): | | | |
| Rubber cure time | 11 | 11 | 11 |
| (min) at 170° C.: | | | |
| M100 - 100% | 1.55 | 1.49 | 1.53 |
| modulus @ 23° C. (MPa): | | | |
| M300 - 300% | 7.64 | 6.44 | 6.56 |
| modulus @ 23° C. (MPa): | | | |
| M300/M100 @ | 4.93 | 4.32 | 4.29 |
| 23° C.: | | | |
| Tensile at | 17.6 | 16.3 | 16.6 |
| Break @ 23° C. (MPa): | | | |
| Elongation at | 559.3 | 580.4 | 577.3 |
| Break @ 23° C. (%): | | | |
| Shore A hardness: | 49.9 | 50.4 | 50.7 |
| Dispersion (%) | 94.4 | 97.8 | 97.8 |
| [disperGRADER]: | | | |
| Z Value (%) | 92.1 | 91.7 | 90.5 |
| [disperGRADER]: | | | |
| Density (g/cm³): | 1.125 | 1.131 | 1.128 |
| ΔG′ (MPa) [RPA; 60° | 0.33 | 0.27 | 0.26 |
| C.; 10 Hz; 1%-20%]: | | | |
| tan δ [RPA; 60° | 0.109 | 0.086 | 0.082 |
| C.; 10 Hz, 10%]: | | | |
| G′ (MPa) [RPA; | 1.31 | 1.38 | 1.36 |
| 60° C.; 10 Hz; 5%]: | | | |
| Electrical Volume | 1.03E+11 | 3.02E+10 | 1.64E+10 |
| Resistivity (Ohm-cm) | | | |
| Thermal Conductivity (W/mK) | 0.282 | 0.359 | 0.364 |

TABLE 44
Rubber Properties

| Formulation: NRESP01 | Example | | |
|---|---|---|---|
| Body Ply Skim (50 phr of CB) | BB1 | BB2 | BB3 |

Formulation note/addition:

| | | | |
|---|---|---|---|
| CB grade ID/code: | N660 | P071A | P071D |
| N2SA (m²/g): | 35.4 | 28.7 | 27.4 |
| STSA (m²/g): | 33.9 | 31.2 | 29.8 |
| OAN (mL/100 g): | 93.6 | 97.6 | 95.9 |
| COAN (mL/100 g): | 73.0 | 85.9 | |
| Plasma CB type: | | A2 | A3 |

Additional type info:

| | | | |
|---|---|---|---|
| ts2 (min) [cure rheology at 170° C.]: | 1.06 | 1.21 | 1.11 |
| t60 (min) [cure rheology at 170° C.]: | 1.76 | 1.9 | 1.84 |
| t95 (min) [cure rheology at 170° C.]: | 3.33 | 3.38 | 3.38 |
| ML₁₊₄ @ 100° C. (MU): | 41.7 | 45.9 | 44.5 |
| Rubber cure time (min) at 170° C.: | 11 | 11 | 11 |
| M100 - 100% modulus @ 23° C. | 1.90 | 1.69 | 1.83 |
| (MPa): | | | |
| M300 - 300% modulus @ 23° C. | 9.39 | 7.38 | 7.71 |
| (MPa): | | | |
| M300/M100 @ 23° C.: | 4.94 | 4.37 | 4.21 |
| Tensile at Break @ 23° C. (MPa): | 17.6 | 14.8 | 15.2 |
| Elongation at Break @ 23° C. (%): | 515.4 | 526.1 | 519.8 |
| Shore A hardness: | 53.6 | 51.9 | 53.1 |
| Dispersion (%) [disperGRADER]: | 96.4 | 97.7 | 97.8 |
| Z Value (%) [disperGRADER]: | 92.3 | 90 | 88.8 |
| Density (g/cm³): | 1.115 | 1.146 | 1.148 |
| ΔG′ (MPa) [RPA; 60° C.; 10 Hz; | 0.50 | 0.38 | 0.39 |
| 1%-20%]: | | | |
| tan δ [RPA; 60° C.; 10 Hz, 10%]: | 0.119 | 0.097 | 0.094 |
| G′ (MPa) [RPA; 60° C.; 10 Hz; 5%]: | 1.56 | 1.56 | 1.59 |
| Electrical Volume Resistivity | 5.12E+10 | 5.17E+11 | 9.44E+10 |
| (Ohm-cm) | | | |
| Thermal Conductivity (W/mK) | 0.287 | 0.407 | 0.412 |

TABLE 45
Rubber Properties

| Formulation: NRESP01 | Example | | |
|---|---|---|---|
| Body Ply Skim (57 phr of CB) | BC1 | BC2 | BC3 |

Formulation note/addition:

| | | | |
|---|---|---|---|
| CB grade ID/code: | N660 | P071A | P071D |
| N2SA (m²/g): | 35.4 | 28.7 | 27.4 |
| STSA (m²/g): | 33.9 | 31.2 | 29.8 |
| OAN (mL/100 g): | 93.6 | 97.6 | 95.9 |
| COAN (mL/100 g): | 73.0 | 85.9 | |
| Plasma CB type: | | A2 | A3 |

Additional type info:

| | | | |
|---|---|---|---|
| ts2 (min) [cure rheology at 170° C.]: | 0.98 | 1.14 | 0.97 |
| t60 (min) [cure rheology at 170° C.]: | 1.72 | 1.89 | 1.70 |
| t95 (min) [cure rheology at 170° C.]: | 3.28 | 3.45 | 3.16 |
| ML₁₊₄ @ 100° C. (MU): | 46.8 | 49.1 | 49.9 |
| Rubber cure time (min) at 170° C.: | 11 | 11 | 11 |
| M100 - 100% modulus @ 23° C. | 2.29 | 2.01 | 2.09 |
| (MPa): | | | |
| M300 - 300% modulus @ 23° C. | 10.9 | 8.58 | 8.80 |
| (MPa): | | | |
| M300/M100 @ 23° C.: | 4.76 | 4.27 | 4.21 |
| Tensile at Break @ 23° C. (MPa): | 16.7 | 14.9 | 15.8 |
| Elongation at Break @ 23° C. (%): | 460.6 | 495.6 | 506.9 |
| Shore A hardness: | 57.1 | 55.5 | 55.8 |
| Dispersion (%) [disperGRADER]: | 91.3 | 98.5 | 98.2 |
| Z Value (%) [disperGRADER]: | 87.6 | 89.4 | 88.2 |
| Density (g/cm³): | 1.162 | 1.165 | 1.165 |
| ΔG′ (MPa) [RPA; 60° C.; 10 Hz; | 0.69 | 0.58 | 0.54 |
| 1%-20%]: | | | |
| tan δ [RPA; 60° C.; 10 Hz, 10%]: | 0.134 | 0.111 | 0.103 |
| G′ (MPa) [RPA; 60° C.; 10 Hz; 5%]: | 1.77 | 1.84 | 1.83 |
| Electrical Volume Resistivity | 2.37E+10 | 3.44E+09 | 1.85E+10 |
| (Ohm-cm) | | | |
| Thermal Conductivity (W/mK) | 0.308 | 0.427 | 0.436 |

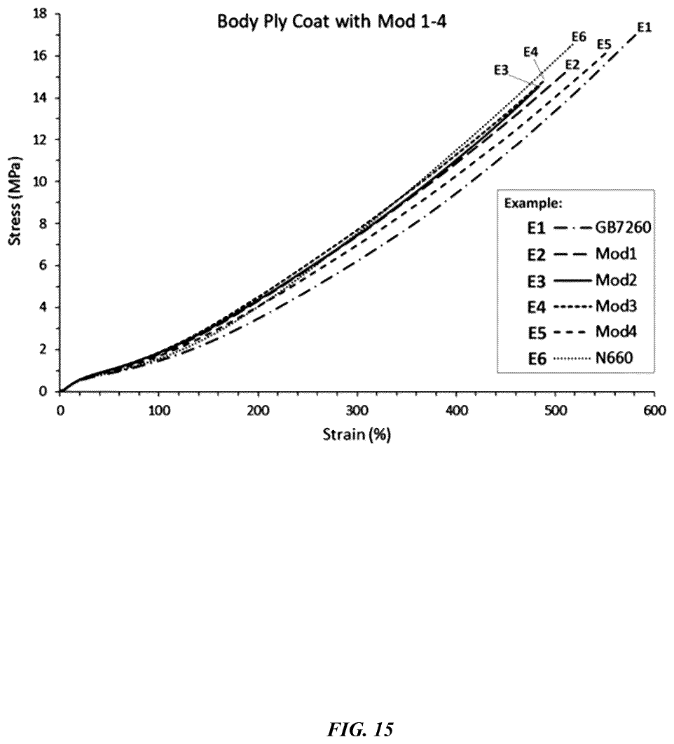

Compound modification can be made to adjust rubber properties as needed for tire applications, for example, to achieve a desired balance of rubber properties and associated tire performance properties. In Table 46, examples Mod 1 through Mod 4 represent such formulation modifications to the NRESP01 body ply skim formulation detailed above. The Baseline example used the NRESP01 formulation without modification, as did the N660 control example (furnace carbon black reference). The plasma carbon black used in the Baseline, Mod 1, Mod 2, Mod 3, and Mod 4 formulations is the Monolith® commercialized grade GB7260, which is a Type A3 plasma carbon black. As shown in Table 47, the substantial advantage of higher (enhanced) thermal conductivity (k) for plasma carbon black versus furnace carbon black was maintained throughout these compound formulation adjustments, with the remarkable increases in k ranging from 42% to 57%. FIG. 15, a corresponding stress-strain graph, further shows that such formulation modifications can be used to match the stress-strain characteristics of furnace black. Notably, by increasing the amount of plasma carbon black in the formulation, the 300% modulus (M300) along with various other properties can move from within 20% to within 5% or even to matching the M300 of the furnace black counterpart.

TABLE 46

| | Baseline | Mod 1 | Mod 2 | | Mod 3 | | Mod 4 | |
|---|---|---|---|---|---|---|---|---|
| CB | — | +7 phr | — | | +7 | phr | +7 | phr |
| Naphthenic Oil | — | — | — | | +1.8 | phr | +1.8 | phr |
| Crystex | — | — | +0.2 | phr | — | | — | |
| CurePro | | | | | | | | |
| MBTS | — | — | — | | +0.2 | phr | +0.2 | phr |
| DPTT | — | — | +0.2 | phr | +0.1 | phr | — | |
| CureRite 18 | — | — | +0.2 | phr | +0.1 | phr | +0.1 | phr |

TABLE 47
Body Ply Skim GB7260 and N660

| | Ex. E1 | Ex. E2 | Ex. E3 | Ex. E4 | Ex. E5 | |
|---|---|---|---|---|---|---|
| | GB7260 | GB7260 | GB7260 | GB7260 | GB7260 | Ex. E6 |
| Test | Baseline | Mod1 | Mod2 | Mod3 | Mod4 | N660 |
| ML (dNm) [cure | 95% | 114% | 97% | 109% | 112% | 100% |
| rheol. at 170° C.] | | | | | | |
| MH (dNm) [cure | 100% | 111% | 119% | 123% | 115% | 100% |
| rheol. at 170° C.] | | | | | | |
| TS1 (min) [cure | 111% | 102% | 94% | 89% | 95% | 100% |
| rheol. at 170° C.] | | | | | | |
| TS2 (min) [cure | 109% | 103% | 83% | 82% | 91% | 100% |
| rheol. at 170° C.] | | | | | | |
| T10 (min) [cure | 109% | 107% | 99% | 97% | 101% | 100% |
| rheol. at 170° C.] | | | | | | |
| T60 (min) [cure | 111% | 106% | 76% | 79% | 92% | 100% |
| rheol. at 170° C.] | | | | | | |
| T95 (min) [cure | 127% | 104% | 68% | 73% | 93% | 100% |
| rheol. at 170° C.] | | | | | | |
| ML1 + 4 (MU) | 102% | 115% | 105% | 111% | 114% | 100% |
| at 100° C. | | | | | | |
| M100 (MPa) | 93% | 112% | 114% | 118% | 112% | 100% |
| M300 (MPa) | 82% | 95% | 97% | 100% | 95% | 100% |
| Tensile | 94% | 88% | 84% | 86% | 92% | 100% |
| Strength (MPa) | | | | | | |
| Elongation | 106% | 97% | 91% | 93% | 101% | 100% |
| at Break (%) | | | | | | |
| Shore A Hardness | 100% | 101% | 105% | 104% | 103% | 100% |
| RPA G′ Cured [1%, | 98% | 116% | 101% | 114% | 115% | 100% |
| 10 Hz, 60° C.] | | | | | | |
| RPA G′ Cured [20%, | 106% | 119% | 110% | 120% | 116% | 100% |
| 10 Hz, 60° C.] | | | | | | |
| RPA G′ Cured [50%, | 106% | 116% | 114% | 120% | 114% | 100% |
| 10 Hz, 60° C.] | | | | | | |
| disperGRADER | 109% | 101% | 105% | 102% | 104% | 100% |
| Dispersion (%) | | | | | | |
| Rebound (0° C.) (%) | 109% | 99% | 108% | 107% | 103% | 100% |
| Rebound (25° C.) (%) | 102% | 102% | 109% | 106% | 102% | 100% |
| Rebound (100° C.) (%) | 101% | 99% | 108% | 102% | 100% | 100% |
| Thermal | 145% | 146% | 143% | 142% | 157% | 100% |
| Conductivity (W/mK) | | | | | | |

NR/SBR Body Ply Skim with Si69. Akrosorb 29460 was compounded into a body ply skim composition using the same formulation and mixing conditions as the NR/SBR formulation above, with the following exceptions: spraying 0.5 phr of H₂O onto 400 g of CB; adding 1, 2, or 3 phr of Akrosorb 29460 in a first pass after the half carbon black oil mix, phenolic resin, antioxidant and antiozonant, and before the stearic acid and zinc oxide; after the thickened naphthenic oil, phenolic resin, antioxidant, and anti ozonantstep, adding the Akrosorb 29460 at 1, 2, or 3 phr and mixing to 130° C.; adding stearic acid and mixing for 60 seconds at 60 RPM; adding zinc oxide and mixing for 60 seconds at 60 RPM; cleaning the ram; and mixing at 110 RPM until a temperature of 150° C. is reached. Results are shown in Table 48 below. Thermal conductivity was not assessed for these particular examples.

TABLE 48
Rubber Properties

| Formulation: | | | | | |
|---|---|---|---|---|---|
| NRESP02 Body | Example | | | | |
| Ply Skim | X1 | X2 | X3 | X4 | X5 |
| Formulation | 1 phr | 1 phr | 2phr | 3 phr | 3 phr + |
| Addition of | | | | | 0.5 phr |
| Akrosorb 29460 | | | | | H₂O |
| CB grade ID/code: | N660 | T3319 | T3319 | T3319 | T3319 |
| N2SA (m²/g): | 35.9 | 29.0 | 29.0 | 29.0 | 29.0 |
| STSA (m²/g): | 35.2 | 32.0 | 32.0 | 32.0 | 32.0 |
| OAN (mL/100 g): | 90.3 | 97.1 | 97.1 | 97.1 | 97.1 |
| COAN (mL/100 g): | 71.2 | 85.0 | 85.0 | 85.0 | 85.0 |
| Plasma CB type: | — | C3 | C3 | C3 | C3 |

Additional type info:

| | | | | | |
|---|---|---|---|---|---|
| ts2 (min) [cure | 1.86 | 2.89 | 2.87 | 2.81 | 2.73 |
| rheology at 170° C.]: | | | | | |
| t60 (min) [cure | 3.15 | 4.32 | 4.38 | 4.34 | 4.21 |
| rheology at 170° C.]: | | | | | |
| t95 (min) [cure | 6.12 | 7.78 | 8.07 | 8.20 | 8.00 |
| rheology at 170° C.]: | | | | | |
| ML₁₊₄ @ 100° | 46.9 | 42.4 | 43.0 | 42.2 | 40.7 |
| C. (MU): | | | | | |
| Rubber cure time | t95 + 5 | t95 + 4 | t95 + 3 | t95 + 3 | t95 + 3 |
| (min) at 170° C.: | | | | | |
| M100 - 100% modulus | 2.15 | 1.83 | 1.82 | 1.95 | 1.8 |
| @ 23° C. (MPa): | | | | | |
| M300 - 300% modulus | 10.7 | 7.82 | 7.88 | 8.42 | 7.9 |
| @ 23° C. (MPa): | | | | | |
| M300/M100 @ | 4.95 | 4.28 | 4.34 | 4.32 | 4.28 |
| 23° C.: | | | | | |
| Tensile at Break | 17.6 | 17.7 | 17.7 | 15.8 | 16.4 |
| @ 23° C. (MPa): | | | | | |
| Elongation at | 471 | 562 | 566 | 511 | 540 |
| Break @ 23° C. (%): | | | | | |
| Shore A hardness: | 53.3 | 52.2 | 52.5 | 54.1 | 52.3 |
| Dispersion (%) | 92.1 | 98.6 | 98.7 | 97.9 | 97.9 |
| [disperGRADER]: | | | | | |
| Z Value (%) | 85.1 | 87.1 | 86.8 | 85.6 | 85.8 |
| [disperGRADER]: | | | | | |
| Density (g/cm³): | 1.13 | 1.13 | 1.13 | 1.13 | 1.13 |
| ΔG′ (MPa) [RPA; 60° | 0.345 | 0.288 | 0.313 | 0.319 | 0.328 |
| C.; 10 Hz; 1%-20%]: | | | | | |
| tan δ [RPA; 60° C.; | 0.104 | 0.087 | 0.085 | 0.082 | 0.084 |
| 10 Hz, 10%]: | | | | | |
| G′ (MPa) [RPA; 60° | 0.929 | 0.941 | 1.01 | 1.05 | 1.06 |
| C.; 10 Hz; 10%]: | | | | | |

### Example 5: Tire Tread Base (Sub-Tread)

The forthcoming examples demonstrate the utility of plasma carbon black when employed in tire rubber compositions for use as a tread base component of a tire. The tread base is also referred to as sub-tread or under-tread. The specific rubber formulations shown are intended to be representative and not limiting. In addition to formulations wherein the only elastomer is NR, other elastomeric polymers can be used as minor polymer components, including various types of IR, BR, SBR, and epoxidized NR. Various furnace carbon black grades may be used, such as N550, N660, N650, N330, and others. Precipitated silica can be used as filler, with or without varieties of sulfur-containing organosilanes and/or other coupling agents. Fillers can also include carbon fillers from pyrolysis of recycled rubber materials, recycled rubber products like end-of-life tires, biomass waste, and other sources. Furnace carbon black, clays, graphenes, precipitated silica, other inorganic particulate fillers, recovered carbon filler from pyrolysis of end-of-life tires, and the like could be used in various combination with the presently disclosed plasma carbon black filler at various loading levels. Other adjustments to the formulation can be made for assorted performance and processability reasons. In particular, there are various options for amounts and types of cure/vulcanization ingredients and for antidegradants such as antioxidants, antiozonants, and the like. Variations in types and amounts of processing aids such as oils, tackifying resins, and the like may be used. The embodiments set forth herein, related to use of plasma carbon black filler in tire rubber compositions used for tread base components, encompass reasonable tread base formulation variations.

The examples below of tire tread base compositions containing plasma carbon black filler show comparable performance (within about 10%, plus or minus) in standard rubber testing to reference carbon black from the furnace process. The production of furnace carbon black generates multiple tons of CO₂ for every ton of carbon black produced, whereas the production of plasma carbon black generates <20% of that CO₂, so these examples show that plasma carbon black fillers in tire tread base components can have a significant positive impact on sustainability of tires without substantially compromising rubber properties.

It was surprisingly discovered for the tire tread base (sub-tread) composition examples that plasma carbon black gives substantially higher (enhanced) thermal conductivity relative to comparative furnace carbon black when compounded into the rubber formulations, with the projected benefits to tire manufacturing and tire performance discussed earlier.

Ingredients of an example NR tread base (sub-tread) compound are listed below.

TABLE 49
Compound Formulation (Tread Base NR)

| | | |
|---|---|---|
| Ingredient | PHR | Wt. % |

Pass 1, Master Batch (MB)

| | | |
|---|---|---|
| Natural rubber (NR) (grade SMR-L); polymer | 100 | 59.00 |
| Carbon black N550; filler | 45 | 26.55 |
| Zinc oxide; activator | 5 | 2.95 |
| Stearic acid; activator, processing aid | 2 | 1.18 |
| Aromatic oil; process oil, processing aid | 10 | 5.90 |
| 6PPD; antiozonant and antioxidant | 2.5 | 1.47 |
| Microcrystalline wax | 2 | 1.18 |
| Total | 166.5 | — |

Pass 2

| | | |
|---|---|---|
| Master Batch (MB) | 166.5 | — |
| CBS; accelerator | 0.9 | 0.53 |
| PVI; pre-vulcanization inhibitor (retarder) | 0.1 | 0.06 |
| Sulfur; curative | 1.5 | 0.88 |
| Perkalink 900; anti-reversion agent/curative | 0.5 | 0.29 |
| Total | 169.5 | 100.00 |

Summary of Mixing Steps. First Pass: add polymer (natural rubber (NR)); mix 120 seconds. Add half carbon black; mix 60 seconds. Add second half of carbon black, oil, wax, and antioxidant; mix 60 seconds. Add stearic acid and zinc oxide; mix 60 seconds. Include two ram clean-out steps at 30 seconds each; mix until drop temperature of 150° C. is reached. Second Pass: add half of first pass mix; mix 15 seconds. Add second half of first pass mix; mix 15 seconds. Add CBTS, sulfur, PK900, and CTP; mix until drop temperature of 105° C. is reached.

TABLE 50
Material Composition and Mixing - First Pass

| Component | Weigh-Up 1^{st} Pass (g) |
|---|---|
| SMR-L | 800 |
| Zinc oxide | 40 |
| Stearic acid | 16 |
| Akrosorb 9740 | 111.2 |
| Antiozonant PD-2 | 20 |
| Akrowax Micro 23 | 16 |
| Carbon Black | 360 |
| Calculated Total | 1363.2 |

Detailed Mixing Steps. Banbury First Pass: starting temperature 70° C. and starting RPM of 40. Add polymer (SMR-L); mix 120 seconds. Add half of the dry carbon black (CB) by pouring down the mixer throat; mix 60 seconds. Add second half of the dry CB, Akrowax 23, Akrosorb 9740, and PD-2; mix 60 seconds. Add stearic acid and zinc oxide; mix 60 seconds. Clean ram; mix 30 seconds. Clean ram; mix at 100 RPM until drop temperature of 150° C. is reached. Milling First Pass: set water temperature on mill to 162° F.; mill gap gauge (a.k.a. mill roll gauge) is 1.2 mm to start.

TABLE 51
Material Composition and Mixing - Second Pass

| Component | Weigh-Up 2^{nd} Pass (g) |
|---|---|
| First pass non-productive mix | 1312.4 |
| Accelerator CBTS | 6.9 |
| Retarder CTP | 0.8 |
| Sulfur | 11.6 |
| PK900 | 3.9 |
| Calculated Total | 1335.6 |

Banbury Second Pass: starting temperature 70° C. and starting RPM of 40. Add half of the non-productive mix (first pass compound); mix 15 seconds. Add second half of the non-productive mix; mix 15 seconds. Add CBTS, sulfur, PK900, and CTP. Lower ram; mix at 60 RPM until drop temperature of 105° C. is reached. Milling Second Pass: water temperature on the mill 160° F. Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges; increase mill gap gauge to 1.2 mm for final sheeting out.

Rubber Properties. The NRUO2 tread base formulation, with 45 phr carbon black, was used to compare rubber properties for A1, A2, and A3 types of plasma carbon black filler (tire rubber composition examples Y2 to Y5) in comparison to N550 furnace carbon black (example Y1), with results shown in Table 52. The colloidal properties of the plasma carbon black samples are in a similar range as the N550 reference furnace carbon black. The examples containing plasma carbon black show comparable rubber performance (within about 10%, plus or minus) to the reference furnace carbon black. Viscoelastic properties and thermal conductivity were not assessed for these particular examples.

TABLE 52
Rubber Properties

| Formulation: | Example | | | | |
|---|---|---|---|---|---|
| NRU02 Sub-tread | Y1 | Y2 | Y3 | Y4 | Y5 |

Formulation note/addition:

| | | | | | |
|---|---|---|---|---|---|
| CB grade ID/code: | N550 | 391F | 391G | 340L | T22 |
| N2SA (m²/g): | 40.5 | 43.3 | 40.2 | 39.5 | 40.7 |
| STSA (m²/g): | 40.0 | 48.2 | 45.5 | 42.1 | 45.6 |
| OAN (mL/100 g): | 126.7 | 135.2 | 134.0 | 134.6 | 123.0 |
| COAN (mL/100 g): | 85.5 | 104.7 | 105.8 | 106.6 | 103.5 |
| Plasma CB type: | — | A1 | A2 | A3 | A3 |

Additional type info:

| | | | | | |
|---|---|---|---|---|---|
| ts2 (min) [cure | 3.28 | 4.01 | 3.81 | 3.5 | 3.54 |
| rheology at 160° C.]: | | | | | |
| t60 (min) [cure | 4.12 | 4.85 | 4.66 | 4.45 | 4.43 |
| rheology at 160° C.]: | | | | | |
| t95 (min) [cure | 5.90 | 6.68 | 6.43 | 6.14 | 6.27 |
| rheology at 160° C.]: | | | | | |
| ML₁₊₄ @ 100° | 56.4 | 48.2 | 48.0 | 51.2 | 53.5 |
| C. (MU): | | | | | |
| Rubber cure time | t95 + 2 | t95 + 2 | t95 + 2 | t95 + 2 | t95 + 2 |
| (min) at 160° C.: | | | | | |
| M100 - 100% modulus | 1.60 | 1.85 | 1.84 | 1.97 | 1.60 |
| @ 23° C. (MPa): | | | | | |
| M300 - 300% modulus | 8.40 | 8.34 | 8.23 | 8.51 | 7.10 |
| @ 23° C. (MPa): | | | | | |
| M300/M100 @ | 5.24 | 4.51 | 4.46 | 4.33 | 4.34 |
| 23° C.: | | | | | |
| Tensile at Break | 19.9 | 19.2 | 19.2 | 20.13 | 19.3 |
| @ 23° C. (MPa): | | | | | |
| Elongation at | 581 | 569 | 568 | 571 | 601 |
| Break @ 23° C. (%): | | | | | |
| Shore A hardness: | 50.3 | 57.2 | 55.7 | 52.1 | 51.2 |
| Dispersion (%) | 97.4 | 99.2 | 98.8 | 98.4 | 98.3 |
| [disperGRADER]: | | | | | |
| Z Value (%) | 91.0 | 95.4 | 96.3 | 94.6 | 93.7 |
| [disperGRADER]: | | | | | |
| Density (g/cm³): | 1.12 | 1.12 | 1.12 | 1.13 | 1.08 |

The NRUO2 tread base formulation, with 45 phr carbon black, was used to compare rubber properties for A1, A2, and A3 types of plasma carbon black filler (tire rubber composition examples Z2 to Z5) in comparison to N660 furnace carbon black (example Z1), with results shown in Table 53. The colloidal properties of the plasma carbon black samples are in a similar range as the N660 reference furnace carbon black. The examples containing plasma carbon black show comparable rubber performance (within about 10%, plus or minus) to the reference furnace carbon black. Viscoelastic properties and thermal conductivity were not assessed for these

TABLE 53
Rubber Properties

| Formulation: | Example | | | | |
|---|---|---|---|---|---|
| NRU02 Sub-tread | Z1 | Z2 | Z3 | Z4 | Z5 |

Formulation note/addition:

| | | | | | |
|---|---|---|---|---|---|
| CB grade ID/code: | N660 | 320A | 320F | 320G2 | 320H2 |
| N2SA (m²/g): | 35.9 | — | — | — | — |
| STSA (m²/g): | 35.2 | — | — | — | — |
| OAN (mL/100 g): | 90.3 | 104.1 | 102.3 | 105.5 | 103.2 |
| COAN (mL/100 g): | 71.2 | 94.7 | 98.0 | 97.0 | 96.5 |
| Plasma CB type: | — | A1 | A2 | A3 | A3 |

Additional type info:

| | | | | | |
|---|---|---|---|---|---|
| ts2 (min) [cure | 3.38 | 3.95 | 4.05 | 3.77 | 3.98 |
| rheology at 160° C.]: | | | | | |
| t60 (min) [cure | 4.17 | 4.67 | 4.85 | 4.65 | 4.84 |
| rheology at 160° C.]: | | | | | |
| t95 (min) [cure | 6.00 | 6.43 | 6.70 | 6.48 | 6.67 |
| rheology at 160° C.]: | | | | | |
| ML₁₊₄ @ 100° | 47.3 | 46.7 | 48.4 | 48.3 | 47.2 |
| C. (MU): | | | | | |
| Rubber cure time | t95 + 2 | t95 + 2 | t95 + 2 | t95 + 2 | t95 + 2 |
| (min) at 160° C.: | | | | | |
| M100 - 100% modulus | 1.38 | 1.48 | 1.58 | 1.52 | 1.65 |
| @ 23° C. (MPa): | | | | | |
| M300 - 300% modulus | 7.45 | 6.64 | 6.83 | 6.67 | 7.04 |
| @ 23° C. (MPa): | | | | | |
| M300/M100 @ | 5.41 | 4.49 | 4.31 | 4.39 | 4.26 |
| 23° C.: | | | | | |
| Tensile at Break | 20.6 | 19.1 | 18.7 | 20.0 | 19.0 |
| @ 23° C. (MPa): | | | | | |
| Elongation at | 609 | 606 | 596 | 615 | 592 |
| Break @ 23° C. (%): | | | | | |
| Shore A hardness: | 46.8 | 47.9 | 48.9 | 47.3 | 49.3 |
| Dispersion (%) | 98.0 | 98.5 | 97.7 | 98.5 | 98.3 |
| [disperGRADER]: | | | | | |
| Z Value (%) | 97.7 | 92.3 | 90.6 | 95.8 | 94.8 |
| [disperGRADER]: | | | | | |
| Density (g/cm³): | 1.12 | 1.12 | 1.12 | 1.12 | 1.12 |

The NRUO2 tread base formulation, with 45 phr carbon black, was used to compare rubber properties for A1, A2, and A3 types of plasma carbon black filler (tire rubber composition examples AA2 to AA5) in comparison to N660 furnace carbon black (example AA1), with results shown in Table 54. The colloidal properties of the plasma carbon black samples are in a similar range as the N660 reference furnace carbon black. The examples containing plasma carbon black show comparable rubber performance (within about 10%, plus or minus) to the reference furnace carbon black. Viscoelastic properties were not assessed for these particular examples.

TABLE 54
Rubber Properties

| Formulation: | Example | | | | |
|---|---|---|---|---|---|
| NRU02 Sub-tread | AA1 | AA2 | AA3 | AA4 | AA5 |

Formulation note/addition:

| | | | | | |
|---|---|---|---|---|---|
| CB grade ID/code: | N660 | P046A | P046B | P053E | P042F |
| N2SA (m²/g): | 35.9 | 27.3 | 25.9 | 24.7 | 29.2 |
| STSA (m²/g): | 35.2 | 29.5 | 28.1 | 26.4 | 30.9 |
| OAN (mL/100 g): | 90.3 | 94.4 | 94.7 | 93.4 | 92.9 |
| COAN (mL/100 g): | 71.2 | 87.6 | 94.6 | — | — |
| Plasma CB type: | — | A1 | A2 | A3 | A3 |

Additional type info:

| | | | | | |
|---|---|---|---|---|---|
| ts2 (min) [cure | 3.41 | 4.34 | 4.63 | 3.75 | 3.85 |
| rheology at 160° C.]: | | | | | |
| t60 (mi) [cure | 4.18 | 5.14 | 5.42 | 4.63 | 4.71 |
| rheology at 160° C.]: | | | | | |
| t95 (min) [cure | 6.03 | 7.23 | 7.40 | 6.54 | 6.61 |
| rheology at 160° C.]: | | | | | |
| ML₁₊₄ @ 100° | 50.1 | 46.8 | 48.2 | 44.6 | 48.3 |
| C. (MU): | | | | | |
| Rubber cure time | t95 + 2 | t95 + 2 | t95 + 2 | t95 + 2 | t95 + 2 |
| (min) at 160° C.: | | | | | |
| M100 - 100% modulus | 1.29 | 1.29 | 1.34 | 1.48 | 1.43 |
| @ 23° C. (MPa): | | | | | |
| M300 - 300% modulus | 6.81 | 5.98 | 6.08 | 6.68 | 6.69 |
| @ 23° C. (MPa): | | | | | |
| M300/M100 @ | 5.28 | 4.63 | 4.55 | 4.53 | 4.67 |
| 23° C.: | | | | | |
| Tensile at Break | 19.8 | 18.3 | 18.8 | 19.7 | 20.5 |
| @ 23° C. (MPa): | | | | | |
| Elongation at | 626 | 615 | 616 | 610 | 622 |
| Break @ 23° C. (%): | | | | | |
| Shore A hardness: | 49.1 | 44.5 | 45.0 | 48.4 | 48.9 |
| Dispersion (%) | 98.2 | 97.5 | 97.0 | 96.8 | 97.5 |
| [disperGRADER]: | | | | | |
| Z Value (%) | 98.3 | 84.7 | 83.9 | 84.1 | 95.7 |
| [disperGRADER]: | | | | | |
| Density (g/cm³): | 1.10 | 1.12 | 1.12 | 1.12 | 1.11 |
| Thermal | 0.283 | 0.399 | 0.386 | 0.390 | 0.393 |
| Conductivity (W/mK): | | | | | |

The NRUO2 tread base formulation, with 45 phr carbon black, was used to compare rubber properties for A1, A2, and A3 types of plasma carbon black filler (tire rubber composition examples AB2 to AB5) in comparison to N762 furnace carbon black (example AB1), with results shown in Table 55. The colloidal properties of the plasma carbon black samples are in a similar range as the N762 reference furnace carbon black. The examples containing plasma carbon black show comparable rubber performance (within about 10%, plus or minus) to the reference furnace carbon black. Viscoelastic properties and thermal conductivity were not assessed for these particular examples.

TABLE 55
Rubber Properties

| Formulation: | Example | | | | |
|---|---|---|---|---|---|
| NRU02 Sub-tread | AB1 | AB2 | AB3 | AB4 | AB5 |

Formulation note/addition:

| | | | | | |
|---|---|---|---|---|---|
| CB grade ID/code: | N762 | 543A | 543B | 543F | 543K |
| N2SA (m²/g): | 28.9 | 27.8 | 25.1 | 26.7 | 26.4 |
| STSA (m²/g): | 27.6 | 29.9 | 27.1 | 29.4 | 28.8 |
| OAN (mL/100 g): | 65.8 | 72.8 | 72.3 | 71.5 | 73.2 |
| COAN (mL/100 g): | 59.2 | 71.5 | — | — | 70.8 |
| Plasma CB type: | — | A1 | A2 | A3 | A3 |

Additional type info:

| | | | | | |
|---|---|---|---|---|---|
| ts2 (min) [cure | 3.67 | 4.35 | 4.42 | 4.54 | 4.45 |
| rheology at 160° C.]: | | | | | |
| t60 (min) [cure | 4.34 | 5.06 | 5.13 | 5.27 | 5.17 |
| rheology at 160° C.]: | | | | | |
| t95 (min) [cure | 6.10 | 6.91 | 6.99 | 7.1 | 6.96 |
| rheology at 160° C.]: | | | | | |
| ML₁₊₄ @ | 39.8 | 37.2 | 37.1 | 38.09 | 38.5 |
| 100° C. (MU): | | | | | |
| Rubber cure time | t95 + 2 | t95 + 2 | t95 + 2 | t95 + 2 | t95 + 2 |
| (min) at 160° C.: | | | | | |
| M100 - 100% modulus | 1.18 | 1.21 | 1.20 | 1.26 | 1.29 |
| @ 23° C. (MPa): | | | | | |
| M300 - 300% modulus | 6.20 | 5.57 | 5.36 | 5.61 | 5.73 |
| @ 23° C. (MPa): | | | | | |
| M300/M100 @ 23° C.: | 5.28 | 4.61 | 4.45 | 4.47 | 4.46 |
| Tensile at Break | 20.5 | 19.0 | 19.6 | 19.9 | 20.3 |
| @ 23° C. (MPa): | | | | | |
| Elongation at Break | 617 | 616 | 633 | 626 | 629 |
| @ 23° C. (%): | | | | | |
| Shore A hardness: | 45.6 | 45.4 | 45.2 | 47.0 | 47.5 |
| Dispersion (%) | 97.1 | 95.9 | 94.6 | 97.5 | 97.6 |
| [disperGRADER]: | | | | | |
| Z Value (%) | 93.4 | 93.6 | 88 | 90.7 | 95.1 |
| [disperGRADER]: | | | | | |
| Density (g/cm³): | 1.12 | 1.12 | 1.12 | 1.12 | 1.12 |

Ingredients of an example NR ASTM tread base (sub-tread) compound are listed below.

TABLE 56
Compound Formulation (Tread Base NR ASTM)

| Ingredient | PHR | Wt. % |
|---|---|---|
| Natural rubber (SMR L); polymer | 100 | 62.07 |
| Stearic acid; activator, processing aid | 3 | 1.86 |
| Zinc oxide; activator | 5 | 3.10 |
| MBTS; accelerator | 0.6 | 0.37 |
| Sulfur; curative | 2.5 | 1.55 |
| Carbon Black | 50 | 31.04 |
| Total | 161.1 | 100.00 |

Summary of Mixing Steps. Add polymer (natural rubber (NR)); mix 30 seconds. Add MBTS; mix 30 seconds. Add stearic acid; mix 60 seconds. Add zinc oxide and half of the dry carbon black (CB); mix 90 seconds. Add second half of the dry CB; mix 90 seconds. Add sulfur; mix for 60 seconds. Clean ram; mix until drop temperature of 125° C. is reached.

TABLE 57
Material Composition and Mixing - First Pass

| Component | Weigh-Up (g) |
|---|---|
| SMR-L | 900 |
| Stearic Acid | 27 |
| Zinc Oxide | 45.0 |
| MBTS | 5.4 |
| Sulfur Powder | 22.5 |
| Carbon Black | 450 |
| Calculated Total | 1449.9 |

Detailed Mixing Steps. Banbury: starting temperature 45° C. and starting RPM of 40. Add polymer (SMR-L); mix 30 seconds. Add MBTS; mix 30 seconds. Add stearic acid; mix 60 seconds. Add half of the dry carbon black (CB) and zinc oxide; mix 90 seconds. Add second half of the dry CB; mix 90 seconds. Add sulfur; mix 60 seconds. Clean ram; mix at 70 RPM until drop temperature of 125° C. is reached. Milling: set water temperature on mill to 165° F.; mill gap gauge (a.k.a. mill roll gauge) is 1.2 mm to start.

Rubber Properties. The NRD01 ASTM D3192 natural rubber formulation, with 50 phr carbon black, was used to compare rubber properties for A1, A2, and A3 types of plasma carbon black filler (tire rubber composition examples AC2 to AC5) in comparison to N550 furnace carbon black (example AC1), with results shown in Table 58. The colloidal properties of the plasma carbon black samples are in a similar range as the N550 reference furnace carbon black. The examples containing plasma carbon black show comparable rubber performance (within about 10%, plus or minus) to the reference furnace carbon black. Viscoelastic properties and thermal conductivity were not assessed for these particular examples.

TABLE 58
Rubber Properties

| Formulation: | Example | | | | |
|---|---|---|---|---|---|
| NRD01 ASTM NR | AC1 | AC2 | AC3 | AC4 | AC5 |

Formulation note/addition:

| | | | | | |
|---|---|---|---|---|---|
| CB grade ID/code: | N550 | 391F | 391G | 340J | 340K |
| N2SA (m²/g): | 40.5 | 43.3 | 40.2 | 39.6 | 40.1 |
| STSA (m²/g): | 40.0 | 48.2 | 45.5 | 42.9 | 44.3 |
| OAN (mL/100 g): | 126.7 | 135.2 | 134.0 | 138.6 | 136.2 |
| COAN (mL/100 g): | 85.5 | 104.7 | 105.8 | — | 106.6 |
| Plasma CB type: | — | A1 | A2 | A3 | A3 |

Additional type info:

| | | | | | |
|---|---|---|---|---|---|
| ts2 (min) [cure | 1.21 | 1.18 | 0.90 | 0.88 | 0.90 |
| rheology at 160° C.]: | | | | | |
| t60 (min) [cure | 4.29 | 3.51 | 2.92 | 3.10 | 3.21 |
| rheology at 160° C.]: | | | | | |
| t95 (min) [cure | 11.7 | 8.81 | 7.87 | 8.44 | 8.49 |
| rheology at 160° C.]: | | | | | |
| ML₁₊₄ @ | 81.4 | 92.0 | 91.0 | 95.9 | 95.9 |
| 100° C. (MU): | | | | | |
| Rubber cure time | t95 + 2 | t95 + 2 | t95 + 2 | t95 + 2 | t95 + 2 |
| (min) at 160° C.: | | | | | |
| M100 - 100% modulus | 2.75 | 3.22 | 3.20 | 3.20 | 3.17 |
| @ 23° C. (MPa): | | | | | |
| M300 - 300% modulus | 12.3 | 12.30 | 12.30 | 12.7 | 12.7 |
| @ 23° C. (MPa): | | | | | |
| M300/M100 @ 23° C.: | 4.45 | 3.82 | 3.84 | 3.97 | 3.99 |
| Tensile at Break | 19.2 | 18.2 | 18.3 | 19.5 | 18.6 |
| @ 23° C. (MPa): | | | | | |
| Elongation at Break | 472 | 458 | 458 | 468 | 457 |
| @ 23° C. (%): | | | | | |
| Shore A hardness: | 50.3 | 67.3 | 67.0 | 61.6 | 62.0 |
| Dispersion (%) | 99.9 | 99.3 | 99.6 | 99.7 | 99.2 |
| [disperGRADER]: | | | | | |
| Z Value (%) | 96.9 | 96.6 | 96.4 | 96.5 | 97.1 |
| [disperGRADER]: | | | | | |
| Density (g/cm³): | 1.14 | 1.14 | 1.15 | 1.14 | 1.15 |

The NRD01 ASTM D3192 natural rubber formulation, with 50 phr carbon black, was used to compare rubber properties for A1, A2, and A3 types of plasma carbon black filler (tire rubber composition examples AD2 to AD5) in comparison to N660 furnace carbon black (example AD1), with results shown in Table 59. The colloidal properties of the plasma carbon black samples are in a similar range as the N660 reference furnace carbon black. The examples containing plasma carbon black show comparable rubber performance (within about 10%, plus or minus) to the reference furnace carbon black. Viscoelastic properties and thermal conductivity were not assessed for these particular examples.

TABLE 59
Rubber Properties

| Formulation: | Example | | | | |
|---|---|---|---|---|---|
| NRD01 ASTM NR | AD1 | AD2 | AD3 | AD4 | AD5 |

Formulation note/addition:

| | | | | | |
|---|---|---|---|---|---|
| CB grade ID/code: | N660 | 198G | 320B | 198K | 293C |
| N2SA (m²/g): | 35.9 | — | — | — | 41.7 |
| STSA (m²/g): | 35.2 | — | — | — | 44.5 |
| OAN (mL/100 g): | 90.3 | 101.5 | 106.4 | 98.7 | 95.1 |
| COAN (mL/100 g): | 71.2 | 94 | — | 92.2 | — |
| Plasma CB type: | — | A1 | A2 | A3 | A3 |

Additional type info:

| | | | | | |
|---|---|---|---|---|---|
| ts2 (min) [cure | 1.12 | 1.36 | 1.44 | 1.07 | 0.89 |
| rheology at 160° C.]: | | | | | |
| t60 (min) [cure | — | — | — | — | — |
| rheology at 160° C.]: | | | | | |
| t95 (min) [cure | 9.46 | 9.25 | 8.71 | 8.13 | 7.6 |
| rheology at 160° C.]: | | | | | |
| ML₁₊₄ @ 100° C. (MU): | 72.7 | 63.0 | 78.0 | 68.6 | 67.3 |
| Rubber cure time | t95 + 2 | t95 + 2 | t95 + 2 | t95 + 2 | t95 + 2 |
| (min) at 160° C.: | | | | | |
| M100 - 100% modulus | 2.52 | 2.45 | 2.45 | 2.57 | 2.39 |
| @ 23° C. (MPa): | | | | | |
| M300 - 300% modulus | 12.6 | 10.9 | 10.2 | 11.1 | 11.0 |
| @ 23° C. (MPa): | | | | | |
| M300/M100 @ | 4.98 | 4.44 | 4.16 | 4.32 | 4.60 |
| 23° C.: | | | | | |
| Tensile at Break | 20.9 | 18.3 | 17.8 | 18.1 | 19.4 |
| @ 23° C. (MPa): | | | | | |
| Elongation at Break | 483 | 482 | 495 | 474 | 490 |
| @ 23° C. (%): | | | | | |
| Shore A hardness: | 56.2 | 58.3 | 57.5 | 57.8 | 57.8 |
| Dispersion (%) | 99.5 | 98.7 | 99.5 | 99.0 | 88.4 |
| [disperGRADER]: | | | | | |
| Z Value (%) | 94.1 | 89.0 | 94.7 | 92.5 | 81.1 |
| [disperGRADER]: | | | | | |
| Density (g/cm³): | 1.14 | 1.10 | 1.14 | 1.11 | 1.14 |

### Example 6: Tire Tread

Examples are provided to demonstrate the utility of plasma carbon black when employed in tire rubber compositions for use as a tread component of a tire. The tread—the portion of the tire that contacts the road surface—is also referred to as the tread cap to distinguish it from the tread base (sub-tread). The specific rubber formulations shown are intended to be representative and not limiting. The SBR/BR polymer ratio can vary in passenger tire formulations from about 100/0 to about 20/80, and other elastomeric polymers can be included, for example, NR, IR, and lithium (anionic) BR. More than one type of SBR can be used in combination, and there are many commercial options of ESBR and SSBR grades with a variety of vinyl and styrene contents available. Functionalized SSBR and other functionalized elastomers may be used and are further elaborated below. The NR/BR polymer ratio can vary in heavy truck tire tread formulations from about 100/0 to about 20/80, and other elastomeric polymers can be included, including SBR, IR, and lithium (anionic) BR. Various furnace carbon black grades may be used in tire treads, such as N110, N134, N234, N220, N330, N339, N375, and others. Fillers can also include carbon fillers from pyrolysis of recycled rubber materials, recycled rubber products like end-of-life tires, biomass waste, and other sources. Various types of precipitated silica can be used as fillers, with or without known varieties of sulfur-containing organosilanes and/or other coupling agents. Furnace carbon black, clays, graphenes, precipitated silica, other inorganic particulate fillers, recovered carbon filler from pyrolysis of end-of-life tires, and the like could be used in various combination with the disclosed plasma carbon black fillers at various loading levels. Other adjustments to the formulation can be made for assorted performance and processability reasons. In particular, there are various options for amounts and types of cure/vulcanization ingredients and for antidegradants such as antioxidants, antiozonants, and the like. Variations in types and amounts of processing aids such as oils, tackifying resins, and the like may be used. The embodiments set forth herein, related to use of plasma carbon black filler in tire rubber compositions used for tread components, encompass reasonable tread formulation variations.

Functionalized solution SBR (functionalized SSBR) and other functionalized elastomers may be utilized in tire tread formulations, especially for passenger vehicle tire treads. Functional groups can be incorporated into diene elastomers by coupling agents, polymerization initiators, polymerization terminators, post-polymerization functionalization approaches, incorporation of functionalized monomers, and the like. For coupling to carbon black, mention may be made, for example, of functional groups comprising a C—Sn bond or aminated functional groups (e.g., aminobenzophenone). For coupling to an inorganic filler such as silica, mention may be made, for example, of silanol functional groups or polysiloxane functional groups having a silanol end, alkoxysilane groups, carboxylic groups, or polyether groups. As other examples of functionalized elastomers, mention may also be made of elastomers (e.g., SBR, BR, NR or IR) of the epoxidized type.

Representative, but not limiting, grades of commercially available functionalized SSBR and functionalized lithium BR include: Kumho Petrochemical Company (KKPC), H series functionalized SSBR (e.g., grades 5251H, 5270H); Asahi Kasei, Tufdene E series functionalized SSBR (e.g., E581, E680) and F series functionalized SSBR (e.g., F3440, F3420); LG Chem, F series functionalized SSBR (e.g., grades F3438, F1810, F4626E), M series functionalized SSBR (e.g., M3626, M1525), functionalized lithium BR (e.g., F0010); and Arlanxeo, Buna FX series functionalized SSBR (e.g., grades FX 3432A-2, FX 5000). These grades, similar grades from other polymer suppliers, and all other known commercially available functionalized SSBRs, functionalized BRs, and other functionalized diene elastomers may be included in embodiments of the present disclosure.

Tread rubber compositions can be envisioned where synergistic performance in tread formulations can be realized between functionalized elastomers and plasma carbon black fillers, where such plasma carbon black fillers have, for example, (1) surface functional groups introduced on the particle surfaces through the particle manufacturing process, and/or (2) special functionalized binders introduced during the pelletization process. The functional surface groups on the carbon black can be made to interact specifically with moieties at the polymer. For example, the functional group could be a polyol on the elastomer and the group on the carbon black may be an acetonitirile group which can be reacted to form urea type moieties. Another possibility is amine groups reacting with carbonyl groups, and these groups can be on either the carbon black or the elastomer. Carboxylic acid groups also may be added to the surface of carbon black particle(s) through oxidation via nitric acid, Hummer's reagent, modified Hummer's reagent, sodium hypochlorite, combinations of acid and peroxides such as sulfuric acid and hydrogen peroxide. Another method to oxidize the surface is through the use of ozone. The oxygen groups at the surface of the carbon black can then be reacted to form other reactive groups such as unconjugated double bonds. Surface defects can also be created on the carbon black through the oxidation process, which can create reactivity that is beneficial to bonding to the elastomer to create a more intimate bond between the carbon black surface and the elastomer.

Other reactive groups that may be added include sulfone, quinone, thioester, etc. These groups can be added via diazonium chemistry. Any group can be added via sequential addition of sodium thiosulfite followed by an amino functionalized thioester or sulfone, for instance.

Additionally, the oxidized carbon black can be treated with Si69 or some similar sulfidosiloxane that may be a disulfide or a tetrasulfide. Another terminology may be an organosilane with a polysulfide moiety.

Hydrocarbon resins and natural resins may be rubber ingredients used in tire treads for improving wet traction, for example, and/or improving other performance or processability characteristics. Hydrocarbon resins include pure monomer resins, resins based on DCPD, C5, C9, C5/C9, and the like. Natural resins include rosin-based resins, terpene-based resins, and the like. These hydrocarbon resins and natural resins can be hydrogenated to various extents. Examples of such resins used in tire rubber compositions are mentioned, for example, in U.S. Pat. Nos. 10,519,299, 11,236,217, and in references cited therein, which are incorporated herein by reference.

Tire tread formulations in which the predominant filler type is furnace carbon black may utilize grades with smaller particle size (higher surface area), such as ASTM grades in the N100, N200, and N300 series ranges, for example, N110, N134, N234, N220, N330, N339, N375 and others.

There may exist furnace carbon black grades with lower surface area and higher structure that are being sold commercially for use in tire tread compositions. Two such grades are: ECORAX S 204 from Orion with STSA=19 m²/g and OAN=138 ml/100 g; and ECORAX S 206 from Orion with STSA=19 m²/g and OAN=73 ml/100 g. The plasma carbon black fillers of the present disclosure, considering the ranges of surface area and structure available from the thermal plasma process, are considered to be comparable fillers to those commercial grades that are used in tread rubber formulations.

In cases where plasma carbon black filler examples are not available to compare directly with N100, N200, or N300 type carbon blacks, plasma carbon black fillers are rather compared to N550, N660, and N772 grades which are considered relevant furnace carbon black references. A basic SBR rubber formulation (specified in ASTM D3191) is used to make carbon black comparisons, as SBR is a common type of diene elastomer employed in passenger tire treads. These results can also be used to demonstrate the utility of plasma carbon black fillers in any rubber formulation where SBR is a major elastomer type in the formulation. The utility of plasma carbon black as a filler in tire treads is also demonstrated in various example rubber formulations used in tire treads for passenger vehicles and in heavy trucks (commercial heavy vehicles), as detailed below.

The examples below of tire tread compositions containing plasma carbon black filler show comparable performance (within about 10%, plus or minus) in standard rubber testing to reference carbon black from the furnace process. The production of furnace carbon black generates multiple tons of CO₂ for every ton of carbon black produced, whereas the production of plasma carbon black generates <20% of that CO₂, so these examples show that plasma carbon black fillers in tire tread components can have a significant positive impact on sustainability of tires without substantially compromising rubber properties. Some advantages are noted in terms of improved filler dispersion and reduced hysteresis (tan delta or tan δ) for certain examples of plasma carbon black fillers relative to the respective furnace carbon black reference.

It was surprisingly discovered for the tire tread composition examples that plasma carbon black gives substantially higher (enhanced) thermal conductivity relative to comparative furnace carbon black when compounded into the rubber formulations, with the projected benefits to tire manufacturing and tire performance discussed earlier.

SBR ASTM Formulation. ASTM 3191 was followed with the exception of using SBR 1502 (non-staining antioxidant) instead of SBR 1500 (staining antioxidant). These two grades of emulsion SBR are nominally the same with the exception of the antioxidant type. In some cases, a mixing scheme with two standard mixing passes using a Banbury internal mixer (versus mixing TBBS into the rubber on the two-roll mill as in the standard method) was employed in which the mixing drop temperature was increased in the first pass (non-productive), as will be indicated where relevant below.

Ingredients of an example ESD01 tread compound are listed below.

TABLE 60
Compound Formulation (Tread ESD01)

| Ingredient | PHR | Wt. % |
|---|---|---|
| SBR 1502; polymer | 100 | 63.80 |
| Zinc Oxide; activator | 3 | 1.91 |
| Sulfur Powder; curative | 1.75 | 1.12 |
| TBBS; accelerator | 1 | 0.64 |
| Stearic Acid; activator, processing aid | 1 | 0.64 |
| Carbon Black; filler | 50 | 31.90 |
| Total | 156.75 | 100.00 |

Summary of Mixing Steps. Modified ASTM standard compound for testing carbon black in SBR by substituting SBR 1502 for SBR 1500. First pass: add half SBR, zinc oxide, stearic acid, then second half SBR; mix for 30 seconds at 30 RPM. Add carbon black and sulfur; mix at 30 RPM until drop temperature of 100° C. is reached. Second pass: mixing occurs on the two-roll mill where TBBS is added.

TABLE 61
Material Composition and Mixing

| Component | Weigh-Up (g) |
|---|---|
| SBR 1502 | 900 |
| Zinc Oxide | 27 |
| Sulfur Powder | 15.8 |
| TBBS | 9 |
| Stearic Acid | 9 |
| Carbon Black | 450 |
| Calculated Total | 1410.8 |

Detailed Mixing Steps. Banbury: starting temperature 15° C. and starting RPM of 30. Add half of polymer (SBR 1502), zinc oxide, stearic acid, and then the second half of SBR 1502; mix 15 seconds. Add carbon black and sulfur; mix 30 seconds. Clean ram; mix 25 seconds. Clean ram; mix at 30 RPM until drop temperature of 100° C. is reached. Milling: make sure chiller is on and set to 45° F.; mill roll gauge is 1.2 mm to start. Pig rolling: mix the TBBS into the bank of the roll. Set the mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges. Increase mill gap gauge to 1.2 mm for final sheeting out.

Rubber Properties. The ASTM ESBR tread formulation (ESD01) was used to compare rubber properties for A1, A2, and A3 types of plasma carbon black filler (tire rubber composition examples AE2 to AE5) in comparison to N550 furnace carbon black (example AEL), with results shown in Table 62. The colloidal properties of the plasma carbon black samples are in a similar range as the N550 reference furnace carbon black. The examples containing plasma carbon black show comparable rubber performance (within about 10%, plus or minus) to the reference furnace carbon black. Viscoelastic properties and thermal conductivity were not assessed for these particular examples.

TABLE 62
Rubber Properties

| Formulation: ESD01 | Example | | | | |
|---|---|---|---|---|---|
| ASTM ESBR Tread | AE1 | AE2 | AE3 | AE4 | AE5 |

Formulation note/addition:

| | | | | | |
|---|---|---|---|---|---|
| CB grade ID/code: | N550 | 396A | 396C | 396D | 340K |
| N2SA (m²/g): | 40.5 | 43.1 | 40.1 | 38.9 | 40.1 |
| STSA (m²/g): | 40.0 | 47.0 | 44.6 | 41.9 | 44.3 |
| OAN (mL/100 g): | 126.7 | 142.5 | 134.5 | 133.8 | 136.2 |
| COAN (mL/100 g): | 85.5 | 107.6 | 106.8 | — | 106.6 |
| Plasma CB type: | | A1 | A2 | A3 | A3 |

Additional type info:

| | | | | | |
|---|---|---|---|---|---|
| ts2 (min) [cure | 4.38 | 5.81 | 5.64 | 6.42 | 5.83 |
| rheology at 160° C.]: | | | | | |
| t60 (min) [cure | 7.99 | 9.80 | 9.33 | 10.8 | 9.89 |
| rheology at 160° C.]: | | | | | |
| t95 (min) [cure | 15.0 | 17.8 | 16.1 | 17.7 | 15.8 |
| rheology at 160° C.]: | | | | | |
| ML₁₊₄ @ 100° C. (MU): | 83.6 | 86.5 | 87.8 | 87.0 | 87.7 |
| Rubber cure time | t95 + 2 | t95 + 2 | t95 + 2 | t95 + 2 | t95 + 2 |
| (min) at 160° C.: | | | | | |
| M100 - 100% modulus | 3.11 | 3.08 | 2.90 | 3.17 | 3.36 |
| @ 23° C. (MPa): | | | | | |
| M300 - 300% modulus | 14.9 | 13.4 | 12.7 | 14.3 | 14.8 |
| @ 23° C. (MPa): | | | | | |
| M300/M100 @ | 4.77 | 4.36 | 4.38 | 4.51 | 4.39 |
| 23° C.: | | | | | |
| Tensile at Break | 18.4 | 16.8 | 15.0 | 19.3 | 17.0 |
| @ 23° C.: | | | | | |
| Elongation at Break | 394 | 404 | 378 | 441 | 376 |
| @ 23° C.: | | | | | |
| Shore A hardness: | 65.1 | 66.5 | 65.5 | 65.8 | 63.2 |
| Dispersion (%) | 97.1 | 99.5 | 99.4 | 99.4 | 99.7 |
| [disperGRADER]: | | | | | |
| Z Value (%) | 84.6 | 96.5 | 96.5 | 97.1 | 97.6 |
| [disperGRADER]: | | | | | |
| Density (g/cm³): | 1.16 | 1.15 | 1.15 | 1.15 | 1.17 |

The ASTM ESBR tread formulation (ESD01) was used to compare rubber properties for A1, A2, and A3 types of plasma carbon black filler (tire rubber composition examples AF2 to AF5) in comparison to N660 furnace carbon black (example AF1), with results shown in Table 63. The colloidal properties of the plasma carbon black samples are in a similar range as the N660 reference furnace carbon black. The examples containing plasma carbon black show comparable rubber performance (within about 10%, plus or minus) to the reference furnace carbon black. Viscoelastic properties and thermal conductivity were not assessed for these particular examples.

TABLE 63
Rubber Properties

| Formulation: ESD01 | Example | | | | |
|---|---|---|---|---|---|
| ASTM ESBR Tread | AF1 | AF2 | AF3 | AF4 | AF5 |

Formulation note/addition:

| | | | | | |
|---|---|---|---|---|---|
| CB grade ID/code: | N660 | 198J | 364B | 293C | 695C |
| N2SA (m²/g): | 35.9 | — | 37.9 | 41.7 | 39.8 |
| STSA (m²/g): | 35.2 | — | 41.6 | 44.4 | 44.6 |
| OAN (mL/100 g): | 90.3 | 100.6 | 100.7 | 95.1 | 103.4 |
| COAN (mL/100 g): | 71.2 | — | 92.4 | — | 95.5 |
| Plasma CB type: | — | A1 | A2 | A3 | A3 |

Additional type info:

| | | | | | |
|---|---|---|---|---|---|
| ts2 (min) [cure | 4.78 | 6.67 | 5.33 | 5.63 | 5.15 |
| rheology at 160° C.]: | | | | | |
| t60 (min) [cure | 8.45 | — | — | — | 8.98 |
| rheology at 160° C.]: | | | | | |
| t95 (min) [cure | 16.0 | 18.8 | 13.56 | 15.93 | 15.37 |
| rheology at 160° C.]: | | | | | |
| ML₁₊₄ @ 100° C. (MU): | 75.3 | 78.9 | 75.9 | 75.3 | 84.8 |
| Rubber cure time | t95 + 2 | t95 + 2 | t95 + 2 | t95 + 2 | t9 + 2 |
| (min) at 160° C.: | | | | | |
| M100 - 100% modulus | 2.55 | 2.62 | 2.34 | 2.83 | 2.93 |
| @ 23° C. (MPa): | | | | | |
| M300 - 300% modulus | 12.8 | 11.8 | 10.5 | 13.3 | 13.1 |
| @ 23° C. (MPa): | | | | | |
| M300/M100 @ | 5.01 | 4.50 | 4.49 | 4.69 | 4.47 |
| 23° C.: | | | | | |
| Tensile at Break | 16.7 | 15.8 | 16.9 | 17.1 | 16.2 |
| @ 23° C.: | | | | | |
| Elongation at Break | 405 | 418 | 489 | 406 | 397 |
| @ 23° C.: | | | | | |
| Shore A hardness: | 62.1 | 63.9 | 64.2 | 55.6 | 64.2 |
| Dispersion (%) | 86.9 | 98.6 | 99.5 | 98.4 | 99.2 |
| [disperGRADER]: | | | | | |
| Z Value (%) | 70.4 | 89.9 | 96 | 94.9 | 94.8 |
| [disperGRADER]: | | | | | |
| Density (g/cm³): | 1.12 | 1.14 | 1.15 | 1.14 | 1.12 |

The ASTM ESBR tread formulation (ESD01) was used to compare rubber properties for A1, A2, and A3 types of plasma carbon black filler (tire rubber composition examples AG2 to AG5) in comparison to N660 furnace carbon black (example AG1), with results shown in Table 64. The colloidal properties of the plasma carbon black samples are in a similar range as the N660 reference furnace carbon black. The examples containing plasma carbon black show comparable rubber performance (within about 10%, plus or minus) to the reference furnace carbon black. Viscoelastic properties and thermal conductivity were not assessed for these particular examples.

TABLE 64
Rubber Properties

| Formulation: ESD01 | Example | | | | |
|---|---|---|---|---|---|
| ASTM ESBR Tread | AG1 | AG2 | AG3 | AG4 | AG5 |

Formulation note/addition:

| | | | | | |
|---|---|---|---|---|---|
| CB grade ID/code: | N660 | P040A | P042B | P042F | P040H |
| N2SA (m²/g): | 35.9 | 30.0 | 29.2 | 29.2 | 28.3 |
| STSA (m²/g): | 35.2 | 32.6 | 32.1 | 30.9 | 31.0 |
| OAN (mL/100 g): | 90.3 | 94.8 | 91.8 | 92.9 | 92.7 |
| COAN (mL/100 g): | 71.2 | 86.0 | — | — | — |
| Plasma CB type: | — | A1 | A2 | A3 | A3 |

Additional type info:

| | | | | | |
|---|---|---|---|---|---|
| ts2 (min) [cure | 4.78 | 5.97 | 6.93 | 5.40 | 5.46 |
| rheology at 160° C.]: | | | | | |
| t60 (min) [cure | 8.45 | 9.87 | 11.0 | 9.56 | 9.14 |
| rheology at 160° C.]: | | | | | |
| t95 (min) [cure | 16.0 | 17.5 | 18.89 | 16.1 | 15.0 |
| rheology at 160° C.]: | | | | | |
| ML₁₊₄ @ 100° C. (MU): | 75.3 | 79.1 | 79.4 | 79.5 | 81.4 |
| Rubber cure time | t95 + 2 | t95 + 2 | t95 + 2 | t95 + 2 | t95 + 2 |
| (min) at 160° C.: | | | | | |
| M100 - 100% modulus | 2.55 | 2.38 | 2.30 | 2.49 | 2.51 |
| @ 23° C. (MPa): | | | | | |
| M300 - 300% modulus | 12.8 | 10.5 | 10.2 | 11.45 | 11.1 |
| @ 23° C. (MPa): | | | | | |
| M300/M100 @ | 5.01 | 4.41 | 4.42 | 4.59 | 4.44 |
| 23° C.: | | | | | |
| Tensile at Break | 16.7 | 11.93 | 14.1 | 11.6 | 11.5 |
| @ 23° C.: | | | | | |
| Elongation at Break | 405 | 362 | 429 | 331 | 336 |
| @ 23° C.: | | | | | |
| Shore A hardness: | 62.1 | 63.0 | 61.7 | 62.9 | 64.3 |
| Dispersion (%) | 86.9 | 98.3 | 98.2 | 94.4 | 97.9 |
| [disperGRADER]: | | | | | |
| Z Value (%) | 70.4 | 87.7 | 88.1 | 87.6 | 87.3 |
| [disperGRADER]: | | | | | |
| Density (g/cm³): | 1.12 | 1.16 | 1.15 | 1.15 | 1.15 |

The ASTM ESBR tread formulation (ESD01) was used to compare rubber properties for A1, A2, and A3 types of plasma carbon black filler (tire rubber composition examples AH2 to AH5) in comparison to N772 furnace carbon black (example AH1), with results shown in Table 65. The colloidal properties of the plasma carbon black samples are in a similar range as the N772 reference furnace carbon black. The examples containing plasma carbon black show comparable rubber performance (within about 10%, plus or minus) to the reference furnace carbon black. Viscoelastic properties and thermal conductivity were not assessed for these particular examples.

TABLE 65
Rubber Properties

| Formulation: ESD01 | Example | | | | |
|---|---|---|---|---|---|
| ASTM ESBR Tread | AH1 | AH2 | AH3 | AH4 | AH5 |

Formulation note/addition:

| | | | | | |
|---|---|---|---|---|---|
| CB grade ID/code: | N772 | 594A | 594B | 594D | 594F |
| N2SA (m²/g): | 26.75 | 29.34 | 27.96 | 27.63 | 27.76 |
| STSA (m²/g): | 25.81 | 32.44 | 30.43 | 30.57 | 30.73 |
| OAN (mL/100 g): | 67.2 | 77.9 | 78.2 | 78.6 | 78.7 |
| COAN (mL/100 g): | 58.1 | 74.2 | — | — | — |
| Plasma CB type: | — | A1 | A2 | A3 | A3 |

Additional type info:

| | | | | | |
|---|---|---|---|---|---|
| ts2 (min) [cure | 5.11 | 6.96 | 8.18 | 6.92 | 7.76 |
| rheology at 160° C.]: | | | | | |
| t60 (min) [cure | 8.32 | 10.56 | 12.74 | 10.79 | 11.78 |
| rheology at 160° C.]: | | | | | |
| t95 (min) [cure | 15.49 | 18.43 | 20.85 | 17.52 | 18.85 |
| rheology at 160° C.]: | | | | | |
| ML₁₊₄ @ 100° C. (MU): | 67.5 | 68.74 | 70.65 | 71.71 | 71.9 |
| Rubber cure time | 18 | 20 | 23 | 20 | 21 |
| (min) at 160° C.: | | | | | |
| M100 - 100% modulus | 1.9 | 2.0 | 2.1 | 2.2 | 2.3 |
| @ 23° C. (MPa): | | | | | |
| M300 - 300% modulus | 9.6 | 8.9 | 9.1 | 9.9 | 10.1 |
| @ 23° C. (MPa): | | | | | |
| M300/M100 @ | 4.94 | 4.38 | 4.38 | 4.47 | 4.37 |
| 23° C.: | | | | | |
| Tensile at Break | 12.5 | 13.5 | 15.1 | 12.7 | 13.2 |
| @ 23° C.: | | | | | |
| Elongation at Break | 382.9 | 451.4 | 489.3 | 398.4 | 409.1 |
| @ 23° C.: | | | | | |
| Shore A hardness: | 59.2 | 57.4 | 57.6 | 58.4 | 59.2 |
| Dispersion (%) | 89.1 | 99.4 | 98 | 99.4 | 98.5 |
| [disperGRADER]: | | | | | |
| Z Value (%) | 74.6 | 94.1 | 91.2 | 93.2 | 91.8 |
| [disperGRADER]: | | | | | |
| Density (g/cm³): | 1.151 | 1.153 | 1.149 | 1.150 | 1.151 |

The ASTM ESBR tread formulation (ESD01) was used to compare rubber properties for A1, A2, and A3 types of plasma carbon black filler (tire rubber composition examples AI2 to AI5) in comparison to N772 furnace carbon black (example AI1), with results shown in Table 66. The colloidal properties of the plasma carbon black samples are in a similar range as the N772 reference furnace carbon black. The examples containing plasma carbon black show comparable rubber performance (within about 10%, plus or minus) to the reference furnace carbon black. Viscoelastic properties and thermal conductivity were not assessed for these

TABLE 66
Rubber Properties

| Formulation: ESD01 | Example | | | | |
|---|---|---|---|---|---|
| ASTM ESBR Tread | AI1 | AI2 | AI3 | AI4 | AI5 |

Formulation note/addition:

| | | | | | |
|---|---|---|---|---|---|
| CB grade ID/code: | N772 | P047A | P045B | P054G | P055I |
| N2SA (m²/g): | 26.8 | 27.6 | 26.7 | 29.5 | 27.9 |
| STSA (m²/g): | 25.8 | 29.8 | 29.2 | 32.2 | 30.4 |
| OAN (mL/100 g): | 67.2 | 74.3 | 69.9 | 69.1 | 68.2 |
| COAN (mL/100 g): | 58.1 | 72.1 | — | 67.5 | — |
| Plasma CB type: | — | A1 | A2 | A3 | A3 |

Additional type info:

| | | | | | |
|---|---|---|---|---|---|
| ts2 (min) [cure | 5.11 | 6.05 | 7.23 | 6.32 | 5.72 |
| rheology at 160° C.]: | | | | | |
| t60 (min) [cure | 8.32 | 9.66 | 11.3 | 9.59 | 9.32 |
| rheology at 160° C.]: | | | | | |
| t95 (min) [cure | 15.5 | 17.4 | 19.3 | 16.1 | 14.8 |
| rheology at 160° C.]: | | | | | |
| ML₁₊₄ @ 100° C. (MU): | 67.5 | 70.1 | 70.5 | 68.6 | 67.1 |
| Rubber cure time | t95 + 2 | t95 + 2 | t95 + 2 | t95 + 2 | t95 + 2 |
| (min) at 160° C.: | | | | | |
| M100 - 100% modulus | 1.90 | 1.89 | 1.84 | 1.92 | 2.02 |
| @ 23° C. (MPa): | | | | | |
| M300 - 300% modulus | 9.60 | 8.24 | 7.87 | 9.01 | 9.67 |
| @ 23° C. (MPa): | | | | | |
| M300/M100 @ | 4.94 | 4.36 | 4.27 | 4.68 | 4.79 |
| 23° C.: | | | | | |
| Tensile at Break | 12.5 | 12.1 | 12.82 | 15.5 | 14.2 |
| @ 23° C.: | | | | | |
| Elongation at Break | 383 | 427 | 459 | 471 | 436 |
| @ 23° C.: | | | | | |
| Shore A hardness: | 59.2 | 59.5 | 53.9 | 56.1 | 56.5 |
| Dispersion (%) | 89.1 | 96.6 | 95.8 | 98.3 | 98.4 |
| [disperGRADER]: | | | | | |
| Z Value (%) | 74.6 | 82.7 | 81.6 | 90.0 | 90.0 |
| [disperGRADER]: | | | | | |
| Density (g/cm³): | 1.15 | 1.14 | 1.15 | 1.15 | 1.15 |

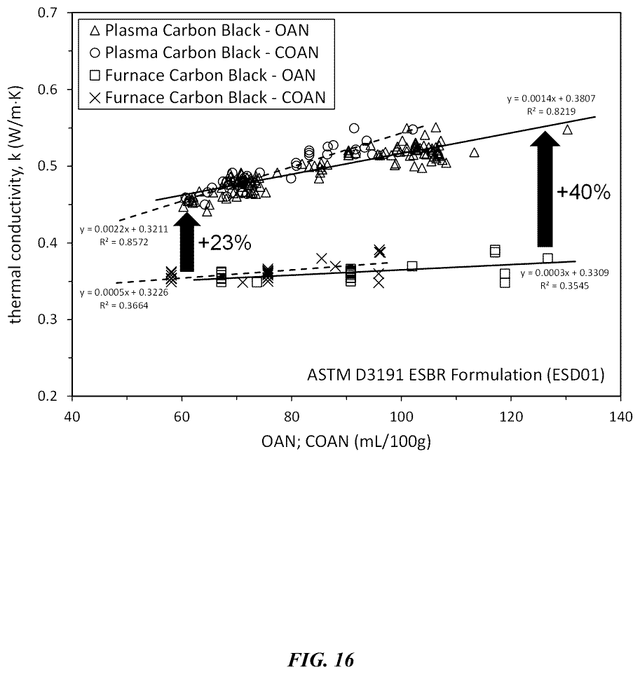

The ASTM ESBR tread formulation (ESD01) was used to evaluate rubber properties for A1, A2, and A3 types of plasma carbon black filler where the filler colloidal properties were varied across the range of nitrogen surface area (N2SA) from 24.2 to 43.0 m²/g and across the range of OAN structure from 60.3 to 130.3 mL/100 g. The number of examples considered was 141, which includes examples that are nominally similar to examples AE2 to AE5, AF2 to AF5, AG2 to AG5, AH2 to AH5, and AI2 to AI5 in Tables 62-66 above. These examples enabled evaluation of the dependence of thermal conductivity (k) on oil absorption number (OAN) in comparison to comparable furnace carbon black grades N772, N660, N550, N330, N326, N220, and N234. As shown in FIG. 16, the plasma carbon black examples have k values that are 23% to 40% higher than corresponding furnace carbon black k values at the same OAN, and the plasma carbon black examples show stronger dependence of k on OAN compared to k for furnace carbon black, which is nearly independent of OAN. For example, the slope of the line (from linear regression) fit to the plasma carbon black data in FIG. 16 is nearly four (4) times greater than the slope of the line fit to the furnace carbon black data. Similar results are noted when k is plotted versus the compressed oil absorption number (COAN), which is also illustrated in FIG. 16.

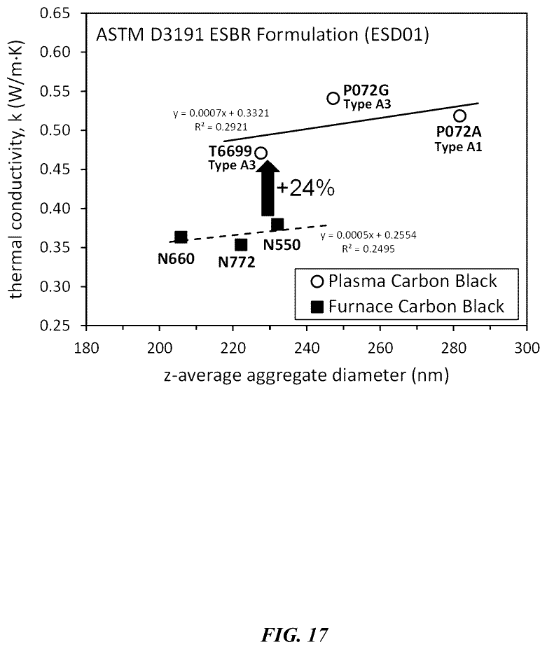

FIG. 17, a graph of thermal conductivity versus aggregate size as quantified using dynamic light scattering (DLS), also demonstrates the substantial increase in (enhancement of) thermal conductivity (k) for plasma carbon black versus furnace carbon black. As shown in FIG. 17, a 24% increase in thermal conductivity is noted for plasma carbon black relative to furnace carbon black at constant Z-average aggregate size in the ASTM D3191 ESBR formulation (ESD01). Disk centrifuge photosedimentometry, another technique for measuring aggregate size of carbon black fillers, also may be used.

The ESD01 ASTM ESBR tread formulation was used to compare rubber properties for A2, A3, B2, and B3 types of plasma carbon black filler (tire rubber composition examples AT2 to AT5) in comparison to N660 furnace carbon black (example AT1), with results shown in Table 67. The B2 and B3 type plasma carbon black fillers contain silica in the binder, and the special additive in the B3 type plasma CB is Si69 (TESPT) silane. The colloidal properties of the plasma carbon black samples are in a similar range as the N660 reference furnace carbon black. The examples containing plasma carbon black show comparable rubber performance (within about 10%, plus or minus) to the reference furnace carbon black. Thermal conductivity was not assessed for these particular examples.

TABLE 67
Rubber Properties

| Formulation: | | | | | |
|---|---|---|---|---|---|
| ESD01 (A and B CB | Example | | | | |
| Type) Tread | AT1 | AT2 | AT3 | AT4 | AT5 |

Formulation note/addition:

| | | | | | |
|---|---|---|---|---|---|
| CB grade ID/code: | N660 | P066B | P066C | P066D | P066E |
| N2SA (m²/g): | 35.4 | 29.4 | 29.3 | 29.2 | 27.7 |
| STSA (m²/g): | 33.9 | 32.5 | 31.9 | 31.7 | 30.4 |
| OAN (mL/100 g): | 93.6 | 107.6 | 106.4 | 106.6 | 107.9 |
| COAN (mL/100 g): | 73.0 | 92.5 | | 91.8 | |
| Plasma CB type: | | A2 | B2 | B3 | A3 |
| Additional type info: | | | | Si69 | |
| ts2 (min) [cure | 4.47 | 5.21 | 5.05 | 5.17 | 4.55 |
| rheology at 160° C.]: | | | | | |
| t60 (min) [cure | 8.03 | 8.59 | 8.35 | 8.61 | 7.59 |
| rheology at 160° C.]: | | | | | |
| t95 (min) [cure | 15.2 | 15.4 | 15.0 | 15.5 | 13.5 |
| rheology at 160° C.]: | | | | | |
| ML₁₊₄ @ 100° C. (MU): | 79.3 | 79.7 | 81.8 | 81.9 | 79.3 |
| Rubber cure time | 17 | 17 | 17 | 18 | 16 |
| (min) at 160° C.: | | | | | |
| M100 - 100% modulus | 2.58 | 2.37 | 2.40 | 2.41 | 2.42 |
| @ 23° C. (MPa): | | | | | |
| M300 - 300% modulus | 12.6 | 10.1 | 10.4 | 10.3 | 10.4 |
| @ 23° C. (MPa): | | | | | |
| M300/M100 @ | 4.88 | 4.26 | 4.33 | 4.27 | 4.30 |
| 23° C.: | | | | | |
| Tensile at Break | 16.5 | 14.4 | 15.9 | 16.6 | 16.4 |
| @ 23° C. (MPa): | | | | | |
| Elongation at Break | 410.7 | 440.2 | 479.8 | 511.2 | 498.5 |
| @ 23° C. (%): | | | | | |
| Shore A hardness: | 62.0 | 61.2 | 61.3 | 61 | 61.6 |
| Dispersion (%) | 82.4 | 98.3 | 98.2 | 98.2 | 98.4 |
| [disperGRADER]: | | | | | |
| Z Value (%) | 64.7 | 87.1 | 84.7 | 85.0 | 88 |
| [disperGRADER]: | | | | | |
| Density (g/cm³): | 1.159 | 1.165 | 1.165 | 1.166 | 1.167 |
| ΔG′ (MPa) | 0.885 | 0.415 | 0.412 | 0.413 | 0.359 |
| [RPA; 60° C.; | | | | | |
| 10 Hz; 1%-20%]: | | | | | |
| tan δ [RPA; | 0.151 | 0.138 | 0.143 | 0.141 | 0.124 |
| 60° C.; 10 Hz, 5%]: | | | | | |
| G′ (MPa) [RPA; | 3.09 | 1.74 | 1.68 | 1.71 | 1.68 |
| 60° C.; 10 Hz; 5%]: | | | | | |

Mixing conditions for the following examples (Tables 68-71) were modified from the ASTM SBR standard as follows: the mixing stage reached a drop temperature of 150° C. by increasing mixer RPM to 72; the productive mixing stage was conducted in the same manner as the ASTM SBR mix.

The ESD04 high drop temperature SBR rubber formulation, with 50 phr carbon black, was used to compare rubber properties for A1, A2, and A3 types of plasma carbon black filler (tire rubber composition examples AJ2 to AJ5) in comparison to N660 furnace carbon black (example AJ1), with results shown in Table 68. The colloidal properties of the plasma carbon black samples are in a similar range as the N660 reference furnace carbon black. The examples containing plasma carbon black show comparable rubber performance (within about 10%, plus or minus) to the reference furnace carbon black. Viscoelastic properties and thermal conductivity were not assessed for these particular examples.

TABLE 68
Rubber Properties

| Formulation: ESBR | Example | | | | |
|---|---|---|---|---|---|
| High DT (150° C.) | AJ1 | AJ2 | AJ3 | AJ4 | AJ5 |

Formulation note/addition:

| | | | | | |
|---|---|---|---|---|---|
| CB grade ID/code: | N660 | 364A | A96B2 | 216I | 172E |
| N2SA (m²/g): | 35.9 | 42.5 | 37.4 | 35.1 | 38.6 |
| STSA (m²/g): | 35.2 | 46.1 | 41.1 | 37.0 | 41.6 |
| OAN (mL/100 g): | 90.3 | 102.7 | 95.4 | 102.1 | 100.4 |
| COAN (mL/100 g): | 71.2 | 92.9 | 89.3 | 94.7 | 93.6 |
| Plasma CB type: | — | A1 | A2 | A3 | A3 |

Additional type info:

| | | | | | |
|---|---|---|---|---|---|
| ts2 (min) [cure | 4.47 | 6.02 | 10.5 | 5.74 | 5.74 |
| rheology at 160° C.]: | | | | | |
| t60 (min) [cure | — | — | — | — | — |
| rheology at 160° C.]: | | | | | |
| t95 (min) [cure | 14.9 | 15.9 | 24.1 | 15.9 | 16.6 |
| rheology at 160° C.]: | | | | | |
| ML₁₊₄ @ 100° C. (MU): | 74.3 | 75.3 | 71.4 | 77.9 | 72.8 |
| Rubber cure time | t95 + 2 | t95 + 2 | t95 + 2 | t95 + 2 | t95 + 2 |
| (min) at 160° C.: | | | | | |
| M100 - 100% modulus | 2.52 | 2.41 | 2.31 | 2.78 | 2.74 |
| @ 23° C. (MPa): | | | | | |
| M300 - 300% modulus | 13.5 | 11.1 | 9.11 | 13.1 | 12.1 |
| @ 23° C. (MPa): | | | | | |
| M300/M100 @ | 5.36 | 4.61 | 4.53 | 4.71 | 4.40 |
| 23° C.: | | | | | |
| Tensile at Break | 14.6 | 14.4 | 18.2 | 16.1 | 16.1 |
| @ 23° C.: | | | | | |
| Elongation at Break | 346 | 405 | 527 | 387 | 422 |
| @ 23° C.: | | | | | |
| Shore A hardness: | 62.7 | 62.2 | 58.0 | 65.5 | 63.0 |
| Dispersion (%) | 88.9 | 98.7 | 99.5 | 99.4 | 99.3 |
| [disperGRADER]: | | | | | |
| Z Value (%) | 77.2 | 95.5 | 97.6 | 96.9 | 92.8 |
| [disperGRADER]: | | | | | |
| Density (g/cm³): | 1.15 | 1.15 | 1.15 | 1.14 | 1.14 |

The ESD04 high drop temperature SBR rubber formulation, with 50 phr carbon black, was used to compare rubber properties for the A2 type of plasma carbon black filler (tire rubber composition examples AQ1 to AQ5), with results shown in Table 69. The colloidal properties of the plasma carbon black samples of Table 69 are in similar ranges as the N772, N660, N650, and N550 reference furnace carbon blacks of Table 71. The examples containing plasma carbon black show comparable rubber performance (within about 10%, plus or minus) to the reference furnace carbon blacks in Table 71.

TABLE 69
Rubber Properties

| Formulation: | Example | | | | |
|---|---|---|---|---|---|
| ESD04 (Variable OAN) | AQ1 | AQ2 | AQ3 | AQ4 | AQ5 |

Formulation note/addition:

| | | | | | |
|---|---|---|---|---|---|
| CB grade ID/code: | P070B | A93F | P005A | ID670 | ID700 |
| N2SA (m²/g): | 30.3 | 33.6 | 30.6 | 33.9 | 30.8 |
| STSA (m²/g): | 33.7 | 36.9 | 32.7 | 39.4 | 34.9 |
| OAN (mL/100 g): | 69.8 | 87.1 | 111.2 | 128.2 | 141.5 |
| COAN (mL/100 g): | 69.8 | 81.4 | 95.6 | 110.6 | 118.4 |
| Plasma CB type: | A2 | A2 | A2 | A2 | A2 |

Additional type info:

| | | | | | |
|---|---|---|---|---|---|
| ts2 (min) [cure rheology at 160° C.]: | 6.56 | 3.64 | 5.51 | 5.62 | 4.84 |
| t60 (min) [cure rheology at 160° C.]: | 10.2 | 6.66 | 9.05 | 8.86 | 8.72 |
| t95 (min) [cure rheology at 160° C.]: | 18.5 | 12.7 | 16.3 | 14.9 | 15.3 |
| ML₁₊₄ @ 100° C. (MU): | 66.2 | 69.0 | 76.5 | 81.8 | 88.6 |
| Rubber cure time (min) at 160° C.: | 21 | 15 | 18 | 17 | 17 |
| M100 - 100% modulus @ 23° C. (MPa): | 1.93 | 2.15 | 2.34 | 2.57 | 3.01 |
| M300 - 300% modulus @ 23° C. (MPa): | 8.94 | 9.50 | 8.89 | 9.47 | 11.5 |
| M300/M100 @ 23° C.: | 4.64 | 4.42 | 3.80 | 3.69 | 3.81 |
| Tensile at Break @ 23° C. (MPa): | 16.5 | 12.2 | 13.4 | 14.1 | 12.8 |
| Elongation at Break @ 23° C. (%): | 499.1 | 396.2 | 483.8 | 465.4 | 367.9 |
| Shore A hardness: | 58.4 | 59.6 | 60.6 | 62.8 | 64.7 |
| Dispersion (%) [disperGRADER]: | 98.6 | 99.1 | 95.9 | 99.6 | 99.4 |
| Z Value (%) [disperGRADER]: | 93.5 | 88.9 | 87.8 | 93.0 | 94.1 |
| Density (g/cm³): | 1.176 | 1.167 | 1.17 | 1.164 | 1.166 |
| ΔG′ (MPa) [RPA; 60° C.; 10 Hz; 1%-20%]: | 0.46 | 0.66 | 0.65 | 1.11 | 1.10 |
| tan δ [RPA; 60° C.; 10 Hz, 5%]: | 0.141 | 0.164 | 0.143 | 0.156 | 0.166 |
| G′ (MPa) [RPA; 60° C.; 10 Hz; 5%]: | 2.31 | 2.58 | 2.55 | 2.89 | 3.06 |
| Electrical Volume Resistivity (Ohm-cm) | 2.72E+10 | 1.33E+11 | 2.54E+10 | 1.12E+03 | 1.45E+04 |
| Thermal Conductivity (W/mK) | 0.480 | 0.488 | 0.540 | 0.573 | 0.576 |
| Rebound (0° C.) (%) | 38.5 | 38.4 | 40.0 | 34.9 | 36.8 |
| Rebound (25° C.) (%) | 54.0 | 53.4 | 53.7 | 47.6 | 50.6 |
| Rebound (100° C.) (%) | 61.9 | 60.9 | 60.5 | 56.1 | 58.7 |

The ESD04 high drop temperature SBR rubber formulation, with 50 phr carbon black, was used to compare rubber properties for the A2 type of plasma carbon black filler (tire rubber composition examples AR1 to AR5), with results shown in Table 70. The colloidal properties of the plasma carbon black samples of Table 70 are in similar ranges as the N772, N660, N650, and N550 reference furnace carbon blacks of Table 71. The examples containing plasma carbon black show comparable rubber performance (within about 10%, plus or minus) to the reference furnace carbon blacks in Table 71.

TABLE 70
Rubber Properties

| Formulation: | Example | | | | |
|---|---|---|---|---|---|
| ESD04 (Variable OAN) | AR1 | AR2 | AR3 | AR4 | AR5 |

Formulation note/addition:

| | | | | | |
|---|---|---|---|---|---|
| CB grade ID/code: | A94B | A94E | ID667 | ID1030 | ID698 |
| N2SA (m²/g): | 38.3 | 40.0 | 35.0 | 40.2 | 31.1 |
| STSA (m²/g): | 42.1 | 45.3 | 38.9 | 45.5 | 35.4 |
| OAN (mL/100 g): | 105.5 | 130.9 | 127.7 | 138.0 | 152.4 |
| COAN (mL/100 g): | 96.9 | 106.5 | 111.2 | 111.7 | 112.6 |
| Plasma CB type: | A2 | A2 | A2 | A2 | A2 |

Additional type info:

| | | | | | |
|---|---|---|---|---|---|
| ts2 (min) [cure | 2.68 | 6.23 | 5.27 | 5.59 | 5.21 |
| rheology at 160° C.]: | | | | | |
| t60 (min) [cure | 5.38 | 10.2 | 8.68 | 9.90 | 8.65 |
| rheology at 160° C.]: | | | | | |
| t95 (min) [cure | 10.6 | 18.2 | 15.8 | 17.7 | 15.0 |
| rheology at 160° C.]: | | | | | |
| ML₁₊₄ @ | 76.3 | 82.7 | 86.3 | 91.9 | 88.9 |
| 100° C. (MU): | | | | | |
| Rubber cure time (min) | 13 | 20 | 18 | 20 | 17 |
| at 160° C.: | | | | | |
| M100 - 100% modulus @ | 2.59 | 2.65 | 2.68 | 3.33 | 2.95 |
| 23° C. (MPa): | | | | | |
| M300 - 300% modulus @ | 12.0 | 11.7 | 10.3 | 14.6 | 11.4 |
| 23° C. (MPa): | | | | | |
| M300/M100 @ 23° C.: | 4.63 | 4.41 | 3.84 | 4.39 | 3.86 |
| Tensile at Break @ | 17.7 | 18.5 | 16.1 | 17.3 | 13.1 |
| 23° C. (MPa): | | | | | |
| Elongation at Break @ | 468 | 501 | 508 | 387 | 379 |
| 23° C. (%): | | | | | |
| Shore A hardness: | 62.1 | 63.5 | 63.2 | 65.1 | 64.1 |
| Dispersion (%) | 98.8 | 98.1 | 99.3 | 99.7 | 98.3 |
| [disperGRADER]: | | | | | |
| Z Value (%) | 94.1 | 94.4 | 89.7 | 97.3 | 94.2 |
| [disperGRADER]: | | | | | |
| Density (g/cm³): | 1.135 | 1.152 | 1.154 | 1.155 | 1.152 |
| ΔG′ (MPa) [RPA; | 0.78 | 1.00 | 1.02 | 1.24 | 1.11 |
| 60° C.; 10 Hz; | | | | | |
| 1%-20%]: | | | | | |
| tan δ [RPA; 60° | 0.138 | 0.148 | 0.160 | 0.155 | 0.167 |
| C.; 10 Hz, 5%]: | | | | | |
| G′ (MPa) [RPA; | 2.782 | 2.91 | 3.03 | 3.38 | 3.19 |
| 60° C.; 10 Hz; 5%]: | | | | | |
| Electrical Volume | 1.80E+10 | 1.47E+06 | 2.24E+04 | 2.54E+04 | 5.51E+05 |
| Resistivity (Ohm-cm) | | | | | |
| Thermal Conductivity (W/mK) | 0.534 | 0.532 | 0.580 | 0.551 | 0.574 |
| Rebound (0° C.) (%) | 38.3 | 36.3 | 36.3 | 35.6 | 37.8 |
| Rebound (25° C.) (%) | 52.0 | 49.5 | 50.0 | 49.8 | 51.0 |
| Rebound (100° C.) (%) | 60.1 | 58.3 | 59.7 | 60.5 | 58.7 |

The ESD04 high drop temperature SBR rubber formulation, with 50 phr carbon black, was used to compare rubber properties for the A2 type of plasma carbon black filler from Tables 69 and 70 (tire rubber composition examples AQ1 to AQ5 and AR1 to AR5) to furnace carbon black N772, N660, N650, and N550 (tire rubber composition examples AS1 to AS4), with the furnace carbon black results shown in Table 71. The colloidal properties of the plasma carbon black samples of Tables 69 and 70 are in similar ranges as the N772, N660, N650, and N550 reference furnace carbon blacks of Table 71. The examples containing plasma carbon black show comparable rubber performance (within about 10%, plus or minus) to the reference furnace carbon blacks in Table 71.

TABLE 71
Rubber Properties

| Formulation: | Example | | | |
|---|---|---|---|---|
| ESD04 (Variable OAN, Furnace) | AS1 | AS2 | AS3 | AS4 |

Formulation note/addition:

| | | | | |
|---|---|---|---|---|
| CB grade ID/code: | N772 | N660 | N650 | N550 |
| N2SA (m²/g): | 26.3 | 35.4 | 36.1 | 39.5 |
| STSA (m²/g): | 25.4 | 33.9 | 34.6 | 38.2 |
| OAN (mL/100 g): | 67.2 | 93.6 | 123.7 | 124 |
| COAN (mL/100 g): | 60.6 | 73.0 | 96.9 | 74.7 |
| Plasma CB type: | | | | |

Additional type info:

| | | | | |
|---|---|---|---|---|
| ts2 (min) [cure | 5.07 | 4.34 | 4.21 | 4.15 |
| rheology at 160° C.]: | | | | |
| t60 (min) [cure | 8.85 | 8.17 | 8.19 | 8.10 |
| rheology at 160° C.]: | | | | |
| t95 (min) [cure | 17.0 | 15.8 | 15.9 | 15.7 |
| rheology at 160° C.]: | | | | |
| ML₁₊₄ @ | 65.5 | 78.3 | 83.6 | 87.5 |
| 100° C. (MU): | | | | |
| Rubber cure time (min) | 19 | 18 | 18 | 18 |
| at 160° C.: | | | | |
| M100 - 100% modulus @ | 1.81 | 2.62 | 3.12 | 3.27 |
| 23° C. (MPa): | | | | |
| M300 - 300% modulus @ | 9.40 | 13.4 | 15.3 | 15.6 |
| 23° C. (MPa): | | | | |
| M300/M100 @ 23° C.: | 5.19 | 5.13 | 4.90 | 4.79 |
| Tensile at Break @ | 11.8 | 16.5 | 20.0 | 18.5 |
| 23° C. (MPa): | | | | |
| Elongation at Break @ | 376 | 387 | 424 | 388 |
| 23° C. (%): | | | | |
| Shore A hardness: | 57.8 | 62.5 | 64.4 | 65.1 |
| Dispersion (%) | 98.0 | 83.8 | 95.3 | 94.1 |
| [disperGRADER]: | | | | |
| Z Value (%) | 91.4 | 70.3 | 84.4 | 82.8 |
| [disperGRADER]: | | | | |
| Density (g/cm³): | 1.162 | 1.163 | 1.164 | 1.166 |
| ΔG′ (MPa) [RPA; | 0.38 | 0.76 | 0.91 | 1.03 |
| 60° C.; 10 Hz; | | | | |
| 1%-20%]: | | | | |
| tan δ [RPA; 60° | 0.130 | 0.152 | 0.150 | 0.168 |
| C.; 10 Hz, 5%]: | | | | |
| G′ (MPa) [RPA; 60° | 2.08 | 2.65 | 2.90 | 3.00 |
| C.; 10 Hz; 5%]: | | | | |
| Electrical Volume | 1.03E+11 | 3.67E+10 | 1.91E+09 | 1.01E+09 |
| Resistivity (Ohm-cm) | | | | |
| Thermal Conductivity (W/mK) | 0.354 | 0.361 | 0.368 | 0.376 |
| Rebound (0° C.) (%) | 39.6 | 37.7 | 35.1 | 33.7 |
| Rebound (25° C.) (%) | 57.0 | 53.8 | 52.0 | 49.3 |
| Rebound (100° C.) (%) | 62.7 | 60.8 | 60.3 | 57.6 |

### Example 7: Silica Passenger Vehicle Tire Tread

In passenger vehicle tires, precipitated silica may be used as a filler in treads, including in combination with sulfur-containing organosilane added as a silica-polymer coupling agent. The organosilane can be bis-(triethoxysilylpropyl)tetrasulfide (TESPT) (also called Si69 manufactured by Evonik), bis-(triethoxysilylpropyl)disulfide (TESPD) (also called Si75 manufactured by Evonik), silanes with mercaptan or blocked mercaptan groups, non-sulfur-containing silanes such as octyltriethoxysilane, any comparable materials or close derivatives thereof, or any combination thereof. Example commercially available silane coupling agents include Si69 which is predominantly composed of TESPT and Si75 which is predominantly composed of TESPD, both manufactured by Evonik. There are other companies that offer grades of TESPT and TESPD which are offered in liquid form or are supplied on a solid carrier like carbon black. Additional sulfur-containing organosilane coupling agents include 3-octanoylthio-1-propyltriethoxy silane and mercapto-functional organosilanes including so-called blocked mercaptan varieties like the Si363 silane produced by Evonik or Momentive's NXT series of silanes.

In addition to various grades of precipitated silica, fumed silica, silica from so-called sustainable sources such as rice husk ash, and other types of silica may be used in tire compounds for various tire components, including in treads. Any silica filler from any source is included herein. Pretreated silicas also may be used, wherein the organosilane is already incorporated with the silica filler by the manufacturer versus being added as separate raw material during rubber mixing.

Silica and carbon black may be used together as fillers in tire treads and in other tire components to achieve a desired balance of tire performance properties. For example, tire tread formulations with silica filler and organosilanes reduce rolling resistance, improve wet traction, and/or provide other tire performance advantages compared to compositions with furnace carbon black filler alone. Plasma carbon black may be incorporated in silica-containing tread rubber formulations, including cases in which precipitated silica is the major filler ingredient and cases in which carbon black is the major filler ingredient. It can be envisaged that silica can be present from 0.5 to 99.5% and also that carbon black can be present from 0.5 to 99.5%. The carbon black that is present can be plasma carbon black or a mixture of both plasma carbon black and furnace carbon black. Additionally, recovered carbon black can be added at up to 30-40%, or any combination of these fillers can be used, as well as exotic additive fillers such as nanotubes and graphene. This is non-limiting in that small amounts of these ingredients can cause large differences in performance. Additionally, small amounts of plasma carbon black can drastically affect the environmental impact of the resultant product. The product will have a smaller CO₂ emission footprint with more plasma carbon black added to the elastomer/carbon black composite.

Passenger vehicle tire tread formulation examples include, but are not limited to, the formulations presented in the tables below. Formulations may include variations of the relative loadings of silica and plasma carbon black and/or other components and parameters.

Ingredients of an example SSBRT01 silica tread compound are listed below.

TABLE 72
Compound Formulation (Silica Tread SSBRT01)

| | | |
|---|---|---|
| Ingredient | PHR | Wt. % |

Pass 1 mixing stage

| | | |
|---|---|---|
| Butadiene Rubber (BR) (grade | 25 | 10.64 |
| Diene 140ND); polymer | | |
| Solution SBR, oil extended (grade | 103.125 | 43.90 |
| Buna VSL 4526-2 HM); polymer | | |
| Carbon Black; filler | 15 | 6.39 |
| Precipitated Silica Mansil | 60 | 25.54 |
| 190G; filler | | |
| TESPT (Si69); silane | 4.8 | 2.04 |
| coupling agent | | |
| TDAE Oil; process oil, | 15 | 6.39 |
| processing aid | | |
| Total | 222.925 | — |

Pass 2 mixing stage

| | | |
|---|---|---|
| First Pass mix | 222.925 | — |
| 6PPD; antiozonant | 2 | 0.85 |
| Zinc Oxide; activator | 2.5 | 1.06 |
| Stearic Acid; activator, | 1.5 | |
| processing aid | | 0.64 |
| Total | 228.925 | — |

Pass 3 mixing stage

| | | |
|---|---|---|
| Second Pass mix | 228.925 | — |
| TBBS; accelerator | 1.7 | 0.72 |
| TBZTD; accelerator | 0.5 | 0.21 |
| DPG; accelerator | 2.5 | 1.06 |
| Sulfur; curative | 1.3 | 0.55 |
| Total | 234.925 | 100.00 |

Summary of Mixing Steps. First Pass: add polymers (natural rubber (NR) and SSBR); mix 60 seconds. Add half silica and the carbon black/plasticizer mix; mix 30 seconds. Add Si69; mix 30 seconds. Add second half silica; mix 30 seconds. Include clean-out step; mix and maintain batch temperature of 140° C. for 120 seconds; mix until drop temperature of 150° C. is reached. Second Pass: add first pass non-productive mix; mix 30 seconds. Add antiozonant, zinc oxide, and stearic acid; mix 30 seconds. Include cleanout step; mix until drop temperature of 150° C. is reached. Third Pass: add second pass non-productive mix; mix 30 seconds. Add TBBS, TBZTD, DPG, and sulfur; mix until drop temperature of 100° C. is reached.

TABLE 73
Material Composition and Mixing - First Pass

| Component | Weigh-Up 1^{st} Pass (g) |
|---|---|
| Diene 140ND | 152.5 |
| Buna VSL 4526-2 HM | 629.1 |
| Mansil 190G | 366.0 |
| Si69 | 29.3 |
| TDAE oil | 91.5 |
| Carbon Black | 91.5 |
| Calculated Total | 1359.9 |

Detailed Mixing Steps. Banbury First Pass: starting temperature 40° C. and starting RPM of 30. Add polymers (Diene 140ND and Buna VSL 4526-2 HM); mix 60 seconds at 120 RPM. While mixing proceeds, manually prepare thickened oil by pouring about half of the carbon black (CB) into the oil. Add half of the Mansil 190G (precipitated silica). Add dry CB (remaining about half). Add TDAE oil (oil thickened with about half of the CB) by pouring down the mixer throat; mix 30 seconds at 60 RPM. Add Si69; mix 30 seconds. Add second half of the Mansil 190G; mix 30 seconds. Clean ram; mix to 140° C. at 150 RPM; maintain 140° C. by mixing at 90 RPM for 120 seconds; mix at 130 RPM until drop temperature of 150° C. is reached. Milling First Pass: set water temperature on mill to 45° F.; mill gap gauge (a.k.a. mill roll gauge) is 1.2 mm to start.

TABLE 74
Material Composition and Mixing - Second Pass

| Component | Weigh-Up 2^{nd} Pass (g) |
|---|---|
| First pass non-productive mix | 1315.3 |
| 6PPD | 11.8 |
| Zinc Oxide | 14.8 |
| Stearic Acid | 8.9 |
| Calculated Total | 1350.8 |

Banbury Second Pass: temperature 40° C. and starting RPM of 30. Add first pass non-productive mix; mix 30 seconds. Add 6PPD, zinc oxide, and stearic acid; mix 30 seconds. Clean ram. Lower ram; mix at 120 RPM until drop temperature of 150° C. is reached. Milling Second Pass: water temperature on mill 45° F.; mill gap gauge starts at 1.2 mm for initial banding.

TABLE 75
Material Composition and Mixing - Third Pass

| Component | Weigh-Up 3^{rd} Pass (g) |
|---|---|
| Second pass non-productive mix | 1327.8 |
| TBBS | 9.9 |
| TBZTD | 2.9 |
| DPG | 14.5 |
| Sulfur | 7.5 |
| Calculated Total | 1362.6 |

Banbury Third Pass: temperature 40° C. and starting RPM of 30. Add second pass non-productive mix; mix 30 seconds at 75 RPM. Add TBBS, TBZTD, DPG, and sulfur; mix 30 seconds at 40 RPM; mix at 90 RPM until drop temperature of 100° C. is reached. Milling Third Pass: water temperature on mill 45° F. Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges; increase mill gap gauge to 1.2 mm for final sheeting out.

Rubber Properties. The SSBRT01 passenger tire tread formulation, with 60 phr silica and 15 phr carbon black (carbon black as the minor filler), was used to compare rubber properties for A1 and A3 types of plasma carbon black filler (tire rubber composition examples AK2 to AK4) in comparison to N772 furnace carbon black (example AK1), with results shown in Table 76. The colloidal properties of the plasma carbon black samples are in a similar range as the N772 reference furnace carbon black. The examples containing plasma carbon black show comparable rubber performance (within about 10%, plus or minus) to the reference furnace carbon black.

TABLE 76
Rubber Properties

| Formulation: | | | | |
|---|---|---|---|---|
| SSBRT01, Silica Passenger Tire Tread | Example | | | |
| (60 phr silica, 15 phr carbon black) | AK1 | AK2 | AK3 | AK4 |

Formulation note/addition:

| | | | | |
|---|---|---|---|---|
| CB grade ID/code: | N772 | P078A | T6699 | P078B |
| N2SA (m²/g): | 26.3 | 27.8 | 29.0 | 28.2 |
| STSA (m²/g): | 25.4 | 30.3 | 32.1 | 30.6 |
| OAN (mL/100 g): | 67.2 | 70.9 | 68.9 | 70.1 |
| COAN (mL/100 g): | 60.6 | 66.7 | 66.4 | 66.5 |
| Plasma CB type: | | A1 | A3 | A3 |

Additional type info:

| | | | | |
|---|---|---|---|---|
| ts2 (min) [cure | 2.75 | 2.93 | 3.22 | 3.01 |
| rheology at 160° C.]: | | | | |
| t60 (min) [cure | 3.95 | 4.16 | 4.56 | 4.29 |
| rheology at 160° C.]: | | | | |
| t95 (min) [cure | 5.76 | 5.98 | 6.64 | 6.14 |
| rheology at 160° C.]: | | | | |
| ML₁₊₄ @ | 65.4 | 63.8 | 63.1 | 65.0 |
| 100° C. (MU): | | | | |
| Rubber cure time (min) | 8 | 8 | 9 | 8 |
| at 160° C.: | | | | |
| M100 - 100% modulus @ | 1.75 | 1.67 | 1.65 | 1.74 |
| 23° C. (MPa): | | | | |
| M300 - 300% modulus @ | 6.91 | 6.56 | 6.15 | 6.55 |
| 23° C. (MPa): | | | | |
| M300/M100 @ 23° C.: | 3.94 | 3.92 | 3.72 | 3.77 |
| Tensile at Break @ | 12.92 | 12.91 | 12.5 | 12.76 |
| 23° C. (MPa): | | | | |
| Elongation at Break @ | 514.0 | 528.9 | 542.3 | 535.6 |
| 23° C. (%): | | | | |
| Shore A hardness: | 54.9 | 54.0 | 54.9 | 55.4 |
| Dispersion (%) | 47.7 | 61.6 | 60.4 | 58.0 |
| [disperGRADER]: | | | | |
| Z Value (%) | 20.2 | 18.2 | 18.2 | 19.0 |
| [disperGRADER]: | | | | |
| Density (g/cm³): | 1.151 | 1.152 | 1.155 | 1.155 |
| ΔG′ (MPa) [RPA; | 0.284 | 0.256 | 0.270 | 0.263 |
| 60° C.; 10 Hz; | | | | |
| 1%-20%]: | | | | |
| tan δ [RPA; 60° | 0.098 | 0.092 | 0.094 | 0.088 |
| C.; 10 Hz, 10%]: | | | | |
| G′ (MPa) [RPA; | 0.83 | 0.82 | 0.82 | 0.84 |
| 60° C.; 10 Hz; 5%]: | | | | |
| Abrasion Loss (mm³): | 127.1 | 130.6 | 119.6 | 119.7 |
| Rebound (0° C.) (%) | 15.6 | 15.6 | 16.8 | 17.1 |
| Rebound (25° C.) (%) | 40.6 | 37.3 | 37.9 | 40.4 |
| Rebound (100° C.) (%) | 61.5 | 58.0 | 58.1 | 59.0 |
| Electrical Volume | 1.41E+11 | 2.32E+10 | 4.58E+10 | 1.87E+10 |
| Resistivity (Ohm-cm): | | | | |
| Thermal Conductivity, k (W/mK) | 0.289 | 0.303 | 0.311 | 0.315 |

The rubber samples containing plasma carbon black show an increase in (enhancement of) thermal conductivity (k) compared to the rubber sample containing furnace carbon black. The increase in k ranged from 5% to 9%, even with carbon black as only a minor filler at 15 phr in the SSBRT01 tread formulation compared to precipitated silica at 60 phr. Even at such a low carbon black loading, a substantial 3.1 to 7.5 times (210% to 650%) improvement in electrical conductivity was observed (where electrical conductivity is the reciprocal of the electrical volume resistivity reported in Table 76). The tread of a tire requires sufficient electrical conductivity to ensure that the vehicle is electrically grounded to the road. Silica is not an electrically conductive filler, so carbon black can be added to a silica-containing tread formulation to provide the necessary electrical conductivity. Electrical conductivity results, including those in Table 76 above, show that plasma carbon black formulations of the present disclosure are improved over furnace carbon black in this function.

Ingredients of an example SSBRT02 silica tread compound are listed below.

TABLE 77
Compound Formulation (Silica Tread SSBRT02)

| | | |
|---|---|---|
| Ingredient | PHR | Wt. % |

Pass 1 mixing stage

| | | |
|---|---|---|
| Butadiene Rubber (BR) (grade | 25 | 10.90 |
| Diene 140ND); polymer | | |
| Solution SBR, oil extended (grade | 103.125 | 44.95 |
| Buna VSL 4526-2 HM); polymer | | |
| Carbon Black; filler | 60 | 26.15 |
| Precipitated Silica Mansil 190G; filler | 15 | 6.54 |
| TESPT (Si69); silane coupling agent | 1.2 | 0.52 |
| TDAE Oil; process oil, processing aid | 15 | 6.54 |
| Total | 219.325 | — |

Pass 2 mixing stage

| | | |
|---|---|---|
| First Pass mix | 219.325 | — |
| 6PPD; antiozonant | 2 | 0.87 |
| Zinc Oxide; activator | 2.5 | 1.09 |
| Stearic Acid; activator, processing aid | 1.5 | 0.65 |
| Total | 225.325 | — |

Pass 3 mixing stage

| | | |
|---|---|---|
| Second Pass mix | 225.325 | — |
| TBBS; accelerator | 1.7 | 0.74 |
| TBZTD; accelerator | 0.5 | 0.22 |
| DPG; accelerator | 0.6 | 0.26 |
| Sulfur; curative | 1.3 | 0.57 |
| Total | 229.425 | 100.00 |

Summary of Mixing Steps. First Pass: Add polymers (natural rubber (NR) and SSBR); mix 60 seconds. Add half silica and carbon black/plasticizer mix; mix 30 seconds. Add Si69; mix 30 seconds. Add second half silica; mix 30 seconds. Include clean-out step. Mix and maintain a batch temperature of 140° C. for 120 seconds; mix until drop temperature of 150° C. is reached. Second Pass: add first pass non-productive mix; mix 30 seconds. Add antiozonant, zinc oxide, and stearic acid; mix 30 seconds. Include cleanout step. Mix until drop temperature of 150° C. is reached. Third Pass: add second pass non-productive mix; mix 30 seconds. Add TBBS, TBZTD, DPG, and sulfur; mix until drop temperature of 100° C. is reached.

TABLE 78
Material Composition and Mixing - First Pass

| Component | Weigh-Up 1^{st} Pass (g) |
|---|---|
| Diene 140ND | 152.5 |
| Buna VSL 4526-2 HM | 629.1 |
| Mansil 190G | 91.5 |
| Si69 | 7.3 |
| TDAE oil | 91.5 |
| Carbon Black | 366.0 |
| Calculated Total | 1337.9 |

Detailed Mixing Steps. Banbury First Pass: starting temperature 40° C. and starting RPM of 30. Add polymers (Diene 140ND and Buna VSL 4526-2 HM); mix at 120 RPM for 60 seconds. While mixing proceeds, manually prepare thickened oil by pouring about 25% of the carbon black (CB) into the oil. Add one half of Mansil 190G; add dry CB (remaining about 75%); add TDAE oil (oil thickened with about 25% of the CB) by pouring down the mixer throat; mix 30 seconds at 60 RPM. Add Si69; mix 30 seconds. Add second half of Mansil 190G; mix 30 seconds. Clean ram; mix at 150 RPM to 140° C.; maintain 140° C. by mixing at 90 RPM for 120 seconds; mix at 130 RPM until drop temperature of 150° C. is reached. Milling First Pass: set water temperature on mill to 45° F.; mill gap gauge (a.k.a. mill roll gauge) is 1.2 mm to start.

TABLE 79
Material Composition and Mixing - Second Pass

| Component | Weigh-Up 2^{nd} Pass (g) |
|---|---|
| First pass non-productive mix | 1316 |
| 6PPD | 12 |
| Zinc Oxide | 15 |
| Stearic Acid | 9 |
| Calculated Total | 1352 |

Banbury Second Pass: temperature 40° C. and starting RPM of 30. Add first pass non-productive mix; mix 30 seconds. Add 6PPD, zinc oxide, and stearic acid; mix 30 seconds. Clean ram. Lower ram; mix at 120 RPM until drop temperature of 150° C. is reached. Milling Second Pass: water temperature on mill 45° F.; mill gap gauge starts at 1.2 mm for initial banding.

TABLE 80
Material Composition and Mixing - Third Pass

| Component | Weigh-Up 3^{rd} Pass (g) |
|---|---|
| Second pass non-productive mix | 1329.4 |
| TBBS | 10 |
| TBZTD | 3 |
| DPG | 3.5 |
| Sulfur | 7.7 |
| Calculated Total | 1353.6 |

Banbury Third Pass: temperature 40° C. and starting RPM of 30. Add second pass non-productive mix; mix 30 seconds at 75 RPM. Add TBBS, TBZTD, DPG, and sulfur; mix 30 seconds at 40 RPM; mix at 90 RPM until drop temperature of 100° C. is reached. Milling Third Pass: water temperature on mill 45° F. Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed the pig roll end-wise back into the mill. Make 10 such pig rolls, alternating starting edges; increase mill gap gauge to 1.2 mm for final sheeting out.

Rubber Properties. The SSBRT02 passenger tire tread formulation, with 15 phr silica and 60 phr carbon black (carbon black as the major filler), was used to compare rubber properties for A1, A2, and A3 types of plasma carbon black filler (tire rubber composition examples AL2 to AL5) in comparison to N772 furnace carbon black (example AL1), with results shown in Table 81. The colloidal properties of the plasma carbon black samples are in a similar range as the N772 reference furnace carbon black. The examples containing plasma carbon black show comparable rubber performance (within about 10%, plus or minus) to the reference furnace carbon black.

A significant and surprising advantage of plasma carbon black over furnace carbon black in the passenger vehicle tire tread formulation SSBRT02 was noted for the property of thermal conductivity (k), which was 32% to 36% higher (enhanced) for plasma carbon black compared to the N772 furnace carbon black. While such N772 type carbon blacks are not commonly used as a major filler in treads, the comparative advantages of plasma carbon black over furnace carbon black (thermal conductivity, sustainability, etc.) should hold for tread grades of carbon black.

TABLE 81
Rubber Properties

| Formulation: | | | | | |
|---|---|---|---|---|---|
| SSBRT02, CB/Silica Passenger Tire Tread | Example | | | | |
| (15 phr silica, 60 phr carbon black) | AL1 | AL2 | AL3 | AL4 | AL5 |

Formulation note/addition:

| | | | | | |
|---|---|---|---|---|---|
| CB grade ID/code: | N772 | P096A | P096B | P096C | P096D |
| N2SA (m²/g): | 26.3 | 28.2 | 26.5 | 26.9 | 25.1 |
| STSA (m²/g): | 25.4 | 30.7 | 28.9 | 29.2 | 27.5 |
| OAN (mL/100 g): | 67.2 | 76.4 | 72.2 | 71.8 | 72.3 |
| COAN (mL/100 g): | 60.6 | 71.1 | 70.3 | 69.9 | 70.7 |
| Plasma CB type: | | A1 | A2 | A3 | A3 |

Additional type info:

| | | | | | |
|---|---|---|---|---|---|
| ts2 (min) [cure | 4.13 | 4.71 | 4.94 | 4.94 | 4.68 |
| rheology at 160° C.]: | | | | | |
| t60 (min) [cure | 5.19 | 5.83 | 6.08 | 6.14 | 5.8 |
| rheology at 160° C.]: | | | | | |
| t95 (min) [cure | 7.51 | 8.59 | 8.83 | 8.66 | 8.24 |
| rheology at 160° C.]: | | | | | |
| ML₁₊₄ @ | 50.52 | 47.9 | 49.7 | 48.9 | 50.3 |
| 100° C. (MU): | | | | | |
| Rubber cure time (min) | 7 | 8 | 8 | 8 | 8 |
| at 160° C.: | | | | | |
| M100 - 100% modulus @ | 1.40 | 1.3 | 1.2 | 1.2 | 1.4 |
| 23° C. (MPa): | | | | | |
| M300 - 300% modulus @ | 5.90 | 5.3 | 4.9 | 4.5 | 5.3 |
| 23° C. (MPa): | | | | | |
| M300/M100 @ 23° C.: | 4.21 | 4.08 | 4.08 | 3.75 | 3.79 |
| Tensile at Break @ | 9.70 | 9.1 | 9.3 | 8.1 | 8.7 |
| 23° C. (MPa): | | | | | |
| Elongation at Break @ | 489.9 | 546.8 | 583.0 | 562.1 | 526.7 |
| 23° C. (%): | | | | | |
| Shore A hardness: | 47.0 | 46.2 | 45.2 | 45.9 | 47.2 |
| Dispersion (%) | 77.3 | 89.5 | 85.8 | 83.9 | 82.5 |
| [disperGRADER]: | | | | | |
| Z Value (%) | 74.2 | 81.6 | 73.5 | 75.3 | 74.8 |
| [disperGRADER]: | | | | | |
| Density (g/cm³): | 1.149 | 1.154 | 1.155 | 1.157 | 1.157 |
| ΔG′ (MPa) [RPA; | 0.187 | 0.211 | 0.232 | 0.199 | 0.206 |
| 60° C.; 10 Hz; 1%-20%]: | | | | | |
| tan δ [RPA; 60° | 0.081 | 0.085 | 0.091 | 0.093 | 0.082 |
| C.; 10 Hz, 10%]: | | | | | |
| G′ (MPa) [RPA; 60° | 1.20 | 1.20 | 1.22 | 1.15 | 1.20 |
| C.; 10 Hz; 5%]: | | | | | |
| Abrasion Loss (mm³): | 267.9 | 230.3 | 266.6 | 302.0 | 232.3 |
| Rebound (0° C.) (%) | 21.7 | 23.8 | 19.2 | 21.8 | 22.4 |
| Rebound (25° C.) (%) | 46.5 | 44.3 | 41.3 | 40.2 | 44.4 |
| Rebound (100° C.) (%) | 63.1 | 66.6 | 58.8 | 58.0 | 62.6 |
| Thermal Conductivity (W/mK) | 0.306 | 0.409 | 0.405 | 0.405 | 0.416 |

### Example 8: Heavy Truck Tire Tread

Ingredients of an example NRBRTOI tread compound are listed below.

TABLE 82
Compound Formulation (Truck Tread NRBRT01)

| | | |
|---|---|---|
| Ingredient | PHR | Wt. % |

Pass 1 mixing stage, master batch (MB)

| | | |
|---|---|---|
| Natural Rubber (NR) | 75 | 41.30 |
| (SMR-L); polymer | | |
| Butadiene Rubber (BR) | 25 | 13.77 |
| (Diene 140ND); polymer | | |
| Carbon Black - Various | 60 | 33.04 |
| Grades & Amounts (base | | |
| is 60 phr); filler | | |
| Zinc Oxide; activator | 5 | 2.75 |
| Stearic Acid; activator, | 2 | 1.10 |
| processing aid | | |
| Naphthenic oil (Plasticizer | 8 | 4.41 |
| In); process oil, | | |
| processing aid | | |
| TMQ; antioxidant | 1.5 | 0.83 |
| 6PPD; antiozonant | 2 | 1.10 |
| and antioxidant | | |
| Total | 178.5 | — |

Pass 2 mixing stage

| | | |
|---|---|---|
| Master Batch (MB) compound | 178.5 | — |
| TBBS; accelerator | 1.5 | 0.83 |
| CTP; PVI pre-vulcanization | 0.1 | 0.06 |
| inhibitor (retarder) | | |
| Sulfur; curative | 1.5 | 0.83 |
| Total | 181.6 | 100.00 |

Summary of Mixing Steps. First Pass: add polymers (natural rubber (NR) and Diene 140ND); mix 60 seconds. Add various grades of carbon black; mix 60 seconds. Add carbon black/plasticizer mix, antioxidant, antiozonant; mix 60 seconds. Add stearic acid and zinc oxide; mix 15 seconds. Include clean-out step. Mix until drop temperature of 150° C. is reached. Second Pass: add first pass mix plus TBBS, CTP, and sulfur; mix until drop temperature of 105° C. is reached.

TABLE 83
Material Composition and Mixing - First Pass

| Component | Weigh-Up 1^{st} Pass (g) |
|---|---|
| NR (SMR-L) | 555 |
| Diene 140ND | 185 |
| Zinc Oxide | 37 |
| Stearic Acid | 14.8 |
| Plasticizer In | 59.2 |
| TMQ | 11.1 |
| 6PPD | 14.8 |
| Carbon Black - | 444 |
| Various Grades | |
| Calculated Total | 1320.9 |

Detailed Mixing Steps. Banbury First Pass: starting temperature 80° C. and starting RPM of 40. Add polymers (SMR-L and Diene 140ND); mix 60 seconds. While mixing proceeds, manually prepare thickened oil by pouring about 25% of the carbon black (CB) into the oil. Add dry CB (remaining about 75%) by pouring down the mixer throat; mix 60 seconds. Add naphthenic oil (oil thickened with about 25% of the N234 CB); add TMQ and 6PPD; mix 60 seconds. Add stearic acid and zinc oxide; mix 15 seconds. Clean ram; mix at 80 RPM until drop temperature of 150° C. is reached. Milling First Pass: set water temperature on mill to 80° F.; mill gap gauge (a.k.a. mill roll gauge) is 1.2 mm to start.

TABLE 84
Material Composition and Mixing - Second Pass

| Component | Weigh-Up 2^{nd} Pass (g) |
|---|---|
| First pass non-productive mix | 1285.2 |
| TBBS | 10.8 |
| CTP | 0.7 |
| Sulfur | 10.8 |
| Calculated Total | 1307.5 |

Banbury Second Pass: temperature 80° C. and starting RPM of 40. Add ingredients: add non-productive mix (first pass compound); add TBBS; CTP; and sulfur. Lower ram; mix at 60 RPM until drop temperature of 105° C. is reached. Milling Second Pass: water temperature on mill 80° F. Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges. Increase mill gap gauge to 1.2 mm for final sheeting out.

Rubber Properties. The NRBRT01 heavy truck tire tread formulation was used to compare rubber properties for A2 and A3 types of plasma carbon black filler. The colloidal properties of the plasma carbon black samples are in a similar range as the N660 reference furnace carbon black. A mixture of plasma carbon black at 15 phr and N234 furnace carbon black at 45 phr was used in tire rubber composition examples AM3 to AMS. Two furnace carbon black reference examples were used: the NRBRT01 formulation with N660 furnace carbon black at 15 phr and N234 furnace carbon black at 45 phr (example AM1); and the NRBRT01 formulation with wholly N234 furnace carbon black at 57 phr (example AM2). The results are shown in Table 85. The examples containing plasma carbon black show comparable rubber performance (within about 10%, plus or minus) to the reference furnace carbon black examples.

TABLE 85
Rubber Properties

| Formulation: | Example | | | | |
|---|---|---|---|---|---|
| NRBRT01 Heavy Truck Tread (N660/N234) | AM1 | AM2 | AM3 | AM4 | AM5 |
| Grade N660 [or plasma CB] loading (phr): | | 15 | 15 | 15 | 15 |
| Furnace N234 loading (phr): | 57 | 45 | 45 | 45 | 45 |
| CB grade ID/code: | N234 | N660 | P071A | P071B | P071D |
| N2SA (m²/g): | 117.7 | 35.4 | 28.7 | 27.8 | 27.4 |
| STSA (m²/g): | 115.4 | 33.9 | 31.2 | 30.3 | 29.8 |
| OAN (mL/100 g): | 118.9 | 93.6 | 97.6 | 94.9 | 95.9 |
| COAN (mL/100 g): | 95.9 | 73.0 | 85.9 | | |
| Plasma CB type: | | | A2 | A3 | A3 |
| Additional type info: | | | | | |
| ts2 (min) [cure rheology at 160° C.]: | 3.04 | 2.91 | 2.74 | 3.21 | 3.09 |
| t60 (min) [cure rheology at 160° C.]: | 4.39 | 4.19 | 4.07 | 4.53 | 4.41 |
| t95 (min) [cure rheology at 160° C.]: | 6.44 | 6.16 | 6.14 | 6.70 | 6.41 |
| ML₁₊₄ @ 100° C. (MU): | 85.6 | 76.1 | 70.1 | 73.7 | 74.3 |
| Rubber cure time (min) at 160° C.: | 8 | 8 | 8 | 9 | 8 |
| M100 - 100% modulus @ 23° C. (MPa): | 2.57 | 2.68 | 2.43 | 2.64 | 2.55 |
| M300 - 300% modulus @ 23° C. (MPa): | 12.86 | 13.4 | 12.2 | 12.6 | 12.2 |
| M300/M100 @ 23° C.: | 5.00 | 4.99 | 5.03 | 4.76 | 4.79 |
| Tensile at Break @ 23° C. (MPa): | 23.4 | 23.2 | 22.9 | 22.9 | 22.7 |
| Elongation at Break @ 23° C. (%): | 510.7 | 507.8 | 526.1 | 518.5 | 531.9 |
| Shore A hardness: | 64.3 | 63.8 | 69.5 | 71.9 | 69.1 |
| Dispersion (%) [disperGRADER]: | 52.6 | 74.1 | 78.9 | 76.4 | 74.7 |
| Z Value (%) [disperGRADER]: | 54.7 | 70.7 | 70.1 | 68.4 | 66.5 |
| Density (g/cm³): | 1.144 | 1.154 | 1.152 | 1.155 | 1.154 |
| ΔG′ (MPa) [RPA; 60° C.; | 3.02 | 2.54 | 2.16 | 2.38 | 2.38 |
| 10 Hz; 1%-20%]: | | | | | |
| tan δ [RPA; 60° C.; | 0.189 | 0.169 | 0.161 | 0.167 | 0.166 |
| 10 Hz, 10%]: | | | | | |
| G′ (MPa) [RPA; 60° | 3.08 | 2.90 | 2.63 | 2.78 | 2.80 |
| C.; 10 Hz; 5%]: | | | | | |
| Rebound (0° C.) (%) | 38.0 | 38.1 | 38.3 | 37.2 | 39.0 |
| Rebound (25° C.) (%) | 45.0 | 46.7 | 46.5 | 46.7 | 47.7 |
| Rebound (100° C.) (%) | 56.3 | 58.2 | 60.2 | 58.4 | 58.9 |
| Thermal Conductivity (W/mK) | 0.329 | 0.324 | 0.338 | 0.341 | 0.336 |

The NRBRT01 heavy truck tire tread formulation was used to compare rubber properties for A2 and A3 types of plasma carbon black filler. The colloidal properties of the plasma carbon black samples are in a similar range as the N660 reference furnace carbon black. A mixture of plasma carbon black at 15 phr and N134 furnace carbon black at 45 phr was used in tire rubber composition examples AN3 to AN5. Two furnace carbon black reference examples were used: the NRBRT01 formulation with N660 furnace carbon black at 15 phr and N134 furnace carbon black at 45 phr (example AN1); and the NRBRT01 formulation with wholly N134 furnace carbon black at 57 phr (example AN2). The results are shown in Table 86. The examples containing plasma carbon black show comparable rubber performance (within about 10%, plus or minus) to the reference furnace carbon black examples.

TABLE 86
Rubber Properties

| Formulation: | Example | | | | |
|---|---|---|---|---|---|
| NRBRT01 Heavy Truck Tread (N660/N134) | AN1 | AN2 | AN3 | AN4 | AN5 |
| Grade N660 [or plasma CB] loading (phr): | | 15 | 15 | 15 | 15 |
| Furnace N134 loading (phr): | 50 | 40 | 40 | 40 | 40 |
| CB grade ID/code: | N134 | N660 | P071A | P071B | P071D |
| N2SA (m²/g): | 145.5 | 35.4 | 28.7 | 27.8 | 27.4 |
| STSA (m²/g): | 141.6 | 33.9 | 31.2 | 30.3 | 29.8 |
| OAN (mL/100 g): | 124.3 | 93.6 | 97.6 | 94.9 | 95.9 |
| COAN (mL/100 g): | 99.0 | 73.0 | 85.9 | | |
| Plasma CB type: | | | A2 | A3 | A3 |
| Additional type info: | | | | | |
| ts2 (min) [cure rheology at 160° C.]: | 2.92 | 2.93 | 2.99 | 3.11 | 3.18 |
| t60 (min) [cure rheology at 160° C.]: | 4.16 | 4.20 | 4.24 | 4.41 | 4.52 |
| t95 (min) [cure rheology at 160° C.]: | 6.01 | 6.14 | 6.15 | 6.38 | 6.53 |
| ML₁₊₄ @ 100° C. (MU): | 81.16 | 76.78 | 73.77 | 71.40 | 71.36 |
| Rubber cure time (min) at 160° C.: | 8 | 8 | 8 | 8 | 9 |
| M100 - 100% modulus @ 23° C. (MPa): | 2.26 | 2.25 | 2.25 | 2.36 | 2.30 |
| M300 - 300% modulus @ 23° C. (MPa): | 11.1 | 11.5 | 10.8 | 11.3 | 11.2 |
| M300/M100 @ 23° C.: | 4.90 | 5.08 | 4.81 | 4.81 | 4.86 |
| Tensile at Break @ 23° C. (MPa): | 24.7 | 22.7 | 22.5 | 22.5 | 21.4 |
| Elongation at Break @ 23° C. (%): | 565.6 | 533.9 | 548.1 | 530.9 | 514.2 |
| Shore A hardness: | 61.9 | 60.7 | 62.1 | 61.9 | 61.3 |
| Dispersion (%) [disperGRADER]: | 26.6 | 66.3 | 66.0 | 69.8 | 75.4 |
| Z Value (%) [disperGRADER]: | 37.6 | 62.3 | 61.3 | 58.4 | 67.3 |
| Density (g/cm³): | 1.126 | 1.140 | 1.143 | 1.141 | 1.143 |
| ΔG′ (MPa) [RPA; 60° C.; | 2.31 | 2.08 | 1.93 | 2.03 | 2.00 |
| 10 Hz; 1%-20%]: | | | | | |
| tan δ [RPA; 60° C.; | 0.160 | 0.157 | 0.149 | 0.147 | 0.147 |
| 10 Hz, 10%]: | | | | | |
| G′ (MPa) [RPA; 60° | 2.71 | 2.58 | 2.53 | 2.63 | 2.60 |
| C.; 10 Hz; 5%]: | | | | | |
| Rebound (0° C.) (%) | 39.0 | 40.0 | 41.7 | 40.0 | 41.9 |
| Rebound (25° C.) (%) | 47.4 | 45.5 | 49.4 | 49.9 | 49.1 |
| Rebound (100° C.) (%) | 57.9 | 58.8 | 60.9 | 61.0 | 59.2 |
| Thermal Conductivity (W/mK) | 0.292 | 0.307 | 0.335 | 0.334 | 0.333 |

The NRBRT01 heavy truck tire tread formulation, with 65 phr of N772 type carbon black, was used to compare rubber properties for A2 and A3 types of plasma carbon black filler (tire rubber composition examples AO2 to AO5) in comparison to N772 furnace carbon black (example AO1), with results shown in Table 87. The colloidal properties of the plasma carbon black samples are in a similar range as the N772 reference furnace carbon black. The examples containing plasma carbon black show comparable rubber performance (within about 10%, plus or minus) to the reference furnace carbon black example.

A significant and surprising advantage of plasma carbon black over furnace carbon black in the NRBRT01 heavy truck tire tread formulation, with 65 phr of carbon black, was noted for the property of thermal conductivity (k), which was 35% to 44% higher (enhanced) for plasma carbon black tire rubber compositions compared to the N772 reference furnace carbon black composition. While N772 is not commonly used in tire tread compositions, fillers with colloidal properties similar to typical tread grades of furnace carbon black can be produced with the thermal plasma process, as shown in the next truck tire tread formulation example (Table 88).

TABLE 87
Rubber Properties

| Formulation: | Example | | | | |
|---|---|---|---|---|---|
| NRBRT01 Heavy Truck Tire Tread (65 phr CB) | AO1 | AO2 | AO3 | AO4 | AO5 |
| Formulation note/addition: | | | | | |
| CB grade ID/code: | N772 | P096B | P096C | P096D | P096E |
| N2SA (m²/g): | 26.3 | 26.5 | 26.9 | 25.1 | 25.2 |
| STSA (m²/g): | 25.4 | 28.9 | 29.2 | 27.5 | 27.3 |
| OAN (mL/100 g): | 67.2 | 72.2 | 71.8 | 72.3 | 74.5 |
| COAN (mL/100 g): | 60.6 | 70.3 | 69.9 | 70.7 | 69.9 |
| Plasma CB type: | | A2 | A3 | A3 | A3 |
| Additional type info: | | | | | |
| ts2 (min) [cure rheology at 160° C.]: | 2.90 | 3.45 | 3.25 | 3.05 | 2.93 |
| t60 (min) [cure rheology at 160° C.]: | 4.11 | 4.49 | 4.30 | 4.21 | 4.11 |
| t95 (min) [cure rheology at 160° C.]: | 5.83 | 6.80 | 6.78 | 6.28 | 6.22 |
| ML₁₊₄ @ 100° C. (MU): | 53.0 | 52.3 | 52.9 | 54.3 | 53.4 |
| Rubber cure time (min) at 160° C.: | 8 | 9 | 9 | 8 | 8 |
| M100 - 100% modulus @ 23° C. (MPa): | 2.31 | 1.84 | 2.26 | 2.46 | 2.32 |
| M300 - 300% modulus @ 23° C. (MPa): | 11.6 | 8.56 | 10.1 | 10.7 | 10.2 |
| M300/M100 @ 23° C.: | 5.02 | 4.65 | 4.47 | 4.34 | 4.40 |
| Tensile at Break @ 23° C. (MPa): | 17.9 | 15.0 | 17.0 | 16.7 | 15.9 |
| Elongation at Break @ 23° C. (%): | 478.9 | 509.6 | 512.3 | 467.8 | 473.8 |
| Shore A hardness: | 57.5 | 57.1 | 57.5 | 59.8 | 58.2 |
| Dispersion (%) [disperGRADER]: | 96.8 | 99.6 | 99.4 | 99.6 | 99.2 |
| Z Value (%) [disperGRADER]: | 91.6 | 96.8 | 95.3 | 93.9 | 94.4 |
| Density (g/cm³): | 1.167 | 1.175 | 1.176 | 1.177 | 1.179 |
| ΔG′ (MPa) [RPA; 60° C.; | 0.50 | 0.57 | 0.61 | 0.73 | 0.76 |
| 10 Hz; 1%-20%]: | | | | | |
| tan δ [RPA; 60° C.; | 0.071 | 0.072 | 0.071 | 0.072 | 0.075 |
| 10 Hz, 10%]: | | | | | |
| G′ (MPa) [RPA; 60° | 1.96 | 2.04 | 2.09 | 2.28 | 2.26 |
| C.; 10 Hz; 5%]: | | | | | |
| Abrasion Loss (mm³): | 79.5 | 83.8 | 84.5 | 90.4 | 100.4 |
| Rebound (0° C.) (%) | 51.7 | 48.2 | 47.8 | 45.4 | 45.8 |
| Rebound (25° C.) (%) | 61.6 | 56.6 | 59.3 | 55.8 | 54.9 |
| Rebound (100° C.) (%) | 67.5 | 64.9 | 65.8 | 62.1 | 59.9 |
| Thermal Conductivity (W/mK) | 0.317 | 0.440 | 0.453 | 0.427 | 0.455 |

The NRBRT01 passenger tire tread formulation, with 50 phr of N234 type carbon black, was used to compare rubber properties for the A2 type of plasma carbon black filler (tire rubber composition example AP2) in comparison to N234 furnace carbon black (example AP1), with results shown in Table 88. The colloidal properties of the plasma carbon black sample are in a similar range as the N234 reference furnace carbon black. The example containing plasma carbon black shows comparable rubber performance (within about 10%, plus or minus) to the reference furnace carbon black.

A significant and surprising advantage of plasma carbon black filler over furnace carbon black in the NRBRT01 heavy truck tire tread formulation, with 50 phr of carbon black, was noted for the property of thermal conductivity (k), which was remarkably 62% higher (enhanced) for the plasma carbon black tire rubber composition compared to the N234 reference furnace carbon black. M234 is a thermal plasma carbon black.

TABLE 88
Rubber Properties

| Formulation: | Example | |
|---|---|---|
| NRBRT01 Heavy Truck Tire Tread (50 phr CB) | AP1 | AP2 |
| Formulation note/addition: | | |
| CB grade ID/code: | N234 | M234 |
| N2SA (m²/g): | 117.7 | 101.7 |
| STSA (m²/g): | 115.4 | 111.4 |
| OAN (mL/100 g): | 118.9 | 167.2 |
| COAN (mL/100 g): | 95.9 | 137.7 |
| Plasma CB type: | | A2 |
| Additional type info: | | |
| ts2 (min) [cure rheology at 160° C.]: | 2.60 | 3.11 |
| t60 (min) [cure rheology at 160° C.]: | 3.86 | 4.80 |
| t95 (min) [cure rheology at 160° C.]: | 5.57 | 6.82 |
| ML₁₊₄ @ 100° C. (MU): | 73.2 | 69.6 |
| Rubber cure time (min) at 160° C.: | 8 | 9 |
| M100 - 100% modulus @ 23° C. (MPa): | 2.20 | 2.61 |
| M300 - 300% modulus @ 23° C. (MPa): | 11.0 | 10.7 |
| M300/M100 @ 23° C.: | 5.0 | 4.10 |
| Tensile at Break @ 23° C. (MPa): | 23.9 | 17.7 |
| Elongation at Break @ 23° C. (%): | 563.1 | 483.2 |
| Shore A hardness: | 62.4 | 63.4 |
| Dispersion (%) [disperGRADER]: | 81.9 | 99.3 |
| Z Value (%) [disperGRADER]: | 78.1 | 91.6 |
| Density (g/cm³): | 1.124 | 1.114 |
| ΔG′ (MPa) [RPA; 60° C.; | 1.97 | 1.84 |
| 10 Hz; 1%-20%]: | | |
| tan δ [RPA; 60° C.; | 0.162 | 0.136 |
| 10 Hz, 10%]: | | |
| G′ (MPa) [RPA; 60° | 2.65 | 2.85 |
| C.; 10 Hz; 5%]: | | |
| Abrasion Loss (mm³): | 58.8 | 73.5 |
| Rebound (0° C.) (%) | 40.0 | 42.3 |
| Rebound (25° C.) (%) | 48.7 | 52.5 |
| Rebound (100° C.) (%) | 57.2 | 59.9 |
| Thermal Conductivity (W/mK) | 0.294 | 0.475 |

### Example 9: Wire Skim Compounds

The forthcoming examples demonstrate the utility of plasma carbon black as a filler in tire rubber compositions for use as wire skim (a.k.a. wire coat) compounds in belt skim and bead filler components of a tire. These tire rubber compositions may be used to coat reinforcing steel cords that are typically coated with brass. Processes for incorporating the uncured rubber compounds onto the steel cords may include, but are not limited to, calendering, pultrusion, and other wire coating operations. The specific rubber formulations shown are intended to be representative and not limiting. In addition to formulations wherein the only elastomer is NR, other elastomeric polymers may be used as minor polymer components, including various types of R, BR, SBR, and epoxidized NR. Various furnace carbon black grades used include N326, N330, N550, and others. Precipitated silica can be used as filler, with or without known varieties of sulfur-containing organosilanes and/or other coupling agent. Furnace carbon black, clays, graphenes, precipitated silica, other inorganic particulate fillers, recovered carbon filler from pyrolysis of end-of-life tires, and the like can be used in various combination with the presently disclosed plasma carbon black filler at various loading levels.

To promote adhesion between the steel cords and the wire skim rubber composition, various rubber ingredients/additives may be included in the rubber formulation. Wire coating formulation can include reactive resins (aka methylene acceptors) such as resorcinol, resorcinol-formaldehyde, phenol-formaldehyde, cardanol, and related materials that are typically used in combination with methylene donors such as hexamethoxymethylmelamine (HMMM) or hexamethylenetetramine (HMT). The wire skim formulation may include metal adhesion promoters that can include cobalt salts of organic acids, hydroxybenzoic acid, resorcinol, complexes of organo cobalt and boron, and mixtures thereof. Cobalt naphthenate and cobalt boro-neodecanoate are specific examples. Precipitated silica can be included, for example to improve rubber-metal adhesion in some cases. The aforementioned ingredients are intended as representative but not limiting examples. Various steel wire pre-treatments and coatings and various ingredients added to rubber formulations to promote bonding between steel cords and rubber are discussed and cited in W. J. Van Ooij, P. B. Harakuni, and G. Buytaert, Rubber Chem. Technol. 82, 315-339 (2009), which is herein incorporated by reference. Additional materials employed in wire coat formulations for belt skim (a.k.a. belt coat) and bead filler components of tires are detailed in U.S. Pub. Nos. 2019/0232718 and 2007/0010606 and in U.S. Pat. Nos. 9,023,928, 4,258,770, 5,126,501, and 4,594,381. The steel cords also may be coated with an adhesive composition such as a resorcinol-formaldehyde-latex (RFL) coating.

Other formulation adjustments may be made for assorted performance and processability reasons. In particular, there are various options for amounts and types of cure/vulcanization ingredients and for antidegradants such as antioxidants, antiozonants, and the like. Variations in types and amounts of processing aids such as oils, tackifying resins, and the like may be used. The embodiments set forth herein, related to use of plasma carbon black filler in tire rubber compositions used for wire skim formulations encompass reasonable wire coat formulation variations.

Example rubber formulations suitable for wire skim compounds for bead filler and belt skim components for tires include those given on pages 78-80 and 110 of The Rubber Formulary by P. A. Ciullo and N. Hewitt (Noyes Publications, Norwich, NY, USA, 1999), which is herein incorporated by reference. Several representative formulations are also tabulated in J. S. Dick, “Utilizing the RPA Variable Temperature Analysis for More Effective Tire Quality Assurance,” conference paper/proceeding, International Tire Exhibition & Conference (ITEC), Akron, Ohio, Sep. 16-18, 2008.

The examples below of tire wire skim compositions containing plasma carbon black filler show comparable performance (within about 10%, plus or minus) in standard rubber testing to reference carbon blacks from the furnace process. The production of furnace carbon black generates multiple tons of CO₂ for every ton of carbon black produced, whereas the production of plasma carbon black generates <20% of that CO₂, so these examples show that plasma carbon black fillers in tire wire skim compositions for belt skim and bead filler components can have a significant positive impact on sustainability of tires without substantially compromising rubber properties.

It was surprisingly discovered for tire wire skim composition examples that plasma carbon black gives substantially higher (enhanced) thermal conductivity relative to comparable furnace carbon black filler when compounded into the rubber formulations, with the projected benefits to tire manufacturing and tire performance discussed earlier.

Ingredients of an example NRK01 wire skim compound are listed below.

TABLE 89
Compound Formulation (Wire Skim NRK01)

| | | |
|---|---|---|
| Ingredient | PHR | Wt. % |

Pass 1, Master Batch (MB)

| | | |
|---|---|---|
| NR (SMR-L); polymer | 100 | 53.50 |
| Carbon Black; filler | 55 | 29.43 |
| Naphthenic oil (Plasticizer In); | 6 | 3.21 |
| process oil, processing aid | | |
| Resorcinol; methylene | 2.63 | 1.41 |
| acceptor resin | | |
| Zinc Oxide; activator | 7 | 3.75 |
| Stearic Acid; activator, | 2.5 | 1.34 |
| processing aid | | |
| TMQ; antioxidant | 1.5 | 0.80 |
| 6PPD; antiozonant and antioxidant | 2.5 | 1.34 |
| Total | 177.13 | — |

Pass 2

| | | |
|---|---|---|
| MB mix | 177.13 | — |
| HMMM; methylene donor | 4.72 | 2.53 |
| TBBS; accelerator | 0.7 | 0.37 |
| Crystex CurePro (insoluble | 4.36 | 2.33 |
| sulfur); curative | | |
| Total | 186.91 | 100.00 |

Summary of Mixing Steps. First Pass: add polymer (natural rubber (NR)); mix 60 seconds. Add half carbon black; mix 60 seconds. Add second half carbon black and plasticizer mix, antioxidant, antiozonant, and resorcinol; mix 60 seconds. Add stearic acid and zinc oxide; mix 20 seconds. Include clean-out step. Mix until drop temperature of 150° C. is reached. Second Pass: add first pass mix plus HMMM, TBBS, and Crystex CurePro; mix until drop temperature of 105° C. is reached.

TABLE 90
Material Composition and Mixing - First Pass

| Component | Weigh-Up 1^{st} Pass (g) |
|---|---|
| NR (SMR-L) | 760 |
| Plasticizer In | 45.6 |
| Resorcinol | 19.95 |
| Zinc Oxide | 53.2 |
| Stearic Acid | 19.0 |
| TMQ | 11.4 |
| 6PPD | 19.0 |
| Carbon Black | 418 |
| Calculated Total | 1346.15 |

Detailed Mixing Steps. Banbury First Pass: starting temperature 80° C. and starting RPM of 40. Add polymer (SMR-L); mix 60 seconds. While mixing proceeds, manually prepare thickened oil by pouring about 25% of the carbon black (CB) into the oil. Add dry CB (remaining about 75%) by pouring down the mixer throat; mix 60 seconds. Add naphthenic oil (oil thickened with about 25% of the CB); add antioxidant DQ and resorcinol; mix 60 seconds. Add stearic acid and zinc oxide; mix 20 seconds. Clean ram; mix at 100 RPM until drop temperature of 150° C. is reached. Milling First Pass: set water temperature on mill to 140° F.; mill gap gauge (a.k.a. mill roll gauge) is 1.2 mm to start.

TABLE 91
Material Composition and Mixing - Second Pass

| Component | Weigh-Up 2^{nd} Pass (g) |
|---|---|
| First pass non-productive mix | 1275.3 g |
| HMMM | 34.0 g |
| TBBS | 5.00 g |
| Crystex CurePro | 31.4 g |
| Calculated Total | 1345.7 g |

Banbury Second Pass: temperature 80° C. and starting RPM of 40. Add ingredients: add non-productive mix (first pass compound); add HMMM, TBBS, Crystex CurePro. Lower ram; mix at 60 RPM until drop temperature of 105° C. is reached. Milling Second Pass: water temperature on mill 140° F. Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges. Increase mill gap gauge to 1.2 mm for final sheeting out.

Rubber Properties. The NRK01 wire skim (a.k.a. wire coat) formulation was used to compare rubber properties for the A2 type of plasma carbon black filler (tire rubber composition example AV2) in comparison to N326 furnace carbon black (example AV1), with results shown in Table 92. The colloidal properties of the plasma carbon black sample are in a similar range as the N326 reference furnace carbon black (a common grade of furnace carbon black employed in steel belt skim and bead filler compounds). The example containing plasma carbon black filler shows comparable rubber performance (within about 10%, plus or minus) to the reference furnace carbon black, including the same cured adhesion, which predicts similar bonding performance to brass-coated steel cords.

A significant and surprising advantage of plasma carbon black over furnace carbon black in the tire wire skim formulation NRK01 is noted for the property of thermal conductivity (k), which was 27% higher (enhanced) for the plasma carbon black tire rubber composition compared to the N326 reference furnace carbon black. M326 is a thermal plasma carbon black sample.

TABLE 92
Rubber Properties

| | |
|---|---|
| Formulation: | Example |

| NRK01 Wire Skim | AV1 | AV2 |
|---|---|---|
| Formulation note/addition: | | |
| CB grade ID/code: | N326 | M326 |
| N2SA (m²/g): | 75.2 | 87.8 |
| STSA (m²/g): | 75.3 | 92.1 |
| OAN (mL/100 g): | 75.6 | 83.9 |
| COAN (mL/100 g): | 70.6 | 81.1 |
| Plasma CB type: | | A2 |
| Additional type info: | | |
| ts2 (min) [cure rheology at 150° C.]: | 2.22 | 2.55 |
| t60 (min) [cure rheology at 150° C.]: | 7.22 | 7.23 |
| t95 (min) [cure rheology at 150° C.]: | 19.2 | 18.4 |
| ML₁₊₄ @ 100° C. (MU): | 56.59 | 61.11 |
| Rubber cure time (min) at 150° C.: | 18 | 18 |
| M100 - 100% modulus @ 23° C. (MPa): | 3.04 | 2.63 |
| M300 - 300% modulus @ 23° C. (MPa): | 12.98 | 10.35 |
| M300/M100 @ 23° C.: | 4.26 | 3.94 |
| Tensile at Break @ 23° C. (MPa): | 22.03 | 20.47 |
| Elongation at Break @ 23° C. (%): | 489.5 | 532.4 |
| Shore A hardness: | 75.7 | 65.30 |
| Dispersion (%) [disperGRADER]: | 81.8 | 97.1 |
| Z Value (%) [disperGRADER]: | 76.1 | 90.5 |
| Density (g/cm³): | 1.158 | 1.138 |
| ΔG′ (MPa) [RPA; 60° C.; | 2.76 | 2.82 |
| 10 Hz; 1%-20%]: | | |
| tan δ [RPA; 60° C.; | 0.189 | 0.183 |
| 10 Hz, 10%]: | | |
| G′ (MPa) [RPA; 60° | 3.23 | 3.10 |
| C.; 10 Hz; 5%]: | | |
| Rebound (0° C.) (%) | 31.0 | 32.1 |
| Rebound (25° C.) (%) | 40.6 | 43.9 |
| Rebound (100° C.) (%) | 52.2 | 56.0 |
| Thermal Conductivity (W/mK) | 0.305 | 0.387 |
| Adhesion to Brass | 100 | 100 |

The NRK01 wire skim formulation, modified to use 65 phr of carbon black versus the original 55 phr, was used to compare rubber properties for A1, A2, and A3 types of plasma carbon black filler (tire rubber composition examples AW2 to AW5) in comparison to N772 furnace carbon black (example AW1), with results shown in Table 93. The higher carbon black loading of 65 phr was used to account for relative reinforcement differences between N772 and N326, as the NRK01 formulation originally used N326. The colloidal properties of the plasma carbon black samples are in a similar range as the N772 reference furnace carbon black. The examples containing plasma carbon black show comparable rubber performance (within about 10%, plus or minus) to the reference furnace carbon black, including the same cured adhesion, which predicts similar bonding performance to brass-coated steel cords.

A significant and surprising advantage of plasma carbon black over furnace carbon black in the tire wire skim formulation NRK01 is noted for the property of thermal conductivity (k), which was 37% to 42% higher (enhanced) for the plasma carbon black tire rubber compositions compared to the N772 reference furnace carbon black.

TABLE 93
Rubber Properties

| Formulation: | Example | | | | |
|---|---|---|---|---|---|
| NRK01 Wire Skim | AW1 | AW2 | AW3 | AW4 | AW5 |
| Formulation note/addition: | | | | | |
| CB grade ID/code: | N772 | P096A | P096B | P096C | P096D |
| N2SA (m²/g): | 26.3 | 28.2 | 26.5 | 26.9 | 25.1 |
| STSA (m²/g): | 25.4 | 30.7 | 28.9 | 29.2 | 27.5 |
| OAN (mL/100 g): | 67.2 | 76.4 | 72.2 | 71.8 | 72.3 |
| COAN (mL/100 g): | 60.6 | 71.1 | 70.3 | 69.9 | 70.7 |
| Plasma CB type: | | A1 | A2 | A3 | A3 |
| Additional type info: | | | | | |
| ts2 (min) [cure rheology at 150° C.]: | 2.51 | 2.58 | 2.96 | 2.79 | 2.29 |
| t60 (min) [cure rheology at 150° C.]: | 5.97 | 6.08 | 6.57 | 6.22 | 5.62 |
| t95 (min) [cure rheology at 150° C.]: | 13.73 | 14.03 | 14.82 | 14.12 | 13.34 |
| ML₁₊₄ @ 100° C. (MU): | 54.9 | 54.3 | 53.8 | 52.8 | 56.0 |
| Rubber cure time (min) at 150° C.: | 18 | 18 | 18 | 18 | 18 |
| M100 - 100% modulus @ 23° C. (MPa): | 3.4 | 3.4 | 3.1 | 3.1 | 3.4 |
| M300 - 300% modulus @ 23° C. (MPa): | 15.3 | 13.6 | 13.6 | 13.5 | 14.0 |
| M300/M100 @ 23° C.: | 4.54 | 4.04 | 4.37 | 4.33 | 4.17 |
| Tensile at Break @ 23° C. (MPa): | 18.1 | 17.2 | 17.7 | 18.7 | 15.9 |
| Elongation at Break @ 23° C. (%): | 382.2 | 407.6 | 408.3 | 435.8 | 368.3 |
| Shore A hardness: | 63.0 | 62.7 | 61.3 | 60.8 | 61.7 |
| Dispersion (%) [disperGRADER]: | 98.2 | 97.8 | 98.9 | 99.2 | 98.9 |
| Z Value (%) [disperGRADER]: | 92.9 | 91.4 | 93.3 | 93.2 | 93.3 |
| Density (g/cm³): | 1.178 | 1.196 | 1.189 | 1.189 | 1.190 |
| ΔG′ (MPa) [RPA; 60° C.; | 1.10 | 1.14 | 1.06 | 1.02 | 1.18 |
| 10 Hz; 1%-20%]: | | | | | |
| tan δ [RPA; 60° C.; | 0.094 | 0.094 | 0.091 | 0.089 | 0.093 |
| 10 Hz, 10%]: | | | | | |
| G′ (MPa) [RPA; 60° | 2.48 | 2.51 | 2.42 | 2.42 | 2.62 |
| C.; 10 Hz; 5%]: | | | | | |
| Thermal Conductivity (W/mK) | 0.332 | 0.470 | 0.464 | 0.456 | 0.465 |
| Cured Adhesion to Brass | 100 | 100 | 100 | 100 | 105 |

The NRK01 wire skim formulation was used to compare rubber properties for A2 and A3 types of plasma carbon black filler. The colloidal properties of the plasma carbon black samples are in a similar range as the N772 reference furnace carbon black. A mixture of plasma carbon black at 27.5 phr and N234 furnace carbon black at 27.5 phr (50/50 mixture of plasma CB and furnace CB) was used in tire rubber composition examples AX3 to AX5. Two furnace carbon black reference examples were used: the NRK01 formulation with N772 furnace carbon black at 27.5 phr and N234 furnace carbon black at 27.5 phr to form a 50/50 mixture in the formulation (example AX1); and the NRK01 formulation with N326 furnace carbon black at 55 phr (example AX2). The results are shown in Table 94. The examples containing plasma carbon black filler show comparable rubber performance (within about 10%, plus or minus) to the reference furnace carbon black, including the same cured adhesion, which predicts similar bonding performance to brass-coated steel cords.

A significant and surprising advantage of plasma carbon black over furnace carbon black in the tire wire skim formulation NRK01 is noted for the property of thermal conductivity (k). Compared to the N772/N234 reference (example AX1), the thermal conductivity was 15% to 22% higher (enhanced) for the plasma carbon black examples. Compared to the N326 reference (example AX2), the thermal conductivity was 11% to 18% higher (enhanced) for the plasma carbon black examples. Even when diluted 50% in a mixture with N234 furnace carbon black, the plasma carbon black still imparted significant increases in the thermal conductivity (k) of the tire rubber compositions relative to the wholly furnace carbon black reference examples.

TABLE 94
Rubber Properties

| Formulation: | Example | | | | |
|---|---|---|---|---|---|
| NRK01 Wire Skim | AX1 | AX2 | AX3 | AX4 | AX5 |
| Grade N772 [or Plasma CB] loading (phr) | 27.5 | | 27.5 | 27.5 | 27.5 |
| Furnace N234 phr loading (phr) | 27.5 | | 27.5 | 27.5 | 27.5 |
| Furnace N326 phr loading (phr) | | 55 | | | |
| CB grade ID/code: | N772 | N326 | P096B | P096C | P096D |
| N2SA (m²/g): | 26.3 | 75.2 | 26.5 | 26.9 | 25.1 |
| STSA (m²/g): | 25.4 | 75.3 | 28.9 | 29.2 | 27.5 |
| OAN (mL/100 g): | 67.2 | 75.6 | 72.2 | 71.8 | 72.3 |
| COAN (mL/100 g): | 60.6 | 70.6 | 70.3 | 69.9 | 70.7 |
| Plasma CB type: | | | A2 | A3 | A3 |
| Additional type info: | | | | | |
| ts2 (min) [cure rheology at 150° C.]: | 2.57 | 2.47 | 2.58 | 2.58 | 2.50 |
| t60 (min) [cure rheology at 150° C.]: | 6.86 | 7.23 | 6.70 | 6.92 | 6.71 |
| t95 (min) [cure rheology at 150° C.]: | 17.1 | 18.26 | 16.6 | 17.1 | 16.5 |
| ML₁₊₄ @ 100° C. (MU): | 62.9 | 60.7 | 62.6 | 62.8 | 64.1 |
| Rubber cure time (min) at 150° C.: | 18 | 18 | 18 | 18 | 18 |
| M100 - 100% modulus @ 23° C. (MPa): | 3.2 | 3.0 | 3.0 | 3.0 | 3.2 |
| M300 - 300% modulus @ 23° C. (MPa): | 14.7 | 13.4 | 13.6 | 13.5 | 14.0 |
| M300/M100 @ 23° C.: | 4.53 | 4.39 | 4.54 | 4.44 | 4.36 |
| Tensile at Break @ 23° C. (MPa): | 19.5 | 23.3 | 20.9 | 19.2 | 19.9 |
| Elongation at Break @ 23° C. (%): | 418.8 | 512.7 | 467.1 | 442.3 | 441.3 |
| Shore A hardness: | 66.0 | 68.8 | 65.5 | 65.7 | 64.9 |
| Dispersion (%) [disperGRADER]: | 95.7 | 88.1 | 97.6 | 96.9 | 96.4 |
| Z Value (%) [disperGRADER]: | 89.3 | 79.0 | 90.2 | 89.4 | 88.9 |
| Density (g/cm³): | 1.154 | 1.156 | 1.155 | 1.159 | 1.157 |
| ΔG′ (MPa) [RPA; 60° C.; | 2.24 | 2.91 | 2.03 | 2.09 | 2.08 |
| 10 Hz; 1%-20%]: | | | | | |
| tan δ [RPA; 60° C.; | 0.151 | 0.174 | 0.148 | 0.149 | 0.146 |
| 10 Hz, 10%]: | | | | | |
| G′ (MPa) [RPA; 60° | 3.21 | 3.45 | 2.99 | 3.02 | 3.07 |
| C.; 10 Hz; 5%]: | | | | | |
| Thermal Conductivity (W/mK) | 0.291 | 0.301 | 0.355 | 0.349 | 0.334 |
| Cured Adhesion to Brass | 100 | 95 | 105 | 95 | 100 |

Ingredients of an example NRK03 wire skim compound are listed below.

TABLE 95
Compound Formulation (Wire Skim NRK03)

| | | |
|---|---|---|
| Ingredient | PHR | Wt. % |

Pass 1, master batch (MB)

| | | |
|---|---|---|
| NR (SMR-L); polymer | 100 | 50.65 |
| Carbon Black; filler | 55 | 27.86 |
| Naphthenic oil (Plasticizer In); | 6 | 3.04 |
| process oil, processing aid | | |
| Resorcinol; methylene | 2.63 | 1.33 |
| acceptor resin | | |
| Cobalt Naphthenate; adhesion | 0.23 to 1 | 0.51 |
| promoter, bonding agent | (base is 1 phr) | |
| Zinc Oxide; activator | 7 | 3.55 |
| Stearic Acid; activator, | 2.5 | 1.27 |
| processing aid | | |
| TMQ; antioxidant | 1.5 | 0.76 |
| 6PPD; antiozonant and antioxidant | 2.5 | 1.27 |
| Total | 188.125 | — |

Pass 2

| | | |
|---|---|---|
| MB mix | 188.125 | — |
| HMMM; methylene donor | 4.25 | 2.15 |
| TBBS; accelerator | 0.7 | 0.35 |
| Crystex CurePro (insoluble | 4.36 | 2.21 |
| sulfur); curative | | |
| Total | 197.435 | 100.00 |

Summary of Mixing Steps. First Pass: add polymer (natural rubber (NR)); mix 60 seconds. Add half carbon black and cobalt naphthenate; mix 60 seconds. Add second half carbon black/plasticizer mix, antioxidant, antiozonant, and resorcinol; mix 60 seconds. Add stearic acid and zinc oxide; mix 20 seconds. Include clean-out step. Mix until drop temperature of 150° C. is reached. Second Pass: add first pass mix plus HMMM, TBBS, and Crystex CurePro; mix until drop temperature of 105° C. is reached.

TABLE 96
Material Composition and Mixing - First Pass

| Component | Weigh-Up 1^{st} Pass (g) |
|---|---|
| NR (SMR-L) | 760 |
| Plasticizer In | 45.6 |
| Resorcinol | 19.95 |
| Cobalt Naphthenate | 7.6 (or 1.75) |
| Zinc Oxide | 53.2 |
| Stearic Acid | 19.0 |
| TMQ | 11.4 |
| 6PPD | 19.0 |
| Carbon Black | 418 |
| Calculated Total | 1353.75 (or 1347.9) |

Detailed Mixing Steps. Banbury First Pass: starting temperature 80° C. and starting RPM of 40. Add polymer (SMR-L); mix 60 seconds. While mixing proceeds, manually prepare thickened oil by pouring about 25% of the carbon black (CB) into the oil. Add dry CB (remaining about 75%) and cobalt naphthenate by pouring down the mixer throat; mix 60 seconds. Add naphthenic oil (oil thickened with about 25% of the CB); add antioxidant DQ and resorcinol; mix 60 seconds. Add stearic acid and zinc oxide; mix 20 seconds. Clean ram; mix at 100 RPM until drop temperature of 150° C. is reached. Milling First Pass: set water temperature on mill to 140° F.; mill gap gauge (a.k.a. mill roll gauge) is 1.2 mm to start.

TABLE 97
Material Composition and Mixing - Second Pass

| Component | Weigh-Up 2^{nd} Pass (g) |
|---|---|
| First pass non-productive mix | 1316.9 |
| HMMM | 29.8 |
| TBBS | 4.9 |
| Crystex CurePro | 30.5 |
| Calculated Total | 1382.1 |

Banbury Second Pass: temperature 80° C. and starting RPM of 40. Add ingredients: add non-productive mix (first pass compound); add HMMM, TBBS, Crystex CurePro. Lower ram; mix at 60 RPM until drop temperature of 105° C. is reached. Milling Second Pass: water temperature on mill 140° F. Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges. Increase mill gap gauge to 1.2 mm for final sheeting out.

Rubber Properties. The NRK03 wire skim formulation, modified to use 65 phr of carbon black versus the original 55 phr, was used to compare rubber properties for A2 and A3 types of plasma carbon black filler (tire rubber composition examples AY2 to AY4) in comparison to N772 furnace carbon black (example AY1), with results shown in Table 98. The higher carbon black loading of 65 phr was used to account for relative reinforcement differences between N772 and N326, as the NRK03 formulation originally used N326. The colloidal properties of the plasma carbon black samples are in a similar range as the N772 reference furnace carbon black. The examples containing plasma carbon black filler show comparable rubber performance (within about 10%, plus or minus) to the reference furnace carbon black, including the same cured adhesion, which predicts similar bonding performance to brass-coated steel cords.

A significant and surprising advantage of plasma carbon black over furnace carbon black in the tire wire skim formulation NRK03 is noted for the property of thermal conductivity (k), which was remarkably 46% to 51% higher (enhanced) for plasma carbon black tire rubber compositions compared to the N772 reference furnace carbon black.

TABLE 98
Rubber Properties

| Formulation: | Example | | | |
|---|---|---|---|---|
| NRK03 Wire Skim | AY1 | AY2 | AY3 | AY4 |
| Formulation note/addition: | | | | |
| CB grade ID/code: | N772 | P096B | P096C | P096D |
| N2SA (m²/g): | 26.3 | 26.5 | 26.9 | 25.1 |
| STSA (m²/g): | 25.4 | 28.9 | 29.2 | 27.5 |
| OAN (mL/100 g): | 67.2 | 72.2 | 71.8 | 72.3 |
| COAN (mL/100 g): | 60.6 | 70.3 | 69.9 | 70.7 |
| Plasma CB type: | | A2 | A3 | A3 |
| Additional type info: | | | | |
| ts2 (min) [cure rheology at 150° C.]: | 2.75 | 2.93 | 3 | 2.44 |
| t60 (min) [cure rheology at 150° C.]: | 6.46 | 6.73 | 6.64 | 6.08 |
| t95 (min) [cure rheology at 150° C.]: | 14.6 | 14.8 | 14.6 | 14.3 |
| ML₁₊₄ @ 100° C. (MU): | 54.7 | 53.6 | 55.3 | 56.0 |
| Rubber cure time (min) at 150° C.: | 18 | 18 | 18 | 18 |
| M100 - 100% modulus @ 23° C. (MPa): | 3.3 | 3.0 | 3.1 | 3.2 |
| M300 - 300% modulus @ 23° C. (MPa): | 15.3 | 13.3 | 13.7 | 13.4 |
| M300/M100 @ 23° C.: | 4.67 | 4.40 | 4.43 | 4.17 |
| Tensile at Break @ 23° C. (MPa): | 17.4 | 17.4 | 17.0 | 18.0 |
| Elongation at Break @ 23° C. (%): | 366.9 | 416.0 | 398.4 | 426.6 |
| Shore A hardness: | 62.1 | 61.9 | 61.4 | 60.9 |
| Dispersion (%) [disperGRADER]: | 98.8 | 98.2 | 99.2 | 99.1 |
| Z Value (%) [disperGRADER]: | 94.4 | 91.4 | 94.1 | 93.3 |
| Density (g/cm³): | 1.173 | 1.204 | 1.185 | 1.185 |
| ΔG′ (MPa) [RPA; 60° C.; | 1.05 | 0.99 | 1.04 | 1.09 |
| 10 Hz; 1%-20%]: | | | | |
| tan δ [RPA; 60° C.; | 0.101 | 0.102 | 0.102 | 0.098 |
| 10 Hz, 10%]: | | | | |
| G′ (MPa) [RPA; 60° | 2.43 | 2.34 | 2.45 | 2.56 |
| C.; 10 Hz; 5%]: | | | | |
| Thermal Conductivity (W/mK) | 0.303 | 0.458 | 0.456 | 0.441 |
| Cured Adhesion to Brass | 100 | 100 | 105 | 100 |

The NRK03 wire skim formulation with cobalt naphthenate at 1 phr was used to compare rubber properties for A2 and A3 types of plasma carbon black filler. The colloidal properties of the plasma carbon black samples are in a similar range as the N772 reference furnace carbon black. A mixture of plasma carbon black at 27.5 phr and N234 furnace carbon black at 27.5 phr (50/50 mixture of plasma CB and furnace CB) was used in tire rubber composition examples AZ3 to AZ5. Two furnace carbon black reference examples were used: N772 furnace carbon black at 27.5 phr and N234 furnace carbon black at 27.5 phr to form a 50/50 mixture in the formulation (example AZ1); and N326 furnace carbon black at 55 phr in the formulation (example AZ2). The results are shown in Table 99. The examples containing plasma carbon black filler show comparable rubber performance (within about 10%, plus or minus) to the reference furnace carbon black, including the same cured adhesion, which predicts similar bonding performance to brass-coated steel cords.

A significant and surprising advantage of plasma carbon black over furnace carbon black in the tire wire skim formulation NRK03 is noted for the property of thermal conductivity (k). Compared to the N772/N234 reference (example AZ1), the thermal conductivity was 11% to 16% higher (enhanced) for the plasma carbon black examples. Compared to the N326 reference (example AZ2), the thermal conductivity was 7% to 13% higher (enhanced) for the plasma carbon black examples. Even when diluted 50% in a mixture with N234 furnace carbon black, the plasma carbon black still imparted significant increases in k relative to the wholly furnace carbon black reference examples.

TABLE 99
Rubber Properties

| Formulation: | Example | | | | |
|---|---|---|---|---|---|
| NRK03 Wire Skim | AZ1 | AZ2 | AZ3 | AZ4 | AZ5 |
| Grade N772 [or Plasma CB] loading (phr) | 27.5 | | 27.5 | 27.5 | 27.5 |
| Furnace N234 phr loading (phr) | 27.5 | | 27.5 | 27.5 | 27.5 |
| Furnace N326 phr loading (phr) | | 55 | | | |
| CB grade ID/code: | N772 | N326 | P096B | P096C | P096D |
| N2SA (m²/g): | 26.3 | 75.2 | 26.5 | 26.9 | 25.1 |
| STSA (m²/g): | 25.4 | 75.3 | 28.9 | 29.2 | 27.5 |
| OAN (mL/100 g): | 67.2 | 75.6 | 72.2 | 71.8 | 72.3 |
| COAN (mL/100 g): | 60.6 | 70.6 | 70.3 | 69.9 | 70.7 |
| Plasma CB type: | | | A2 | A3 | A3 |
| Additional type info: | | | | | |
| ts2 (min) [cure rheology at 150° C.]: | 2.23 | 1.96 | 2.23 | 2.34 | 2.26 |
| t60 (min) [cure rheology at 150° C.]: | 6.37 | 6.28 | 6.37 | 6.6 | 6.4 |
| t95 (min) [cure rheology at 150° C.]: | 15.97 | 16.02 | 15.8 | 16.39 | 15.75 |
| ML₁₊₄ @ 100° C. (MU): | 63.06 | 61.89 | 62.02 | 62.47 | 62.16 |
| Rubber cure time (min) at 150° C.: | 18 | 18 | 18 | 18 | 18 |
| M100 - 100% modulus @ 23° C. (MPa): | 3.9 | 3.6 | 3.7 | 3.6 | 3.8 |
| M300 - 300% modulus @ 23° C. (MPa): | 16.4 | 14.4 | 14.9 | 14.7 | 14.9 |
| M300/M100 @ 23° C.: | 4.19 | 3.94 | 3.99 | 4.11 | 3.95 |
| Tensile at Break @ 23° C. (MPa): | 19.6 | 20.7 | 20.5 | 21.5 | 20.1 |
| Elongation at Break @ 23° C. (%): | 383.2 | 437.0 | 434.4 | 455.8 | 423.1 |
| Shore A hardness: | 70.8 | 71.2 | 69.4 | 68.8 | 67.2 |
| Dispersion (%) [disperGRADER]: | 93 | 66.7 | 95.5 | 96.8 | 93.2 |
| Z Value (%) [disperGRADER]: | 86.8 | 65.4 | 88.2 | 90.4 | 85.9 |
| Density (g/cm³): | 1.158 | 1.156 | 1.162 | 1.162 | 1.164 |
| ΔG′ (MPa) [RPA; 60° C.; | 2.84 | 3.59 | 2.40 | 2.70 | 2.75 |
| 10 Hz; 1%-20%]: | | | | | |
| tan δ [RPA; 60° C.; | 0.168 | 0.192 | 0.142 | 0.162 | 0.167 |
| 10 Hz, 10%]: | | | | | |
| G′ (MPa) [RPA; 60° | 3.88 | 4.20 | 3.64 | 3.75 | 3.78 |
| C.; 10 Hz; 5%]: | | | | | |
| Thermal Conductivity (W/mK) | 0.303 | 0.312 | 0.344 | 0.335 | 0.351 |
| Cured Adhesion to Brass | 100 | 95 | 100 | 105 | 110 |

Ongoing and predicted evolutions in raw materials used in rubber compositions for tires, including several macro-trends in rubber formulating/compounding, are included within the scope of the present disclosure. Examples include efforts to replace conventional rubber ingredients with less hazardous/toxic alternatives, which includes safer alternatives to resorcinol type resins, and development of new stabilizers (antioxidants, antiozonants, etc.) to replace 6PPD in tire formulations. The eventual elimination of the multifunctional stabilizer 6PPD from tire compounds may also lead to the inclusion of more saturated elastomers (EPDM, partially or fully hydrogenated SBR and BR, etc.) in tire rubber formulations. Sustainable raw materials like plant oils, pyrolysis carbon from end-of-life tires and from biomass feedstocks, ground rubber particles, natural resins, lignin, microcellulose, nanocellulose, and the like are increasingly being used. Alternate sources of natural rubber are being developed, such as guayule and dandelion rubber. The present disclosure anticipates and incorporates all these changing raw materials sources and compositions. The present disclosure also applies to non-pneumatic tire components (including without limitation treads, sub-treads, and other components) with tire rubber compositions similar to those used in conventional pneumatic tires.

In any of the examples above, the latex slurry of the elastomer can be jet milled with a slurry of the plasma carbon black in order to pre-mix the rubber and the carbon black. Instead of adding the elastomer and the carbon black separately, a combination of the two can be added in one step. A particularly useful embodiment of this type of mixing is the mixture of natural rubber latex or emulsified styrene rubber latex with a slurry or dispersion of carbon black. The carbon black dispersion may be a water slurry and the water slurry may be pre-treated with a surfactant and sonicated or mixed via high shear or low shear mixing. After mixing these two solutions, the rubber/carbon black mixture can be dried, for instance in a spray dryer or in a rotary kiln or the like.

Any of the ingredients or classes of ingredients of a rubber article described herein can be deemed to be a special binder. Special binders may be added to the carbon black at the pelletization stage, or via a spray after the carbon black has been pelletized (before or after the dryer), or may be sprayed or added to the carbon black while it is still fluffy prior to being pelletized.

Any of the ingredients or classes of ingredients below can be substituted for, or expanded upon by, the ingredients used in the example formulations described in Examples 1-9 above.

Examples of elastomers used in the synthesis of rubber articles which can be used in tires include natural rubber (NR), copolymers of dienes including styrene-butadiene copolymers (e.g., styrene-butadiene rubber (SBR) of varied microstructures), butadiene rubber (BR), isoprene rubber (IR), halo-isoprene rubber (e.g., chloroprene), halobutyl rubber (e.g., bromobutyl rubber (BIIR)), and related elastomer types. More saturated elastomers like ethylene-propylene-diene rubber (EPDM), and partially or fully hydrogenated SBR, BR, and IR, can be incorporated in tire rubber formulations. The different elastomer types can be used in various combinations within a rubber formulation. Natural rubber from various natural sources can be used, including hevea, guayule and dandelion rubber. The natural rubber can be modified chemically or otherwise, for example epoxidized, hydrogenated, or deproteinized.

Functionalized SBR, BR, IR, and other functionalized elastomers can be utilized in tire rubber compositions. Functional groups can be incorporated into diene elastomers by coupling agents, polymerization initiators, polymerization terminators, post-polymerization functionalization approaches, incorporation of functionalized monomers, and/or the like. For non-limiting examples, for coupling to carbon black, functional groups comprising a C—Sn bond or aminated functional groups (e.g., aminobenzophenone) may be used; for coupling to an inorganic filler such as silica, silanol functional groups or polysiloxane functional groups having a silanol end, alkoxysilane groups, carboxylic groups, or polyether groups may be used. Other examples of functionalized elastomers include elastomers (e.g., SBR, BR, NR or IR) of the epoxidized type. Representative, but not limiting, grades of commercially available functionalized SSBR and functionalized lithium BR include: Kumho Petrochemical Company (KKPC), H series functionalized SSBR (e.g., grades 5251H, 5270H); Asahi Kasei, Tufdene E series functionalized SSBR (e.g., E581, E680) and F series functionalized SSBR (e.g., F3440, F3420); LG Chem, F series functionalized SSBR (e.g., grades F3438, F1810, F4626E), M series functionalized SSBR (e.g., M3626, M1525), and functionalized lithium BR (e.g., F0010); Arlanxeo, Buna FX series functionalized SSBR (e.g., grades FX 3432A-2, FX 5000). These grades, similar grades from other polymer suppliers, and all other commercially available functionalized SSBRs, functionalized BRs, and other functionalized diene elastomers are included in embodiments of the present disclosure.

Various accelerators available for formulating rubber articles may be classified by chemical structure. An example classification is as follows: 1. Thiazoles (Mercapto), 2. Sulfenamides, 3. Guanidines, 4. Dithiocarbamates, 5. Thiurams, and 6. Specialty Accelerators. Raw materials for thiazoles are aniline, carbon disulfide, and sulfur. Thiazole accelerators include, but are not limited to, 2-mercaptobenzothiazole (MBT), 2,2′ dibenzothiazole disulfide (MBTS), and the zinc salt of 2-mercaptobenzothiazole or zinc-2-mercaptobenzothiazole (ZMBT). Sulfenamides may be made by the reaction of 2-mercaptobenzothiazole with an N-chloramine or by oxidation of the appropriate amine salt of 2-mercaptobenzothiazole. Sulfenamide type accelerators include, but are not limited to, N-oxydiethylene benzothiazole-2-sulfenamide (OBTS), N-cyclohexyl-2-benzothiazolesulfenamide (CBS or CBTS), N-tert-butyl-2-benzothiazolesulfenamide (BBTS), N-oxydiethylene thiocarbamyl-N-oxydiethylene sulfenamide (Cure-Rite18), 4-Morpholinyl-2-benzothiazole disulfide (OMTS), and benzothiazyl 1,2-dicyclohexylsulfenamide (DCBS). Dithiocarbamate type accelerators include, but are not limited to, zinc dimethyldithiocarbamate (ZDMC), zinc diethyldithiocarbamate (ZDEC), zinc dibutyldithiocarbamate (ZDBC), zinc dibenzyl dithiocarbamate (ZBED), zinc N, N-di-n-butyldithiocarbamate/di-n-butylamine complex (ZDBCX), copper dimethyldithiocarbamate (CuDD), tellurium diethyldithiocarbamate (TDEC), and 2,2′-dithiodiethylammonium-bis-dibenzyldithiocarbamate (SAA-30). Thiuram type accelerators include, but are not limited to, tetramethylthiuram monosulfide (TMTM), tetramethylthiuram disulfide (TMTD), tetraethylthiuram disulfide (TETD), combination of tetramethylthiuram disulfide/tetraethylthiuram disulfide (TM/ETD), dipentamethylene thiuram tetrahexasulfide (DPTT), and tetrabenzylthiuram disulfide (TBzTD). Guanidine type accelerators include guanidine and its derivatives, for example, diphenyl guanidine (DPG).

Retarders and antireversion agents can be but are not limited to Cyclohexylthiophthalimide (CTP). This is an organosulfur compound that is used in production of rubber articles to slow the cure and stop (or inhibit) reversion from occurring. Processing oils may be classified into the three categories of paraffinic, naphthenic, and aromatic. Sulfur and sulfur donating molecules can be in the form of insoluble or soluble sulfur, nanoparticles, micron sized particles, or larger than micron sized particles, and may be known by brand names including Crystex and Rubbermakers, for example.

Activating agents can be ZnO or other metal oxides. The metal oxides can be nanoparticles or high surface area particles; they can also be micron sized or larger particles. The ZnO activators can be made via the French process or the American process, for example.

Antidegradants may include 1,2-Dihydro-2,2,4-trimethylquinoline (TMQ), which is an antioxidant used in rubber compounding to protect rubber from oxidative degradation. Another antidegradant (specifically antiozonant) is 6PPD N¹-(4-Methylpentan-2-yl)-N⁴-phenylbenzene-1,4-diamine, which is under scrutiny because the corresponding 6 PPD quinone is cytotoxic to certain species of fish. It can be envisaged that antioxidants can be fixed either to the surface of a particle or to a polymer in order to stop the toxic molecule from becoming bioavailable in rivers and streams. Other antidegradants found in rubber formulations may be waxes. Microcrystalline waxes may migrate to the rubber surface at a slow rate in order to form a surface barrier that protects the rubber from ozone and other degradants in the environment.

Adhesion promoters such as cobalt naphthenate, or other adhesion promoters that perform similarly to cobalt naphthenate, can be used.

Other classes of materials include reinforcing tire components used in the body ply. In tires for passenger vehicles, reinforcing cords in the body ply may be made of textile cord material, for example, polyester, rayon, nylon, aramid, combinations thereof, or similar suitable organic polymeric compounds that may be coated with an adhesive or bonding coating such as resorcinol-formaldehyde latex (RFL). In heavy truck and bus tires, reinforcing cords in the body ply may be made of steel that may be coated with brass or other coating.

Another class of materials is stainless steel wire that may be coated with brass or other similar compositions for the belt and the bead of the tire. The brass coating may contain copper, but the other metallic elements can be varied.

Adhesion of the cord to the surrounding rubber matrix is of utmost importance, and changing carbon black product, even between two suppliers of furnace black, can negatively affect the quality of such adhesion. The bonding between rubber and cord may be established via the formation of a copper sulfide interphase. Adhesion may depend on the thickness of the sulfide layer and thus the content of copper in the brass coating. The example of the steel cord shows the complexity of each ingredient and component that is used to make a tire.

The cord may be activated toward better adhesion. An adhesion activator, which may comprise a polyepoxide, can improve adhesion of the cord to rubber compounds after the cord is dipped with an RFL dip. Treatment of a cord may include treating the cord with an aqueous RFL emulsion comprising a resorcinol formaldehyde resin and one or more elastomer latexes.

Hardeners and hardening systems can be incorporated into the rubber matrix, including without limitation in rubber matrices for wire and bead skim components of the tire. Hardening systems may be or include methylene acceptors and methylene donors. A methylene acceptor may be mixed before or in the first pass, and then the methylene donor may be mixed in the next or second pass. These passes are sometimes referred to as the non-productive (earlier) pass and the productive (later) pass.

Methylene acceptors can be, for example, any of a resorcinol, a cardanol, a phenol formaldehyde, 3,5 xylenol, alkylphenol, polyphenol, arylalkylphenols, hydroquinone, naphthalene diols, cresol, t-butylphenol, hydroxybenzene, and/or the like. Also, a novolac resin that is either purchased or generated in situ from a reaction between a phenol and a formaldehyde, or any combination of phenolic resins, or any combination of two, three, or more of the above phenolic resins at ratios of 10:90, 20:80, 30:70, 40:60, 50:50, or any other ratio may be advantageous. In addition to phenolic resins, epoxy based resins can be used.

Methylene donors can be, for example, hexamethylenetetramine (HMT) or hexamethoxymethylmelamine (HIMMM) or other such molecules which react with methylene acceptors to form cured, crosslinked polymer resin within a final cured rubber article. If an epoxy is used as the methylene acceptor, the methylene donor may be selected from aliphatic polyamines, alicyclic polyamines, alicyclic polyamines, and aromatic polyamines.

Methylene acceptors may be one type of resin. Other resin types may be or include nonreactive phenolic resins, petroleum resins, tackifying resins, processing resins and other such resins. Hydrocarbon resins and natural resins are rubber ingredients that may be used in tire rubber compositions. Hydrocarbon resins include pure monomer resins, resins based on dicyclopentadiene (DCPD), C5, C9, C5/C9, and the like. Natural resins include rosin-based resins, terpene-based resins, and the like. These hydrocarbon resins and natural resins can be hydrogenated to various extents.

Peptizers utilized in rubber compounding may include diphenyl sulfides, xylyl mercaptan, phenylhydrazine, pentachlorothiophenol and the like. Loading levels may be between 0.1 and 0.5 phr or 0.05 and 0.3 weight percent as a rough estimation for natural rubber. More peptizer may be required for synthetic polymers where levels up to 1 weight percent can be observed.

The M100 or modulus at 100% elongation of a rubber article may be predicted by the polymer, the formulation and, for carbon black filled rubber articles, the surface area and structure of the carbon particles. For furnace carbon black and plasma carbon black having similar surface area (e.g., N2SA or STSA) and structure (e.g., OAN or COAN), the M100 values in the same tire rubber formulations are typically within about +/−0.2 MPa. However, while filler behavior at the nanoscale in terms of reinforcement may be similar, thermal conductivity differs widely—often 30% greater for the plasma carbon black filled rubber article versus its furnace carbon black filled counterpart. The enhanced thermal conductivity may be from 5% to 10% to 15% to 20% to 30% to 40%, even up to 200% or more greater for the plasma carbon black filled rubber article, a surprising result.

Each tire formulation/example disclosed herein is different, but possesses similarities. For instance, in the various examples presented within each of Examples 1-9, total polymer loading was in a range of 53.5 and 59.0 weight percent for all rubber formulations with the exception of the passenger vehicle tread, which was at 42.5 weight percent. The fillers (e.g., carbon black and precipitated silica) were loaded in a range of 26.6 and 32.8 weight percent. Elemental sulfur was present at 0.3 to 2.3 weight percent, and accelerators were loaded between 0.4 and 2.0 weight percent. Many adjustments or modifications to formulations can be made to these example tire rubber compositions to optimize performance or to accommodate specific goals for the compounds (stiffer vs. softer vs. rolling resistance vs. hysteresis). It is envisaged that these example ranges may be extended to accommodate such purposes. For non-limiting example, polymer(s) may be present in a range of about 35% to 65%, filler(s) from about 22% to 38%, elemental sulfur from about 0 to 5%, and accelerator(s) from about 0 to 5%, more or less, all by weight.

Systems and methods of the present disclosure may be combined with or modified by other systems and/or methods, such as, for example, chemical processing and heating methods, chemical processing systems, reactors and plasma torches, and carbon particles described in Int. Pat. Pub. No. WO 2015/116807 (“SYSTEM FOR HIGH TEMPERATURE CHEMICAL PROCESSING”), Int. Pat. Pub. No. WO 2015/116797 (“INTEGRATION OF PLASMA AND HYDROGEN PROCESS WITH COMBINED CYCLE POWER PLANT AND STEAM REFORMERS”), Int. Pat. Pub. No. WO 2015/116798 (“USE OF FEEDSTOCK IN CARBON BLACK PLASMA PROCESS”), Int. Pat. Pub. No. WO 2015/116800 (“PLASMA GAS THROAT ASSEMBLY AND METHOD”), Int. Pat. Pub. No. WO 2015/116811 (“PLASMA REACTOR”), Int. Pat. Pub. No. WO 2015/116943 (“PLASMA TORCH DESIGN”), Int. Pat. Pub. No. WO 2016/126598 (“CARBON BLACK COMBUSTIBLE GAS SEPARATION”), Int. Pat. Pub. No. WO 2016/126599 (“CARBON BLACK GENERATING SYSTEM”), Int. Pat. Pub. No. WO 2016/126600 (“REGENERATIVE COOLING METHOD AND APPARATUS”), Int. Pat. Pub. No. WO 2017/019683 (“DC PLASMA TORCH ELECTRICAL POWER DESIGN METHOD AND APPARATUS”), Int. Pat. Pub. No. WO 2017/027385 (“METHOD OF MAKING CARBON BLACK”), Int. Pat. Pub. No. WO 2017/034980 (“HIGH TEMPERATURE HEAT INTEGRATION METHOD OF MAKING CARBON BLACK”), Int. Pat. Pub. No. WO 2017/044594 (“CIRCULAR FEW LAYER GRAPHENE”), Int. Pat. Pub. No. WO 2017/048621 (“CARBON BLACK FROM NATURAL GAS”), Int. Pat. Pub. No. WO 2017/190045 (“SECONDARY HEAT ADDITION TO PARTICLE PRODUCTION PROCESS AND APPARATUS”), Int. Pat. Pub. No. WO 2017/190015 (“TORCH STINGER METHOD AND APPARATUS”), Int. Pat. Pub. No. WO 2018/165483 (“SYSTEMS AND METHODS OF MAKING CARBON PARTICLES WITH THERMAL TRANSFER GAS”), Int. Pat. Pub. No. WO 2018/195460 (“PARTICLE SYSTEMS AND METHODS”), Int. Pat. Pub. No. WO 2019/046322 (“PARTICLE SYSTEMS AND METHODS”), Int. Pat. Pub. No. WO 2019/046320 (“SYSTEMS AND METHODS FOR PARTICLE GENERATION”), Int. Pat. Pub. No. WO 2019/046324 (“PARTICLE SYSTEMS AND METHODS”), Int. Pat. Pub. No. WO 2019/084200 (“PARTICLE SYSTEMS AND METHODS”), Int. Pat. Pub. No. WO 2019/195461 (“SYSTEMS AND METHODS FOR PROCESSING”), Int. Pat. Pub. No. WO 2022/076306 (“SYSTEMS AND METHODS FOR PROCESSING”), Int. Pat. Pub. No. WO 2023/059520 (“SYSTEMS AND METHODS FOR ELECTRIC PROCESSING”), Int. Pat. Pub. No. WO 2023/137120 (“METHODS AND SYSTEMS FOR USING SILICON-CONTAINING ADDITIVES TO PRODUCE CARBON PARTICLES”), Int. Pat. Pub. No. WO 2023/235486 (“RECYCLED FEEDSTOCKS FOR CARBON AND HYDROGEN PRODUCTION”), Int. Pat. Pub. No. WO 2024/086782 (“SYSTEMS AND METHOD FOR MODULATING REACTING FLOWS”), and Int. Pat. Pub. No. WO 2024/086831 (“METHODS AND ADDITIVES TO IMPROVE PERFORMANCE OF CARBON PARTICLES IN ELASTOMER COMPOSITES”), each of which is incorporated herein by reference in its entirety.

Further variations and modifications of the present disclosure will be apparent to those skilled in the art and are intended to be encompassed by the claims appended hereto. While embodiments of the present disclosure are shown and described herein, such embodiments are provided by way of example only. It is not intended for the scope of the present disclosure to be limited by the specific examples provided within the specification. The descriptions and illustrations of the embodiments herein are not meant to be construed in a limiting sense. Numerous variations, changes, and substitutions may occur to those skilled in the art without departing from the present disclosure. It should be understood that no aspect of the present disclosure is limited to the specific depictions, configurations, relative proportions, examples, or results set forth herein, which depend upon a variety of conditions and variables. It should be understood that various alternatives to the embodiments described herein may be employed and that the present disclosure shall also cover any such alternatives, modifications, variations or equivalents. It is intended that the following claims define the scope of the invention and that methods and structures within the scope of these claims and their equivalents be covered thereby.

1. A rubber article comprising at least 2% by weight of a plasma carbon black filler compounded therein, wherein the rubber article is of a type that is an inner liner, a sidewall, a sub-tread, a bead skim, a wire skim, a tread, or a body ply skim.

2. The rubber article of claim 1, comprising at least 10% by weight of natural rubber, butadiene rubber, halobutyl, butyl rubber, isoprene rubber, chloroprene rubber, EPDM, and/or synthetic elastomer.

3. The rubber article of claim 1, comprising one or more of a precipitated silica, a recovered carbon, a furnace carbon black, a graphene, a lignin, carbon nanotubes, and a clay.

4. The rubber article of claim 3, wherein a ratio of the plasma carbon black filler to the precipitated silica, the recovered carbon, the furnace carbon black, the graphene, the lignin, the carbon nanotubes, or the clay is in a range of 1:10 to 10:1.

5. The rubber article of claim 3, wherein the precipitated silica, the recovered carbon, or the furnace carbon black is present in a range of 15 phr to 60 phr.

6. The rubber article of claim 1, wherein the rubber article has an enhanced thermal conductivity compared to a second rubber article of the same type that comprises furnace carbon black filler and no plasma carbon black filler.

7. The rubber article of claim 6, wherein the enhanced thermal conductivity is greater than or equal to 0.33 W/mK.

8. The rubber article of claim 6, wherein the enhanced thermal conductivity of the rubber article exceeds a thermal conductivity of the second rubber article by at least 5%.

9. The rubber article of claim 8, wherein the enhanced thermal conductivity of the rubber article exceeds the thermal conductivity of the second rubber article by at least 20%.

10. The rubber article of claim 1, comprising at least 0.2% by weight of MBT or MBTS.

11. The rubber article of claim 1, comprising sulfur in a range of about 0.05 to 5 percent by weight.

12. The rubber article of claim 1, wherein the rubber article has an enhanced diffusion compared to a second rubber article of the same type that comprises furnace carbon black filler and no plasma carbon black filler.

13. The rubber article of claim 1, wherein the rubber article has a reduced viscoelastic loss tangent (tan δ) compared to a second rubber article of the same type, wherein the second rubber article comprises (i) furnace carbon black in a weight percentage within 20% of the plasma carbon black filler in the rubber article and (ii) 0% by weight of the plasma carbon black filler.

14. The rubber article of claim 13, wherein the reduced viscoelastic loss tangent (tan δ) is at least 2% lower than a viscoelastic loss tangent of the second rubber article.

15. A carbon particle made via a combustion-free thermal plasma process, the carbon particle having properties comprising: a centrifugal particle sedimometry (CPS) measured equivalent sphere diameter of less than 1 micrometer; a lattice constant (Lc) greater than 3 nanometers (nm); and a deviation of less than 20% between a measured aggregate diameter and a calculated aggregate diameter, wherein the measured aggregate diameter is a Z-average value measured by dynamic light scattering (DLS), and wherein the calculated aggregate diameter (Da) is determined by the equation [Da=(2540+(71*OAN))/STSA].

16. The carbon particle of claim 15, comprising a silane added to the carbon particle after the carbon particle is pelletized and dried.

17. The carbon particle of claim 15, wherein a silicon content of the carbon particle is greater than 0.05% but less than 1%.

18. A rubber article comprising an elastomer composition, wherein the elastomer composition:
a. comprises a plasma carbon black filler compounded therein, wherein the plasma carbon black filler has a statistical thickness surface area (STSA) and an oil absorption number (OAN) within 15% of a comparative STSA and a comparative OAN, respectively, of a comparative furnace carbon black filler; and
b. has a thermal conductivity at least 10% greater than a comparative thermal conductivity of a comparative elastomer composition comprising the comparative furnace carbon black filler.
